(19) United States
(12) Patent Application Publication
(10) Pub. No.: US 2013/0191098 A1
(43) Pub. Date: Jul. 25, 2013

(54) METHODS AND SYSTEMS FOR SIMULATIONS OF COMPLEX BIOLOGICAL NETWORKS USING GENE EXPRESSION INDEXING IN COMPUTATIONAL MODELS

(71) Applicant: Clyde F. Phelix, San Antonio, TX (US)

(72) Inventor: Clyde F. Phelix, San Antonio, TX (US)

(73) Assignee: BOARD OF REGENTS OF THE UNIVERSITY OF TEXAS SYSTEM, Austin, TX (US)

(21) Appl. No.: 13/701,760

(22) PCT Filed: Jun. 2, 2011
(86) PCT No.: PCT/US11/38959

§ 371 Date: Mar. 25, 2013

(30) Foreign Application Priority Data
Jun. 2, 2010 (US) 61350703

(51) Int. Cl. G06F 19/12

(52) U.S. Cl. CPC G06F 19/12
USPC 703/11

(57) ABSTRACT

A method has been developed for using genome-wide transcription profile (i.e., gene-expression level) values to derive a gene expression index used as a kinetic value for every biological reaction and process assigned to each and every gene. This kinetic value is used in computational biology programs, i.e., mathematical models integrating genome, transcriptome, proteome, reactome, fluxome, metabolome, physiome, and phenome, in any combination, for simulations or theoretical systematic analyses of all life forms. This approach allows a model to be generated for any individual organism at any state of life, health condition, or disease/traumatic process. The model can include any or all biological reactions and processes, because an exact kinetic value becomes available; and, thereby, the outcomes represent stable or dynamic states of the individual organism at the time the biological specimen or sample was collected. Model systems without and with regulatory steps and mechanisms can be used to assess the present state of the specimen or sample and an acute response to an intervention within the system for the former and to predict some future state or status of treatment by testing single or multiple interventions within the regulated, dynamically responsive system for the latter; providing a prognostic value. Additionally, for multicellular organisms, the model can be tissue or cell type specific, depending on the source of the sample. Because of this capability, combined simulations can be generated with subsets of cells/tissues/organs/organ systems represented in a single model, in essence a reconstruction of the partial or complete organism in a single (or separate but integrated) computational model(s). Because all gene-expression values become available with genome-wide transcriptomic methods, surrogate tissue or cell samples can be used to predict other cells, tissues, or whole organism-level status; a utility essential for personalized individual medical care and history recording. This hierarchical computational approach is based upon the assumption that the transcriptome drives the reactome; and the proteome and metabolome, and other organism-level functions thereby effected, are resultant accompaniments to this basic integrative process in all organisms. If the genome and gene annotation (function) are known, or once they become known, for an organism and the transcriptome can be generated (even if from the genome of another related species, e.g., bovine genome used for buffalo), then this method can be used to generate a computational model representing that organism, inclusive of all living domains, Archaea, Bacteria, and Eukarya. The secondary data sets generated by the simulations are used for commercial and health care or promotion purposes of maximized yield or biomass production, health monitoring for improvement or sustained quality (for plants and animals, as well as smaller multicellular or unicellular organisms, such as insects and parasites, and microbes in ecological and environmental management, toxicology, agriculture, horticulture, and health management in general), bioremediation and biomining of pollutants, toxic substances, and precious metals, metabolic management for weight control, biomarker identification for commercial value (e.g., novel biofuels and sources), disease identification and management for prognosis, drug target identification, development, and testing, wound and tissue healing, overcoming drug resistances of bacteria, fungus, and cancer cells, development of novel singular or multiple therapies to individualize cancer treatments to the patient and specific molecular characteristics of the cancer cells or for treatment of metabolic disorders, and, in general, any biology-based approach to impact the improvement of humankind where study and testing of cellular based specimens is included. Additionally, the linking of the biological reactions to the life-sustaining and life-reproducing processes within the simulations generates data sets on individuals and ever increasing numbers of group samples in diverse categories in order that more global applications such as epidemiology, ecobiology, longitudinal growth and development analytics, and population dynamics studies can be implemented and performed.

### BACKGROUND OF THE INVENTION

1. Field of the Invention

The invention generally relates to computational models of living systems. More particularly, the invention relates to computational biology modeling systems using the genome-wide transcription profile values to derive a model for simulation or systematic analyses of biological reactions and metabolism in specific, individual organisms and life forms.

2. Description of the Relevant Art

Gene expression profiling has become commonplace for study and testing of many living organisms for which the genome is known. The human genome is most popularized but numerous genomes are known for other animals, plants, and microorganisms that live as single cells or in colonies; these cross the three domains of living organisms, Archaea, Bacteria, and Eukarya. Many different methods are used to measure gene expression level for singular genes, subsets of any size, or collectively altogether in a single analysis called genome-wide microarray.

The term gene expression index is used differently in many of these cases—and in particular for this invention. In the case of microarray analyses, the gene index is a value generated for each gene represented on a microarray chip or slide after accounting for technical quality controls on the raw value of the methodological signal; the value resulting from this indexing is then often called the gene expression level value that is then used in gene expression profiling on the genome wide scale. Many different indexing methods have been developed to generate reliable values to be used as a gene expression level in a profile analysis and other comparative studies or tests. Prior art teaches that the gene expression level values can be used to generate categorical data sets that can be used, along with other measures of biological chemicals from the same organism, as the source of the specimen or sample for the microarray test (see for example, U.S. Pat. Nos. 6,692,916; 6,963,806; 7,062,384; and U.S. Patent Application Publication Nos.: 2009/0192046 and 2005/0260615, all of which are incorporated herein by reference). These approaches can allow assignment of an individual profile to a category for diagnosis, treatment assignments, and prognosis, or in general for determining a nutrient composition to support or to adjust an organism's metabolism as in weight control for domesticated pets (See, for example, U.S. Patent Application Publication No. 2007/0118259, which is incorporated herein by reference).

Although impractical, some approaches perform extensive calculations to determine an estimate of the number of copies of a mRNA (defined in next paragraph) specific for a gene within a cell, but this is rare and the indexing or semi-quantitative methods as described for determining gene expression level values are more common. Also, the term gene expression level is commonly used to mean a value has been generated that reflects the amount of mRNA produced from a gene.

Variants in protocols for measuring gene expression levels target different features of the molecules resultant of gene expression, a process called transcription, and these molecules collectively are called ribonucleic acids (RNA); one particular type used to generate proteins (note that ‘peptides of all lengths’ is inferred when using this term, protein singular or plural, to indicate a gene product) is messenger or mRNA. Thus, a gene expression profile is often also called a transcription profile. This process of protein production is called translation. There is wide acceptance that the level of mRNA inside a cell, or specimen containing cells, is a direct reflection to the level of protein/peptide available to perform their functions inside the cell or outside if secreted.

Translation is a regulated process dependent on other proteins. Proteins and peptides can be found in two states, inactive and active. There can be two types of inactive protein, that which can be activated, like newly synthesized protein, or that which is determined to be degraded. This collective process of getting from the gene to the active protein along with the levels of the reactants interacting with the protein determines the kinetic value for that protein as a represented entity within a biological system at any point in time.

These methods, however, do not address the insufficient experimental determination of kinetic values for the mechanisms known to be involved in and critical for complex biological systems, leading to serious indetermination of parameters in a computational model.

### SUMMARY OF THE INVENTION

A method is described for simulating the reactions (reactome) of known biological pathways in an individual that is the source of a biological specimen or sample based on use of a computer-implemented computational modeling system containing the proteins and reactants of the biological pathway. The method includes obtaining a data set representing the gene expression values levels (transcriptome) for the individual biological specimen. The obtained gene expression values are inputted into the modeling system. The modeling system automatically assigns a Kineticome Control Coefficient, computationally derived from the value of gene expression level value. The modeling system further assigns a weighting factor that is combined with the Coefficient to derive a gene expression index value. In some embodiments, a user of the modeling system may assign the weighting factor, or modify the weighting factor. The modeling system applies the derived gene expression index as the kinetic reaction rate value (kineticome) for each protein and reactant interaction of the biological pathway. Output data sets are generated by the modeling system representing the simulated reactions (reactome) and metabolites (metabolome) of the biological pathway in the biological specimen. The generated output of biological processes represents functional properties of living systems.

In one embodiment, the biological specimen is a treated biological specimen, such treatment including exposure to a therapeutic agent, protein, enzyme or other substrate. The resulting gene expression level values represent the effect of the treatment on the biological specimen. The output data set, therefore represents the simulated reactions (reactome) and metabolites (metabolome) of the biological pathway in the treated biological specimen. The modeling system generates an output of biological processes representing functional properties of living systems.

The data set representing the gene expression level values (transcriptome) for the biological specimen may be obtained through microarray analysis. The gene expression index for each gene is computationally derived as a combination of proportion of the total of gene expression level values within the gene expression values data set, called the Kineticome Control Coefficient, and a weighting factor accounting for other determinants of kinetics collectively. The kinetic reaction rate value (kineticome) applied by the model for each protein and reactant interaction of the biological pathway is adjusted by a mathematical modification of either the Coefficient or weighting factor, such mathematical factoring comprised of either a user-defined input variable; or an input variable derived by the modeling system through analysis of the output deviation from a desired target output data set.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts a schematic diagram of a method used to analyze biological systems;

FIG. 2 shows a detailed diagram of cholesterol production;

FIG. 3 shows a plot of the value of the cholesterol metabolic profile at the end of the simulation;

FIG. 4A depicts the effect of replicating knockout conditions with a cholesterol model;

FIG. 4B depicts the effect of replicating desmosterolosis conditions with a cholesterol model;

FIGS. 5A-C depict the results of using the cholesterol model to replicates SLOS disease which is due to mutations in Dhcr7 that decrease enzyme activity;

FIGS. 6A-F depict various sensitivity analyses of the cholesterol model;

FIG. 7A depicts a metabolic profile from each simulation under conditions for the different AD stages;

FIG. 8A shows a plot of cholesterol ratio with reference to normal baseline levels versus the ratio of modified-Idi2 to SAD-Idi2 value;

FIG. 8B shows a plot of cholesterol ratio with reference to normal baseline levels versus the ratio of modified Fdft1 to SAD-Idi2 value;

FIG. 8C shows a parameter sweep of Idi2 and Fdft1 values with respect to cholesterol ratio;

FIG. 8D depicts the metabolic profile generated by the combination of changes in Fdft1 and Idi2;

FIG. 9 depicts the dose response to statin of cholesterol metabolism in human skeletal muscle;

FIG. 10 depicts the percent change in metabolite concentrations at the two highest degrees of HMGCR inhibition;

FIG. 11 depicts a line graph of percent change in ubiquinone and cholesterol levels in the cholesterol biosimulations models of human liver, skeletal muscle, and brain;

FIG. 12 depicts human skeletal muscle cells in vitro statin dose response of cholesterol synthesis rate;

FIG. 13 depicts human ovarian progesterone synthesizing (granulosa) cell in vitro statin dose response of cholesterol synthesis rate;

FIG. 14 illustrates the isoprenoid and sterol biosynthetic pathways;

FIG. 15 depicts biosimulation modeling of a genetic mutation in the dhcr7 gene;

FIG. 16 depicts biosimulation of severe Alzheimer's Disease based on fold change in gene expression;

FIG. 17 depicts biosimulation of severe Alzheimer's Disease based on fold change in gene expression;

FIG. 18 depicts the accumulation of HMG-CoA (precursor to mevalonate at HMGCR reaction) metabolite with simulation of effects of statins;

FIG. 19 depicts a graphical display of plasma levels of progesterone and estrogen generated by separate steroid biosimulation models;

FIG. 20 depicts a graphical display of cellular levels of several gonadal steroids generated by the same steroid biosimulation models;

FIG. 21 shows an illustration of a SimBiology multiorgan model used to simulate an organ system subset of a complete organism;

FIG. 22 depicts how the biosimulation model predicts that the levels of ketone bodies increase dramatically with starvation;

FIG. 23 depicts results of Time Course Biosimulation for Multi-organ System Model, after a challenge with a glucose solution as used in human glucose tolerance tests;

FIG. 24A depicts time-course of plasma glucose as reconstructed from C-peptide deconvolution, in nondiabetic patients (NGT), following oral glucose and isoglycemic intravenous glucose administration;

FIG. 24B depicts time-course of insulin concentrations as reconstructed from C-peptide deconvolution, in nondiabetic patients (NGT), following oral glucose and isoglycemic intravenous glucose administration;

FIG. 24C depicts time-course of insulin secretion rates, as reconstructed from C-peptide deconvolution, in nondiabetic patients (NGT), following oral glucose and isoglycemic intravenous glucose administration.

FIG. 25 shows the results of biosimulation on neotal baboon brain model to test effects of fold changes in select genes;

FIG. 26 shows the results of biosimulation on neotal baboon brain model, specifically that lower concentration of DHA increases desmosterol levels, while the higher causes a decrease;

FIG. 27 shows the effects of sleep on brain cholesterol and isoprenoid metabolism as predicted by the biosimulation;

FIG. 28 shows the effects of sleep deprivation on brain cholesterol and isoprenoid metabolism as predicted by the biosimulation;

FIG. 29 depicts sleep deprivation increases on ubiquinone levels as predicted by the biosimulation;

FIGS. 30A-D depict modeling results from studies of the biosimulation of oxidative pathways to apoptotic cell death;

FIG. 31 depicts modeling results related to oxidative stress in the biosimulation of oxidative pathways to apoptotic cell death;

FIG. 32 depicts modeling results related to ER stress in the biosimulation of oxidative pathways to apoptotic cell death;

FIG. 33 depicts modeling results related to glutathione-redox balance in the biosimulation of oxidative pathways to apoptotic cell death;

FIG. 34 depicts modeling results related to DNA methylation in the biosimulation of oxidative pathways to apoptotic cell death;

FIG. 35 depicts sensitivities analyses performed on the oxidative pathways to apoptotic cell death models for macrophage from subjects without (A) and subjects with (B) atherosclerosis;

FIG. 36 depicts the level of activity (flux) for cystathionase in macrophage from subjects with atherosclerosis;

FIG. 37 depicts the results of time course biosimulation for central carbohydrate metabolism and hydrogen production in Archaea under two different growth conditions;

FIG. 38 depicts results of time course biosimulation for central carbohydrate metabolism and glycogen levels over the simulation time, in Archaea under two different growth conditions;

FIGS. 39A-39C depict the change in average flux through metabolic pathways due to heterotrohic growth conditions;

FIG. 40 depicts the graphical data for the temporal increase in cholera toxin secretion (flux) by the bacteria within the intestinal lumen;

FIG. 41 depicts a graph of concentration change over time for accumulation of the cholera toxin A1 subunit in the cytosol of intestinal epithelial cells;

FIG. 42 depicts cAMP accumulation within the cytosol of intestinal epithelial cells;

FIG. 43 is a temporal profile of the chloride concentration increase within the intestinal lumen, due to the Vibrio cholera infection in the simulation;

FIG. 44 depicts the collection of water within the intestinal lumen on a temporal basis high correlated with the chloride efflux shown in FIG. 43;

FIGS. 45A-D depict various predictions of the cholera model related to Wnt;

FIG. 46 shows that an end point of the cellular communications in response to the bacterial infection is the switching of immunoglobulin production to IgA by populations of B-lymphocytes in the lamina propria;

FIG. 47 depicts the triacylglycerol biosynthesis pathway;

FIG. 48 depicts an example of a biochemical pathway map from KEGG;

FIG. 49 depicts human liver biosimulation;

FIG. 50 depicts that for human airway epithelial cells kinetic values at HMGCS and HMGCR steps in sterol synthesis have most profound effects on early intermediate metabolites the sterol pathway;

FIG. 51 depicts a graph of hepatic glucose transport flux based on a liver biosimulation model;

FIG. 52 shows the results from a biosimulation of the skeletal muscle metabolic flux one year after gastric bypass surgery in morbidly obese humans;

FIG. 53 shows that myristoyl-CoA is selectively reduced by nearly 40% one year after gastric bypass surgery in humans;

FIG. 54 shows that fetal liver under conditions of restricted calories shows changes in myristoyl-CoA.

FIG. 55 is a schematic diagram of the C30 botryococcene biosynthesis;

FIG. 56 depicts the results of time course biosimulation for fatty acid biosynthesis under conditions of increased acetate and deprivation of nitrogen;

FIG. 57 depicts results of simulation on diglycerides that are used by the cell for production of membrane phospholipids;

FIG. 58 depicts results of simulation on the C30 botryococcene molecule after transgenic addition of the botryococcene synthase reaction in the model;

FIG. 59 depicts the temporal profile of TGFBI gene expression as mRNA levels for the in vitro and in silico results;

FIGS. 60A, 60B, 61A, and 61B depict 3-D graphs showing concentration or flux on the y-axis, time to peak value and sample identifier on the x-axis and dependent variables measured on the z-axis for various test in a MG63 Osteosarcoma cell model;

FIG. 62: depicts the flux of the cleavage reaction of active caspase-3;

FIGS. 63A-63D depict the sensitivities tests for each of the four different cancer patient groups;

FIGS. 64A-D depict signaling and external apoptosis (TNFα, TRAIL, FasL) pathways sensitivities analyses.

FIG. 65: Simulation results for one of the external apoptotic pathways (TNFα).

FIGS. 66A-66B depict sensitivities analysis results of the TGFβ signaling for the MG63 cells;

FIG. 67 is a schematic diagram, that illustrates the integrated functional genomics approach for using transcriptome to reactome and transcriptome to metabolome technology for testing clinical cases of cancers for determining biomarkers and companion testing for efficacy;

FIG. 68 depicts the results of time course biosimulation for surrogate cancer cell system model, after a challenge with a standard dose of cytarabine;

FIG. 69 depicts Okasaki fragments accumulate in the good responder indicating a more successful effect of the chemotherapeutic drug;

FIG. 70 depicts a sensitivities analysis of surrogated liver cells and leukemia cells in patient model for poor outcome to chemotherapeutic treatment;

FIG. 71 depicts sensitivities analysis of surrogated liver cells and leukemia cells in patient model for good outcome to chemotherapeutic treatment;

FIG. 72 depicts the percent differences in gene expression over the prior decade for the human adrenal cortex;

FIG. 73 is a graph of stable growth arrest for each individual human subject in the original study;

FIGS. 74A-C depict the 3D graphical display of the sensitivities analyses results on the PBMCs from the normal, benign, and malignant groups of patient subjects;

FIG. 75A-B depict the results of the training set of PBMCs for assessing the “SARA” biomarker identified by the sensitivities analyses in FIG. 74;

FIG. 76 depicts results of the validation data sets using the training data set results as cut off values for the “SARA” biomarker test results to assign patients to the diagnostic categories of normal, benign, and malignant;

FIG. 77 depicts a temporal profile of the flux through the model simulation of the TGFBI mRNA expression;

FIG. 78 depicts the results of the training set of PBMCs for assessing the biomarker identified by the temporal analyses in FIG. 77; and

FIG. 79 depicts the results of the validation data sets using the training data set results as cut off values for the “slope of BN mRNA expression flux” biomarker test results to assign patients to the diagnostic categories of normal, benign, and malignant.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

It is to be understood the present invention is not limited to particular devices or biological systems, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise.

The following definitions are provided:

“Genome” as used herein relates to the entirety of an organism's hereditary information encoded in the organism's DNA. The genome includes both the genes and the non-coding sequences of the DNA.

“Transcriptome” as used herein relates to the set of all RNA molecules, including mRNA, rRNA, tRNA, and other non-coding RNA produced in one or a population of cells.

“Proteome” as used herein is the entire set of proteins expressed by an organism. More specifically, it is the set of expressed proteins in a given type of cell or organism at a given time under defined conditions.

“Reactome” as used herein refers to the biological reactions occurring in an organism. A Reactome may include all of the biological reactions that occur, or a subset of biological reactions which lead to a specific result.

“Kineticome” as used herein is the collection of all of the kinetic values attributed to the collection of all proteins (the proteome) or gene products that produce peptides.

“Fluxome” as used herein refers to the flux associations, in a plurality of enzyme reactions, between a plurality of reactants, also called substrates, and a plurality of metabolites, also called products.

“Metabolome” as used herein refers to the complete set of small-molecule metabolites to be found within an organism.

“Physiome” as used herein refers to the physiological dynamics of the organism.

“Phenome” as used herein is the set of all phenotypes expressed by an organism. The phenotype is the collective, or individual, biological processes, functions, and activities of an organism driven by the genes.

“Gene expression level” as used herein is the measurement of the activity (the expression) of the genes in an organism or a cell.

The utilization of indexing gene expression level values is described, such as to account for recognized biological principles that are also determinants of kinetic values of biological reactions and processes; thus, making possible the generation of a systems biology simulation (biosimulation) for the individual from which the specimen or sample was taken. It should be understood that an individual would mean a collection of cells for single celled organisms and thus the term sample is always combined with specimen to represent this broadened meaning. This simulation generates a secondary data set providing a vast amount of information on biological pathways for metabolism and cellular processes. This information is useful to the benefit of the individual whether directed at humans from themselves or experts, or from other organisms, such as a pet, agricultural animal or plant, insect pests that destroy natural resources or crops, parasites that plague humans, animals, and plants, algae producing biofuels, bacteria being eliminated by antibiotics, or hydrogen fuel being generated by archaea, as a limited set of examples.

In other instances of measuring gene expression where either a subset of genes is studied or tested or the approach requires raw data normalization to become more meaningful, the original methodological signal value for each gene can be normalized to the value for a gene recognized to have a stable expression level; the resultant value is also called a gene expression index. In one embodiment, this type of gene expression information is used for a subsequent indexing again to account for recognized processes that are also determinants of kinetic values of biological reactions and processes.

In one embodiment, an indexing method uses gene expression level as a function of a set of level values (whether with reference to one, some, or all genes) to generate a Kineticome Control Coefficient (“KCC”) for each gene product that is combined with a weighting factor that accounts for the collective contributions of these other determinants of a kinetic value. The weighting factor can be considered as a constant in the case of each gene and thereby the simulation results will reflect primarily the contributions of gene expression activities. Or the factor can be changed in known instances of alterations to genes and their proteins/products that would impact the corresponding kinetic value appropriate to the individual case.

One advantage of the methods described herein is that they meet a specified need that there is often insufficient experimental determination of kinetic values for the mechanisms known to be involved in and critical for complex biological systems, leading to serious indetermination of parameters in a computational model. Another more important advantage is the ability to use the methods to generate useful information about an individual specimen or sample for understanding the individual's molecular and cellular biology or pathology. The primary contribution of the embodiments described herein is an approach to convert gene expression level values (e.g., signal intensity or a derivative thereof) into a gene expression index value for each gene in any genome for any living (or shortly dead) organism. This process adds a new utility to the gene expression level values on small to genome-wide scales. A second contribution then is not only the term kineticome for the collection of derived gene expression indexes, but its immediate utility in that the ultimate gene expression index value, unique to the individual specimen or sample, can be used as the exact kinetic value for every gene to be represented in a mathematical, computational model, for the system (or network) of biological reaction(s) or processes in which the protein/product of each gene is involved. The gene expression index can also be used to determine a level value for the protein (gene products) themselves for representation in the model. This approach places into a “black box”, as a collective weighting factor, at least 4 biological components to get from a gene to a biological action that is proceeding at a specific rate at any one point in time during the state of the organism at the time a specimen or sample is taken to measure the gene expression level value. These 4 components are:
1. Transcription (RNA from DNA as a regulated process);
2. Transcriptional processing (maturation of mRNA)
3. Translation (production of peptides and proteins from mRNA); and
4. Posttranslational processing (modifications of proteins to activate and control degree of activity, and for inactivation, and destruction or degradation).

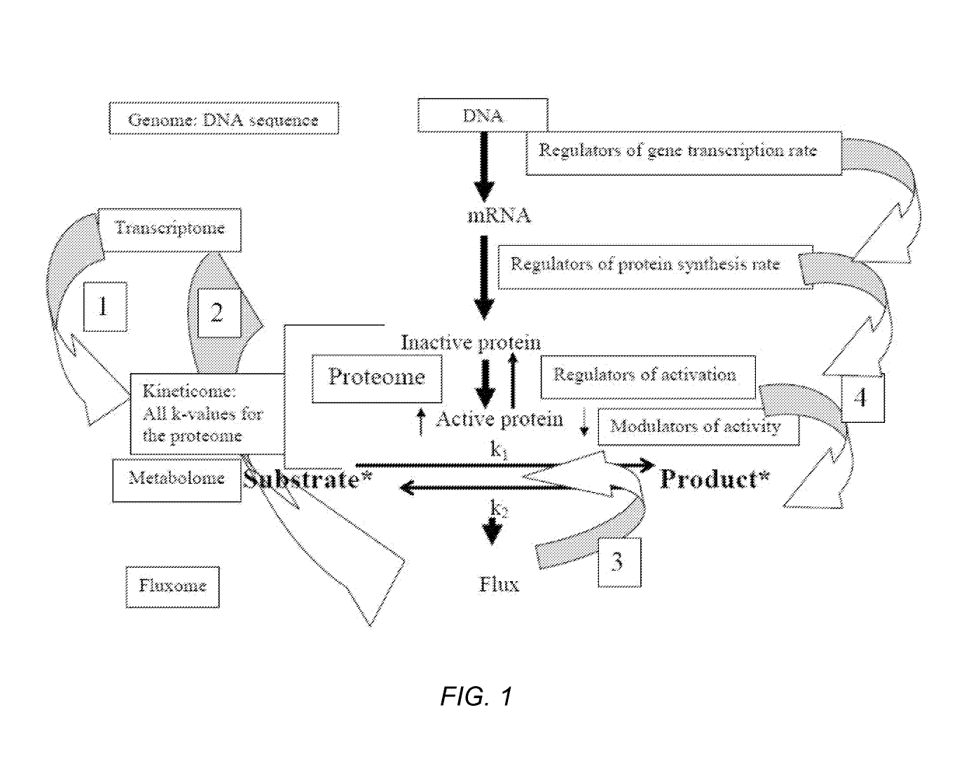

FIG. 1 illustrates these components and the basic schema of an embodiment. The representation of these biological components in the weighing factor as determinants of reaction kinetics does not preclude the representation of these components in a biosimulation designed with regulatory mechanisms included (#4 in FIG. 1) or that focus on these biological processes themselves.

A third consideration, also supported by FIG. 1, is that the gene expression index represents the degree to which the level of a particular gene is expressed within the total expression level for all genes and is proportional to the degree to which that gene, throughout its biological impact, contributes to the total phenotypic activities of biological reactions and processes. From this point forward, this principle will be referred to as the Kineticome Control Coefficient, which determines in combination with the weighting factor, the gene expression index. Undeniably, gene expression level is reflective of a certain amount of protein, e.g. enzyme or peptide hormone, that is present within a biological system. Classic kinetic analyses of biological reactions and processes (collectively termed pathways) substantiates this accepted fact, whether considering enzymatic, transport, or binding (as limited examples of) reactions, or processes, such as cellular division, gene expression regulation, cellular growth and death, cellular migration, and responses to environmental constituents like nutrients, drugs, or toxins. The methodological signal value of each gene included in a study or test however it might be indexed originally is used to derive a Kineticome Control Coefficient, for each of these genes, that is combined with a weighting factor to generate the gene expression index used as a kinetic value for the biosimulation in this invention. The weighting factor takes into account other contributors to kinetic determinations and can range from zero to 100 or thousands and potentially greater values in pathological or extreme physiological conditions.

First, the dogma of molecular biology needs to be explained in a bit more detail and then the concept of “-omics” before this novel approach to determining the kineticome is fully appreciated. The genome represents all of the genes of an organism at the highest level of biological control and with their unique nucleotide sequences determine the genotype; the phenotype is the collective, or individual, biological processes, functions, and activities of an organism driven by the genes—as a result of differential gene expression and variable peptide/protein activity dependent on the particular nucleotide sequences of the corresponding gene. The dogma of molecular biology (See FIG. 1) is that DNA makes RNA makes peptides/proteins makes reactions and biological processes (that proceed at certain kinetic rates determined by regulation of the peptide/protein activation and inactivation) makes metabolites; overall, this dogma extends to different cells in different tissues in different organs in different organ systems in whole organism(s) generating the metabolic and physiological state(s) of these organism(s), and collectively this conglomeration of biological properties represents the phenotype emergent from the genotype. Merging these concepts and terminologies, from this dogma there are all inclusive sets of genes (genome), RNA levels (transcriptome), peptide/protein levels (proteome), reactions (reactome), flux of metabolites, molecular or ionic species, and compounds through reactions (fluxome), metabolites (metabolome), and physiological and phenotypic state(s) (physiome and phenome, respectively). Thus the dogma of molecular biology can be extended and updated to the “-omes”, i.e., the genome drives the transcriptome drives the proteome drives the reactome drives the fluxome drives the metabolome drives the physiome drives the phenome. The “-omes’ are used in the described hierarchical computational modeling that attempts to take into account part or all of these levels of biological control as illustrated in FIG. 1.

A “black box” (#4 in FIG. 1) receives information on the production of mature RNA, the conversion of RNA to protein, and the modifications for regulation of the protein to contribute a weighting factor for any particular kinetic rate in one or more reactions or biological processes. Concomitantly, the method assumes that “the transcriptome drives the reactome kinetics”; at least a substantial driving force or determinant. Notably, the weighting factor does allow one to account for modifications to kinetics by these other sources of determinants. The reactome is known from the bibliome (collective literature in bibliography of human history).

The transcriptome data, as gene expression level and transcription profile, is generated most commonly today by the technique called genome-wide microarray analysis, but others exist and will be invented in the future and can readily be included into the approach described herein. The computational model is produced automatically and/or manually by using the bibliome and available pathway structures from public internet sites (e.g., Kyoto Encyclopedia of Genes and Genomes (“KEGG”), MetaCyc, BioCyc, AraCyc, Reactome®, etc.). Manual curation of the pathway networks beyond the specific reactions, genes, and process steps provided by these resources is typically required. Modeling software programs can be purchased (e.g., COPASI, MatLab SimBiology, etc.) or developed independently by one skilled in that area. Standard spreadsheet, database, graphical, and statistical software can be used to perform the gene expression indexing and sorting to assign the kinetic values appropriately within the model and to analyze the secondary data sets. U.S. Pat. No. 6,983,227 describes a method to develop software for virtual models of complex systems and is incorporated herein by reference.

In one embodiment, a method first generates the kinetic value needed for each reaction or process in the resultant model that would use such determining parameters, e.g., deterministic model of adult human liver metabolism. The secondary data set resulting from the simulations run on the model then become a tremendously useful resource, e.g., determination of specific alterations in metabolic pathways in the liver of a diabetic patient to establish an individualized starting dose of statin to control cholesterol synthesis. Transcriptome, or genome-wide gene expression, data sets are available for download and analysis such as the ArrayExpress Gene Expression Atlas and the National Center for Biotechnology Information (NCBI) Genome web site via the Gene Expression Omnibus (GEO) DataSets site for testing and validation. Any one of these transcriptome data sets may be considered as a gene expression profile. To generate new transcriptomic data, of course, one merely needs the cellular specimen or sample with intact RNA and have the microarray test performed via available academic or commercial laboratories; some microarray laboratories are also certified as clinical laboratories in anticipation of United States Food and Drug Administration (FDA) approval and utilization on human patients.

The methods described herein may be implemented with a subset of genes for which expression levels are determined for a specimen or sample. In biologically relevant terms, the proportional expression of any one gene relative to the expression level of other genes in the genome determines its contribution to the kinetic state of the considered biological reaction(s) and/or process(es). To whatever degree this novel biological theory might be true or untrue, the results of the proof of concept and reduction to practice are, presently, remarkable matches of experimental and clinical data with acceptable and reliable utilities. Diverse sources of information on gene expression profiles are useful to demonstrate the ease of achieving this use of the invention. For example, tissue and organ specific expression profiles are available from T1 Dbase, Human Genome eXpression Profiles (HGXP), and Allen Brain Atlas. One other example could be use of the currently commercially available PCR-Arrays® that are pathway specific, from QIAGEN SABiosciences. As another example of genome-wide uses demonstrating the ease and flexibility of the invention for studies across species and for sophisticated biological pathways, GEO transcriptome data sets for ovarian cells collected as specimens or samples during specific developmental stages of the follicles through the estrous or menstrual cycles (i.e., used rat, buffalo, bovine, and rhesus monkey data sets) generated simulations of plasma estradiol and progesterone levels matching the well known profiles, and species differences, throughout the estrous/menstrual cycle.

The global applicability of method to the three domains that include all living organisms stems from the following basic, widely accepted, principles of biology. There are several different types of gene expression and those key to this invention are cell-specific, tissue-specific, organ-specific, organ-system-specific, and organism-specific (in two senses of the term, i.e., a species or a particular individual). In the cases of single cell organisms, the cell-specific expression is the organism-specific expression as well. Thus, when in the possession of a transcriptome data set, or truncated gene expression profile, that was generated from a specimen or sample containing a single type of cell, then the mathematical or computational model produced is specific to that cell and species. As an extension, this would be true for every type of gene expression stated. For example, if a skeletal muscle tissue sample is used from a particular, individual human research subject, patient, or commercial customer (e.g., a professional football player), the resultant human skeletal muscle model would represent that person's skeletal muscle at the time the sample was collected. This holds true for other animals, as well, for example with dogs after exercise conditioning. This type of representation, equivalent to how a blood sample taken to check cholesterol levels once a year represents the blood levels at the time the sample was collected, thus, is state-specific, e.g., pre-exercise versus post-exercise conditioning. In such cases a commonly used modeling method is called deterministic with mass action reactions and flux of ‘molecules’, ‘compounds’, ‘elemental micronutrients and vitamins’, or ‘ionic species’ through the biological reactions or processes calculated with ordinary differential equations (ODEs). Other modeling approaches may be equally useful or integrated to extend an application to another scale of analysis, e.g., membrane physiology, cell or animal population growth analyses or cancer survival rates. Importantly then, three additional types of gene expression are useful: age-specific, pathology-specific, and what could be called ‘purpose-specific’ gene expression. The third type would include processes such as wound healing, responses to hypoxic or toxic insults, and trauma or injury. If the method is used to calculate kinetic values used in such a state-specific model, then the question of what the phenotype is, rather than how that particular phenotype was generated, is answered. On the other hand, modifications of the modeling technique, still using the basic premises of this method, can allow investigative applications to answer the latter question—generating value in studying progressive developmental, aging, disease or healing processes and determining prognoses, as prime examples.

A most closely related prior art is called constraint-based modeling. Prior art exists (e.g., U.S. Pat. No. 6,983,227, which is incorporated herein by reference) for computer programs and applications based upon this constraint-based modeling to determine the kinetic values for reactions. Again, in contrast to the present method, the prior art uses constraint on flux values, thus determining kinetic values by using an algorithm as a result of modeling not as a determination of behavior of the simulation.

The life cycle of most biological macromolecules exhibit commonalties such as: production (biosynthesis or anabolism), maturation, activation, biological activity or function, inactivation, and destruction (degradation or catabolism). (See FIG. 1). Each of these levels has complexities of multistep processes and each of these consecutively will have regulated kinetics and require kinetic values in a mathematical model. These collectively are taken into account in the present method by the weighting factor or they can be included as separate steps with more complete models of regulated systems that will have predictive properties, referred to as dynamic modeling in this method. The likelihood that the actual kinetic value of each and every one of these steps and processes can be determined is extremely low, even across a few generations of humans. Thus there are, in practicality, two choices: 1) trust the human made algorithms to generate parameters for each of these steps and processes until all are known for every possible case; or 2) trust and use the biological principle put forth in practice by the present method. With either choice there is risk of false-positive or false-negative kinetic values to be used. With the first choice, this might never be known for each and every sample; with genome-wide microarray technology, these are known and the accepted risk is manageable. Since the commercial microarray technology is in a competitive arena, that technology will advance much faster than the rate of accumulating the scientific evidence necessary to understand more completely the risks taken with the algorithms.

The present method does not use constraints and has an arrow going directly from the representation of ‘microarray gene expression level’ to ‘kinetic values for individual reactions and processes’ and subsequently the simulations generate ‘flux and metabolite levels’. (See FIG. 1). These flux and metabolite levels themselves, or the effect they have on complex biological processes, like cell proliferation or death, are then used by or for the individual from which the specimen or sample was collected. The global utility of these secondary data sets is an advantage of the method. They are repeatable and have validity even to fit into a realm of existing knowledge; they are provided to a user for indicated or desired uses; and they are of substance in that they can be acted on to bring about an understanding of a condition or status of an organism or to intervene and bring about changes in that organism. Subsequent use of the method for that individual allows tracking of the effectiveness of the intervention and anticipated changes. In addition, because these data sets, simulated metabolome for example, can contain all known components, the present method has the advantage of generating new knowledge in areas not possible with prior art—in particular the fact that the new knowledge is from individual specimens or samples.

In one embodiment, a method is used to generate an individualized biosimulation process: a) that derives a unique gene expression index value, for each and every gene measured in an individual organism, from a raw or normalized signal value for gene expression level, generated in a transcriptome analysis by genome-wide microarray methodologies or other applicable, standard methodologies; b) that identifies, sorts into a step by step sequence, and assigns each gene along with its expression index value to its corresponding protein-dependent step or multiple steps in one or more metabolic and/or systematic biological pathways (the reactome); c) that inserts all individual gene expression index values as the kinetic values at the assigned step or steps, within a global or partial, systems biology, network computational model; d) that executes a simulation of the biochemical and systematic network, in silico, using computational biological methods; e) that determines, by use of that kinetic value set (hereafter termed kineticome): 1—the flux associations, in a plurality of enzyme reactions, between a plurality of reactants, also called substrates, and a plurality of metabolites, also called products (the fluxome); 2—reliably representative levels of reactants and metabolites; as well as levels for all other molecules, elements, and compounds, both biological, natural, or synthetic, included within the model; and altogether specified for all of their localizations within biological compartments and structures of cells, systems, and multicellular organisms (the metabolome); 3—binding properties of biological macromolecules together, or with signaling molecules and compounds, for activation, signaling, or actions otherwise mediating biological processes, 4—transport rates and permeability ‘values’ of ions, nutrients, or other biological, natural, or synthetic molecules, elements, and compounds across biological structures, 5—biologically relevant properties derived from these ‘values’; examples such as membrane potential, pH, pressure, tension, or gene transcription rates (2, 3, 4, & 5 as the physiome), and 6—temporally definitive, salient and dynamic features of all biological processes (including 1-5 above) essential to sustaining and reproducing life processes and forms in all organisms (altogether as the phenome); and f) that generates end user data sets and reports, readily modifiable to meet clients' specialized needs. A unique feature of this method is that the simulation model is a direct representation of the individual organism from which the specimen or sample was taken to generate the gene expression information on the transcriptome results originally—it is that cell, that tissue, that organ, that organ system, that organism; that person for human applications. No other prior art has apparently achieved this level of utility and applicability.

In applications to health for humans, animals, and plants the essential information for insights into the diagnoses, treatments, and prognoses has historically come from the phenome, physiome, and metabolome (or metabolic profile), for which there is a limited toolset for measurement; and they are the most difficult or impossible to generate comprehensively with present technologies for analyzing a specimen or sample from the organism. On the other hand, the transcriptome (or transcription or gene expression profile altogether or in subsets) of cellular specimens or samples from organisms can readily be generated with existing methods. The method takes the transcriptome (gene expression profile information and results) and generates the complete set of these other subsequent “-omes” to extend the resources available to investigate and to understand normal, abnormal, and recoverable biological systems features.

Experimental and purposeful manipulations of the individual or categorically grouped data sets and model systems extends the utilities of the method into a new realm of discovery and knowledge. Commercial and agricultural utilities of the secondary data sets generated by the method have equal potential for impact. Prime examples include but are not limited to biological modeling for maximal production of biofuels from seeds, such as soybean, or algae that secrete oils and preserve biomass; bioremediation or biomining of precious metals with archaea under harsh conditions or other bacteria; improving yields, nutritional value, and survival of food plants under limiting conditions; improving and controlling animal fertility and reproductive capabilities; and improving and monitoring vegetable, fruit, and meat to improve nutritive and appetitive qualities. The application of the method to toxicology testing and investigations will help protect all organisms from natural and industrial substances and compounds found in the environment. Now with the space-station, one can easily envision investigations and tests of extended zero gravity effects on biological systems, e.g., wound healing processes.

This advance in the technology is a radical and essential extension beyond genome-based personalized medicine and health promotion in humans, animals, and even plants. Typically genome-based personalized medicine is used once and the test result is static for an individual throughout life—your DNA sequence is expected to be unchanged. Prior modeling technologies either have a computer algorithm estimate a reasonable kinetic value or rely on kinetic data sets that are of questionable applicability in all cases or generally not available. In that way, prior technologies are limited: a) to creating a reasonable baseline model system from uncertain population-based data sets and from trained computational models, b) at best, to using traditional fold change in gene expression level data, from transcriptome (altogether or in subsets) analyses across different sample populations, c) thereby, to resetting subsets of reaction properties (called parameters) in the baseline model, d) then, to interpreting that reset model only as the second state and e) finally, only allowing application of the simulation results, statistically, to groups of individuals categorized to that second state. A critical failure is that there is no way of knowing if the baseline model genuinely represents the baseline state at which the reference (or control group) sample was taken for the other group of subjects on which the transcriptome analyses were performed; were they even the same age group or gender as for the samples used to generate the baseline model? Although this approach is still possible with the present method, the baseline is the individual at a known moment in time, or is from a specimen or sample set of a study or test group(s) generated from a representative and specified population that would be intrinsically consistent with the study or test group(s), not a representative, external, population data set. The prior art has limited predictive qualities restricted to population-based probability, not individualized data sets—they can not state that this is what your metabolism looks like now and might change to with these alterations to these sets of parameters. If such alterations are made on the individual and a subsequent sample taken at the predicted end point, the present method will reveal if the prediction was accurate based upon the population-based evidence. Regardless of population outcomes, the subsequent simulation is of that same individual—a paired comparison of repeated measures across time and treatments, or longitudinal tracking. A unique individual history is generated with sample collections at regular intervals, as well as for categorical groups. Additionally, collections of individuals within and across experimental study or test groups can be analyzed statistically using the secondary data sets generated by the collections of individual simulations. In other words, the method, by providing the secondary data sets, e.g., comprehensive metabolic profile, is useful to the individual subject or patient (personally and via a health care provider or advisor), as well as for clinically relevant categories for development and testing of novel therapies, e.g., Phase I and Phase II clinical trials.

Additionally the prior art has claims to produce organism- or cell/tissue-specific models merely by having recognized metabolic pathways and biological processes important for them—but unless all kinetic values for every step in the pathways are known exactly, no other feature makes these model approaches individual-based and specimen-specific modeling. Just because you put a cow in a building, the structure is not automatically a barn; just because your mother says your room looks like a pigsty, does not mean a pig could thrive there. If a specimen of your muscle cells is used to set the kinetic parameters for a global metabolic model of human cells, then that is a model of your muscle; and if your muscle is collected again after running a marathon a week later, the resultant model is of your muscle at that specific time after the marathon. If the global metabolic profile of Kobe beef can be examined specifically and individually, then other beef cattle strains can be compared and modified via feed stock—or otherwise developed to meet specified product qualities. If you are on a ‘high protein-low carbohydrate’ diet your cheek cells should be just as ketogenic as your liver or muscle cells—proportionate to conglomerate corresponding gene-expression conversion values. This is the ideal technology for providing global metabolic and biologic information about specific individuals generated from each specific individual, whether a human, animal, plant, bacterium, i.e., inclusive of the three domains of life, Archaea, Bacteria, and Eukarya. This universal applicability allows unlimited end user flexibility, in utilities to study and to solve problems in biology, ecology, and medicine, and creativity, in utilizing and interpreting the resultant data sets for the metabolome, fluxome, physiome, and phenome. These features can complement traditional and novel approaches to utilizing and interpreting data from genomic and transcriptomic studies and tests. For humans and animals, this method is the one true individualized health management tool for the pinnacle advancement of personalized medicine. The potential applications are limitless across organisms and for combining multiple cells, tissues, organs, organ systems, and even organisms within a single computational model. The considered applications herein are representative for clinical and commercial utilities of great import and are not to be construed as all inclusive.

A fundamental embodiment includes the utilization of surrogate cell or tissue specimens or samples to predict simulation outcomes for other cells, tissues, organs, and organ systems (‘target set’) within the same multicellular organism. Population data is required to generate the conversion factors for the gene expression index of each gene in the surrogate cell transcriptome to the index for that gene in the ‘target set’. There is a long history in the scientific literature (the bibliome) recognizing differential gene expression levels from cell type to cell type, e.g., fat cell to skeletal muscle cell, tissue to tissue, e.g., plant leaf to plant root, organ to organ, e.g., brain versus heart, and organ system to organ system, e.g., circulatory to reproductive system—as well as from organism to organism (either intraspecific or interspecific, and even across Domains). Therefore, it follows that the derived gene expression index value set (kineticome) should correspond equally in proportion among the sources of specimen and “target set”. To establish this set of conversion factors, many data bases already exist that contain genome-wide transcriptome data for gene expression levels from candidate surrogate cells and ‘target sets’ for many species of animals, including humans, and plants. These too are referred to as a gene expression index based on profiles of gene expression levels. Additional, more specialized and specified data sets can be generated over time. A primary surrogate cell for animals is the buccal epithelial (cheek) cell as used commonly for DNA identification tests. A second surrogate cell source are the white blood cells from a blood sample. A third surrogate cell set is respiratory epithelium of either the nasal mucosa or that from the lower respiratory tract to study and to test biological pathways involved in allergies and asthma, as well as other respiratory disorders. This premise applies to other multicellular organisms, e.g., insect tissue or cellular surrogates. Once a conversion matrix is established with ever increasingly larger data sets to support the reliability of the conversion factors for each gene, virtually any cell or tissue can serve as a surrogate.

The primary premise for the global applicability of the method to all living organisms is that if the genome (DNA sequence) of an organism is known, if the gene annotation (assignment of gene sequences to known genes, their corresponding proteins, and biological functions) is established, and if the genome-wide microarray analysis of that genome is available (in other words, a transcriptome analysis can be performed), then the method can be used to generate a deterministic computational model of the entire or partial metabolic network and set of systematic biological processes. Such a deterministic model, lacking regulatory steps and mechanisms (See FIG. 1) represents the state of the organism (or specimen or sample specifically, if not an entire organism) at the time taken; similar to an annual blood test panel for humans or animals. Dynamically responsive models that include regulatory response mechanisms in addition to the network of the deterministic model can use the gene expression index as a start point and with perturbation of the system, e.g., addition of a drug to a human model, or pesticide to an insect model, a predictive value is generated to guide experimentation or treatment of the individual organism for a desired end point. This predictive quality differs from the prior art as a state-dependent comparison. A dynamically responsive model will progress through a series of state changes based on the nature or abnormal properties of regulatory and modulatory biological systems, e.g., feedback onto proteins and transcription factor generated alterations of gene expression levels.

One considered application emphasizes the potential impact and benefit of such capabilities in clinical settings; with a surrogate cell sample and cancer cell sample from an oncology patient, both the patient organ systems critical to pharmacodynamics, metabolism to active form, and clearance for known chemotherapeutic agents, together with the cancer cell multiplication and growth (hyperplasia and hypertrophy), epithelial-mesenchymal transition, and cell-death (apoptosis) processes can be modeled simultaneously. The clinicians could request simulation results on the present status of the patient and cancer cells for categorization, acute response to a range of candidate chemotherapeutic agents with the deterministic model, intermediate and long term responses of the patient and cancer growth (proliferation) and spread (metastasis) potential with the dynamic model, and ultimate prognosis for remission. Additionally, with such models in scientifically designed experiments new combinatorial therapies or novel chemotherapeutic targets can be developed. The method complements existing genomic test results that would become incorporated into the derivation of the gene-specific kinetic values from the Kineticome Control Coefficient.

More and more, the impact of slight differences between nucleotide sequences in the genes (genomics) of individuals becomes familiar knowledge. A commonly used genomic analysis is the detection of SNP (single nucleotide polymorphisms) that are either located in the promoter region of genes affecting the regulation of gene expression or they are located in the encoding region and affect the function of the protein either as a gain in or of function or a loss of function. In the latter case, genomic testing is key for determining whether a cancer patient is a low or high metabolizer for either activation or inactivation of chemotherapeutic agents. Other applications of genomic testing have implications for nutrient metabolism or metabolic rate capabilities, as well predilections for particular diseases and disorders. Again the major limitations of these methods is that they provide singular information as indicators or indices and they do not provide any functional information on the impact of these genomic characteristics within the complex biological systems of the individual on whom the tests are performed. Gene mutation analysis is another method to detect and determine gene differences that impact protein functions similarly as increased or decreased, and in some cases taking on altogether different functions as a gain-of-function. The present method provides that needed functional information integrated within either limited subsets of the system or on a global level. There is a limited range of changes expected in these cases of genomic variances that are seen as altered gene expression levels that can be to a null level in some cases or altered protein activity with only slight changes in gene expression levels. As this information becomes known or estimated in each case the Kineticome Control Coefficient will be adjusted automatically if gene expression level has changed and the manual curation process accounts for any change necessary in the weighting factor as the second step in deriving the kinetic values in order to account for protein changes (See FIG. 1). An obvious example would be the use of the method to model responses and reactions of a breast cancer patient to tamoxifen by combining the genomic information gained to categorize the patient as either a low or high metabolizer, adjust the weighting factor accordingly in the biosimulation model that includes representation of the patient's blood, liver, and cancer cells. Then simulations can be run to determine a prognosis of successful treatment.

Because the method includes genomic-transcriptomic level representation within the simulation model, in silico genetic manipulations, such as gene knock-out, knock-down, and knock-in (in other words classical transgenics) are possible. Such transgenic studies can be performed in silico before the costs are incurred to perform the same study in vivo consuming or risking living organisms. Such manipulations can have robust commercial and medical impact, for example, genetic modifications of algae for optimization of oil production and to contain genes from other organisms that most effectively secrete the oil to the growth medium; here the oil is immediately available for capture and processing as biofuel or nutrient-supplementation for animals and humans. It is also possible to envision a type of formulation containing reagents to transfer genes into antibiotic resistant bacteria or chemotherapeutic resistant cancer cells that could have topical application or systemic administration. If these genes (or possibly a single gene) could resensitize the resistant bacteria or cancer cells to a regime of antibiotics or chemotherapeutic agents, infection and oncology management in clinical settings could be ameliorated more effectively than with present day treatment regimens. For example, what works for one patient does not always work for another patient with a similar decubitus and bacterial strain or cancer type; and there are few empirical methods of predicting what treatment regimen will work best for any particular patient case. One considered application demonstrates how tissue samples (a remote surrogate cell and local affected tissue) could be taken from a human victim of ‘bed sore’ (decubitus) and of the antibiotic resistant bacteria infecting that local tissue of the same individual. The simulation model could include the surrogate-cell representation of the patient's circulation, metabolism, and excretion (clearance) of antibiotics, of the affected tissue, and of the antibiotic resistant bacteria; a range of known antibiotic regimens could be tested and the resensitization-formulation could be tested after being developed using population data. Similar approaches can be used to develop and to test plant resistance to insects and herbicides; or insects to insecticides.

The anticipated service to pharmaceuticals and ultimately clinicians (after FDA approval) for history, diagnosis complementation, and prognosis is based upon comprehensive metabolic profiles. This feature links genome, or transcriptome more specifically to the metabolome, readily lending utility to optimal biomarker identification. Distinctively, the method provides a means to track the pattern or profile of metabolites as known entities and at a low cost prior to utilization of much more costly instrument based detection and quantization methods. Moreover the possibility exists of using a service, personally as a consumer, that would help him/her understand his/her own metabolism and make changes in his/her behaviors (diet, exercise, alcohol consumption, etc.) to determine the impact—and having a web site with the personalized information to understand the importance and health relevance of the various metabolic pathways and metabolites, e.g., fatty acid synthesis versus catabolism, oxidative load (glutathione), aging processes, inflammation, etc. One can easily see how this could extend to domestic pets and their health management.

The technology will be essentially the same for the research/clinical based and consumer direct companies. No FDA approval is required for the latter, but properly collected data could be useful when ultimately dealing with FDA or federal funding agencies for grants to perform clinical trials. Development of software would be needed to process all of the data from sample, gene expression profiles and link into computational simulation models; just the same, commercially available spreadsheet, data base, simulation, graphical, and statistical analyses software can be used by anyone with appropriate training with the software and basic skill sets in biology. Mathematical expertise is not required but access to such expertise through professionals in that specialty is beneficial.

The method described assumes from a background in biology an awareness of the “Dogma of Cell (or Molecular) Biology”, DNA is used to make RNA is used to make proteins. The cellular process of getting from DNA (the genes) to the RNA is called gene expression and microarray technology (e.g., Affymetrix) allows the expression profile to be determined, for example, of all 22,000 plus genes in the human genome, the transcriptome. The method may be used to simulate, in silico, the entire human metabolic system and all of the known metabolites and grows simply by including new knowledge on these matters of chemical identity and pathway assignments. The method for an individual simulation that is described places the level from RNA to biological activity, a rate value, into a ‘black box’, a commonly practiced approach called reduction.

Scientists understand that extremely complex, yet relatively well known, processes take place within all body cells in the last step between RNA and protein, as well as for regulating the biological activity of the proteins. These processes determine (in part attributable to the weighting factor) the kinetic value for the biological activity within the metabolic pathways or other biological process pathways. This kinetic value is used for generating a computer model to simulate any pathway or biological process. It is difficult to know this value for every gene and for every process or metabolic pathway involved. Therefore, the best and most complete information source available, the gene expression profile, is used. U.S. Pat. No. 7,711,490, which is incorporated herein by reference, proposes a statistical method to determine what level of active protein is possible with what level of RNA.

In an embodiment, the method makes use of buccal (cheek) mucosal or nasal respiratory epithelial cells and blood leukocytes (white blood cells) as the surrogate cell to generate the gene expression profile. It is also possible to collect surrogate cells from feces, urine, saliva, sputum, and bronchial or peritoneal lavage. Similarly in plants, leaf or stem cells can be used as surrogates for other parts. Also, body regions of insects can be used to surrogate organ systems contained within.

The types of users of the method include, but are not limited to, individual scientists at academic and for-profit institutions, pharmaceutical companies, biotech companies, and finally, after FDA approval, physicians who would use the service to assist in diagnosis, treatment design and efficacy, and prognosis. The consumer based business would offer services to any individual, expecting professional athletes as big customers (skeletal muscle could be used as the sample). The method is also useful for pet owners concerned for the health of their pets; agribusiness for livestock and feedstock.

With current direct-to-consumer genomic businesses, a customer sends them a sample once, gets information on their genes and what they are likely either to suffer or die from . . . somewhat ethically questionable. The service created by the present method helps identify metabolic indicators (biomarkers), pathways, and biological processes, e.g., aging, that can be impacted through drug development, medical therapies, and individual designed life changes—all from a non-invasive sample of surrogate cells (or more extensive sample collection clinically, e.g., liver or skeletal muscle biopsy).

All three domains of living organisms may be modeled once their genome is known and the transcriptome becomes available—and the reactome and metabolome have been incorporated, in part or whole, into a mathematical model. Several examples of applications may be used. Understanding antimicrobial resistance in bacteria, yeast, and parasites is one application, concomitant with development of novel approaches to treat infections. Research into commercial and agricultural plants and crops, such as soy bean, corn, and rice, may also be modeled, because their genomes are known and the commercial resources exist to generate genome-wide transcriptome data sets. One can easily envision investigating the effects of generating a transgenic soy bean model that would include entire sets of genes that would produce novel energy fuels. Because differential gene expression regulates beyond metabolism alone, the present method is being used in schema that include higher order physiological functions or pathologies, like blood pressure, aging, asthma, and neuronal long term potentiation (LTP); continuing even to include phenotypic expression at levels such as cognition (related to LTP) and behavior (again related to LTP as learning and memory functions). These utilities are possible because the present method readily allows development of computational models that include representations of multiple cell types, or tissues, or organ systems—even regional differences can be incorporated, such as cholesterol homeostasis in different brain regions affected by sleep or neurodegenerative diseases like Alzheimer's or Huntington's Disease

Gene Expression Index (GEI) Formula:

GEI=Kineticome Control Coefficient(KCC)×weighting factor(wf)=reaction kinetic value(k).

### Kineticome Control Coefficient (KCC):

The basic assumption of the KCC is that the transcriptome drives the reactome by determining a proportion of the kinetic properties of every reaction contributed by a gene product, e.g., enzymes in reactions, proteins binding to other molecules like other proteins, ligands, transported molecules, compounds, ions, elements, and assembly processes, such as DNA synthesis or transcription to RNA. First the key role of protein concentration in determining kinetic values of reactions must be established and then the approaches for deriving the KCC from gene expression data can be demonstrated.

The support of this assumption is that the level of gene expression as a reflection of mRNA concentration within a cell (or cells of a tissue or other type of specimen/sample) is also a reflection of the level of translation and thus protein concentration. The concentration of a protein, such as an enzyme, transporter, or ion channel, is a definitive contributor to determining the kinetics of that protein's actions and ultimately over time to the flux of molecules (e.g., reactants), ions, compounds, elements, or synthetic substances in association with the protein. Thus, the concentration of mRNA is reflective of the concentration of protein in this illustration: (Note k₁=kinetic value or protein synthesis rate.)

$$[ mRNA ] {}^{{k}_{1}} [ Protein ]$$

The basic approach to describing the contribution of protein concentration to the kinetics of a reaction is best displayed by considering classical enzyme kinetics.
In a simplest form a typical enzyme reaction is symbolically shown as:

$$[ S ] + [ E ] {{⇄}^{{k}_{f}}}_{{k}_{r}} [ P ] + [ E ]$$

where,
[S]=concentration of substrate
[E]=concentration of enzyme
[P]=concentration of product
k_{f}=kinetic value of forward reaction
kᵣ=kinetic value of reverse reaction

Concentration of the enzyme has a most dramatic role in determining the kinetic value of the reaction.

A basic formula to represent this is:

kα[E]>[S]>[P]

The classical reaction expression for deriving the Michaelis-Menton constant (K_{M}) is:

$$[ S ] + [ E ] {{⇄}^{{k}_{1}}}_{{k}_{- 1}} [ ES ] {}^{{k}_{2}} [ P ] + [ E ]$$

where,
[S]=concentration of substrate
[E]=concentration of enzyme
[ES]=concentration of enzyme-substrate complex
[P]=concentration of product
k₁=kinetic value of association of substrate with enzyme
k₋₁=kinetic value of dissociation of substrate from enzyme
k₂=kinetic value of catalysis or dissociation of product from enzyme
With further derivation of the formulae for considering key factors in such kinetic determinations, this association can be made:

If [S] is large compared to K_{M}, then the term

[S]/(K_{M}+[S])≈1

Therefore, the rate of product formation is (vₘₐₓ=maximum velocity of reaction)

$$\frac{d [ P ]}{d t} \approx {v}_{max} = {{k}_{2} [ E ]}_{0}$$

Thus the product formation rate only depends on the enzyme concentration, the equation resembles a unimolecular reaction with a corresponding pseudo-first order rate constant k₂. Thus it only matters how fast the [ES] complex turns its bound substrate into product and not how often the enzyme and the substrate meet.

Such representation can also be used for ligand binding kinetics, where a ligand could be any extracellular (intercellular) or intracellular chemical messenger, whether endogenous or exogenous of natural or synthetic origin.

$$[ L ] + [ R ] {{⇄}^{{k}_{f}}}_{{k}_{r}} [ C ]$$

where,
[L]=ligand concentration
[R]=unligated receptor protein concentration
[C]=ligated receptor complex concentration
k_{f}=kinetic value of ligand receptor association reaction
kᵣ=kinetic value of ligand receptor dissociation reaction
With further derivation of the formulae for considering key factors in such kinetic determinations, this association can be made:
When the concentration of unligated (R) and ligated (C) receptor are associated with the two kinetic values and ligand concentration (L), then the rate of ligated receptor complex can be derived:

$$\frac{d C}{d t} = {k}_{f} ( R ) ( L ) - {k}_{r} ( C )$$

Analogous to the total enzyme concentration, the total number of receptors bound (ligated) and unbound (unligated) is dependent on gene expression level ultimately. The sum of the bound receptors, C, and unbound receptors, R, is constant at the total number of receptors, R_{T}:

R_{T}=R+C

Such representation can also be used for transport events that determine essential biological properties of cells, tissues and organs, for example across a membrane, called ion flux important for determining membrane potentials (See Table 1). For example, Table 1 depicts calculation of membrane potential from ion concentrations outside and inside the neuron simulation, and the flux through the protein ion channels used as the values of permeability (P). The Goldman-Hodgkin-Katz voltage equation was used to calculate the milliVolt (mV) values.

In some embodiments, Kineticome Control Coefficient Values may be obtained from web sources on gene expression. For example, Table 2 shows KCC values derived from the publically available Human Genome eXpression Profiles. Specifically, Table 2 depicts gene expression levels in adult human brain. Table 2 consists of a list of expressed genes, sorted by decreasing level of expression. For each gene, identified by UniGene cluster ID (“ID”) and by gene description (“Description”) and symbol (“Gene”), the percentage over the total transcriptional activity (“EXPR %”) and total number of ESTs (“ESTs”) reported in the unbiased cDNA libraries of the specific tissue, available to the study are given. In this case the weighting factor would be 1.

TABLE 1

| Time | | | | | | | | | | [Cl−] | [Cl] |
|---|---|---|---|---|---|---|---|---|---|---|---|
| (ms) | Vm (mV) | divis value | Pk | [K+]out | [K+]in | Pna | [Na+]out | [Na+]in | Pcl | in | out |
| 0 | −73.3777 | 0.054308 | 2.44468 | 5.93825 | 140.366 | 1.2275E−43 | 149.678 | 15 | 0.0001 | 10 | 120 |
| 1 | −39.7801 | 0.206127 | 3.2638 | 6.03522 | 140.356 | 0.471702 | 149.678 | 15.0012 | 0.0001 | 10 | 120 |
| 2 | −29.436 | 0.310802 | 3.82082 | 6.12756 | 140.345 | 0.942278 | 149.678 | 15.0032 | 0.0001 | 10 | 120 |
| 3 | −23.8143 | 0.388515 | 4.29707 | 6.2155 | 140.334 | 1.39097 | 149.678 | 15.006 | 0.0001 | 10 | 120 |
| 4 | −20.1469 | 0.449407 | 4.72524 | 6.29923 | 140.322 | 1.81857 | 149.677 | 15.0095 | 0.0001 | 10 | 120 |
| 5 | −17.5238 | 0.49873 | 5.11816 | 6.37896 | 140.31 | 2.2258 | 149.677 | 15.0137 | 0.0001 | 10 | 120 |
| 6 | −15.5326 | 0.539756 | 5.48107 | 6.45489 | 140.298 | 2.61342 | 149.677 | 15.0185 | 0.0001 | 10 | 120 |
| 7 | −13.9495 | 0.574766 | 5.81511 | 6.5272 | 140.286 | 2.9821 | 149.676 | 15.0239 | 0.0001 | 10 | 120 |
| 8 | −12.6359 | 0.605536 | 6.11876 | 6.59607 | 140.273 | 3.33254 | 149.675 | 15.0299 | 0.0001 | 10 | 120 |
| 9 | −11.499 | 0.633494 | 6.38893 | 6.66166 | 140.26 | 3.6654 | 149.675 | 15.0364 | 0.0001 | 10 | 120 |
| 10 | −10.4747 | 0.659785 | 6.62225 | 6.72412 | 140.247 | 3.98131 | 149.674 | 15.0435 | 0.0001 | 10 | 120 |
| 11 | −9.51926 | 0.685291 | 6.81641 | 6.78362 | 140.234 | 4.28089 | 149.673 | 15.051 | 0.0001 | 10 | 120 |
| 12 | −8.60624 | 0.710586 | 6.97129 | 6.84028 | 140.221 | 4.56473 | 149.673 | 15.059 | 0.0001 | 10 | 120 |
| 13 | −7.72293 | 0.735946 | 7.08929 | 6.89426 | 140.207 | 4.83341 | 149.672 | 15.0675 | 0.0001 | 10 | 120 |
| 14 | −6.8665 | 0.761398 | 7.17494 | 6.94567 | 140.194 | 5.0875 | 149.671 | 15.0763 | 0.0001 | 10 | 120 |
| 15 | −6.03937 | 0.786816 | 7.23388 | 6.99463 | 140.18 | 5.32752 | 149.67 | 15.0856 | 0.0001 | 10 | 120 |
| 16 | −5.24641 | 0.811979 | 7.27186 | 7.04128 | 140.167 | 5.55401 | 149.669 | 15.0952 | 0.0001 | 10 | 120 |
| 17 | −4.49213 | 0.836661 | 7.29409 | 7.08571 | 140.154 | 5.76747 | 149.668 | 15.1051 | 0.0001 | 10 | 120 |
| 18 | −3.7797 | 0.860662 | 7.30486 | 7.12803 | 140.14 | 5.96838 | 149.667 | 15.1154 | 0.0001 | 10 | 120 |
| 19 | −3.11115 | 0.883811 | 7.30751 | 7.16835 | 140.127 | 6.15723 | 149.666 | 15.1259 | 0.0001 | 10 | 120 |
| 20 | −2.48687 | 0.905989 | 7.30456 | 7.20676 | 140.114 | 6.33446 | 149.665 | 15.1367 | 0.0001 | 10 | 120 |
| 21 | −1.90599 | 0.927125 | 7.29782 | 7.24335 | 140.1 | 6.50053 | 149.664 | 15.1478 | 0.0001 | 10 | 120 |
| 22 | −1.36755 | 0.947156 | 7.28859 | 7.27822 | 140.087 | 6.65585 | 149.663 | 15.1592 | 0.0001 | 10 | 120 |
| 23 | −0.86952 | 0.966069 | 7.27778 | 7.31145 | 140.074 | 6.80084 | 149.662 | 15.1707 | 0.0001 | 10 | 120 |
| 24 | −0.40994 | 0.983857 | 7.26605 | 7.34311 | 140.127 | 6.9359 | 149.661 | 15.1825 | 0.0001 | 10 | 120 |

TABLE 2
HUMAN GENOME EXPRESSION PROFILES - BRAIN

| ID | ESTs | EXPR(%) | GENE | DESCRIPTION |
|---|---|---|---|---|
| Hs.387567 | 13 | 0.017 | ACLY | ATP citrate lyase |
| Hs.108689 | 4 | 0.005 | SREBF2 | sterol regulatory element binding transcription |
| | | | | factor 2 |
| Hs.437096 | 2 | 0.003 | SCAP | SREBP cleavage-activating protein |
| Hs.416385 | 16 | 0.021 | INSIG1 | insulin induced gene 1 |
| Hs.37 | 2 | 0.003 | ACAT1 | Acetyl-Coenzyme A acetyltransferase 1 |
| Hs.278544 | 3 | 0.004 | ACAT2 | acetyl-Coenzyme A acetyltransferase 2 |
| | | | | (acetoacetyl Coenzyme A thiolase) |
| Hs.397729 | 4 | 0.005 | HMGCS1 | 3-hydroxy-3-methylglutaryl-Coenzyme A |
| | | | | synthase 1 (soluble) |
| Hs.11899 | 5 | 0.007 | HMGCR | 3-hydroxy-3-methylglutaryl-Coenzyme A |
| | | | | reductase |
| Hs.130607 | 8 | 0.011 | MVK | mevalonate kinase (mevalonic aciduria) |
| Hs.30954 | 4 | 0.005 | PMVK | phosphomevalonate kinase |
| Hs.252457 | 5 | 0.007 | MVD | mevalonate (diphospho) decarboxylase |
| Hs.76038 | 9 | 0.012 | IDI1 | isopentenyl-diphosphate delta isomerase |
| Hs.335918 | 5 | 0.007 | FDPS | farnesyl diphosphate synthase |
| Hs.191435 | 14 | 0.019 | FDFT1 | farnesyl-diphosphate farnesyltransferase 1 |
| Hs.71465 | 2 | 0.003 | SQLE | squalene epoxidase |
| Hs.442223 | 3 | 0.004 | LSS | lanosterol synthase |
| Hs.75616 | 7 | 0.009 | DHCR24 | 24-dehydrocholesterol reductase |
| Hs.417077 | 4 | 0.005 | CYP51A1 | cytochrome P450, family 51, subfamily A, |
| | | | | polypeptide 1 |
| Hs.435166 | 1 | 0.001 | LBR | lamin B receptor |
| Hs.31130q | 7 | 0.009 | TM7SF2 | (DHCR14) transmembrane 7 superfamily |
| | | | | member 2 |
| Hs.393239 | 4 | 0.005 | SC4MOL | sterol-C4-methyl oxidase-like |
| Hs.57698 | 3 | 0.004 | NSDHL | (H105E3) NAD(P) dependent steroid |
| | | | | dehydrogenase-like |
| Hs.187579 | 2 | 0.003 | HSD17B7 | hydroxysteroid (17-beta) dehydrogenase 7 |
| Hs.196669 | 2 | 0.003 | EBP | emopamil binding protein (sterol isomerase) |
| Hs.287749 | 14 | 0.019 | SC5DL | sterol-C5-desaturase (ERG3 delta-5-desaturase |
| | | | | homolog, fungal)-like |
| Hs.11806 | 12 | 0.016 | DHCR7 | 7-dehydrocholesterol reductase |
| Hs.25121 | 1 | 0.001 | CYP46A1 | cytochrome P450, family 46, subfamily A, |
| | | | | polypeptide 1 |
| Hs.82568 | 5 | 0.007 | CYP27A1 | cytochrome P450, family 27, subfamily A, |
| | | | | polypeptide 1 |
| Hs.213289 | 3 | 0.004 | LDLR | low density lipoprotein receptor (familial |
| | | | | hypercholesterolemia) |

TABLE 3A

| | | | | | caudate |
|---|---|---|---|---|---|
| Gene Name | spinal cord | Amygdala | thalamus | testis | nucleus |
| SREBF2 | 0.03407 | 0.02451 | 0.03047 | 0.01758 | 0.01601 |
| PDHA1 | 0.02046 | 0.0144 | 0.02932 | 0.0142 | 0.01187 |
| AACS | 0.02981 | 0.04823 | 0.02919 | 0.04991 | 0.0116 |
| HMGCS1 | 0.03428 | 0.01891 | 0.02346 | 0.01315 | 0.01101 |
| HMGCR | 0.02941 | 0.03746 | 0.0325 | 0.00584 | 0.01535 |
| MVK | 0.02261 | 0.01745 | 0.02418 | 0.0293 | 0.01518 |
| PMVK | 0.04572 | 0.02659 | 0.02723 | 0.02149 | 0.02148 |
| MVD | 0.01625 | 0.01425 | 0.01297 | 0.02281 | 0.01586 |
| IDI1 | 0.04719 | 0.03401 | 0.03966 | 0.01037 | 0.01402 |
| IDI2 | 0.02315 | 0.02022 | 0.01295 | 0.00816 | 0.03211 |
| FDPS | 0.02116 | 0.01937 | 0.02091 | 0.01416 | 0.0054 |
| FDFT1 | 0.04348 | 0.01516 | 0.01716 | 0.03202 | 0.01048 |
| SQLE | 0.03886 | 0.02177 | 0.02651 | 0.04023 | 0.01228 |
| LSS | 0.04553 | 0.02714 | 0.02759 | 0.02744 | 0.01543 |
| CYP51A1 | 0.05081 | 0.02807 | 0.02824 | 0.02535 | 0.01477 |
| DHCR14A | 0.01717 | 0.03559 | 0.01354 | 0.01023 | 0.01337 |
| SC4MOL | 0.07383 | 0.02824 | 0.02249 | 0.02298 | 0.01055 |
| DHCR7 | 0.04138 | 0.02442 | 0.03159 | 0.0369 | 0.01538 |
| DHCR24 | 0.08281 | 0.0193 | 0.0469 | 0.01819 | 0.01266 |
| CYP46A1 | 0.04273 | 0.10549 | 0.10193 | 0.01304 | 0.14823 |
| CYP27B1 | 0.03869 | 0.01018 | 0.00549 | 0.02356 | 0.00831 |
| CH25H | 0.10665 | 0.04583 | 0.02659 | 0.01779 | 0.01067 |

Tables 3A and 3B shows KCC values derived from the publically available T1Dbase. Specifically, Tables 3A and 3B show values from T1 Dbase of cholesterol homeostasis genes for several different human tissues. In these cases the weighting factor would be 1.

TABLE 3B

| Gene Name | cerebellum | Liver | hypothalamus | ovary | kidney |
|---|---|---|---|---|---|
| SREBF2 | 0.02363 | 0.00835 | 0.00761 | 0.00741 | 0.00557 |
| PDHA1 | 0.01059 | 0.00575 | 0.00804 | 0.01078 | 0.01272 |
| AACS | 0.01412 | 0.005 | 0.01016 | 0.00789 | 0.01295 |
| HMGCS1 | 0.00964 | 0.0066 | 0.00936 | 0.00821 | 0.00623 |
| HMGCR | 0.00749 | 0.00294 | 0.0117 | 0.0043 | 0.00385 |
| MVK | 0.01395 | 0.02128 | 0.01115 | 0.02342 | 0.01199 |
| PMVK | 0.01632 | 0.02152 | 0.01295 | 0.01293 | 0.0127 |
| MVD | 0.00359 | 0.00311 | 0.00539 | 0.00881 | 0.00676 |
| IDI1 | 0.00899 | 0.00227 | 0.0156 | 0.00767 | 0.00309 |
| IDI2 | 0.00806 | 0.00767 | 0.01066 | 0.0083 | 0.00951 |
| FDPS | 0.00808 | 0.01326 | 0.01125 | 0.00823 | 0.00457 |
| FDFT1 | 0.01194 | 0.0071 | 0.01038 | 0.00756 | 0.00766 |
| SQLE | 0.01146 | 0.00402 | 0.00676 | 0.00607 | 0.00612 |
| LSS | 0.01187 | 0.01391 | 0.01377 | 0.01 | 0.00858 |
| CYP51A1 | 0.01194 | 0.00735 | 0.02196 | 0.0115 | 0.00532 |
| DHCR14A | 0.01228 | 0.04834 | 0.00961 | 0.00755 | 0.0097 |
| SC4MOL | 0.00604 | 0.0061 | 0.01923 | 0.00338 | 0.0042 |
| DHCR7 | 0.01204 | 0.02916 | 0.00818 | 0.01893 | 0.00683 |
| DHCR24 | 0.01285 | 0.02285 | 0.0106 | 0.01358 | 0.00636 |
| CYP46A1 | 0.01489 | 0.00356 | 0.02028 | 0.00632 | 0.00344 |
| CYP27B1 | 0.00676 | 0.0027 | 0.00265 | 0.03106 | 0.02743 |
| CH25H | 0.01859 | 0.0095 | 0.01049 | 0.01643 | 0.00893 |

Table 4 shows KCC values derived from the publically available Allen Brain Atlas (Allen Mouse Brain Atlas=AMBA). Specifically, Table 4 shows examples of Cholesterol Homeostasis Gene Expression Levels, Weighting Factor, and k-values generated from AMBA.

TABLE 4

| | | | Gene |
|---|---|---|---|
| | Expression | | Expression |
| Gene | Level | Weighting | Index |
| Symbol | (KCC) | Factor | (k-value) |
| Srebf1 | 0.305151 | 0.01 | 0.00305151 |
| Srebf2 | 36.643 | 0.01 | 0.36643 |
| Insig1 | 20.7821 | 0.01 | 0.207821 |
| Scap | 56.5689 | 0.01 | 0.565689 |
| Aacs | 55.7659 | 0.01 | 0.557659 |
| Acat 1 | 79.8099 | 0.01 | 0.798099 |
| Acat2 | 69.7841 | 0.01 | 0.697841 |
| Hmgcs1 | 100 | 0.01 | 1 |
| Hmgcr | 23.3004 | 0.01 | 0.233004 |
| Mvk | 28.2158 | 0.01 | 0.282158 |
| Pmvk | 63.1306 | 0.01 | 0.631306 |
| Mvd | 28.568 | 0.01 | 0.28568 |
| Sqle | 100 | 0.01 | 1 |
| Lss | 1.41746 | 0.01 | 0.0141746 |
| Cyp51 | 40.854 | 0.01 | 0.40854 |
| Dhcr14a | 0.515589 | 0.01 | 0.00515589 |
| Dhcr24 | 32.5613 | 0.01 | 0.325613 |
| Lbr | 0.169152 | 0.01 | 0.00169152 |
| Sc4mol | 45.516 | 0.01 | 0.45516 |
| Hsd17b7 | 13.7824 | 0.01 | 0.137824 |
| Ebpl | 88.35 | 0.01 | 0.8835 |
| Sc5dl | 19.531 | 0.01 | 0.19531 |
| Dhcr7 | 61.466 | 0.01 | 0.61466 |

Process of Generating a KCC from a Human Specimen Using Genome-Wide Microarray Analyses:
Collect a Sample, for Example Cheek Cells, to the Point of Getting Information that You could Use:
1. Microarray chip is used to generate a fluorescence signal for each spot in the array, each of which represents a gene in your genome, about 22,000 gene signals (or more than 50,000 with high density where some genes are represented on the array chip more than once).
2. There are additional spots for methods controls, most importantly background (or a background is built into each spot on the array).
3. That is the true “raw” data set.

### Data Processing

1. Raw signal is processed to account for background signal and standard methods quality control.
[e.g., some spots will have a raw signal value that is less than the background value to be subtracted; so a default absolute minimum value will be assigned.

Several methods are used as per reference to Irizarry et al., Bioinformatics 22 (7):789-794, 2006.]

2. For each individual sample (or pooled samples on one chip) you must normalize the Step 1 processed signal values. (Seven methods are described in Fundel et al., Bioinformatics and Biology Insights 2008:2 291-305, e.g., globalization, centralization, median absolute deviation scale, etc.)

This value would be used as a KCC.

Globalization is the normalization method used in the enclosed examples for genome-wide calculations of KCC values for each gene (KCCg), but any of the others would be equally useful. Globalization is achieved by dividing the signal intensity for each gene (si_{g}) by the total intensity of the given array (siₜₒₜₐₗ), for example the sum of all the 22,000 or so gene signal intensity values in a spreadsheet containing the raw data.

$$KCCg = \frac{{si}_{g}}{{si}_{total}}$$

### Steps for Prior Art to Generate Fold Difference Values on Gene Expression Level

3. You now have a gene expression value for each of your genes in your cheek sample. Now you want to compare that with the cheek cells of a newborn baby. How many genes are expressed differently over that age difference?
A. A p-value (probability of significant difference) is generated for the value of each gene from your cheek cell versus the same gene from the baby cheek cells.
B. A fold change is calculated. It would be expected that the genes for handling toxins in foods, e.g., pesticide residues on fruits and vegetables, to be expressed many times higher in an adult who has been eating such food products for many years.
The risk is for false positives or false negatives. What if these genes that you intuitively expected to be on your ‘short’ list as having significant differences with age, actually did not show up on your list?
Once you have a list of genes that are up or down regulated in their expression, you need to have sophisticated algorithms to analyze them. So if your p-value approach is not very good, then the subsequent analyses are weakened.
Improved Method to Derive a k-Value in a Biosimulation
Take your cheek cell values from step 2 as a KCC and combine them with a weighting factor (wf) and the product is used as a k-value in a biosimulation of any or all biological pathways, like the detoxification pathway. Then take that information and say here is how your detoxification pathway is working compared to that newborn baby. Or if you changed your diet or only ate certified organic fruits and vegetables for a month or so, then your model can be compared back to yourself before that change in diet—now your detoxification pathway is less activated reflecting your reduced load of pesticides or other environmental toxins.

Table 5 shows an example of calculating KCC and k-values for genes of the plant, Arabidopsis, which has 8298 genes on this microarray chip. Only 9 of these genes are shown.

TABLE 5

| | SIGNAL | | Weighting | |
|---|---|---|---|---|
| ID_REF | VALUE | KCC | Factor | k value |
| 18418_at | 0.5 | 0.00000033 | 100 | 0.00003277 |
| 18419_at | 1.4 | 0.00000092 | 100 | 0.00009176 |
| 18420_at | 13.8 | 0.00000905 | 100 | 0.00090451 |
| 18421_at | 14.9 | 0.00000977 | 100 | 0.00097661 |
| 18422_at | 0.8 | 0.00000052 | 100 | 0.00005244 |
| 18423_at | 1.6 | 0.00000105 | 100 | 0.00010487 |
| 18424_at | 0.6 | 0.00000039 | 100 | 0.00003933 |
| 18425_s_at | 1.6 | 0.00000105 | 100 | 0.00010487 |
| 18426_at | 1 | 0.00000066 | 100 | 0.00006554 |
| SUM of all 8298 | 1525687 | | | |
| intensity values | | | | |

### The Weighting Factor:

The method is readily adaptable where one can easily use it to study only the influence of the ‘transcriptome’ (via KCC) on the reactome/metabolome and/or biological processes by using an arbitrary and constant weighting factor, e.g., 0.01, 0.1, 1, or 100; or if you want to use the invention for both transcriptome and proteome interactions, you would need additional information on the proteome. The metabolome can contribute to kinetic values by activation or negative feedback, etc. That type of user would obviously need more sophisticated skill sets. On the other hand, for simple analysis a constant arbitrary weighting factor may be used.

In one embodiment, a weighting factor can have an arbitrary constant value. Such factors are commonly used in standard approaches to comparative gene expression studies using microarray analyses, and are called multiplicative factors. (see Fundel et al., Bioinformatics and Biology Insights 2008:2 291-305.) With the invention, the weighting factor is used to represent the 4 steps of modulating the proteome for influence on k-values of biological reactions and processes. Example I-2 shows how the weighting factor is used to reduce the k-value of an enzyme in the cholesterol homeostasis system in order to mimic the effect of an inhibitor, a statin. On the other hand, the KCC would be increased or decreased to mimic transgenic conditions of gene knock-out, -down, or -in, where gene expression levels would be completely blocked (KCC=0), decreased or increased by any degree (KCC divided or multiplied or otherwise modified by a value>1). The weighting factor would also be used to adjust k-values to mimic conditions of known effects of gene mutations or SNPs on the activity of the protein. The details on such effects of DNA sequences on protein activity are becoming more available over time. A prime example is a gene mutation of the gene for the final enzyme in the cholesterol biosynthesis pathway, DHCR7, in a condition called Smith-Lemli-Opitz syndrome (SLOS). In this condition the dhcr7 gene expression level is increased but enzyme activity is lowered to less than ten times normal values.

All examples will be based on using an arbitrary weighting factor; however a more sophisticated user can easily adapt the method to their level of skill and sophisticated experimentation.

If the user of the invention has all the data needed to determine exact weighting factors from the proteome and other detailed biological information on the specific conditions of the biological system under study, they can use any value for the weighting factor, either as a constant or a variable factor, and still have the KCC reflect the individual specimen's gene expression level as it impacts the kinetic value too. Lacking such detailed proteomic information and system information does not prevent utilization of the method.

In another embodiment, a weighting factor can be generated by an end user of higher skill level to account for multiple sub-factors, such as rate of translation to produce new protein, rate of degradation removing protein from the total pool, rate of activation by posttranslational processes such as phosphorylation, and rate of inactivation by dephosphorylation, ubiquitination, or allosteric inhibitory negative feedback. One can not expect a single formula that would assign a distinct and constant value for each of these contributors (sub-factors) to the weighting factor in the case of each reaction in the reactome. However, arbitrary values and proportions of contributions can be assigned for some, while developing technologies provide “-omic”-wide values for others. The present method uses the “-omic” information to determine the kineticome and generate kinetic models; prior art methods, however, use stoichiometric constraint-based systems models and determine flux from the “-omics” information to feed into the model. They do not anticipate the kineticome and its utility in kinetic deterministic systems models as derived from the KCC and weighting factor.

Table 6 shows an example of individual (bottom set of columns) k-values or averages for groups (top right two columns) for simulating the enzymes in the biosynthesis of gibberellin in the plant, Arabidopsis.

TABLE 6

| | | | | | IAA- |
|---|---|---|---|---|---|
| Gene name | Reaction id | Reaction EC | Enzymatic activity | Control | treated |
| KS1 | 4.2.3.19-RXN | 4.2.3.19 | ent-kaurene synthase | 0.0036603 | 0.0036545 |
| CPS | 5.5.1.13-RXN | 5.5.1.13 | ent-copalyl diphosphate | 0.0036603 | 0.0036545 |
| | | | synthase | | |
| KAO1 | 1.14.13.79- | 1.14.13.79 | ent-kaurenoate oxidase | 0.0038927 | 0.0037461 |
| | RXN | | | | |
| GA3 | 1.14.13.78- | 1.14.13.78 | ent-kaurene oxidase | 0.0045467 | 0.0044606 |
| | RXN | | | | |
| GA3ox2 | RXN1F-165 | 1.14.11.— | gibberellin9 3-oxidase | 0.0036603 | 0.0036545 |
| GA3ox1 | RXN1F-165 | 1.14.11.— | gibberellin 3-oxidase | 0.0050906 | 0.0046259 |
| GA20ox1 | RXN1F-99 | 1.14.11.— | gibberellin 20-oxidase | 0.0036603 | 0.0036545 |
| GA3ox2 | RXN1F-170 | 1.14.11.15 | gibberellin20 3-oxidase | 0.0036603 | 0.0036545 |
| GA2ox3 | RXN-886 | 1.14.11.— | gibberellin 2-oxidase | 0.0036603 | 0.0036545 |
| GA2ox8 | RXN-991 | 1.14.11.— | gibberellin53 2-oxidase | 0.0036603 | 0.0036926 |
| GA2ox8 | RXN-947 | 1.14.11.— | gibberellin12 2-oxidase | 0.0036603 | 0.0036926 |
| AT1G02400 | RXN-6550 | 1.14.11.— | gibberellin 2-beta- | 0.0042584 | 0.0053617 |
| | | | dioxygenase | | |

| GSM9595 | GSM9596 | GSM9597 | GSM9598 | GSM9599 | GSM9600 |
|---|---|---|---|---|---|
| k value | k value | k value | k value | k value | k value |
| 0.0036657 | 0.003660717 | 0.00365459 | 0.003655041 | 0.0036581 | 0.0036502 |
| 0.0036657 | 0.003660717 | 0.00365459 | 0.003655041 | 0.0036581 | 0.0036502 |
| 0.0037363 | 0.003815321 | 0.00412654 | 0.003785492 | 0.0036581 | 0.0037948 |
| 0.0044395 | 0.004759028 | 0.00444145 | 0.00468619 | 0.0043725 | 0.0043231 |
| 0.0036657 | 0.003660717 | 0.00365459 | 0.003655041 | 0.0036581 | 0.0036502 |
| 0.0051315 | 0.0050863 | 0.00505392 | 0.004494646 | 0.0046864 | 0.0046967 |
| 0.0036657 | 0.003660717 | 0.00365459 | 0.003655041 | 0.0036581 | 0.0036502 |
| 0.0036657 | 0.003660717 | 0.00365459 | 0.003655041 | 0.0036581 | 0.0036502 |
| 0.0036657 | 0.003660717 | 0.00365459 | 0.003655041 | 0.0036581 | 0.0036502 |
| 0.0036657 | 0.003660717 | 0.00365459 | 0.003769425 | 0.0036581 | 0.0036502 |
| 0.0036657 | 0.003660717 | 0.00365459 | 0.003769425 | 0.0036581 | 0.0036502 |
| 0.0044822 | 0.004091983 | 0.00420094 | 0.005416393 | 0.0053967 | 0.0052719 |

FIG. 1 is an illustration of a comparison of the described new method of modeling with prior art models. 1. Present method: The Transcriptome reflects some component of the regulatory process for determining appearance of the metabolome and fluxome in any one individual cell or organism. The Transcriptome is used to derive a Kineticome Control Coefficient that is combined with a weighting factor representing other determinants of kinetics, such as represented by number 4, for generation of a metabolome and fluxome for an individual specimen. The Transcriptome derived kinetic values are tools for the instrument of simulations as deterministic computational models. Requires only prior knowledge of reactions in system.

2 & 3: Prior art: Statistical estimations of gene expression level effects on flux (U.S. Pat. No. 7,711,490) or flux constraint based methods (U.S. Published Patent Application No. 2003/0059792) generate flux values within predetermined limits that are then used to calculate the kinetic values for reactions (3). The resultant kinetic values are observations not a tool for the instrument of simulations. This approach from flux to kinetic values utilizes the stoichiometric computational models. This does not allow representation of individual specimens; can only reflect categorical group data; uses only fold changes in gene expression levels to alter model; requires extensive prior knowledge of proteome and metabolome. 4. Dynamic modeling includes regulatory and modulatory factors from genome through proteome to account for responses from an initial state of a transcriptome-determined metabolome and fluxome to predicted states after introduction of an external factor into the system, e.g., drug for therapy.

*—Appropriate for enzymes, but also reflects molecules or compounds undergoing transport or binding dynamics.

### APPLICATIONS BY EXAMPLE

### Example I

### A) Tissue Studies

### Example I-1

### Modeling Cholesterol Metabolism by Gene Expression Profiling in the Hippocampus

The usefulness and validity of a biochemical model of cholesterol homeostasis in the brain was tested. A concentration was placed on the hippocampus since cholesterol synthesis in this area is greatly affected by diseases such as Alzheimer's Disease (“AD”), Huntington's Disease (“HD”), Smith-Lemli-Opitz syndrome (“SLOS”), and desmosterolosis; resulting in neuron death or loss of function.

System wide in situ hybridization data for large numbers of genes has recently become available through the Allen Mouse Brain Atlas (AMBA, http://www.brain-map.org). Using the AMBA the expression levels and patterns in the hippocampus for all genes involved in the core cholesterol homeostasis process were obtained. Because mRNA expression based on in situ hybridization is a relative measurement the resulting reaction constants were normalized. Since the kinetic values were normalized and there is practically no concentration information of many of the metabolites involved in brain cholesterol production it was decided to normalize the time and concentration of the model and examine the percent changes due to mRNA variations due to illnesses or genetic manipulations. When the percentage changes in mRNA expression observed in AD were incorporated into the mouse hippocampus model, the reported cholesterol increases in both moderate and severe AD stages were confirmed. Similarly, by incorporating the reported percentage changes due to HD the mouse hippocampus model reproduced the reported increase in cholesterol concentration. In addition, the simulations replicated SLOS, and knock out studies of Dhcr14, Lbr, and Dchr24. A sensitivity analysis of the baseline cholesterol model suggested that Idi2, at the isoprenoid branch point, and Fdft1, downstream of this reaction, have a strong influence on cholesterol production, as has been suggested by experiments. Overall, the adult hippocampus cholesterol metabolism model replicated several sets of experimental evidence suggesting that the technical approach can be used to parameterize biochemical models based on mRNA expression patterns and resultant model can be used to pinpoint key reactions, which, upon manipulation, may adjust cholesterol levels and reinstate homeostasis under diseased conditions.

The objective of this study was to test the methodology of mapping enzymatic mRNA expression data to reaction rate constants. For this purpose a computer model of adult brain cholesterol production based on the expression levels of genes involved in cholesterol biosynthesis was built. A focus was placed on the hippocampus since cholesterol homeostasis in this area of the brain is greatly affected by diseases such as AD and HD.

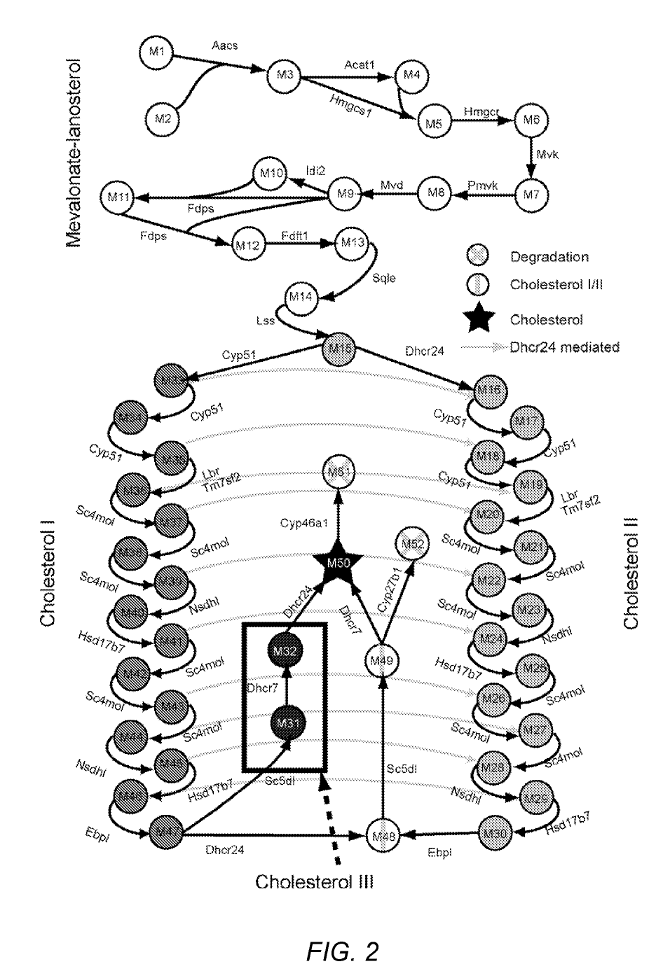

FIG. 2 shows a detailed diagram of cholesterol production, for simplicity the metabolite names have been indexed M1 to M52, their corresponding names can be found in Table 7.

TABLE 7

| | |
|---|---|
| M1 | acetate |
| M2 | coenzyme A |
| M3 | acetyl-CoA |
| M4 | acetoacetyl-CoA |
| M5 | 3-hydroxy-3-methyl-glutaryl CoA |
| M6 | mevalonate |
| M7 | mevalonate-5 phosphate |
| M8 | mevalonate-5-pyrophosphate |
| M9 | Δ3-isopentenyl pyrophosphate |
| M10 | dimethylallyl pyrophosphate |
| M11 | geranyl pyrophosphate |
| M12 | farnesyl pyrophosphate |
| M13 | squalene |
| M14 | (S)-squalene-2,3-epoxide |
| M15 | lanosterol |
| M16 | 24,25-dihydrolanosterol |
| M17 | 4,4-dimethyl-14α-hydroxymethyl-5α- |
| | cholesta-8-en-3β-ol |
| M18 | 4,4-dimethyl-14α-formyl-5α-cholesta-8- |
| | en-3β-ol |
| M19 | 4,4-dimethyl-5α-cholesta-8,14-dien-3β- |
| | ol |
| M20 | 4,4-dimethyl-5α-cholesta-8-en-3β-ol |
| M21 | 4α-hydroxymethyl-4β-methyl-5α- |
| | cholesta-8-en-3β-ol |
| M22 | 4α-formyl-4β-methyl-5α-cholesta-8-en- |
| | 3β-ol |
| M23 | 4α-carboxy-4β-methyl-5α-cholesta-8- |
| | en-3β-ol |
| M24 | 4α-methyl-5α-cholesta-8-en-3-one |
| M25 | 4α-methyl-cholesta-8-enol |
| M26 | 4α-hydroxymethyl-5α-cholesta-8-en-3β- |
| | ol |
| M27 | 4α-formyl-5α-cholesta-8-en-3β-ol |
| M28 | 4α-carboxy-5α-cholesta-8-en-3β-ol |
| M29 | 5α-cholesta-8-en-3-one |
| M30 | zymostenol |
| M31 | 7-dehydrodesmosterol |
| M32 | desmosterol |
| M33 | 4,4-dimethyl-14α-hydroxymethyl-5α- |
| | cholesta-8,24-dien-3β-ol |
| M34 | 4,4-dimethyl-14α-formyl-5α-cholesta- |
| | 8,24-dien-3β-ol |
| M35 | 4,4-dimethyl-5α-cholesta-8,14,24-trien- |
| | 3βol |
| M36 | 4,4-dimethyl-5α-cholesta-8,24-dien-3β- |
| | ol |
| M37 | 4α-hydroxymethyl-4β-methyl-5α- |
| | cholesta-8,24-dien-3β-ol |
| M38 | 4α-formyl-4β-methyl-5α-cholesta-8,24- |
| | dien-3β-ol |
| M39 | 4α-carboxy-4β-methyl-5α-cholesta- |
| | 8,24-dien-3β-ol |
| M40 | 4α-methyl-5α-cholesta-8,24-dien-3-one |
| M41 | 4α-methyl-zymosterol |
| M42 | 4α-hydroxymethyl-5α-cholesta-8,24- |
| | dien-3β-ol |
| M43 | 4α-formyl-5α-cholesta-8,24-dien-3β-ol |
| M44 | 4α-carboxy-5α-cholesta-8,24-dien-3β- |
| | ol |
| M45 | 5α-cholesta-8,24-dien-3-one |
| M46 | zymosterol |
| M47 | 5α-cholesta-7,24-dien-3β-ol |
| M48 | lathosterol |
| M49 | 7-dehydro-cholesterol |
| M50 | cholesterol |
| M51 | 24-hydroxy-cholesterol |
| M52 | 27-hydroxy-7-dehydrocholesterol |

In brief, cholesterol synthesis starts with the generation of mevalonate, isoprenoid side-products and squalene. The post-squalene portion commits to sterol synthesis and leads to lanosterol production. The process branches into two alternate routes, both of them producing cholesterol. Cholesterol I, characterized by lanosterol to lathosterol synthesis, is the predominant pathway in adult neural tissues. Cholesterol I branches into cholesterol III which is characterized by production of desmosterol. Cholesterol III is most prominent during early brain development. Cholesterol II is characterized by zymosterol production.

TABLE 8
Adult hippocampus cholesterol expression profile.

| | |
|---|---|
| Enzymes | Base |

Presqualene Enzymes/Biosynthesis

| | | |
|---|---|---|
| E1 | AACS | 0.557 |
| E2 | ACAT1 | 0.798 |
| E3 | HMGCS1 | 1.000 |
| E4 | HMGCR | 0.233 |
| E5 | MVK | 0.283 |
| E6 | PMVK | 0.631 |
| E7 | MVD | 0.286 |
| E8 | IDI2 | 0.061 |
| E9 | FDPS | 0.765 |
| E10 | FDFT1 | 0.093 |
| E11 | SQLE | 1.000 |

Postsqualene Enzymes

| | | |
|---|---|---|
| E12 | LSS | 0.014 |
| E13 | CYP51 | 0.408 |
| E14 | LBR | 0.002 |
| E15 | DHCR14 | 0.005 |
| | (codedby Tm7sf2) | |
| E16 | DHCR24 | 0.325 |
| E17 | SC4MOL | 0.455 |
| E18 | NSDHL | 0.568 |
| E19 | HSD17B7 | 0.137 |
| E20 | EBPL | 0.835 |
| E21 | SC5DL | 0.195 |
| E22 | DHCR7 | 0.614 |

Degradation

| | | |
|---|---|---|
| E23 | CYP46A1 | 1.000 |
| | CYP39A1 | 0.002 |
| E24 | CYP27B1 | 0.030 |

The expression values of all genes involved in core cholesterol production in the hippocampus were obtained from the AMBA. Table 8 shows the normalized (0-1) base expression levels of the involved enzymes. Enzymes can be divided by metabolic stage (synthesis and degradation) and pre/post-squalene transition, mediated by squalene epoxidase (SQLE). While reactions before squalene can be involved in other metabolic pathways, the post-squalene products are exclusively committed to cholesterol production. The overall pattern of cholesterol related genes indicates an apparent bottle-neck effect due to the relatively low expression of Lbr and Tm7sf2 (which produces DHRC14). The gene products of Lbr and Tm7sf2 have Dhcr14 enzyme activity, involved in a conversion step from lanosterol (M15) to cholesterol (M50). However, post-squalene genes downstream of Lbr and Tm7sf2 are expressed at much higher levels. Therefore, cholesterol could still be synthesized despite the low expression of Lbr and Tm7sf2 as long as high levels of substrate for these Dhcr14 enzymes are produced. In fact, Cyp51, the gene product of which acts on the Dhcr14 intermediary product, is expressed at an appropriately higher magnitude. In the post-squalene segment involved in the production of S-2,3-epoxysqualene (M14), had the highest expression at 100%. This S-2,3-epoxysqualene intermediate is used to synthesize lanosterol (M15), the initial steroidal precursor following the mevalonate pathway. In the degradation component, Cyp46a1, responsible for conversion of cholesterol to 24S-hydroxycholesterol (M51) and subsequent removal from neural tissue, was expressed at 100%. However, the other two degradation genes, Cyp27b1 and Ch25h, were not expressed, although Ch25h has been found in the hippocampal region in aged and AD human subjects.

Using the network structure described in FIG. 2 and the expression values of cholesterol genes (listed in Table 8) a mass-action model of cholesterol metabolism was built. This model includes the known enzymes and corresponding genes involved in cholesterol anabolism and catabolism. As explained below, a direct linear mapping between mRNA expression values to rate constants of metabolite production was assumed. The assigned k_{f,b} values between 0 and 1, where 1 corresponds to the maximum expression value at 100% were used.

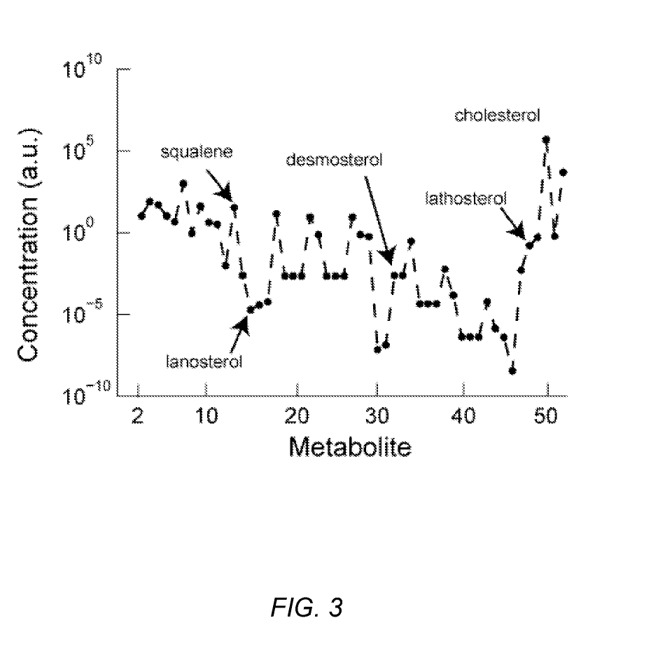

The model consisted of 53 reactions (Table 9), carried out by 24 different kinetic values (Table 10), and produced 51 metabolites (Table 8). Since no temporal restrictions were implemented the time evolution of the systems of equations is not directly mapped to actual time units. All simulations were run for 1×10⁶ a.u. (arbitrary units), which resulted in stable levels of almost all metabolites. The metabolites that did not reach a stable level were those that were end-products, for which downstream metabolism was not explicitly modeled, thus resulting in accumulation of metabolite. The reactants that are a result of basic biological functions such as ATP, NADPH, and O₂ were assumed to be constant for all conditions. Since the specific concentration of reactants is not known an initial arbitrary concentration of 0.1 (arbitrary units) for all reactants was assigned. FIG. 3 shows a plot of the value of the cholesterol metabolic profile at the end of the simulation.

TABLE 9

| | | | | | | | | |
|---|---|---|---|---|---|---|---|---|
| RN | Enzyme | Reaction | R | Base | HD | IAD | MAD | SAD |

Mevalonate-Lanosterol

| | | | | | | | | |
|---|---|---|---|---|---|---|---|---|
| ML1 | AACS | acetate + coenzyme A → | k_{f} | 0.557 | 0.601 | 0.566 | 0.566 | 0.566 |
| | | acetyl-CoA | | | | | | |
| ML2 | ACAT1 | 2 * acetyl-CoA [symbol] acetoacetyl- | k_{f} | 0.798 | 0.849 | 0.558 | 0.558 | 0.558 |
| | | CoA + coenzyme A | | | | | | |
| | | | k_{b} | 0.798 | 0.849 | 0.558 | 0.558 | 0.558 |
| ML3 | HMGCS1 | acetyl-CoA + acetoacetyl-CoA + | k_{f} | 1.000 | 0.994 | 0.698 | 0.698 | 0.698 |
| | | H2O → 3-hydroxy-3-methyl- | | | | | | |
| | | glutaryl CoA + coenzyme A | | | | | | |
| ML4 | HMGCR | 3-hydroxy-3-methyl-glutaryl | k_{f} | 0.233 | 0.178 | 0.233 | 0.233 | 0.233 |
| | | CoA [symbol] 2 * NADPH [symbol] H+ → | | | | | | |
| | | mevalonate + 2 * NADP⁺ + | | | | | | |
| | | coenzyme A | | | | | | |
| ML5 | MVK | mevalonate + ATP + Mg [symbol] → | k_{f} | 0.283 | 0.283 | 0.326 | 0.320 | 0.407 |
| | | mevalonate-5 phosphate + ADP | | | | | | |
| ML6 | PMVK | mevalonate-5 phosphate + ATP + | k_{f} | 0.631 | 0.707 | 0.631 | 0.631 | 0.631 |
| | | Mg [symbol] → mevalonate-5- | | | | | | |
| | | pyrophosphate + ADP | | | | | | |
| ML7 | MVD | mevalonate-5-pyrophosphate + | k_{f} | 0.286 | 0.274 | 0.286 | 0.286 | 0.286 |
| | | ATP → delta3-isopentenyl | | | | | | |
| | | pyrophosphate + ADP + Pi + | | | | | | |
| | | CO₂ | | | | | | |
| ML8 | IDI2 | delta3-isopentenyl | k_{f} | 0.061 | 0.057 | 0.061 | 0.061 | 0.061 |
| | | pyrophosphate + Mg⁺⁺ [symbol] | | | | | | |
| | | dimethylallyl pyrophosphate | | | | | | |
| | | | k_{b} | 0.061 | 0.057 | 0.061 | 0.061 | 0.061 |
| ML9 | DMTT | delta3-isopentenyl | k_{f} | 0.765 | 0.845 | 0.759 | 0.963 | 0.999 |
| | (FDPS) | pyrophosphate + dimethylallyl | | | | | | |
| | | pyrophosphate + PPi → geranyl | | | | | | |
| | | pyrophosphate | | | | | | |
| ML10 | GTT | delta3-isopentenyl | k_{f} | 0.765 | 0.845 | 0.759 | 0.963 | 0.999 |
| | (FDPS) | pyrophosphate + geranyl | | | | | | |
| | | pyrophosphate → famesyl | | | | | | |
| | | pyrophosphate + PPi | | | | | | |
| ML11 | FDFT1 | 2 * farnesyl pyrophosphate + | k_{f} | 0.093 | 0.124 | 0.083 | 0.112 | 0.122 |
| | | NADPH + H [symbol] → squalene + | | | | | | |
| | | NADP⁺ | | | | | | |
| ML12 | SQLE | squalene + O₂ + NADPH + H [symbol] → | k_{f} | 1.000 | 1.000 | 1.000 | 1.000 | 1.000 |
| | | (S)-squalene-2,3-epoxide + | | | | | | |
| | | H₂O | | | | | | |
| ML13 | LSS | (S)-squalene-2.3-epoxide → | k_{f} | 0.014 | 0.014 | 0.011 | 0.018 | 0.020 |
| | | lanosterol | | | | | | |

Cholesterol I

| | | | | | | | | |
|---|---|---|---|---|---|---|---|---|
| ChI1 | CYP51A1 | lanosterol + NADPH + O_{2 →} | k_{f} | 0.408 | 0.410 | 0.409 | 0.409 | 0.409 |
| | | 4,4-dimethyl-14alpha- | | | | | | |
| | | hydroxymethyl-5alpha- | | | | | | |
| | | cholesta -8,24-dien-3beta-ol [symbol] | | | | | | |
| | | NADP [symbol] [symbol] H₂O | | | | | | |
| ChI2 | CYP51A2 | 4 [symbol] 4-dimethyl- [symbol] 4alpha- | k_{f} | 0.408 | 0.410 | 0.409 | 0.409 | 0.409 |
| | | hydroxymethyl-5alpha- | | | | | | |
| | | cholesta-8,24-dien-3beta-ol [symbol] | | | | | | |
| | | NADPH + O₂ → 4,4-dimethyl- | | | | | | |
| | | 14alpha-formyl-5alpha- | | | | | | |
| | | cholesta-8,24-dien-3beta-ol + | | | | | | |
| | | NADP⁺ + 2 * H₂O | | | | | | |
| ChI3 | CYP51A3 | 4,4-dimethyl-14alpha-formyl- | k_{f} | 0.408 | 0.410 | 0.409 | 0.409 | 0.409 |
| | | 5alpha-cholesta-8,24-dien- | | | | | | |
| | | 3beta-ol + NADPH + O2 → | | | | | | |
| | | 4,4-dimethyl-5alpha-cholesta- | | | | | | |
| | | 8,14,24-trien-3beta-ol + | | | | | | |
| | | NADP⁺ + H₂O + formate | | | | | | |
| ChI4 | LBR | 4,4-dimethyl-5alpha-cholesta- | k_{f} | 0.002 | 0.002 | 0.002 | 0.002 | 0.002 |
| | | 8,14 [symbol] 24-trien-3beta-ol + | | | | | | |
| | | NADPH → 4,4-dimethyl- | | | | | | |
| | | 5alpha-cholesta-8,24-dien- | | | | | | |
| | | 3beta-ol + NADP⁺ | | | | | | |
| ChI5 | DHCR14 | 4,4-dimethyl-5alpha-cholesta- | k_{f} | 0.005 | 0.005 | 0.005 | 0.005 | 0.005 |
| | | 8,14,24-trien-3beta-ol + | | | | | | |
| | | NADPH → 4,4-dimethyl- | | | | | | |
| | | 5alpha-cholesta-8 [symbol] 24-dien- | | | | | | |
| | | 3beta-ol + NADP⁺ | | | | | | |
| ChI6 | SC4MOL | 4,4-dimethyl-5alpha-cholesta- | k_{f} | 0.455 | 0.471 | 0.455 | 0.455 | 0.455 |
| | | 8,24-dien-3beta-ol + NADP + | | | | | | |
| | | O2 → 4alpha-hydroxymethyl- | | | | | | |
| | | 4beta-methyl-5alpha-cholesta- | | | | | | |
| | | 8,24-dien-3beta-ol + NADP⁺ + | | | | | | |
| | | H₂O | | | | | | |
| ChI6 | SC4MOL | 4alpha-hydroxymethyl-4beta- | k_{f} | 0.455 | 0.471 | 0.455 | 0.455 | 0.455 |
| | | methyl-5alpha-cholesta-8,24- | | | | | | |
| | | dien-3beta-ol + NADPH + O₂ → | | | | | | |
| | | 4alpha-formyl-4beta- | | | | | | |
| | | methyl-5alpha-cholesta-8 [symbol] 24- | | | | | | |
| | | dien-3beta-ol + NADP⁺ + 2 * | | | | | | |
| | | H₂O | | | | | | |
| ChI7 | SC4MOL | 4alpha-formyl-4beta-methyl- | k_{f} | 0.455 | 0.471 | 0.455 | 0.455 | 0.455 |
| | | 5alpha-cholesta-8,24-dien- | | | | | | |
| | | 3beta-ol + NADPH + O₂ → | | | | | | |
| | | 4alpha-carboxy-4beta-methyl- | | | | | | |
| | | 5alpha-cholesta-8,24-dien- | | | | | | |
| | | 3beta-ol + NADP⁺ + H₂O | | | | | | |
| ChI8 | NSDHL | 4alpha-carboxy-4beta-methyl- | k_{f} | 0.568 | 0.568 | 0.665 | 0.696 | 0.784 |
| | | 5alpha-cholesta-8,24-dien- | | | | | | |
| | | 3-beta-ol + NADP⁺ → 4alpha- | | | | | | |
| | | methyl-5alpha-cholesta-8,24- | | | | | | |
| | | dien-3-one + NADPH + CO₂ | | | | | | |
| ChI9 | HSD17B7 | 4alpha-methyl-5alpha-cholesta- | k_{f} | 0.137 | 0.172 | 0.194 | 0.236 | 0.259 |
| | | 8,24-dien-3-one + NADPH → | | | | | | |
| | | 4alpha-methyl-zymosterol + | | | | | | |
| | | NADP+ | | | | | | |
| ChI10 | SC4MOL | 4alpha-methyl-zymosterol + | k_{f} | 0.455 | 0.471 | 0.455 | 0.455 | 0.455 |
| | | NADPH + O₂ → 4alpha- | | | | | | |
| | | hydroxymethyl-5alpha- | | | | | | |
| | | cholesta-8,24-dien-3beta-ol [symbol] | | | | | | |
| | | NADP⁺ + H₂O | | | | | | |
| ChI11 | SC4MOL | 4alpha-hydroxymethyl-5alpha- | k_{f} | 0.455 | 0.471 | 0.455 | 0.455 | 0.455 |
| | | cholesta-8.24-dien-3beta-ol + | | | | | | |
| | | NADPH + O₂ → 4alpha-formyl- | | | | | | |
| | | 5alpha-cholesta-8,24-dien- | | | | | | |
| | | 3beta-ol + NADP⁺ + 2 * H₂O | | | | | | |
| ChI12 | SC4MOL | 4alpha-formyl-5alpha-cholesta- | k_{f} | 0.455 | 0.471 | 0.455 | 0.455 | 0.455 |
| | | 8 [symbol] 24-dien-3beta-ol + NADPH [symbol] | | | | | | |
| | | O₂ → 4alpha-carboxy-5alpha- | | | | | | |
| | | cholesta-8,24-dien-3beta-ol + | | | | | | |
| | | NADP⁺ + H₂O | | | | | | |
| ChI13 | NSDHL | 4alpha-carboxy-5alpha- | k_{f} | 0.568 | 0.568 | 0.665 | 0.696 | 0.784 |
| | | cholesta-8,24-dien-3beta-ol + | | | | | | |
| | | NADP⁺ → 5alpha-cholesta- | | | | | | |
| | | 8 [symbol] 24-dien-3-one + NADPH [symbol] | | | | | | |
| | | CO₂ | | | | | | |
| ChI14 | HSDI7B7 | 5alpha-cholesta-8,24-dien-3- | k_{f} | 0.137 | 0.172 | 0.194 | 0.236 | 0.259 |
| | | one + NADPH → zymosterol + | | | | | | |
| | | NADP⁺ | | | | | | |
| ChI15 | EBPL | zymosterol → 5alpha-cholesta- | k_{f} | 0.835 | 0.887 | 0.898 | 0.855 | 0.649 |
| | | 7 [symbol] 24-dien-3beta-ol | | | | | | |
| ChI16 | DHCR24 | 5alpha-cholesta-7 [symbol] 24-dien- | k_{f} | 0.325 | 0.307 | 0.326 | 0.326 | 0.326 |
| | | 3beta-ol + NADPH → | | | | | | |
| | | lathosterol + NADP⁺ | | | | | | |
| ChI17 | SCD5L | lathosterol + O₂ + NADPH → | k_{f} | 0.195 | 0.183 | 0.186 | 0.163 | 0.167 |
| | | 7-dehydro-cholesterol + H2O + | | | | | | |
| | | NADP⁺ | | | | | | |
| CHI18 | DHCR7 | 7-dehydro-cholesterol + | k_{f} | 0.614 | 0.718 | 0.657 | 0.514 | 0.466 |
| | | NADPH → cholesterol + | | | | | | |
| | | NADP⁺ | | | | | | |

Cholesterol II

| | | | | | | | | |
|---|---|---|---|---|---|---|---|---|
| ChII1 | DHCR24 | lanosterol + NADPH → 24,25- | k_{f} | 0.325 | 0.307 | 0.326 | 0.326 | 0.326 |
| | | dihydrolanosterol + NADP⁺ | | | | | | |
| ChII2 | CYP51 | 24,25-dihydrolanosterol + | k_{f} | 0.408 | 0.410 | 0.409 | 0.409 | 0.409 |
| | | NADPH + O₂ → 4 [symbol] 4-dimethyl- | | | | | | |
| | | 14alpha-hydroxymethyl- | | | | | | |
| | | 5alpha-cholesta-8-en-3beta-ol + | | | | | | |
| | | NADP⁺ + H₂O | | | | | | |
| ChII3 | CYP51 | 4,4-methyl-14alpha- | k_{f} | 0.408 | 0.410 | 0.409 | 0.409 | 0.409 |
| | | hydroxymethyl-5alpha- | | | | | | |
| | | cholesta-8-en-3beta-ol + | | | | | | |
| | | NADPH + O₂ → 4,4-dimethyl- | | | | | | |
| | | 14alpha-formyl-5alpha- | | | | | | |
| | | cholesta-8-en-3beta-ol + | | | | | | |
| | | NADP⁺ + 2 * H₂O | | | | | | |
| ChII4 | CYP51 | 4,4-dimethyl-14alpha-formyl- | k_{f} | 0.408 | 0.410 | 0.409 | 0.409 | 0.409 |
| | | 5alpha-cholesta-8-en-3beta-ol + | | | | | | |
| | | NADPH + O₂ → 4,4-dimethyl- | | | | | | |
| | | 5alpha-cholesta-8,14-dien- | | | | | | |
| | | 3beta-ol + NADP⁺ + H₂O + | | | | | | |
| | | formate | | | | | | |
| ChII5 | LBR | 4,4-dimethyl-5alpha-cholesta- | k_{f} | 0.002 | 0.002 | 0.002 | 0.002 | 0.002 |
| | | 8,14-dien-3beta-ol + NADPH → | | | | | | |
| | | 4 [symbol] 4-dimethyl-5alpha- | | | | | | |
| | | cholesta- [symbol] -en-3beta-ol + | | | | | | |
| | | NADP [symbol] | | | | | | |
| ChII6 | DHCR14 | 4,4-dimethyl-5alpha-cholesta- | k_{f} | 0.005 | 0.004 | 0.005 | 0.005 | 0.005 |
| | | 8,14-dien-3beta-ol + NADPH → | | | | | | |
| | | 4,4-dimethyl-5alpha- | | | | | | |
| | | cholesta-8-en-3beta-ol + | | | | | | |
| | | NADP⁺ | | | | | | |
| ChII7 | SC4MOL | 4,4-dimethyl-5alpha-cholesta- | k_{f} | 0.455 | 0.470 | 0.455 | 0.455 | 0.455 |
| | | 8-en-3beta-ol + NADPH + O₂ → | | | | | | |
| | | 4alpha-hydroxymethyl- | | | | | | |
| | | 4beta-methyl-5alpha-cholesta- | | | | | | |
| | | 8-en-3beta-ol + NADPH⁺ + H₂O | | | | | | |
| ChII8 | SC4MOL | 4alpha-hydroxymethyl-4beta- | k_{f} | 0.455 | 0.470 | 0.455 | 0.455 | 0.455 |
| | | methyl-5alpha-cholesta-8-en- | | | | | | |
| | | 3beta-ol + NADPH + O₂ → | | | | | | |
| | | 4alpha-formyl-4beta-methyl- | | | | | | |
| | | 5alpha-cholesta-8-en-3beta-ol + | | | | | | |
| | | NADP⁺ + 2 * H₂O | | | | | | |
| ChII9 | SC4MOL | 4alpha-formyl-4beta-methyl- | k_{f} | 0.455 | 0.470 | 0.455 | 0.455 | 0.455 |
| | | 5alpha-cholesta-8-en-3beta-ol + | | | | | | |
| | | NADPH + O₂ → 4alpha- | | | | | | |
| | | carboxy-4beta-methyl-5alpha- | | | | | | |
| | | cholesta-8-en-3beta-ol + | | | | | | |
| | | NADP⁺ + H₂O | | | | | | |
| ChII10 | NSDHL-1 | 4alpha-carboxy-4beta-methyl- | k_{f} | 0.568 | 0.568 | 0.665 | 0.696 | 0.784 |
| | | 5alpha-cholesta-8-en-3beta-ol + | | | | | | |
| | | NADP⁺ → 4alpha-methyl- | | | | | | |
| | | 5alpha-cholesta-8-en-3-one + | | | | | | |
| | | CO₂ + NADPH | | | | | | |
| ChII11 | HSD17B7 | 4alpha-methyl-5alpha-cholesta- | k_{f} | 0.137 | 0.171 | 0.194 | 0.236 | 0.259 |
| | | 8-en-3-one + NADPH → | | | | | | |
| | | 4alpha-methyl-cholesta-8- | | | | | | |
| | | enol + NADP⁺ | | | | | | |
| ChII12 | SC4MOL | 4alpha-methyl-cholesta-8-enol + | k_{f} | 0.455 | 0.470 | 0.455 | 0.455 | 0.455 |
| | | NADPH + O₂ → 4alpha- | | | | | | |
| | | hydroxymethyl-5alpha- | | | | | | |
| | | cholesta-8-en-3beta-ol + | | | | | | |
| | | NADP⁺ + H₂O | | | | | | |
| ChII13 | SC4MOL | 4alpha-hydroxymethyl-5alpha- | k_{f} | 0.455 | 0.470 | 0.455 | 0.455 | 0.455 |
| | | cholelsta-8-en-3beta-ol + | | | | | | |
| | | NADPH + O₂ → 4alpha-formyl- | | | | | | |
| | | 5alpha-cholesta-8-en-3beta-ol + | | | | | | |
| | | NADP⁺ + 2 * H₂O | | | | | | |
| ChII14 | SC4MOL | 4alpha-formyl-5alpha-cholesta- | k_{f} | 0.455 | 0.470 | 0.455 | 0.455 | 0.455 |
| | | 8-en-3beta-ol + NADPH + O₂ → | | | | | | |
| | | 4alpha-carboxy-5alpha- | | | | | | |
| | | cholesta-8-en-3beta-ol + | | | | | | |
| | | NADP⁺ + H₂O | | | | | | |
| ChII15 | NSDHL | 4alpha-carboxy-5alpha- | k_{f} | 0.568 | 0.568 | 0.665 | 0.696 | 0.784 |
| | | cholesta-8-en-3beta-ol + | | | | | | |
| | | NADP+ → 5alpha-cholesta-8- | | | | | | |
| | | en-3-one + NADPH + CO₂ | | | | | | |
| ChII16 | HSD17B7 | 5alpha-cholesta-8-en-3-one + | k_{f} | 0.137 | 0.171 | 0.194 | 0.236 | 0.259 |
| | | NADPH → zymosterol + | | | | | | |
| | | NADP⁺ | | | | | | |
| ChII17 | EBPL | zymosterol → lathosterol | k_{f} | 0.835 | 0.887 | 0.898 | 0.855 | 0.649 |

Cholesterol III

| | | | | | | | | |
|---|---|---|---|---|---|---|---|---|
| ChIII1 | SC5DL | 5alpha-cholesta-7,24-dien- | k_{f} | 0.195 | 0.183 | 0.186 | 0.163 | 0.167 |
| | | 3beta-ol + NADPH + O₂ → 7- | | | | | | |
| | | dehydrodesmosterol + NADP⁺ + | | | | | | |
| | | 2 * H₂O | | | | | | |
| ChIII2 | DHCR7 | 7-dehydrodesmosterol + | k_{f} | 0.614 | 0.717 | 0.657 | 0.514 | 0.466 |
| | | NADPH → desmosterol + | | | | | | |
| | | NADP⁺ | | | | | | |
| ChIII3 | DHCR24 | demosterol + NADPH → | k_{f} | 0.325 | 0.307 | 0.326 | 0.326 | 0.326 |
| | | cholesterol + NADP⁺ | | | | | | |

Degradation

| | | | | | | | | |
|---|---|---|---|---|---|---|---|---|
| D1 | CYP46A1 | cholesterol → 24-hydroxy- | k_{f} | 1.000 | 0.526 | 1.000 | 1.000 | 1.000 |
| | | cholesterol | | | | | | |
| D2 | CYP27B1 | 7-dehydro-cholesterol → 27- | k_{f} | 0.030 | 0.037 | 0.030 | 0.030 | 0.030 |
| | | hydroxy-7-dehydro-cholesterol | | | | | | |

RN: Reaction name;
R: rate constant (k_{f}, forward: k_{b}, backward);
Base: Baseline values;
HD: Huntington's disease;
IAD, MAD, SAD: incipient, moderate, and severe Alzheimer's disease. [symbol]
indicates data missing or illegible when filed

TABLE 10

| | Enzymes | Base | HD | IAD | MAD | SAD |
|---|---|---|---|---|---|---|
| E1 | AACS | 0.557 | 0.601 | 0.566 | 0.566 | 0.566 |
| E2 | ACAT1 | 0.798 | 0.849 | 0.558 | 0.558 | 0.558 |
| E3 | HMGCS1 | 1.000 | 0.994 | 0.698 | 0.698 | 0.698 |
| E4 | HMGCR | 0.233 | 0.178 | 0.233 | 0.233 | 0.233 |
| E5 | MVK | 0.283 | 0.283 | 0.326 | 0.320 | 0.407 |
| E6 | PMVK | 0.631 | 0.707 | 0.631 | 0.631 | 0.631 |
| E7 | MVD | 0.286 | 0.274 | 0.286 | 0.286 | 0.286 |
| E8 | IDI2 | 0.061 | 0.057 | 0.061 | 0.061 | 0.061 |
| E9 | FDPS | 0.765 | 0.845 | 0.759 | 0.963 | 0.999 |
| E10 | FDFT1 | 0.093 | 0.124 | 0.083 | 0.112 | 0.122 |
| E11 | SQLE | 1.000 | 1.000 | 1.000 | 1.000 | 1.000 |
| E12 | LSS | 0.014 | 0.014 | 0.011 | 0.018 | 0.020 |
| E13 | CYP51 | 0.408 | 0.410 | 0.409 | 0.409 | 0.409 |
| E14 | LBR | 0.002 | 0.002 | 0.002 | 0.002 | 0.002 |
| E15 | DHCR14 | 0.005 | 0.005 | 0.005 | 0.005 | 0.005 |
| | (codedby Tm7sf2) | | | | | |
| E16 | DHCR24 | 0.325 | 0.307 | 0.325 | 0.325 | 0.325 |
| E17 | SC4MOL | 0.455 | 0.471 | 0.455 | 0.455 | 0.455 |
| E18 | NSDHL | 0.568 | 0.568 | 0.665 | 0.696 | 0.784 |
| E19 | HSD17B7 | 0.137 | 0.172 | 0.194 | 0.236 | 0.259 |
| E20 | EBPL | 0.835 | 0.887 | 0.898 | 0.855 | 0.649 |
| E21 | SC5DL | 0.195 | 0.183 | 0.186 | 0.163 | 0.167 |
| E22 | DHCR7 | 0.614 | 0.718 | 0.657 | 0.514 | 0.466 |
| E23 | CYP46A1 | 1.000 | 0.526 | 1.000 | 1.000 | 1.000 |
| E24 | CYP27B1 | 0.030 | 0.037 | 0.030 | 0.030 | 0.030 |

The following enzymes are listed in Table 10: AACS—Acetoacetyl-CoA synthease; ACAT1—Acetyl-Coenzyme A acetyltransferase 1; HMGCS1—3-hydroxy-3-methylglutaryl-Coenzyme A synthase 1; HMGCR—3-hydroxy 3-methylglutaryl-Coenzyme A reductase; MVK—Mevalonate kinase; PMVK—Phosphomevalonate Kinase; MVD—Diphosphomevalonate decarboxylase; IDI2—Isopentenyl diphosphate isomerase 2; FDPS—Farnesyl diphosphate synthetase; FDFT1—Farnesyl diphosphate farnesyl transferase 1 (squalene synthase); SQLE—Squalene epoxidase; LSS—Lanosterol synthase; CYP51—Cytochrome P450, family 51; LBR—Lamin B receptor; TM7SF2 (produces DHCR14) Transmembrane 7 superfamily member 2; DHCR24—24-dehydrocholesterol reductase; SC4MOL—Sterol-C4-methyl oxidase-like; HSD17B7—-Hydroxysteroid (17-beta) dehydrogenase 7; EBPL—Phenylalkylamine Ca²⁺ antagonist, emopamil binding protein; SC5DL—Sterol-C5-desaturase; DHCR7—7-dehydrocholesterol reductase; CYP46A1—Cytochrome P450, family 46, subfamily a, polypeptide 1; CYP39 A1—Cytochrome P450, family 39, subfamily a, polypeptide 1; CYP27 B1—Cytochrome P450, family 27, subfamily b, polypeptide 1.

This mouse hippocampal model differs from traditional approaches in that the reaction rate constants are given by the expression pattern of each gene. Therefore multiple simulations to tune the model to a specified metabolic profile were not run. Validation of this type of model requires relative comparisons within the baseline metabolic profile and relative changes due to genetic or pharmacological manipulations.

Initially, the metabolic profile showed that the lanosterol-lathosterol products were found at higher concentrations than desmosterol (FIG. 3), a characteristic of the cholesterol pathway in the adult brain. Specifically, the average concentrations of lanosterol (M15), 4,4-dimethyl-5α-cholesta-8,24-dien-3β-ol (M34), 4-α-methylzymosterol (M41), and 5α-cholesta-7,24-dien-3β-ol (M47) was higher than the average concentration of 24,25-dihydrolanosterol (M16), and desmosterol (M32). The mouse hippocampal model replicated this internal characteristic of cholesterol metabolism using a simplified enzymatic network approach and reaction rate constants that did not required tuning.

The cholesterol model also replicated multiple knockout and genetic defect studies. When Dhcr14 reactions, associated with Lbr and Tm7sf2 genes, are knocked-out, the brain produces practically no cholesterol (M50). This condition in the model was tested by independently setting the kinetic value of the Dhcr14, Lbr and Tm7sf2, reactions to zero. In cases of modeled single knockouts, the cholesterol levels did not change from baseline.

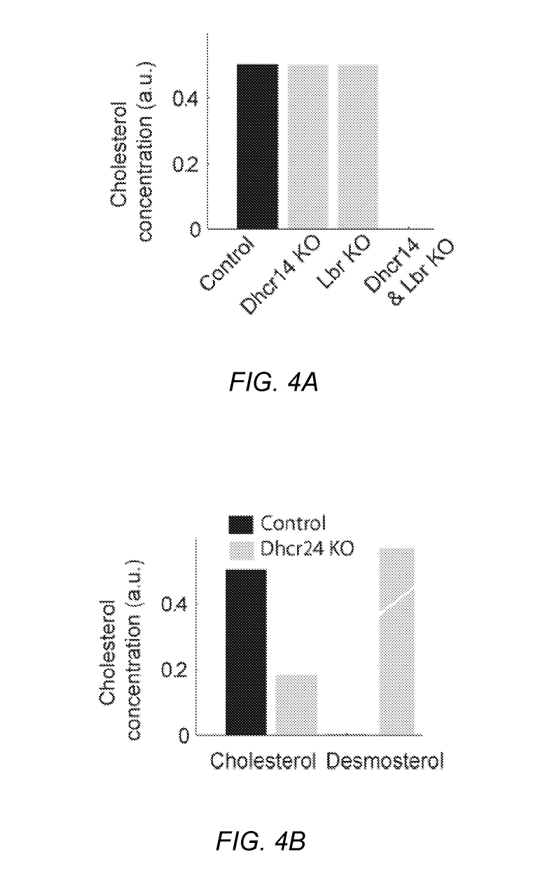

However, when these Dhcr14 reactions were both set to zero, cholesterol levels dropped to null (FIG. 4A), indicating that both reactions are well below saturation levels, as suggested by in vivo studies.

Elimination of Dhcr24 in mice leads to undetectable cholesterol and dramatically increased desmosterol (M30) levels with age, a condition known as desmosterolosis. In this case cholesterol production regresses to producing desmosterol (M32) which is the main sterol during early developmental stages (see Cholesterol III in FIG. 2). The model faithfully replicated this process. When the kinetic parameter of Dhcr24 was set to zero, cholesterol (M50) production decreased while desmosterol (M32) levels increased through the Cholesterol III pathway. Since desmosterol degradation mechanisms do not seem to compensate in vivo with desmosterolosis, the model also showed this product accumulating indefinitely (FIG. 4B).

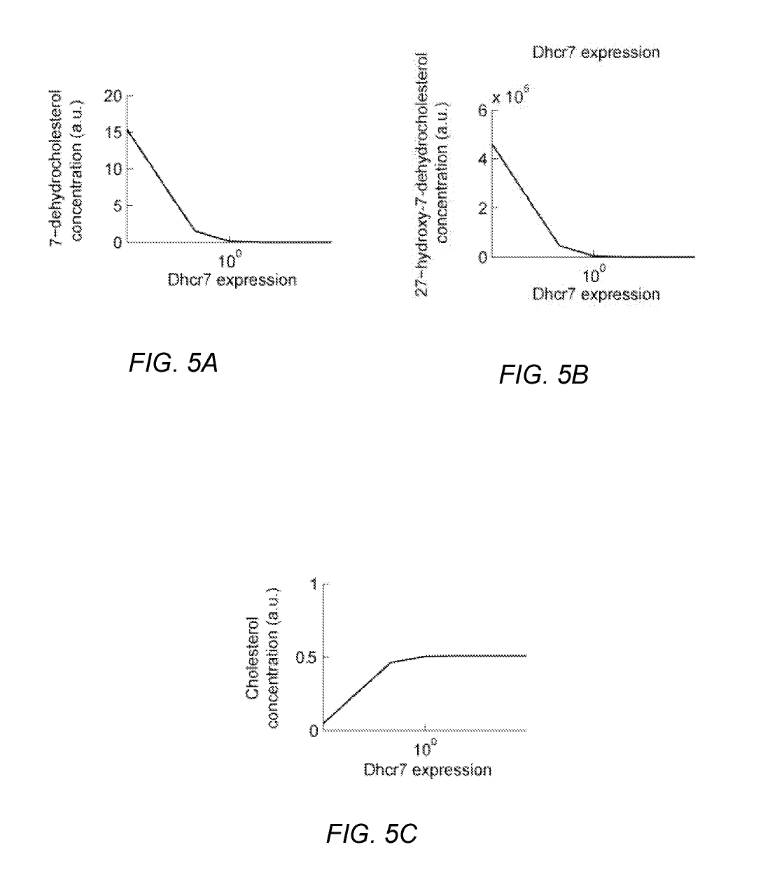

SLOS is attributed to a mutation in the Dhcr7 gene that encodes the final enzyme responsible for brain cholesterol synthesis. The SLOS mutation lessens or eliminates the enzymatic functional properties of the DHCR7 protein. The loss of function due to DHCR7 reduction results in excessive accumulation of 7-dehydrocholesterol (M47) and a reduction of cholesterol (M48). 7-dehydrocholesterol is the immediate precursor to cholesterol and 27-hydroxy-7-dehydrocholesterol (M52). The mouse hippocampus model was tested to mimic SLOS by performing a sensitivity analysis of the Dhcr7 baseline kinetic value by 3 orders of magnitude. As experimentally shown, 7-dehydrocholesterol accumulates as Dhcr7 decreases, as a direct consequence 27-hydroxy-7-dehydrocholesterol increases (FIGS. 5A and B). In the model of SLOS, 7-dehydrocholesterol accumulates because the small rate of transformation to 27-hydroxy-7-dehydrocholesterol mediated by Cyp27b 1 cannot compensate for the much higher rate of production of 7-dehydrocholesterol by SC5DL. Also consistent with in vivo SLOS conditions, experimental reduction of Dhcr7, in this model, resulted in a decrease in cholesterol production (FIG. 5C). In contrast, increases in the kinetic rate for the Dhcr7 reaction produced a saturation of cholesterol levels. This saturation effect on cholesterol production shown in FIG. 5C is due to a limitation in the production of 7-dehydrocholesterol mediated by Sc5dl, with a kf=0.195 that is less than one third of the basal Dhcr7 value.

Remarkably, without the need for tuning kinetic parameters, the simulations replicate basic genetic manipulations at multiple sites of the cholesterol synthesis pathway, suggesting that the strategy of mapping reaction rate constants with gene expression levels can describe the overall homeostatic behavior of cholesterol production in the brain.

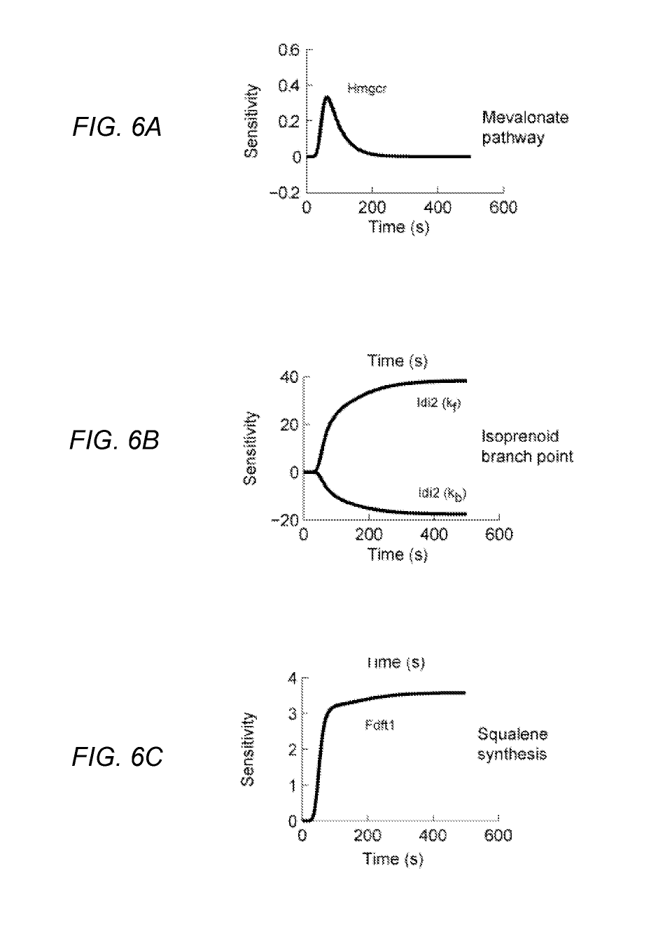

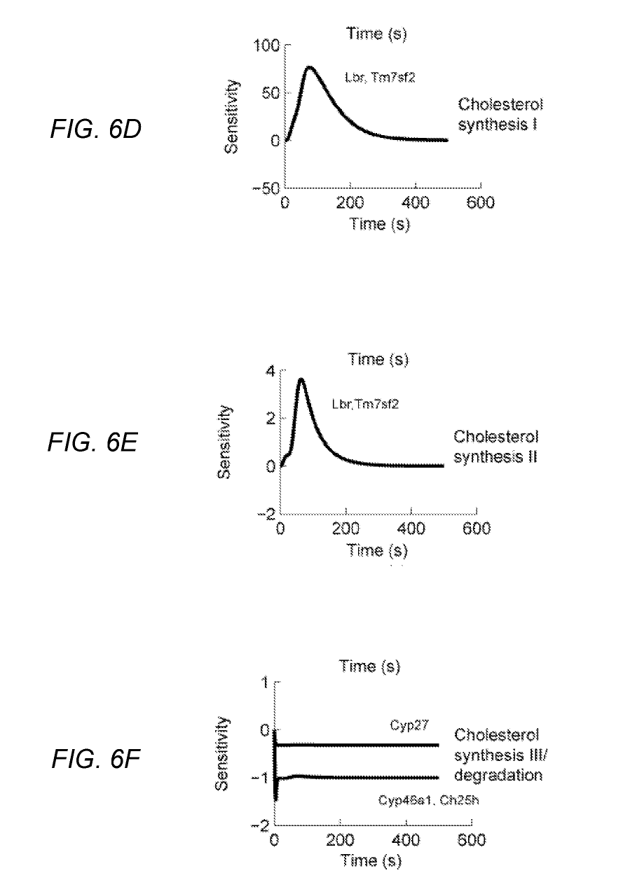

Since the cholesterol model developed in the previous section could replicate the effects of strong (knockout) manipulations it was decided to study the effects of small changes in reaction parameters on cholesterol production. A local sensitivity analysis was applied to the baseline model to determine potential points of regulation of cholesterol homeostasis. The result of such analysis is a time dependent evolution of the observed variable due to an infinitesimal perturbation in a rate constant. In this case the response of cholesterol production to all kinetic parameters was tested (FIG. 6). For clarity purposes a division of the analysis in the rate constants involved in the mevalonate branch (FIG. 6A), isoprenoid branch point (FIG. 6B), squalene synthesis (FIG. 6C), and Cholesterol I to III (FIGS. 6D, 6E, and 6F, respectively with Cholesterol III including cholesterol degradation) was performed. In general, perturbations in most kinetic rates resulted in no changes in cholesterol expression. Those kinetic reactions that had an effect on cholesterol production showed transitory and long term influence.

In the mevalonate pathway (from M1-M6 in FIG. 2) changes in all the kinetic rates resulted in transient changes in cholesterol production. The largest peak in sensitivity was from manipulation of Hmgcr (FIG. 6A). The enzymatic site of HMGCR in the cholesterol pathway (M5 to M6) is affected by statins, cholesterol synthesis inhibiting drugs that have been shown to have a negative correlation with incidence of Alzheimer's disease. The sensitivity analysis suggests that the acute effect of statins might differ from long term treatments.

Analysis of the isoprenoid branch point (M7-M 10) revealed only one gene that resulted in a strong effect on cholesterol levels, Idi2. Interestingly, the effect of changes in Idi2 resulted in long lasting modulation of cholesterol production (FIG. 6B). However, since Idi2 controls a forward and backward reaction the net result is more modest, as expected with a freely reversible reaction.

The effect of statins on suppression of the mevalonate pathway and the isoprenoid branch point can result in suppression of farnesylpyrophosphate and geranyl-geranylpyrophosphate needed for synaptic plasticity. Therefore, post-isoprenoid metabolic sites of intervention can be considered as novel therapeutics to control cholesterol metabolism without the side effects associated with statins. The sensitivity analysis of the squalene synthesis segment (M11 to M14) uncovered a very strong dependence of cholesterol production on the value of Fdft1, the gene product of which, squalene synthase mediates production of squalene from farnesyl pyrophosphate. Although the value of the relative sensitivity due to Fdft1 was smaller than in Idi2, this process is not affected by a backward reaction. As in the Idi2 case, changes in Fdft1 resulted in sharp and prolonged modification of cholesterol production, corroborating the proposal that this reaction is a candidate target of intervention when brain cholesterol metabolism is defective, but also not without potential complications.

Cholesterol I and II pathways showed transient sensitivity mediated by Lbr and Tm7sf2 (FIGS. 6D and E). Cholesterol III only showed sensitivity to changes in degradation (FIG. 6F), as expected from basic mass-action analysis (FIG. 1). Overall, the sensitivity analysis shows that Idi2 and Fdft1 are regulatory sites in the production of cholesterol that could have substantial long term effects, while multiple sites along the pathway have only transient effects.

The robustness of the model to changes in reaction rate constants of HMGCR and CYP46A1 was tested further. These enzymes display important kinetic parameters that stabilize cholesterol levels. The values of Hmgcr and Cyp46a1 were varied separately and simultaneously, to determine their effects on cholesterol levels. With independent simulations, their kinetic values were increased and decreased by three orders of magnitude. In each case the concentration levels of cholesterol, mevalonate, and 24-hydroxycholesterol were monitored for the effects of such manipulations. Only in the case when the kinetic rate constant controlled by Cyp46a1 decreased by a factor of 100 did cholesterol increase indefinitely (not shown). This accumulation is clearly due to the abolishment of degradation of cholesterol. All other manipulations showed changes only of a few percentage points, thus confirming that the simulations were robust to parameter manipulation.

Given that mouse hippocampus model was able to reproduce the effects of several genetic manipulations it was determined if the model could reveal cholesterol metabolism changes in AD. The experimental measurement of cholesterol in neural tissues presents challenges different from other tissues and is dependent on the cellular compartments sampled. One group has shown age-related decrease in major membrane lipids is accelerated in individuals with AD, while others have shown that an increase in plasma cholesterol is a risk factor for AD. However, there is evidence that membrane cholesterol content may either indicate metabolic changes that lead to AD, or could be a biomarker signaling a high magnitude of neuronal death.

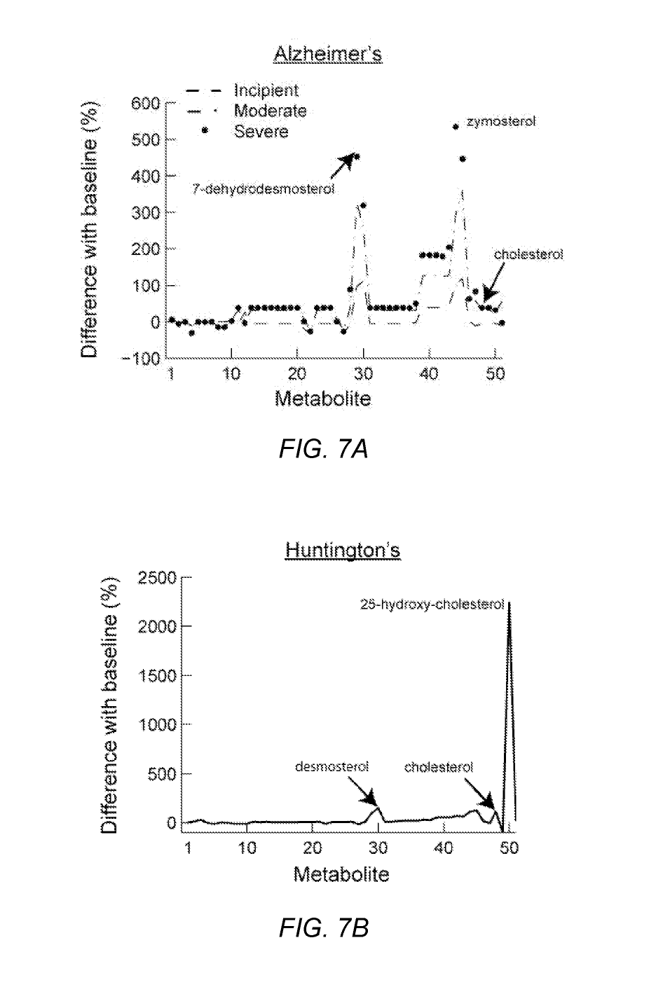

Published microarray data from the CA1 region of the human hippocampus was used from cases with varied severity of AD determined by cognitive status: incipient (IAD), moderate (MAD), or severe (SAD). The baseline cholesterol gene expression values were modified by the percent changes found in the three independent microarrays of incipient, moderate, and severe AD (compare changes from baseline in Table 10). The modified expression values were used to perform independent simulations for IAD, MAD, and SAD stages of cognitive loss (Table 9). The metabolic profile from each simulation under conditions for the different AD stages (FIG. 7A) revealed cholesterol to have a small decrease for IAD (−5%) with respect to the baseline model, whereas, both MAD and SAD showed increases of 31% and 38%, respectively. Quantitative comparisons are difficult to make when using the calculated concentration values from the model against experimental measurements of total tissue free cholesterol. However, increases in tissue free cholesterol are associated with increases in plasma membrane cholesterol. Free cholesterol levels of isolated frontal cortex membranes of human cases have been found to be slightly higher for mild AD, and are significantly and progressively elevated in the moderate and severe cases. Thus, these modeling results can replicate the trend for increased neuronal cholesterol in AD patients as the illness progresses.

The predictive power of modeling resides in monitoring variables that are difficult to measure experimentally. Using computer modeling one gains insight into changes in metabolic pathways otherwise difficult to measure experimentally. As seen in the case of the AD models, all levels of illness severity showed remarkable changes in the production of 7-dehydrodesmosterol and desmosterol (M31 and M32). Both of these metabolites increased in parallel (98%, 326% and 452% for 7-dehydrodesmosterol; 112%, 256%, 320% for desmosterol, for IAD, MAD, and SAD). Desmosterol and 7-hydrodesmosterol are generated in the cholesterol biosynthesis pathway 111 (FIG. 2), which contributes minimally to cholesterol production in the normal adult brain, showing a shift in cholesterol metabolic pathways as the severity of AD increases.

The increases in 7-dehydrodesmosterol, desmosterol and cholesterol are not due to a change in the enzymes directly involved in their production. In fact, during AD the expression of Dhcr7, the gene involved in desmosterol production, decreases as a function of the severity of the illness (from 0.65 in IAD to 0.47 in SAD, with 0.61 the value at baseline). In the case of 7-dehydrodesmoterol the Sc5dl value is slightly reduced as well (from 0.19 in IAD to 0.17 in SAD). Direct cholesterol production through Dhcr24 is unaffected by AD, an apparent discord since Dhcr24 is the Seladin-1 gene. Thus, the overall changes observed in cholesterol production are a result of the emergent properties of the biochemical network.

The sensitivity analysis shown in FIG. 6 gives more insights into other possible points responsible for metabolic changes in AD. This analysis suggests that small changes in Idi2 and Fdft1 could account for the strong and sustained changes in cholesterol production. While Idi2 does not show any changes during AD, Fdft1 partially accounts for the observed changes in cholesterol production (−10% in IAD, to 20% in MAD and SAD). The other gene that could contribute significantly to the increase of cholesterol production in AD is Hsd17b7 which increases from 0.137 at baseline to 0.259 in SAD (an 89% increase). Hsd17b7 is involved in the large increase in zymosterol production seen in FIG. 7A, which then gets compensated by the decrease in Ebpl (from 0.835 in baseline to 0.649 in SAD), Sc5dl (from 0.195 in baseline to 0.167 in SAD), and Dhcr7 (from 0.614 in baseline to 0.466 in SAD), which results in cholesterol production in cholesterol pathway II. Finally, the other gene responsible for large increases in cholesterol production is Mvk that increases about 75% from baseline to SAD (see reaction ML5 through ML7 in Table 9) and a lesser contribution from Fdps (30%), both of which are in the mevalonate synthesis pathway.

Huntington's disease is associated with early pathologies in the caudate nucleus in the adult brain and directly related to motor deficiencies; whereas, cognitive loss is associated with pathologies in the hippocampus. Due to the lack of direct information regarding the effects of HD on cholesterol metabolism in the hippocampus microarray data of cholesterol metabolism genes from the caudate were used to simulate HD changes in the adult mouse hippocampus (see Table 10, HD column). The simulations show that cholesterol increases by 120% of its baseline value (FIG. 7B). In this case the results are remarkably in agreement with recent published results of an HD transgenic mouse model that displays a 130% increase in cholesterol levels. As opposed to the case in AD, during HD only one of the core cholesterol metabolism genes shows a notable increase, Fdft1, from 0.093 during baseline levels, to 0.124, a 33% increase that accounts for the observed change in cholesterol production. All the other genes used for the model vary by less than 10% from baseline values.

Cholesterol production is affected by Hmgcr manipulation, which is the site of statin interference presently targeted to lower cholesterol levels in the brain as a treatment for AD. However, recent reports suggest that statins also affect the production of molecules related to synaptic plasticity, thus potentially causing a significant side effect to AD patients undergoing statin treatment. The metabolites produced at the isoprenoid branch point in the early cholesterol pathway are involved in synaptic plasticity, emphasizing the importance of finding sites for intervention downstream of this point or multiple points at which a combined effect is not strong on the isoprenoids involved in synaptic plasticity. The sensitivity analysis in FIG. 6 shows that the isoprenoid and squalene sections of the pathway (FIGS. 6B and C) are sensitive to small changes in Idi2 and Fdtfl, respectively. More importantly, rate changes in either of these reactions result in persistent changes in cholesterol production. In the squalene branch point, manipulations of Fdft1 show a strong influence in the production of cholesterol, with the advantage of being downstream from the isoprenoid branch point.

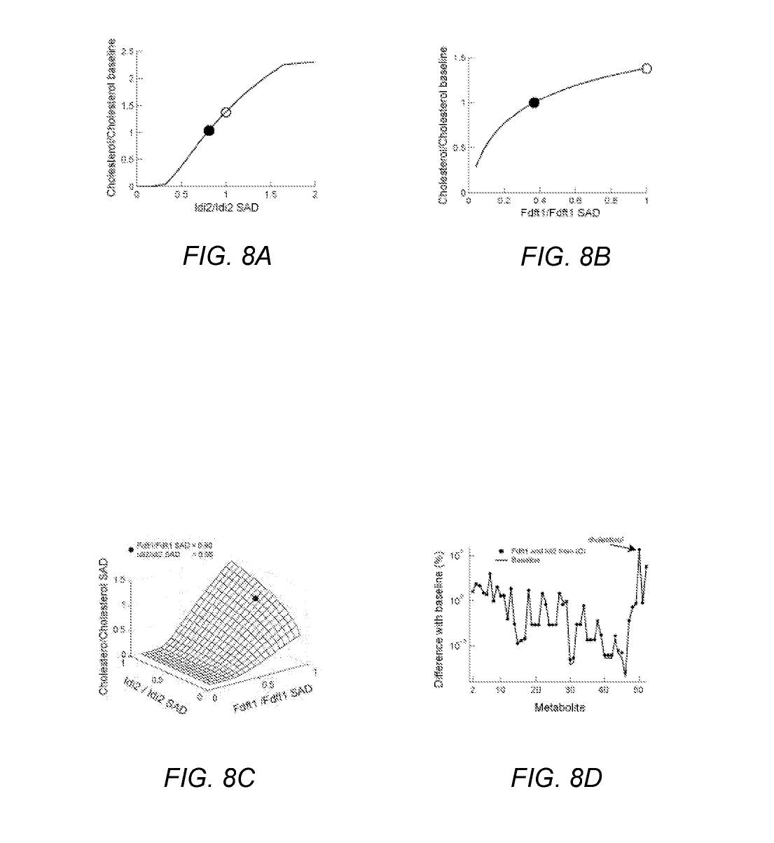

Finally, the amount of change in Idi2 and Fdft1 expression from SAD necessary to re-establish baseline cholesterol levels was determined. FIG. 8A shows a plot of cholesterol ratio with reference to normal baseline levels versus the ratio of modified-Idi2 to SAD-Idi2 value. A value of 1 in the ordinate corresponds to the baseline cholesterol level and in the abscissa to the value of Idi2 in SAD. The plot shows that the value of Idi2 has to be decreased by about 20% to recover baseline cholesterol levels. The same analysis for Fdft1 (FIG. 8B) shows that the activity of this gene has to be decreased by more than 60% to return to normal cholesterol concentrations. Since both sites could synergistically contribute to changing cholesterol levels a parameter sweep of Idi2 and Fdft1 values was run to find the values that return cholesterol production to baseline levels (FIG. 8C). Interestingly, while Fdft1 has to be reduced less than when modified alone (0.9 instead of 0.4 of the value of Fdft1 in SAD) the value of Idi2 had to be modified much more (0.55 instead of 0.8 of the original Idi2 SAD, black dot in FIG. 8C). The metabolic profile generated by the combination of changes in Fdft1 and Idi2 that recovered baseline cholesterol levels resulted in a consistent recovery, or normalization, of the entire baseline metabolic profile (FIG. 8D). In fact, calculating the least square distance between the baseline model and all the test metabolic profiles confirmed this normalization. The metabolic profile optimized only for matching cholesterol production coincided with the most normalized profile collectively. Thus, regulation of Idi2 and Fdft1 could be candidate targets to help in recovering normal hippocampal cholesterol metabolism in SAD cases. In fact, recent data suggest that modulating Fdft1 can regulate cholesterol levels without inhibiting isoprenoid synthesis seen with statins.

A technique that linearly mapped mRNA expression patterns to reaction rate constants was implemented. This technique to model brain cholesterol biosynthesis and degradation was useful. Although, the simulation of knockout manipulations can be explained from the network structure, the relative final metabolite levels in all other manipulations were a result of the specific values of the derived rate constants. The model was used to predict the metabolic profile changes of multiple diseases, including AD and HD. Sensitivity analyses showed that cholesterol production is transiently dependent on changes in the isoprenoid section and that a reaction mediated by Fdft1 during squalene synthesis can have long lasting effects on cholesterol production.

Determining the kinetic rates of large numbers of biochemical reactions based on metabolic and gene expression patterns is a difficult problem in systems biology. The approach assumed that the rate of production, not the metabolite concentration, is dependent on gene expression. Thus, as mRNA are produced and, presumably, enzymes are translated in the cell the probability of a reaction varies.

The model is based on the general expression of genes in the hippocampus; therefore, the simulations are not applicable to individual cells but tissues. The dynamical process of gene regulatory networks was not explicitly modeled here and could significantly modify the results. Furthermore, the relationship between mRNA expression and protein translation could be non-trivial, as it is in the case of stable mRNA and short lived proteins. Nevertheless, the implementation, as any other simulation strategy, is a simplified version of the processes taking place in a real tissue or individual cells. For simplicity it was assumed that higher values of mRNA expression linearly translate to faster reaction rate constants.

Independently of the underlying biophysical foundations of the model, the practical results from the approach are that the normalized kinetic values replicate experimental results and there is no need to train the model to a specific metabolic profile or known protein shape. Deriving reaction rate constants from test-tube experiments, or inducing their value computationally does not warranty finding a set of reactions that can replicate multiple normal and disease conditions. This is due to the presence of local minima that arise in such systems. Thus, since the rates are derived directly from mRNA expression it was hypothesized that the relative levels of rate constants represent the relationships actually present in the real system.

The deregulation of cholesterol homeostasis, accumulation of precursor metabolite, or compromise of supplies to side products from cholesterol synthesis is a major contributor to neurodegenerative diseases by causing neuron functional loss. Statins, which are HMG-CoA reductase inhibitors, are now being considered as potentially therapeutic measures in some neurodegenerative diseases such as AD. However, the levels of specific inhibition on downstream intermediary metabolites brought on by statins have not been extensively studied.

Three main regulatory sites in the cholesterol network were found, Hmgcr, Idi2, and Fdft1. Hmgcr and Idi2 are involved in pre-isoprenoid branch point processes. Cholesterol showed transitory sensitivity to manipulation of either gene expression resulting in temporal concentration changes that returned to baseline values at long simulation times. The evidence from the Hmgcr sensitivity analysis supports the idea that other compensatory factors play a role in the long term efficacy of statins to sustain a decreased cholesterol biosynthesis. In contrast, Fdft1 was involved in the production of squalene which is after the isoprenoid branch point. The side products of the isoprenoid branch are associated with molecules involved in synaptic plasticity, thus it is important to find cholesterol regulatory sites after the isoprenoid branch point. Recent evidence suggests that the model actually predicts correctly the Fdft1 regulatory site.

The objective was not to model the complete cholesterol homeostasis network during HD or AD; however, this validated model did reveal several characteristics of these diseases. The cholesterol changes in the HD model quantitatively matched the experimental evidence. These results contrast with recent reports from another group asserting the hypothesis that cholesterol biosynthesis and levels decrease in human HD. However, a direct correlation exists among mRNA levels for the Hmgcr gene, HMGCR protein content, and enzyme activity as they change over the progression of the HD pathology in transgenic mice.

The simulation results from incipient, moderate, and severe stages of AD qualitatively replicate experimental data. However, the accumulation of cholesterol in AD is highly likely to vary from region to region. Nevertheless, this cholesterol network reproduces the sensitivity found in the Hmgcr and Fdft1 sites. Furthermore, the simulations strengthen the argument for increased neuronal cholesterol in moderate and severe AD. This combination of techniques and analysis supports the hypothesis that cholesterol increases as a function of AD development and that recovery of baseline levels can be achieved by regulation in the Fdft1 site, where inhibitors are known to be selective for lowering cholesterol in neurons without affecting isoprenoid synthesis.

In these simulations only the most immediately related genes in cholesterol biosynthesis and degradation were included. Expanding the metabolic network to regulatory genes would probably result in the discovery of more regulatory sites by using a similar sensitivity analysis. A finer grained model could include micro-RNAs, e.g., miR-33, that affect cholesterol homeostasis and are changed in diseases, e.g., AD. Therefore, the linkage of gene transcription level to kinetic rates in combination with sensitivity analysis of the biochemical network can be a powerful technique to determine regulatory sites in metabolic reactions.

The adult hippocampus cholesterol metabolism model replicated several sets of experimental evidence, from several human genetic disorders, knockout mice, and AD and HD. This proposed technique of using gene expression to model reaction rate constants in biochemical pathways and sensitivity analysis can determine the effects of subtle and knockout changes in cholesterol production. Extension of the model including the regulatory and downstream metabolic reactions should result in more detailed and quantitative predictions on cholesterol homeostasis during normal and disease states.

Baseline gene expression data used in this study was obtained from the AMBA (Seattle, Wash., http://www.brain-map.org/). A detailed explanation of how expression values are calculated can be found in the AMBA website (http://mouse.brain-map.org/pdf/InformaticsDataProcessing.pdf). All genes necessary for cholesterol production are present in the hippocampus, particularly centered in the neuronal layers. The reported values of expression intensity from the AMBA ranges from 0 to 100 (See Table 10). These values were re-normalized between Eε(0-1), see below. A one substrate linear mass-action mechanism (eqn (1) was assumed.

$$S {}^{{k}_{f} , {k}_{b}} P \\ \frac{d [ P ]}{d t} = {k}_{f} [ S ] - {k}_{b} [ P ] \qquad ( 1 )$$

where S is the substrate; k_{f}=E_{f} and k_{b}=E_{b}, are the forward and backward rate constants. Similarly, E_{f} and E_{b} are the normalized expression level values of the enzymes involved in producing P and S. This model can be extended to a two-substrate catalysis system (eqn (2))

$$A + B {}^{{k}_{f} , {k}_{b}} C \\ \frac{d [ C ]}{d t} = {k}_{f} [ A ] [ B ] - {k}_{b} [ C ] \qquad ( 2 )$$

While there is a significant amount of experimental data on the mRNA expression levels of most genes involved in cholesterol production in the liver, evidence on the biochemical control of brain cholesterol homeostasis in baseline and diseased states is slowly emerging. The core biochemical pathway of cholesterol synthesis is well characterized (see FIG. 2), consisting of 51 enzymatic reactions, see Table 9. For degradation, two additional reactions were modeled, Cyp46a1 and Cyp27b1 (reactions D1 and D2 in Table 9) based on available AMBA gene expression data, bringing the total of modeled reactions to 53. The core cholesterol metabolic reaction set is controlled by 24 genes and corresponding enzymes (Table 10). The core pathway produces 52 different metabolites (Table 8). The network model was generated from existing pathway information on cholesterol biosynthesis (see superpathway of cholesterol biosynthesis in http://biocyc.org/ and steroid biosynthesis in http://www.genome.jp/kegg) and known enzymatic steps for neuronal catabolism of cholesterol and 7-dehydrocholesterol for removal from the brain.

mRNA expression levels on all genes for enzymes essential in cholesterol production and degradation in brain tissue were obtained from the AMBA and used those values to set up enzymatic reaction constants. The reaction constants in the range of [0-1], with 1 being the maximum expression level (e.g., Hmgcs1, Sqle, and Cyp46a1) were assigned. While mostly all known cholesterol reactions favor a forward reaction, the Idi2 reaction (ML8 in Table 9) has equally reversible properties. The equilibrium of Idi2 favors dimethylpyrophosphate (M10 in Table 8), but the reversibility of the isomerase reaction demonstrated direct formation of the reactant, isopentyl-pyrophosphate (M9 in Table 8). Therefore, the relationship k_{f}=k_{b} was used.

There was one gene, Nsdhl, with complete sets of images on AMBA but no reported mRNA expression level data sets. Lacking the AMBA value an expression number was derived with the following method. The assumption was that rate constants along consecutive downstream reactions are preserved between mouse and human brains. First, the gene expression for Nsdhl (Hq) and the gene for the immediately prior enzyme reaction, Sc4mol, (Hp) from human brain data (http://telethon.bio.unipd.it/bioinfo/HGXP_{—}170/index.html) was obtained. Second, the ratio of Hq to Hp (R_{f}=H_{q}/Hₚ) was calculated. Finally, the predicted enzymatic mRNA mouse expression was calculated by M_{q}=R_{f}×Mₚ; where Mₚ is the immediately prior enzyme reaction, Sc4mol.

For the kinetic parameters of AD the available microarray data from cholesterol biosynthesis and degradation markers was used. The percent changes from age matched controls to incipient, moderate, and severe AD cases were applied to the baseline mRNA expression values in order to derive disease state kinetic parameters. For HD the kinetic parameters were calculated from fold changes provided by microarray data (Table 10). Eqn (3) was used to derive the HD kinetic parameters (Eₖₐ) from the fold changes (Fₖ) and baseline expression (E_{kb}) provided by the AMBA.

Eₖₐ=E_{kb}2^{F}^{ₖ} (3)

The original biochemical network model was assembled in COPASI (www.copasi.com).

After testing with baseline values for the reactions, the model was exported in SBML. All test models used to generate the data sets presented in this study were simulated after import of the SBML file into the SimBiology toolbox in Matlab (Natick, Mass.). A sensitivity analysis was performed (FIG. 6) using an algorithm included in the SimBiology toolbox.

### Example I-2

### Skeletal Muscle and Effects of Statins on Cholesterol and Isoprenoid Metabolism

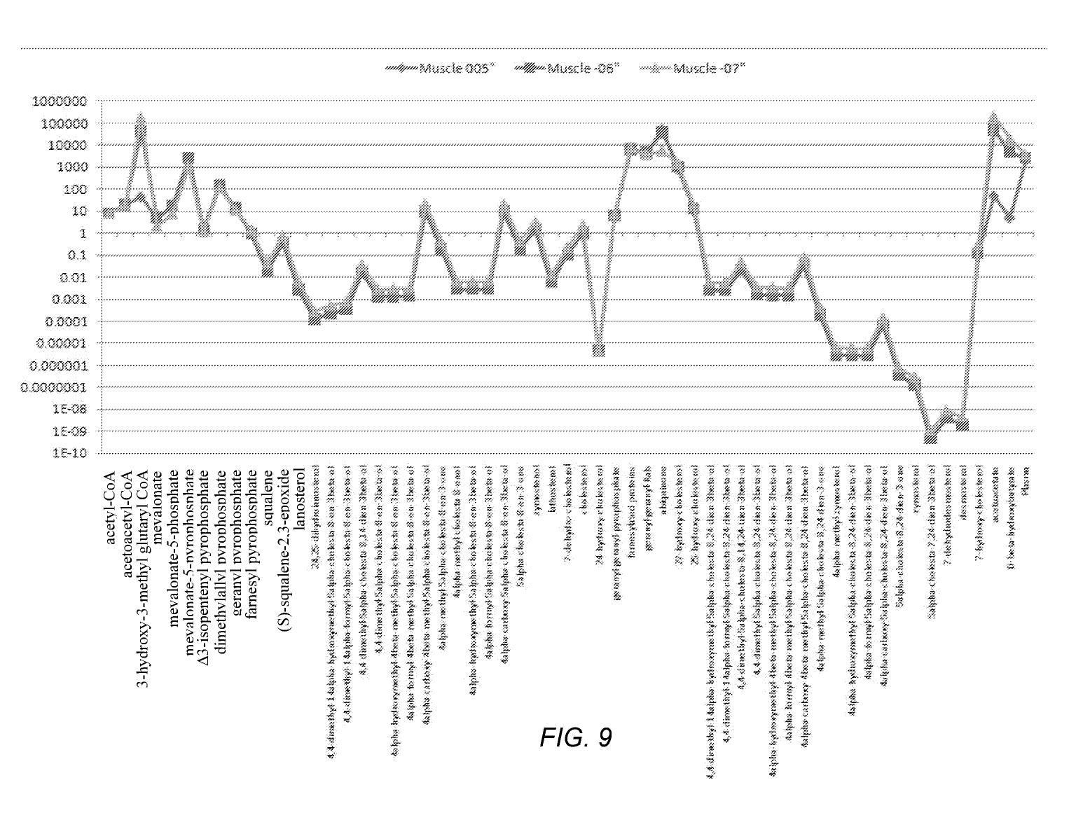

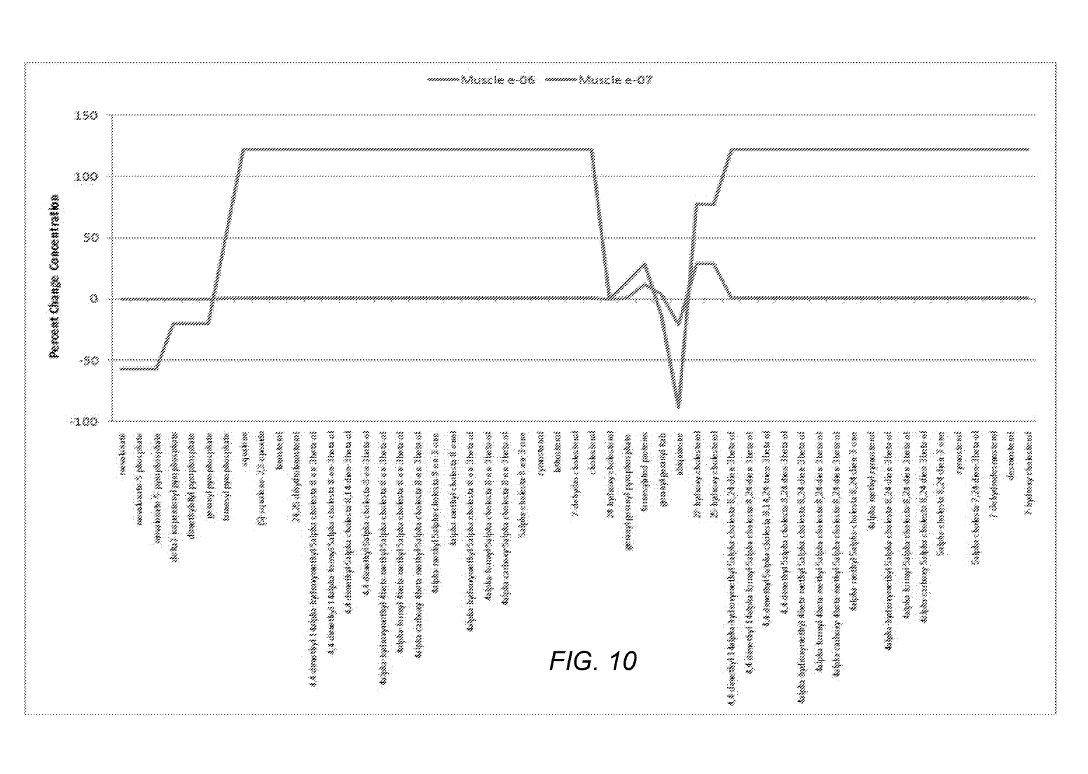

The effect of statins on cholesterol and isoprenoid metabolism may be studied using the cholesterol biosimulation. FIG. 9 depicts the dose response to statin of cholesterol metabolism in human skeletal muscle; the weighting factor value of HMGCR was reduced to mimic enzyme inhibition by a statin. FIG. 10 depicts the percent change in metabolite concentrations at the two highest degrees of HMGCR inhibition. The data generated from the biosimulation of inhibition of HMGCR by statins is presented in Table 11, which shows the enzyme flux values in adult human skeletal muscle biosimulation model upon administration of statins. Note the dramatic rise in cholesterol intermediates (plateau at left and right) and that the isoprenoids (deep dips in center) are suppressed the most dramatically at either degree of HMGCR inhibition. The first metabolite on the far left is mevalonate that is the product of the HMGCR enzyme; note that the higher level of HMGCR inhibition decreases mevalonate and subsequent intermediates to as much as 50% of control levels.

TABLE 11

| | HMGCR | HMGCR | |
|---|---|---|---|
| Metabolite | 5e−03 | 5e−07 | % Difference |
| 1 ACAT1[Flux] | 0.54027 | 0.54027 | 0 |
| 2 HMGCS-1[Flux] | 0.0491155 | 0.0491155 | 0 |
| 3 HMGCR[Flux] | 0.54027 | 0.232457 | −56.9739204 |
| 4 MVK[Flux] | 0.54027 | 0.232455 | −56.9742906 |
| 5 PMVK[Flux] | 0.54027 | 0.232449 | −56.9754012 |
| 6 MVD[Flux] | 0.54027 | 0.231581 | −57.1360616 |
| 7 IDI 1[Flux] | 0.0647678 | 0.0412915 | −36.2468696 |
| 8 DMTT[Flux] | 0.0647678 | 0.0412701 | −36.2799107 |
| 9 GTT[Flux] | 0.0647678 | 0.041268 | −36.283153 |
| 10 FDFT1[Flux] | 0.00286382 | 0.00634956 | 121.716449 |
| 11 SQM[Flux] | 0.00286382 | 0.00634957 | 121.716798 |
| 12 LSS[Flux] | 0.00286382 | 0.00634971 | 121.721686 |
| 13 DHCR24[Flux] | 0.000123322 | 0.000273433 | 121.722807 |
| 14 CYP51A1-1[Flux] | 0.000123322 | 0.000273433 | 121.722807 |
| 15 CYP51A1-2[Flux] | 0.000228726 | 0.000507136 | 121.72206 |
| 16 CYP51A1-3[Flux] | 0.000330076 | 0.000731851 | 121.721967 |
| 17 LBR[Flux] | 0.000484551 | 0.00107436 | 121.722791 |
| 18 SC4MOL-1[Flux] | 0.00127493 | 0.00282682 | 121.723546 |
| 19 SC4MOL-2[Flux] | 0.00133604 | 0.00296232 | 121.7239 |
| 20 SC4MOL-3[Flux] | 0.0013948 | 0.0030926 | 121.723545 |
| 21 NSDHL-1[Flux] | 0.00285288 | 0.00632938 | 121.859314 |
| 22 HSD17B7-1[Flux] | 0.00286084 | 0.00634709 | 121.861062 |
| 23 SC4MOL-4[Flux] | 0.00286095 | 0.00634734 | 121.86127 |
| 24 SC4MOL-5[Flux] | 0.00286106 | 0.00634759 | 121.861478 |
| 25 SC4MOL-6[Flux] | 0.00286117 | 0.00634783 | 121.861336 |
| 26 NSDHL-2[Flux] | 0.0028638 | 0.00635752 | 121.995949 |
| 27 HSD17B7-2[Flux] | 0.00286381 | 0.00635763 | 121.999015 |
| 28 EBP[Flux] | 0.00286382 | 0.00635822 | 122.018842 |
| 29 SC5DL[Flux] | 0.00286382 | 0.00635822 | 122.018842 |
| 30 DHCR7[Flux] | 0.00204558 | 0.00454162 | 122.021138 |
| 31 CYP46a1[Flux] | 0 | 0 | 0 |
| 32 BBB[Flux] | 0.00203541 | 0.00451948 | 122.042733 |
| 33 RABGGTA[Flux] | 0.000876021 | 0.00110747 | 26.4204854 |
| 34 FNTA[Flux] | 0.00586224 | 0.00872896 | 48.9014438 |
| 01 | 0.000045 | 0.000045 | 0 |
| ATP-citrate lyase[Flux] | | | |
| 37 GGPS1[Flux] | 0.00437975 | 0.00518809 | 18.4563046 |
| 38 TPT ubiquinone[Flux] | 0.0487981 | 0.0146519 | −69.9744457 |
| 39 CYP27[Flux] | 0.000818234 | 0.00181665 | 122.02084 |
| 40 CH25H[Flux] | 0.000010177 | 2.25972E−05 | 122.041859 |
| 41 CYP39A1[Flux] | 4.5401E−11 | 4.53998E−11 | −0.00264311 |
| 17a DHCR14[Flux] | 0.000726826 | 0.00161154 | 121.722943 |
| 34a FNTB[Flux] | 0 | 0 | 0 |
| 02 PDH[Flux] | 1.62 | 1.62 | 0 |
| 03 ACAD8[Flux] | 9.56594E−05 | 9.56594E−05 | 0 |
| 42 P1 CYP51A1-a[Flux] | 0.0027405 | 0.00607628 | 121.721584 |
| 43 P1 CYP51A1-2[Flux] | 0.00263509 | 0.00584258 | 121.722218 |
| 44 P1 CYP51A1-3[Flux] | 0.00253374 | 0.00561787 | 121.722434 |
| 45 P1 LBR[Flux] | 0.000660976 | 0.00146553 | 121.72212 |
| 46 P1 DHCR14[Flux] | 0.000991464 | 0.0021983 | 121.722624 |
| 47 P1 SC4MOL-1[Flux] | 0.00158888 | 0.00352292 | 121.723478 |
| 48 P1 SC4MOL-2[Flux] | 0.00152777 | 0.00338742 | 121.723165 |
| 49 P1 SC4MOL-3[Flux] | 0.00146901 | 0.00325713 | 121.722793 |
| 50 P1 NSDHL-1[Flux] | 1.09355E−05 | 2.42466E−05 | 121.723744 |
| 51 P1 HSD17B7-1[Flux] | 2.9824E−06 | 6.61272E−06 | 121.724785 |
| 52 P1 SC4MOL-4[Flux] | 2.8677E−06 | 6.35838E−06 | 121.72403 |
| 53 P1 SC4MOL-5[Flux] | 2.7574E−06 | 6.11383E−06 | 121.724451 |
| 54 P1 SC4MOL-6[Flux] | 2.65135E−06 | 5.87869E−06 | 121.724405 |
| 55 P1 NSDHL-2[Flux] | 1.97369E−08 | 4.37617E−08 | 121.725296 |
| 56 P1 HSD17B7-2[Flux] | 5.38278E−09 | 1.1935E−08 | 121.725577 |
| 57 P1 EBP[Flux] | 2.56322E−10 | 5.68337E−10 | 121.727749 |
| 58 P1 DHCR24[Flux] | 1.89868E−11 | 4.2099E−11 | 121.727727 |
| 59 P3 SC5DL[Flux] | 2.37336E−10 | 5.26238E−10 | 121.727003 |
| 60 P3 DHCR7[Flux] | 7.91119E−11 | 1.75413E−10 | 121.727705 |
| 61 P3 DHCR24[Flux] | 7.91119E−11 | 1.75414E−10 | 121.728969 |
| 62 DHCR24 43[Flux] | 0.000105404 | 0.000233703 | 121.721187 |
| 63 DHCR24 44[Flux] | 0.00010135 | 0.000224715 | 121.721756 |
| 64 DHCR24 45 46[Flux] | 0.000881302 | 0.00195404 | 121.721952 |
| 65 DHCR24 47[Flux] | 6.35554E−05 | 0.000140917 | 121.723095 |
| 66 DHCR24 48[Flux] | 0.000061111 | 0.000135497 | 121.722767 |
| 67 DHCR24 49[Flux] | 5.87606E−05 | 0.000130285 | 121.721698 |
| 68 DHCR24 50[Flux] | 0.00145808 | 0.0032329 | 121.723088 |
| 69 DHCR24 51[Flux] | 7.95308E−06 | 1.76339E−05 | 121.724162 |
| 70 DHCR24 52[Flux] | 1.14708E−07 | 2.54335E−07 | 121.723855 |
| 71 DHCR24 53[Flux] | 1.10296E−07 | 2.44553E−07 | 121.724269 |
| 72 DHCR24 54[Flux] | 1.06054E−07 | 2.35147E−07 | 121.723839 |
| 73 DHCR24 55[Flux] | 2.63161E−06 | 5.83495E−06 | 121.725484 |
| 74 DHCR24 56[Flux] | 1.43541E−08 | 3.18268E−08 | 121.726197 |
| 75 DHCR24 57[Flux] | 5.12646E−09 | 1.13668E−08 | 121.728054 |
| 76 DHCR24 58[Flux] | 1.58224E−10 | 3.50826E−10 | 121.727424 |
| 77 HMGCL[Flux] | 0 | 0.169326 | 169 |
| 78 HMGCS2[Flux] | 0.491155 | 0.491155 | 0 |
| 79 RABGGTB[Flux] | 0.00350264 | 0.00407869 | 16.4461663 |
| 80 CYP7A1[Flux] | 0.00203541 | 0.00451943 | 122.040277 |
| 81 | 1E−20 | 0.0153994 | 154 |
| DBHdehydrogen[Flux] | | | |

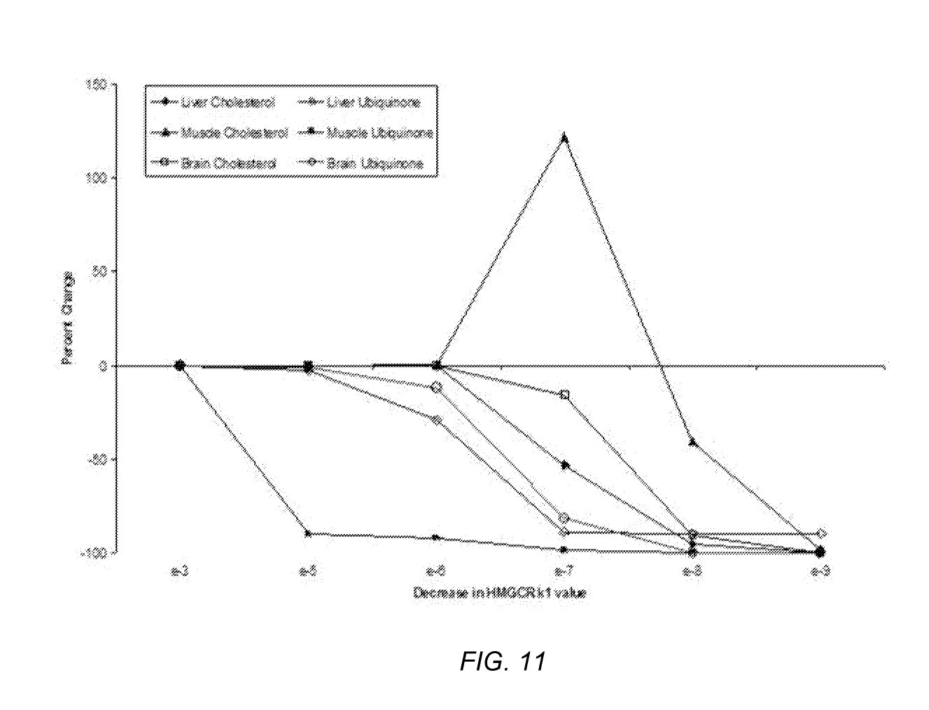

FIG. 11 depicts a line graph of percent change in ubiquinone and cholesterol levels in the cholesterol biosimulations models of human liver, skeletal muscle, and brain. Note that ubiquinone levels are suppressed more dramatically at lower levels of statin-simulated inhibition of HMGCR and that cholesterol levels increase at higher levels of HMGCR inhibition before finally decreasing.

To verify these results, data from the studies of the effect of statins on cell ubiquinone levels was compared to the results from the cholesterol biosimulation. Table 12 shows data from published work by others showing that liver cell ubiquinone levels are more dramatically depressed by lower doses of statins than the cholesterol levels.

TABLE 12

| | HMGCR | | | | | |
|---|---|---|---|---|---|---|
| | Activity | Simulation | Concentrations | | Cholesterol | |
| DOSE | % decrease | k1 HMGCR | ubiquinone | Total Q10 | atorvastatin | simvastatin |
| 0 | 0 | 0.006000 | 0.90436 | 2.07 | 15.62 | 15.67 |
| 0.01 | 1.59 | 0.005904 | | | 15.52 | 15.63 |
| 1 | 15.99 | 0.005040 | 0.51775 | 1.19 | | |
| 3 | 28.50 | 0.004289 | 0.22781 | 0.61 | 14.27 | 14.17 |
| 5 | 42.33 | 0.003459 | 0.17949 | 0.538 | | |
| 10 | 84.16 | 0.000950 | 0.05566 | 0.165 | 13.71 | 12.66 |
| 20 | 169.35 | 0.000475 | | | 13.66 | 13.97 |

Human clinical trials with statins also corroborate the biosimulation model of increased cholesterol and decreased ubiquinone in skeletal muscle (Paiva et al., Clin Pharmacol Ther 2005; 78:60-8), as shown in Table 13.

TABLE 13

| | Cholesterol | Ubiquinone |
|---|---|---|
| Placebo | 11.59 μmol/g | 39.7 nmol/g |
| Simvastatin | 16.06 μmol/g | 26.4 nmol/g |
| Percent from placebo | 139% rise | 134% drop |

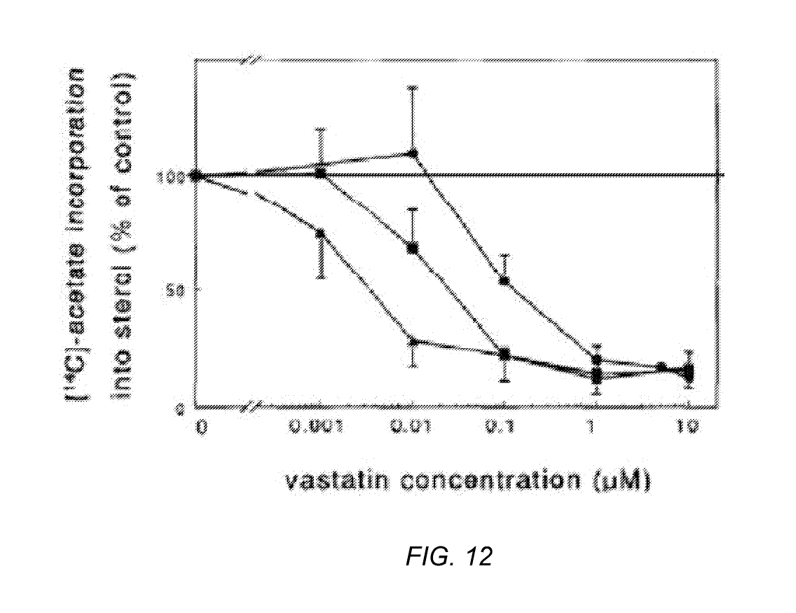

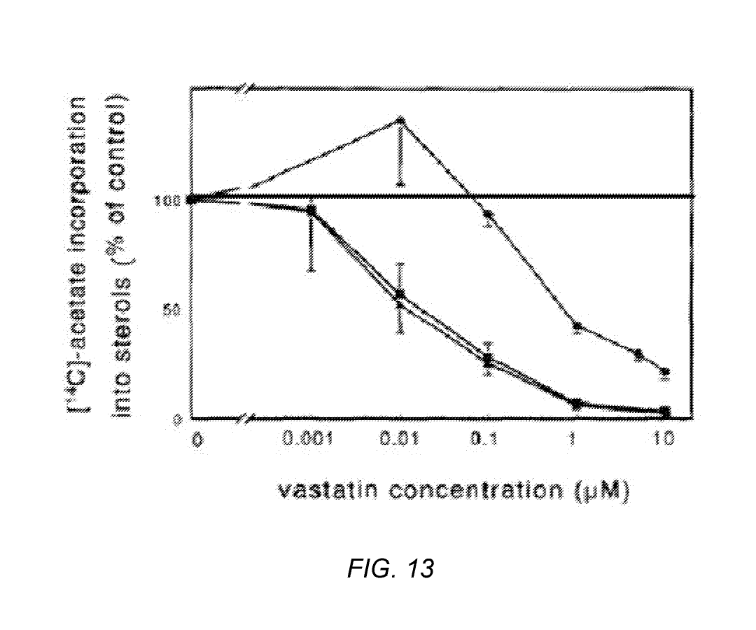

FIG. 12 depicts human skeletal muscle cells in vitro statin dose response of cholesterol synthesis rate (van Vliet et al., Biochemical Pharmacology 52:1387-92, 1996). FIG. 13 depicts human ovarian progesterone synthesizing (granulosa) cell in vitro statin dose response of cholesterol synthesis rate (van Vliet et al., Biochemica et Biophysica Acta, 1301:237-41, 1996).

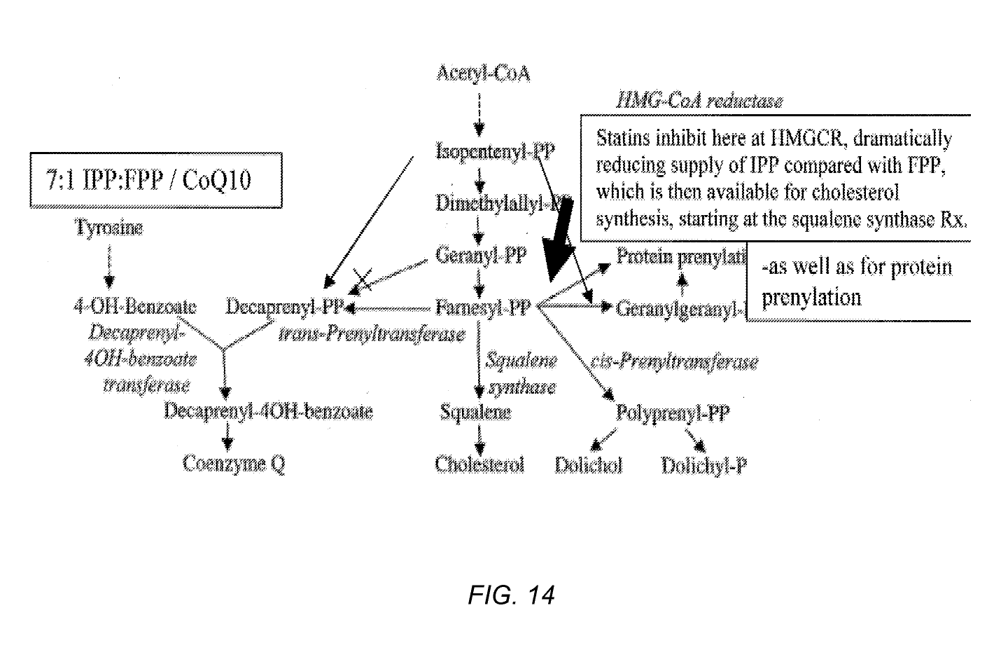

The effects of statins on the cholesterol biosynthetic pathways are shown in FIG. 14. FIG. 14 illustrates the isoprenoid and sterol biosynthetic pathways that explain how statins can lower delta3-isopentenyl pyrophosphate (IPP) levels and cause shunt of all intermediate metabolites from coenzyme Q synthesis into cholesterol synthesis. (Source Dallner, G. and Sindelar P. J. (2000) Regulation of Ubiquinone Metabolism. Free Radical Biology & Medicine 29(3/4):285-294)

At the dark arrow depicted in FIG. 14:

| Enzyme | Reaction |
|---|---|
| FNTA | “farnesyl pyrophosphate” + |
| | protein→“farnesylated protein” |
| FNTB | “farnesyl pyrophosphate” + |
| | protein→“farnesylated protein” |
| PTAR1 | “farnesyl pyrophosphate” + |
| | protein→“farnesylated protein” |
| GGPSI | “farnesyl pyrophosphate” + |
| | “delta3-isopentenyl pyrophosphate” = |
| | geranyl-geranyl-pyrophosphate + PPi |
| RABGGTA | geranyl-geranyl-pyrophosphate + Rab = |
| | geranyl-geranyl-Rab + PPi |
| RABGGTB | geranyl-geranyl-pyrophosphate + Rab = |
| | geranyl-geranyl-Rab + PPi |

trans-Prenyltransferase (TPT) for Coenzyme Q (ubiquinone) synthesis:
TPT “farnesyl pyrophosphate” + 7 * “delta3-isopentenyl pyrophosphate”→ ubiquinone
(X on line from geranyl-PP to decaprenyl-PP above means that reaction is not included in model, based upon literature and KEGG site.)

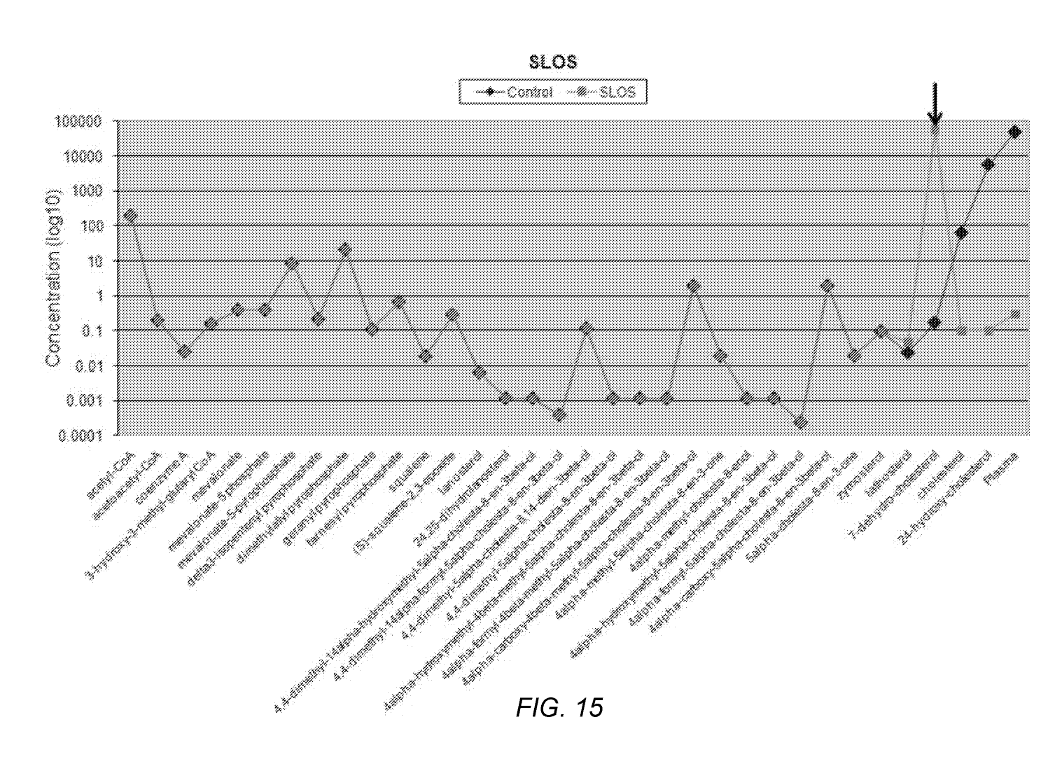

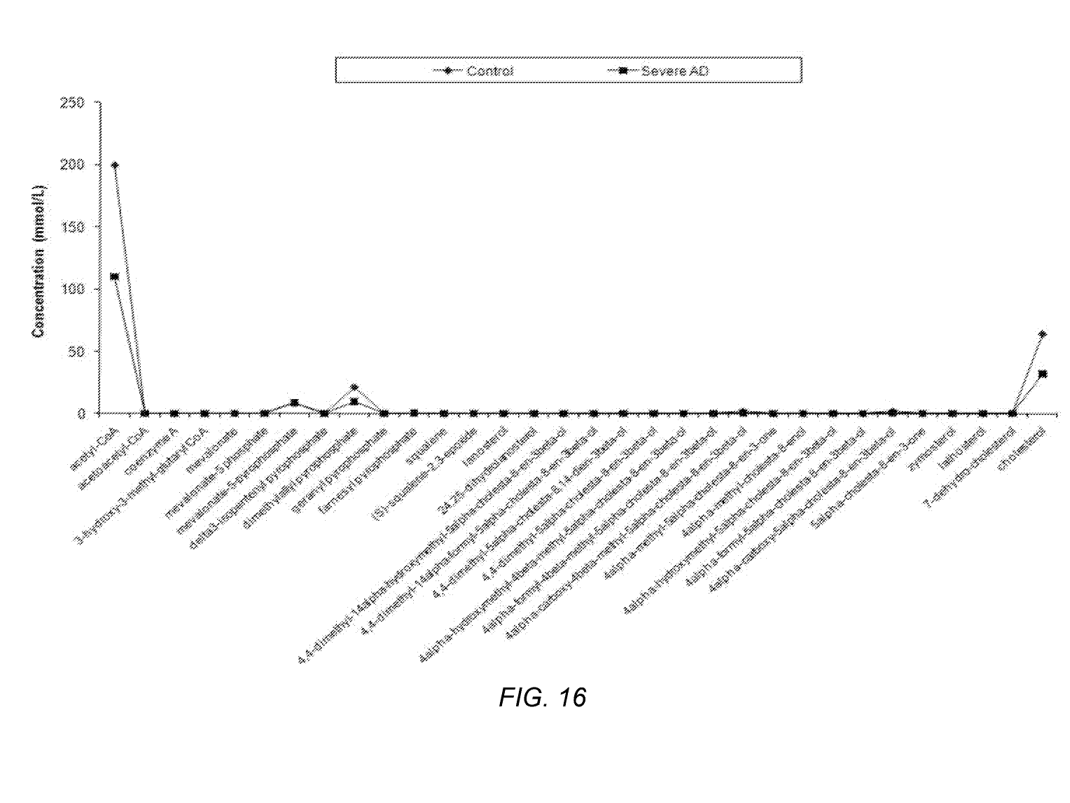

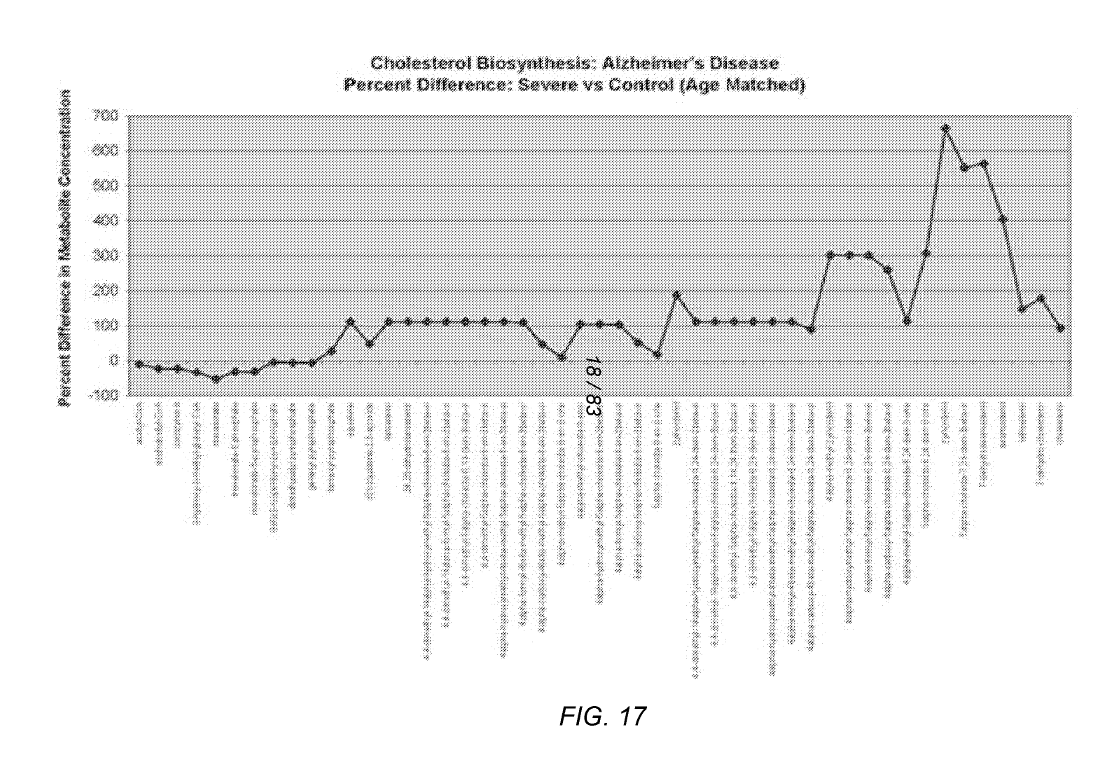

The cholesterol biosimulation can also be used to simulate the effects of genetic mutations. For example, FIG. 15 depicts biosimulation modeling of a genetic mutation in the dhcr7 gene. This mutation causes a dramatic increase in 7-dehydro-cholesterol (arrow) and dramatic drop in levels of cholesterol and the 24-hydroxy-cholesterol both in brain and the plasma in the cholesterol biosimulation. FIG. 16 depicts biosimulation of severe Alzheimer's Disease based on fold change in gene expression—concentration in mmol/L of cholesterol and intermediates are increased. FIG. 17 depicts biosimulation of severe Alzheimer's Disease based on fold change in gene expression—Showing percent change in concentration of cholesterol and intermediates are increased.

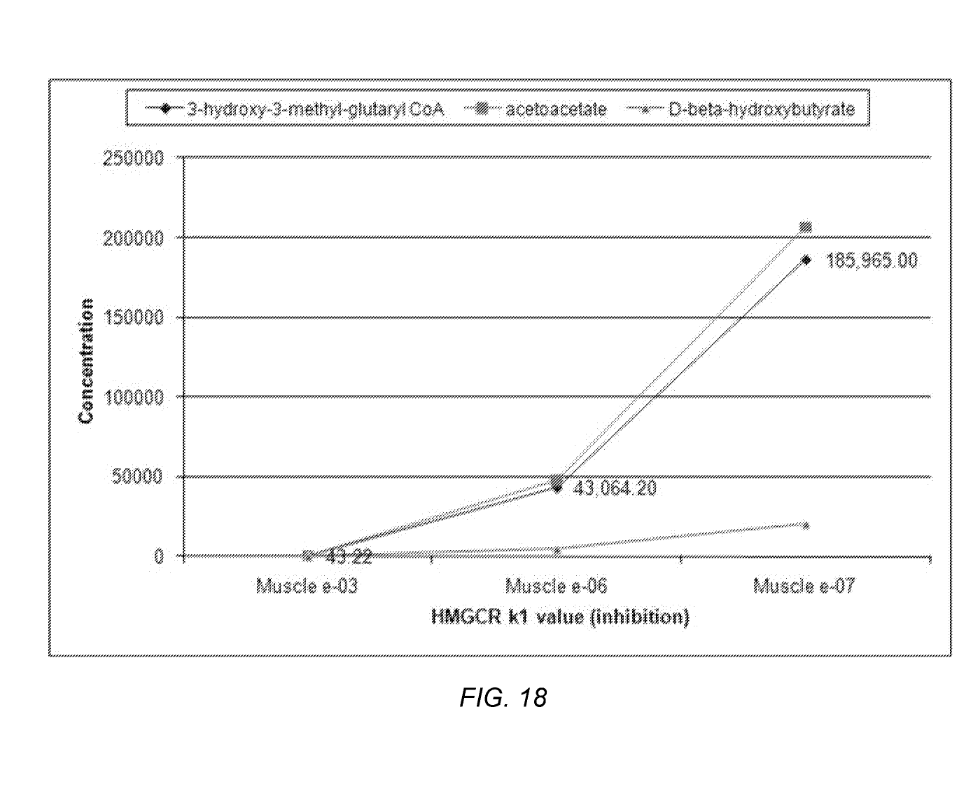

FIG. 18 depicts the accumulation of HMG-CoA (precursor to mevalonate at HMGCR reaction) metabolite with simulation of effects of statins. Acetoacetate and d-beta-hydroxybutyrate are synthesized from HMG-CoA as part of the ketogenic metabolic pathway found in liver and muscle. Here are the fold increases in HMG CoA with the e-06 and e-07 values for the k1 of HMGCR (e-03 is control) after 1×10⁶ seconds of simulation.

HMGCRk1=5e-06 995.35

HMGCRk1=5e-07 4,301.59

The results from the biosimulation can be compared to in vivo studies. Table 14 shows the accumulation of HMG-CoA in clam oocytes treated with a statin inhibitor, lovastatin at 50 M concentration. (Turner et al., 1995) The level of HMG-CoA from clam oocytes after 20 or 40 minutes of treatment with either vehicle or lovastatin is shown in Table 14.

TABLE 14

| | |
|---|---|
| 20 min | 40 min |

| veh | statin | veh | statin |
|---|---|---|---|
| 51.47 | 250.49 | 85.78 | 693.14 |
| % change | 486.67 | % change | 808.00 |

### Example I-3

### Cholesterol and Steroid Biosynthesis in Gonadal Cells

Table 15 shows a listing of some of the metabolites produced in steroid biosynthesis in gonadal cells. Table 15 also shows the difference in metabolite levels between brain and ovary cells.

TABLE 15

| | Brain | Ovary | Percent |
|---|---|---|---|
| acetyl-CoA | 12.82 | 6.23 | −51.38 |
| acetoacetyl-CoA | 60.38 | 32.21 | −46.65 |
| 3-hydroxy-3-methyl-glutaryl CoA | 18.89 | 12.05 | −36.21 |
| mevalonate | 3.00 | 6.02 | 100.48 |
| mevalonate-5 phosphate | 6.61 | 22.09 | 234.13 |
| mevalonate-5-pyrophosphate | 472.30 | 3314.11 | 601.68 |
| delta3-isopentenyl pyrophosphate | 1.20 | 0.5344 | −55.57 |
| dimethylallyl pyrophosphate | 112.41 | 36.59 | −67.44 |
| geranyl pyrophosphate | 11.24 | 3.65 | −67.44 |
| farnesyl pyrophosphate | 1.53 | 2.98 | 94.47 |
| squalene | 0.14939 | 0.654206 | 337.91 |
| (S)-squalene-2,3-epoxide | 5.60 | 12.26 | 118.95 |
| lanosterol | 0.008805 | 0.073506 | 734.82 |
| 24,25-dihydrolanosterol | 0.0001585 | 0.024625 | 15436.91 |
| 4,4-dimethyl-14alpha-hydroxymethyl-5alpha-cholesta-8-en-3beta-ol | 0.0003142 | 0.04307 | 13608.75 |
| 4,4-dimethyl-14alpha-formyl-5alpha-cholesta-8-en-3beta-ol | 0.0004671 | 0.056887 | 12078.33 |
| 4,4-dimethyl-5alpha-cholesta-8,14-dien-3beta-ol | 0.0581138 | 1.20 | 1978.37 |
| 4,4-dimethyl-5alpha-cholesta-8-en-3beta-ol | 0.0013002 | 0.002706 | 108.14 |
| 4alpha-hydroxymethyl-4beta-methyl-5alpha-cholesta-8-en-3beta-ol | 0.0014357 | 0.002709 | 88.65 |
| 4alpha-formyl-4beta-methyl-5alpha-cholesta-8-en-3beta-ol | 0.001569 | 0.002711 | 72.76 |
| 4alpha-carboxy-4beta-methyl-5alpha-cholesta-8-en-3beta-ol | 55.61 | 327.08 | 488.10 |
| 4alpha-methyl-5alpha-cholesta-8-en-3-one | 1.49 | 0.436126 | −70.75 |
| 4alpha-methyl-cholesta-8-enol | 0.0089475 | 0.002929 | −67.26 |
| 4alpha-hydroxymethyl-5alpha-cholesta-8-en-3beta-ol | 0.0089478 | 0.002929 | −67.26 |
| 4alpha-formyl-5alpha-cholesta-8-en-3beta-ol | 0.0089483 | 0.002929 | −67.26 |
| 4alpha-carboxy-5alpha-cholesta-8-en-3beta-ol | 56.02 | 327.10 | 483.87 |
| 5alpha-cholesta-8-en-3-one | 1.49 | 0.436159 | −70.80 |
| zymostenol | 7.46 | 49.06 | 556.86 |
| lathosterol | 0.0023588 | 0.004361 | 84.89 |
| 7-dehydro-cholesterol | 0.257573 | 0.831618 | 222.86 |
| cholesterol | 20.40 | 45.51 | 123.07 |
| 24-hydroxy-cholesterol | 1.27 | 4.54E−06 | −99.99 |
| geranyl-geranyl-pyrophosphate | 5.41 | 2.39 | −55.85 |
| farnesylated proteins | 36801.10 | 17859.60 | −51.46 |
| geranyl-geranyl-Rab | 7370.74 | 4760.61 | −35.41 |
| ubiquinone | 5584.81 | 110.52 | −98.02 |
| 27-hydroxy-cholesterol | 1789.34 | 6568.99 | 267.11 |
| 25-hydroxy-cholesterol | 202.36 | 449.23 | 121.99 |
| 4,4-dimethyl-14alpha-hydroxymethyl-5alpha-cholesta-8,24-dien-3beta-ol | 0.0086494 | 0.055061 | 536.59 |
| 4,4-dimethyl-14alpha-formyl-5alpha-cholesta-8,24-dien-3beta-ol | 0.0084964 | 0.041244 | 385.42 |
| 4,4-dimethyl-5alpha-cholesta-8,14,24-trien-3beta-ol (FFMAS) | 0.0386201 | 0.100595 | 160.47 |
| 4,4-dimethyl-5alpha-cholesta-8,24-dien-3beta-ol | 0.0076633 | 0.000223 | −97.09 |
| 4alpha-hydroxymethyl-4beta-methyl-5alpha-cholesta-8,24-dien-3beta-ol | 0.0075278 | 0.000221 | −97.06 |
| 4alpha-formyl-4beta-methyl-5alpha-cholesta-8,24-dien-3beta-ol | 0.0073947 | 0.000219 | −97.04 |
| 4alpha-carboxy-4beta-methyl-5alpha-cholesta-8,24-dien-3beta-ol | 0.407198 | 0.02184 | −94.63 |
| 4alpha-methyl-5alpha-cholesta-8,24-dien-3-one | 0.0027146 | 1.17E−05 | −99.56 |
| 4alpha-methyl-zymosterol | 1.6E−05 | 7.78E−08 | −99.51 |
| 4alpha-hydroxymethyl-5alpha-cholesta-8,24-dien-3beta-ol | 1.572E−05 | 7.7E−08 | −99.50 |
| 4alpha-formyl-5alpha-cholesta-8,24-dien-3beta-ol | 1.544E−05 | 7.63E−08 | −99.50 |
| 4alpha-carboxy-5alpha-cholesta-8,24-dien-3beta-ol | 0.0008502 | 7.62E−06 | −99.10 |
| 5alpha-cholesta-8,24-dien-3-one | 5.668E−06 | 4.08E−09 | −99.92 |
| zymosterol | 1.771E−06 | 2.73E−09 | −99.84 |
| 5alpha-cholesta-7,24-dien-3beta-ol | 5.567E−10 | 2.39E−13 | −99.95 |
| 7-dehydrodesmosterol | 4.231E−08 | 1.21E−11 | −99.97 |
| desmosterol | 7.521E−08 | 3.96E−12 | −99.99 |

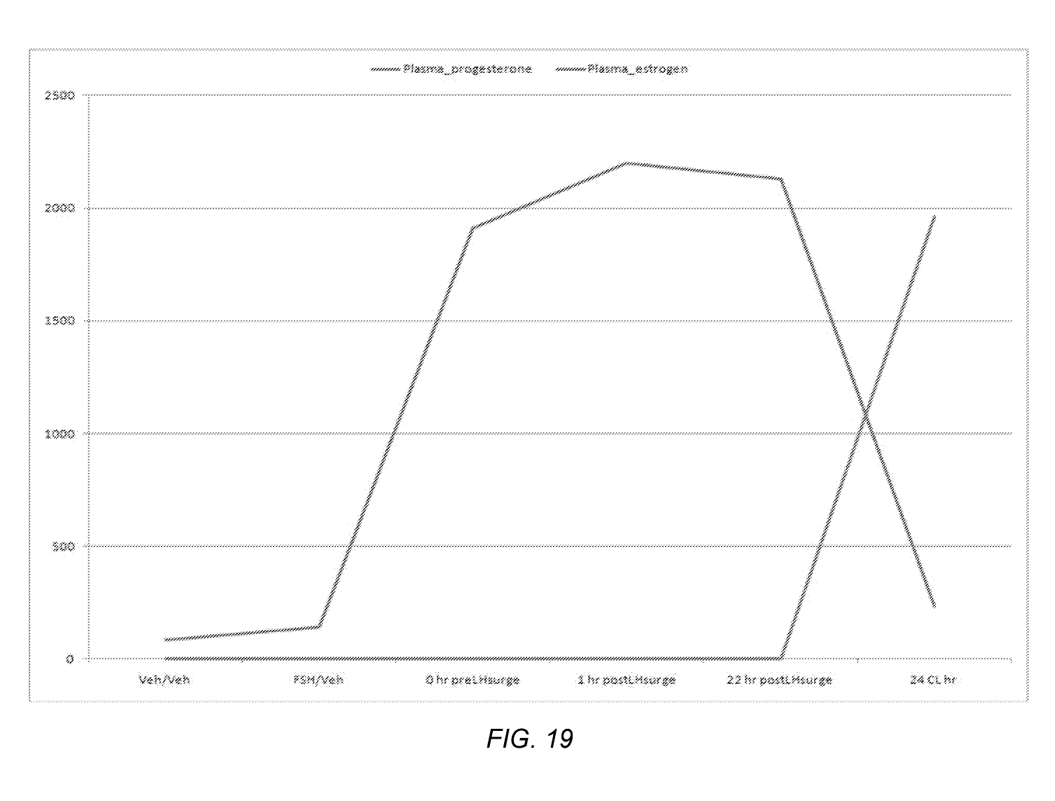

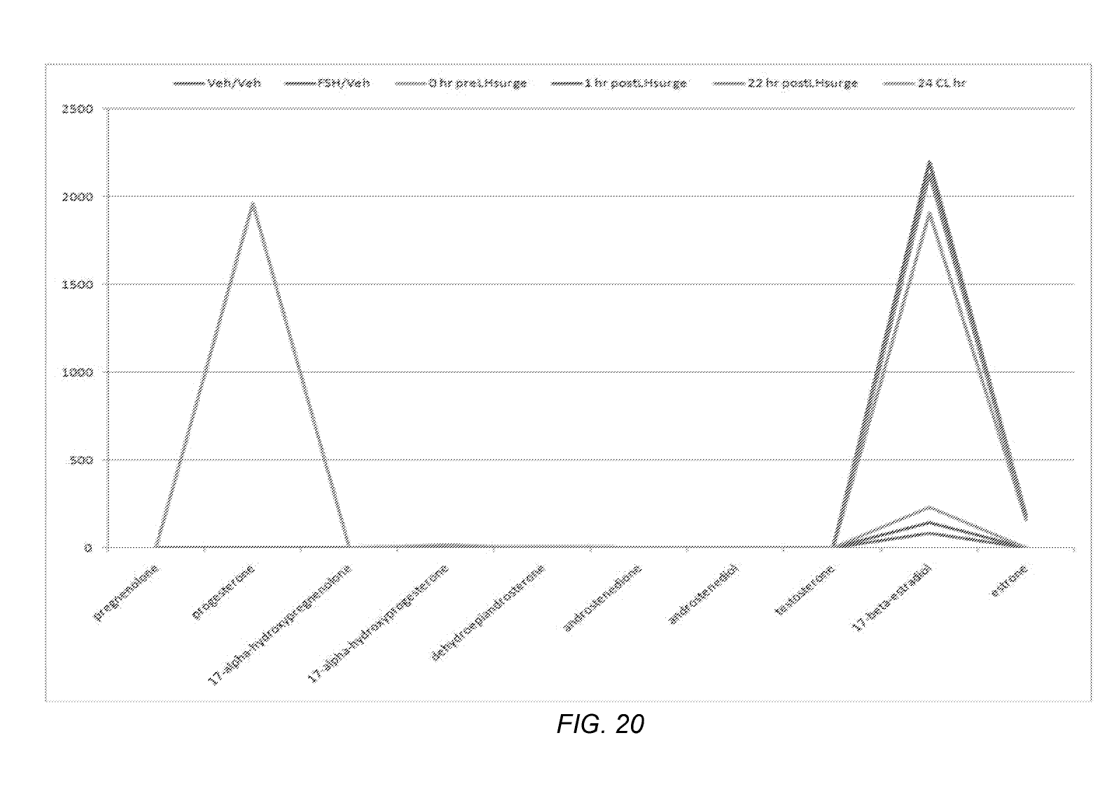

The graphical display of plasma levels of progesterone and estrogen generated by separate steroid biosimulation models using microarray data from ovarian follicular cells sampled at different stages of the estrous or menstrual cycles from rat, mouse, buffalo, and monkey is depicted in FIG. 19. FIG. 20 depicts a graphical display of cellular levels of several gonadal steroids, in particular, progesterone and 17-beta-estradiol, generated by the same steroid biosimulation models.

### Example I-4

Integrated Organ Systems Metabolomics Transcriptomics Computational Model

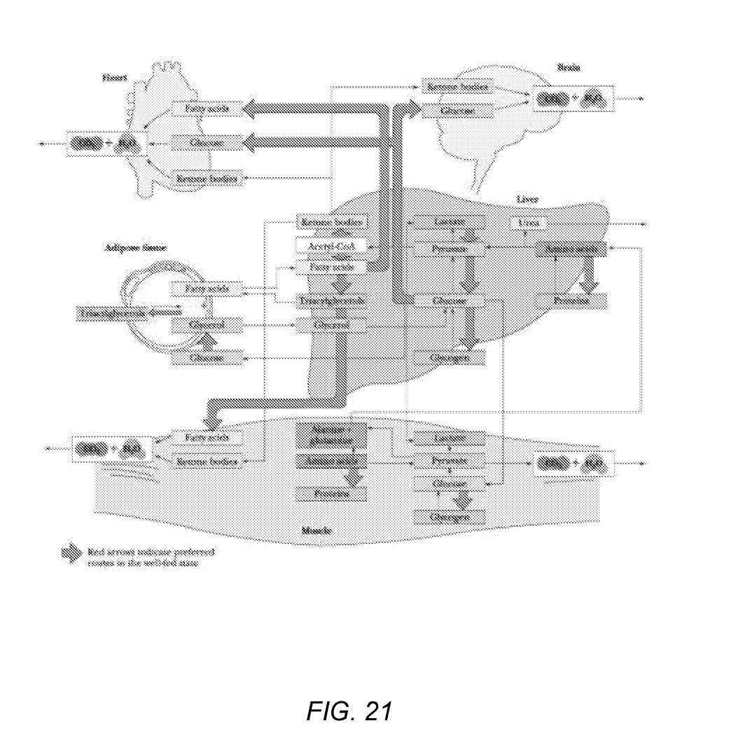

FIG. 21 shows an illustration of a SimBiology multiorgan model used to simulate an organ system subset of a complete organism. The genes related to the core metabolic processes depicted in FIG. 21, as well as ATP production, were identified. Conversion factors to convert the KCC of oral mucosa (buccal cheek epithelial/surrogate) cells to other tissues/organs of the adult human were generated and are listed in Table 16. The data from GSE3526 were used.

TABLE 16

| | | | | | Skeletal |
|---|---|---|---|---|---|
| Gene Symbol | Adipose | Heart | Hippocampus | Liver | Muscle |
| GLUD1 | 1.02170671 | 0.76959721 | 1.724320866 | 3.59994469 | 0.829385455 |
| GLUD2 | 0.7301649 | 0.57678243 | 1.375899568 | 2.31549203 | 0.74945496 |
| SLC6A15 | 1.28963206 | 1.65787872 | 1.789864235 | 1.43227701 | 1.281179656 |
| SLC6A19 | 0.87778198 | 1.37866968 | 1.076424785 | 1.05054227 | 1.331235873 |
| SLC7A5 | 0.17194948 | 0.22420409 | 0.562283693 | 0.31583278 | 0.286777177 |
| SLC7A8 | 0.91220667 | 0.6802867 | 0.683027323 | 0.72550125 | 0.810221496 |
| GPT | 0.88712469 | 1.06065837 | 0.631812028 | 1.75721004 | 1.230052826 |
| GOT1 | 0.36245022 | 2.5828374 | 1.099581799 | 2.39347443 | 2.457364066 |
| GOT2 | 0.4227718 | 2.74012403 | 1.020920599 | 3.08803114 | 2.796492415 |
| SLC1A1 | 0.96206186 | 1.00848729 | 1.230576758 | 1.12599849 | 1.144552695 |
| SLC25A11 | 0.71001463 | 2.15616367 | 1.218671463 | 0.97993712 | 2.539339195 |
| SLC25A13 | 1.10951694 | 0.61280727 | 1.205525502 | 7.75951077 | 0.593878881 |
| SLC7A11 | 0.35171452 | 0.58590594 | 4.590120239 | 0.45108588 | 0.518463735 |
| ACLY | 1.556309 | 1.22086265 | 1.389866194 | 1.29771983 | 1.03173082 |
| CLYBL | 1.11641874 | 1.52752771 | 0.907157145 | 3.34408201 | 1.733713024 |
| MLYCD | 0.97310911 | 2.03874839 | 0.706948112 | 1.5241078 | 2.348268527 |
| AACS | 1.1543694 | 0.32407234 | 0.663622408 | 0.19325522 | 0.234722191 |
| SLC13A5 | 1.45213751 | 1.61874877 | 2.148027348 | 27.7358695 | 1.479697631 |
| SLC25A1 | 2.09806337 | 0.43182204 | 0.690118351 | 2.02490474 | 0.442355475 |
| PRKAA1 | 1.46130413 | 1.51187573 | 1.340194481 | 1.97770829 | 1.036714109 |
| PRKAR2A | 0.81005041 | 1.08385416 | 0.923725057 | 0.86856999 | 1.371691416 |
| PRKAB1 | 0.80610337 | 0.62179762 | 0.801052157 | 0.70863358 | 0.748638347 |
| PRKAG1 | 1.03372987 | 1.20282809 | 0.878842232 | 0.90640367 | 1.346669895 |
| PRKAG2 | 1.05707132 | 1.52781781 | 1.323351694 | 1.1946201 | 1.428355179 |
| PPP2CA | 0.77041968 | 0.64321545 | 0.883157157 | 0.62956405 | 1.240181802 |
| PPM1F | 1.10815152 | 1.16063631 | 1.105732928 | 0.88302592 | 0.852888995 |
| PPP2CB | 1.07463731 | 0.6530556 | 1.728347506 | 0.87262553 | 0.974328602 |
| PPM1H | 0.915088 | 1.11321708 | 1.28002499 | 0.86599168 | 1.341600689 |
| ABCA1 | 3.26533985 | 1.44046761 | 1.146164014 | 4.51532756 | 1.527619818 |
| ACAT1 | 1.42384331 | 3.6335167 | 0.720906142 | 4.52008322 | 4.208357706 |
| ACAT2 | 0.517412 | 0.3318813 | 0.732221014 | 1.36345855 | 0.532787968 |
| HMGCS1 | 0.26439608 | 0.18637035 | 0.573883725 | 1.20825961 | 0.162572805 |
| HMGCR | 0.23706922 | 0.15579704 | 0.552364372 | 0.40024764 | 0.142513507 |
| MVK | 0.83881833 | 0.88443211 | 0.94519984 | 1.1388682 | 0.958146668 |
| PMVK | 0.51004828 | 0.59107876 | 0.629986924 | 0.71316039 | 0.52824301 |
| MVD | 0.60926043 | 0.89363209 | 0.932992421 | 0.80496097 | 0.896017329 |
| IDI1 | 0.77900395 | 0.40387538 | 1.892977954 | 1.79284233 | 2.537669286 |
| IDI2 | 1.1859921 | 1.52608991 | 1.57690809 | 1.23367962 | 1.47118793 |
| FDPS | 0.69922259 | 0.51253241 | 0.752092604 | 1.38321081 | 0.450006081 |
| GGPS1 | 1.20300023 | 1.29112606 | 1.273391388 | 0.73506709 | 1.254555115 |
| FDFT1 | 0.69707899 | 0.42598041 | 0.823777239 | 0.58525031 | 1.208640459 |
| SQLE | 0.53159815 | 0.46916862 | 0.819132692 | 0.56333608 | 0.560224599 |
| LSS | 1.48472257 | 1.10411594 | 1.218552879 | 1.89661103 | 1.037725923 |
| CYP51A1 | 0.53878499 | 0.2572072 | 1.022756536 | 1.83149394 | 0.221897416 |
| LBR | 1.69250926 | 0.74019128 | 0.662552912 | 1.60085461 | 0.676396935 |
| TM7SF2 | 1.02638107 | 0.89981406 | 0.796262735 | 0.96140359 | 0.501588544 |
| SC4MOL | 0.29076319 | 0.09223855 | 0.657040263 | 2.85320995 | 0.074334243 |
| NSDHL | 0.53636208 | 0.58962369 | 0.653398546 | 0.690223 | 0.354856975 |
| HSD17B7 | 0.72178502 | 0.92825678 | 1.177156053 | 2.15259203 | 0.580001242 |
| EBP | 0.38403078 | 0.42492257 | 0.455864953 | 1.67462252 | 0.332478096 |
| SC5DL | 1.26204168 | 2.06833682 | 1.720623229 | 1.390112 | 1.389391093 |
| DHCR7 | 0.65203801 | 0.63665532 | 0.924854096 | 1.36989588 | 0.685464684 |
| DHCR24 | 0.27536688 | 0.17265167 | 0.608704976 | 1.27317371 | 0.435351089 |
| CYP27A1 | 1.20805541 | 1.05500326 | 1.343893948 | 6.48266802 | 1.257027917 |
| CYP39A1 | 1.17757624 | 0.91521221 | 0.59784935 | 10.921249 | 0.630695257 |
| CYP7A1 | 1.04703761 | 1.34762876 | 1.317363653 | 35.0527201 | 1.181560155 |
| CYP46A1 | 1.29738494 | 2.14380028 | 21.59361584 | 1.52970678 | 1.916770552 |
| CH25H | 2.59287321 | 1.0101977 | 0.840764405 | 0.61357256 | 0.605043654 |
| PANK1 | 0.62478967 | 1.63936631 | 0.899594764 | 6.40867873 | 1.086599521 |
| PANK2 | 1.13694295 | 0.94243235 | 1.503372104 | 0.83475677 | 0.897700091 |
| PANK3 | 1.10543847 | 1.11465495 | 1.133955363 | 2.03715633 | 1.319528121 |
| PANK4 | 0.96263141 | 1.10014326 | 1.122159047 | 0.96294525 | 1.790413303 |
| AASDHPPT | 1.13563201 | 1.02067492 | 2.167036091 | 1.34576407 | 1.728872995 |
| COASY | 0.68431167 | 0.8521119 | 0.876356 | 1.26813745 | 0.744908694 |
| RAF1 | 0.89563003 | 1.06874233 | 0.759667673 | 0.98774279 | 1.073579869 |
| MAP4K1 | 1.05034299 | 1.22937891 | 1.036551716 | 1.3077745 | 1.053941949 |
| MAP4K2 | 1.03049195 | 1.41675348 | 1.270822266 | 1.02769492 | 1.257827431 |
| MAP4K3 | 1.54245903 | 1.72764106 | 1.319360204 | 1.14955377 | 2.699796673 |
| MAP4K4 | 1.58113531 | 1.82882265 | 3.597947503 | 1.79730551 | 0.663794556 |
| MAP4K5 | 0.97604469 | 0.7805865 | 1.100159368 | 0.6153465 | 0.671076205 |
| MAP3K1 | 0.59574571 | 0.36213459 | 0.213407676 | 0.3686813 | 0.169679384 |
| MAP3K3 | 1.14338982 | 1.49229306 | 0.746806032 | 0.91814268 | 0.95721785 |
| MAP3K7 | 1.24546949 | 0.88806543 | 1.005240979 | 1.04055687 | 0.906131595 |
| MAP3K8 | 3.38042881 | 1.28966348 | 0.847183517 | 1.12146997 | 0.85574537 |
| MAP3K9 | 0.44822186 | 0.52809877 | 1.959043532 | 0.67372691 | 0.513169831 |
| MAP3K12 | 1.36802911 | 1.59572318 | 2.119772141 | 1.48503631 | 1.731675317 |
| MAP2K1 | 0.79799519 | 0.45713454 | 2.091034632 | 1.13732128 | 1.379076771 |
| MAP2K3 | 0.5066057 | 0.44086272 | 0.194067931 | 0.75377805 | 0.965953484 |
| MAP2K5 | 1.15670511 | 1.17454704 | 1.537312155 | 0.9351881 | 1.258964448 |
| MAP2K7 | 0.88550426 | 1.00109167 | 1.110477169 | 1.06861746 | 1.354354723 |
| MAPK1 | 0.65103903 | 0.59396071 | 0.473450525 | 0.54957864 | 0.410963694 |
| MAPK3 | 0.73406334 | 0.59837238 | 0.821259578 | 0.51655232 | 0.718716524 |
| MAPK6 | 0.48834983 | 0.42472466 | 0.678174675 | 0.89447747 | 1.18115016 |
| MAPK7 | 0.81304274 | 0.78270836 | 0.716379397 | 0.65262266 | 0.598928524 |
| MAPK9 | 0.92034253 | 1.23474052 | 1.071516585 | 0.7308098 | 1.142501262 |
| MAPK10 | 2.77325419 | 1.45250848 | 4.419319616 | 1.40066695 | 1.55823853 |
| MAPK11 | 0.98472033 | 1.40125177 | 1.195928142 | 0.99458851 | 1.812378468 |
| MAPK12 | 1.04228757 | 2.45922362 | 1.320819968 | 1.24548659 | 1.708948691 |
| MAPK13 | 0.10058824 | 0.08370395 | 0.141723163 | 0.11297968 | 0.090500984 |
| MAPK14 | 0.64835986 | 0.58564044 | 0.574644853 | 0.68659215 | 0.966822609 |
| MAPK15 | 1.19892448 | 1.83687338 | 1.524411873 | 1.40308249 | 1.690940662 |
| ATP7A | 1.4442537 | 1.3986751 | 1.22929648 | 1.07381178 | 1.077798995 |
| CREB1 | 1.72507235 | 1.13786785 | 0.753900156 | 1.16824052 | 0.672371774 |
| CREB3 | 1.07402138 | 1.04240665 | 1.289411126 | 0.9768229 | 1.01002837 |
| CREBL2 | 1.24248728 | 1.16987668 | 1.247215954 | 1.19870293 | 1.013367268 |
| CREB3L1 | 1.78973705 | 4.68332144 | 1.397699041 | 1.24102656 | 1.453766593 |
| ACSL1 | 5.42837361 | 1.16642247 | 0.499996005 | 5.90866231 | 2.372436488 |
| ACADVL | 1.03021237 | 1.636023 | 0.532309922 | 1.90723744 | 1.48505989 |
| EHHADH | 2.07022151 | 1.37943046 | 0.947720224 | 36.0072973 | 0.73648894 |
| HADH | 2.40458894 | 1.1538053 | 0.78389849 | 2.27044425 | 2.960989503 |
| HADHA | 1.12204562 | 1.07178127 | 0.623936185 | 1.18128087 | 1.413929208 |
| HADHB | 1.13909955 | 2.84354472 | 0.715960714 | 1.4584897 | 2.394392815 |
| ACADL | 2.33103138 | 1.26640566 | 1.445346777 | 3.88360387 | 2.619633234 |
| ACADM | 2.30161358 | 4.29720194 | 0.994868593 | 4.94168178 | 5.410629999 |
| ACAA1 | 0.5502388 | 0.72741433 | 0.586059785 | 4.1707841 | 0.342722922 |
| ACAA2 | 0.9420331 | 1.41952905 | 1.330583714 | 1.2403141 | 1.392228134 |
| MDH1 | 0.90180191 | 4.10117266 | 2.062786765 | 0.96030698 | 2.452905565 |
| MDH1B | 1.34026624 | 1.61954913 | 1.612033106 | 1.1902706 | 1.887568401 |
| ME1 | 1.04678692 | 1.27074362 | 1.077905869 | 1.01416569 | 1.180910481 |
| ME2 | 0.83295704 | 1.04928554 | 1.14737834 | 0.86785787 | 1.970615337 |
| ME3 | 1.03429583 | 1.64433227 | 1.287032156 | 1.16250782 | 1.602818393 |
| TIMM17A | 0.84847458 | 1.29447773 | 1.233436157 | 1.07170581 | 1.285289246 |
| ACACA | 2.1316077 | 0.68389196 | 1.493831595 | 1.14323882 | 0.664850354 |
| ACACB | 13.698405 | 3.96676505 | 0.940568587 | 6.01971039 | 3.109078338 |
| MCAT | 0.70762469 | 0.73312532 | 0.960717691 | 0.7097204 | 0.994035918 |
| FASN | 7.57489325 | 0.32474528 | 1.1970657 | 7.6804753 | 0.312414759 |
| SLC27A5 | 0.90261188 | 1.32461154 | 1.099955234 | 1.00518342 | 1.179700277 |
| CPT1A | 1.11669819 | 1.22131499 | 1.184868202 | 1.81314537 | 1.13924702 |
| CHKB /// | 0.66393589 | 6.24984751 | 0.602459916 | 0.91701332 | 3.391128793 |
| CPT1B | | | | | |
| CPT1C | 0.91205486 | 1.31210607 | 4.133965632 | 1.14801856 | 1.04599019 |
| CPT2 | 0.4589899 | 0.82894817 | 0.653259498 | 1.47795507 | 0.902362593 |
| CRAT | 0.87950752 | 1.27665992 | 0.926626056 | 1.27908156 | 1.480427209 |
| SLC25A20 | 1.25967776 | 1.69804966 | 0.722769333 | 2.92545915 | 1.552441506 |
| PGM1 | 1.50889449 | 1.55605804 | 0.756789395 | 2.32557106 | 6.979445143 |
| PGM2 | 0.31473949 | 0.18768941 | 0.146830611 | 0.26274169 | 0.089713552 |
| PGM3 | 1.02672642 | 0.60717728 | 0.888296157 | 1.32562523 | 0.732088982 |
| PGM5 | 2.70261525 | 5.46796455 | 0.789170326 | 0.78536435 | 2.673543122 |
| UGP2 | 2.02177676 | 1.67572385 | 0.872591966 | 7.74955674 | 1.481102232 |
| GYS1 | 0.7677727 | 1.85864905 | 0.510227118 | 0.35711444 | 3.61881815 |
| GYS2 | 0.34521581 | 0.31021146 | 0.336902141 | 12.6925241 | 0.239423604 |
| GSK3B | 0.99893733 | 1.25563813 | 1.688157439 | 0.79113461 | 0.755718925 |
| PYGB | 0.7693114 | 2.67558069 | 1.482664582 | 0.64857554 | 0.702108791 |
| PYGL | 0.97005144 | 0.27116888 | 0.352255353 | 1.15332519 | 0.318098178 |
| PYGM | 0.22233164 | 0.54215747 | 0.593855407 | 0.13133814 | 17.75196957 |
| SLC2A1 | 1.17692251 | 1.77109911 | 1.197124099 | 1.06068698 | 1.218815903 |
| SLC2A2 | 1.07595828 | 1.37251204 | 1.020931778 | 101.497058 | 1.074910959 |
| SLC2A3 | 4.8650999 | 2.6541687 | 1.674276471 | 1.35070582 | 1.350751217 |
| SLC2A4RG | 0.85935687 | 0.97352196 | 1.257651987 | 1.09356041 | 1.104923039 |
| SLC2A4 | 0.87975526 | 1.6078052 | 1.314190407 | 1.16697672 | 1.976873982 |
| SLC2A5 | 1.04328336 | 1.33939371 | 1.149022667 | 1.09079111 | 1.184348584 |
| SLC2A6 | 0.93781216 | 1.61628549 | 2.696267895 | 1.41114554 | 1.28853794 |
| SLC2A8 | 0.96728659 | 1.33891219 | 1.217350394 | 1.43487467 | 1.352142143 |
| SLC2A9 | 0.8637958 | 1.35208077 | 1.139609899 | 1.14120156 | 1.404907262 |
| SLC2A10 | 2.67232188 | 0.85505177 | 0.919121898 | 7.5605893 | 0.72025115 |
| SLC2A11 | 0.91545325 | 1.56961289 | 1.412800342 | 1.08791738 | 1.444271983 |
| SLC2A13 | 1.01689149 | 1.34249623 | 2.054143709 | 1.0203583 | 1.110883427 |
| SLC2A14 /// | 3.72697937 | 2.51968837 | 1.988922194 | 1.05405079 | 1.347868568 |
| SLC2A3 | | | | | |
| PC | 3.10288076 | 0.81504737 | 1.881305959 | 4.26255549 | 1.126638755 |
| PCK1 | 34.0028327 | 0.81070385 | 0.597480803 | 122.127137 | 0.738790362 |
| PCK2 | 1.60787725 | 0.43533876 | 0.493723686 | 11.180985 | 0.462673198 |
| ENO1 | 0.11787998 | 0.06708969 | 0.326413573 | 0.28124597 | 0.157354162 |
| ENO2 | 1.38248749 | 2.15632283 | 16.89788445 | 1.05621961 | 0.810327373 |
| ENO3 | 0.65539966 | 0.81578091 | 0.684368737 | 0.81544441 | 1.539725938 |
| PGAM1 | 0.52166683 | 0.37440778 | 0.879301904 | 0.43925188 | 0.156441123 |
| PGAM2 | 0.2053085 | 2.55470524 | 0.367639107 | 0.17575865 | 10.0070911 |
| PGK1 | 0.64158426 | 0.85834032 | 0.796646648 | 0.59650347 | 0.936295549 |
| PGK2 | 0.86018992 | 1.04937826 | 1.156936517 | 1.10257102 | 1.18994124 |
| GAPDH | 0.45719752 | 1.17971344 | 1.053967774 | 0.48906557 | 2.801542436 |
| GAPDHS | 0.81008709 | 1.37824999 | 0.960239795 | 0.81833907 | 1.373564982 |
| TPI1 | 0.59656744 | 0.92185445 | 0.920707058 | 0.60539421 | 2.159692065 |
| ALDOA | 0.657114 | 1.18485822 | 0.830552036 | 0.26541403 | 8.726630111 |
| ALDOB | 1.12603184 | 1.49563685 | 1.16383698 | 192.380769 | 1.1864474 |
| ALDOC | 1.38198265 | 4.9955966 | 15.73855968 | 1.7355614 | 0.696297863 |
| FBP1 | 1.49755187 | 1.2545261 | 0.888138521 | 38.9586072 | 0.957959049 |
| FBP2 | 0.64902032 | 0.97092005 | 1.068279687 | 0.71547595 | 13.3226056 |
| PFKFB1 | 1.10458153 | 1.28229157 | 1.312696505 | 1.07799284 | 1.293412235 |
| PFKFB2 | 0.89793794 | 1.23211162 | 1.106241232 | 0.95658878 | 1.236133659 |
| PFKFB3 | 6.10099456 | 0.42062824 | 1.347345998 | 0.39300561 | 2.528200361 |
| PFKFB4 | 0.93155019 | 1.19139418 | 1.077951829 | 0.97188358 | 1.091492765 |
| GPI /// | 1.07247166 | 1.39293405 | 1.165246137 | 0.72886055 | 1.465521933 |
| LOC100133951 | | | | | |
| G6PC | 0.8554139 | 1.20711239 | 0.975210166 | 71.6630352 | 1.064169884 |
| G6PC2 | 0.97075206 | 1.40186993 | 1.104036259 | 1.03383086 | 1.292230053 |
| G6PC3 | 1.15612184 | 1.16529177 | 1.378026257 | 0.87020001 | 1.25369721 |
| HK1 | 0.35477788 | 0.64571489 | 0.990401621 | 0.11704626 | 0.724139735 |
| HK2 | 0.96633993 | 1.08475996 | 1.119532082 | 1.0289183 | 1.047126134 |
| HK3 | 1.12994098 | 1.35829659 | 1.003259086 | 1.5412548 | 1.271398227 |
| HKDC1 | 0.83185875 | 1.21299103 | 0.941164742 | 0.93528384 | 1.435030006 |
| PFKL | 0.68394174 | 0.60850857 | 0.929079416 | 0.8466797 | 0.546970963 |
| PFKM | 0.70287315 | 5.50105611 | 1.713594044 | 0.22128466 | 8.865785963 |
| PFKP | 0.38397755 | 0.86184159 | 1.494879555 | 0.13515583 | 0.246044466 |
| PKLR | 1.02986307 | 1.09058271 | 1.070096669 | 2.50372812 | 1.621873 |
| PKM2 | 0.37140411 | 1.05066706 | 1.054056242 | 0.1005685 | 2.571813491 |
| RABGGTA | 0.39190176 | 0.34406357 | 0.418204933 | 0.35277624 | 0.41916801 |
| RABGGTB | 1.26604093 | 0.87050453 | 0.781820198 | 1.26959127 | 1.26028996 |
| FNTA | 1.14250365 | 1.33464761 | 1.391748247 | 1.38407745 | 0.934843588 |
| FNTB | 0.64150964 | 0.67007294 | 0.815370877 | 0.66179559 | 0.918231114 |
| PGGT1B | 1.11232188 | 1.29362786 | 1.086324665 | 0.99076781 | 1.165264172 |
| PDSS1 | 0.63688053 | 0.71979902 | 0.725277783 | 0.76800436 | 0.942632001 |
| PDSS2 | 1.07127831 | 1.0942339 | 0.869910152 | 1.28555084 | 1.207934981 |
| COQ2 | 0.68470534 | 1.020342 | 0.489247438 | 0.70723845 | 1.588860886 |
| COQ3 | 0.99159977 | 1.69041054 | 1.078386296 | 1.11218693 | 1.947186966 |
| COQ7 | 1.0267437 | 1.36504852 | 1.185806698 | 1.01392333 | 1.879846826 |
| DHDDS | 0.89340926 | 0.99629138 | 0.922033177 | 0.9541571 | 0.961665736 |
| DOLPP1 | 0.7678957 | 1.02784251 | 1.08815203 | 1.14102353 | 0.771129184 |
| DOLK | 0.84941535 | 0.92664809 | 0.941676961 | 0.87777119 | 0.798221489 |
| HMGCL | 0.87557661 | 1.06155279 | 0.631539767 | 2.96736152 | 1.295074323 |
| HMGCS2 | 1.28184184 | 1.85885788 | 1.238292248 | 13.3401894 | 1.695629715 |
| BDH1 | 0.48513378 | 0.88831753 | 0.596943965 | 2.51643551 | 0.682681282 |
| BDH2 | 1.66811454 | 1.04262541 | 0.934214697 | 2.49458665 | 0.676248803 |
| OXCT1 | 1.04606791 | 1.14637789 | 1.05228821 | 0.94195922 | 1.062164339 |
| OXCT2 | 0.88453068 | 1.30056354 | 1.397360079 | 1.13050106 | 1.414987344 |
| HIBCH | 0.78989668 | 0.31187336 | 0.429950334 | 1.69519399 | 0.552098751 |
| SLC16A7 | 7.26483208 | 6.56400097 | 1.023652836 | 1.01624049 | 1.654330572 |
| SLC16A1 | 2.43118514 | 4.35091057 | 2.614769359 | 3.00920979 | 4.191063554 |
| SLC16A3 | 0.5682966 | 0.90061103 | 0.895838749 | 0.99608612 | 1.152315423 |
| SLC16A4 | 1.80053889 | 1.13455948 | 1.053570895 | 2.08764329 | 0.908464339 |
| SLC16A8 | 1.06866568 | 1.31697526 | 1.212450933 | 1.06703977 | 1.15674985 |
| SLC5A8 | 0.82585118 | 1.17755358 | 1.147293218 | 1.03816841 | 1.377279551 |
| LDHA | 1.20450131 | 0.34687399 | 0.479707079 | 0.9496796 | 2.404636487 |
| LDHB | 2.74268424 | 6.09628711 | 3.261125754 | 0.20963798 | 1.156520496 |
| NDUFA4 | 1.08058497 | 2.75980863 | 1.871084268 | 0.85746875 | 2.811093065 |
| NDUFA5 | 0.8497723 | 2.20373785 | 1.304779968 | 1.31583389 | 1.136045465 |
| NDUFA6 | 1.00187421 | 1.59210215 | 1.089180487 | 0.89616081 | 1.497969629 |
| NDUFA7 | 0.6782262 | 1.04173499 | 0.608264803 | 0.72153892 | 1.221841523 |
| NDUFA8 | 0.86654439 | 1.92661094 | 1.165682396 | 0.67862813 | 2.161641952 |
| NDUFA9 | 0.87793292 | 1.92696634 | 0.791406326 | 0.90820839 | 1.889329242 |
| NDUFA10 | 1.02513595 | 1.2687304 | 1.212571546 | 1.02220106 | 1.169600425 |
| NDUFA11 | 0.92583175 | 1.41784836 | 1.050955431 | 1.15589134 | 1.170204356 |
| NDUFAB1 | 0.81551266 | 2.24345644 | 0.85567575 | 0.7789762 | 1.833444491 |
| NDUFAF1 | 0.7106298 | 0.95010927 | 1.073767497 | 1.02607838 | 1.671768689 |
| NDUFB1 | 1.30538725 | 2.9929239 | 1.015921254 | 1.23884091 | 2.091280526 |
| NDUFB2 | 1.06364515 | 1.39676223 | 1.134953338 | 1.17488062 | 1.82285507 |
| NDUFB5 | 1.42864099 | 1.68939995 | 0.79874207 | 1.04908113 | 2.15403067 |
| NDUFB6 | 1.17377325 | 1.63646845 | 1.520436791 | 1.59141219 | 1.359510264 |
| NDUFB7 | 0.82907323 | 1.46609313 | 0.775587833 | 0.66191933 | 2.081998079 |
| NDUFB8 | 1.13331221 | 2.35097045 | 1.154361071 | 1.54208269 | 1.422400824 |
| NDUFB9 | 0.86901599 | 2.02407787 | 1.121298992 | 0.91550391 | 2.554697068 |
| NDUFB10 | 0.99007075 | 2.83979165 | 1.202027191 | 0.98282237 | 3.164436176 |
| NDUFC1 | 0.62500174 | 1.58897671 | 0.784785539 | 0.72892574 | 2.456726128 |
| NDUFC2 | 1.25133982 | 1.25057282 | 1.99866235 | 1.34886794 | 1.765443837 |
| NDUFS1 | 2.26709616 | 6.02868637 | 2.994751333 | 4.56797927 | 6.561396455 |
| NDUFS2 | 0.96994696 | 1.91171266 | 1.111001992 | 1.29371379 | 1.908552476 |
| NDUFS4 | 1.06543014 | 1.06890963 | 0.837188236 | 0.74525831 | 2.183219102 |
| NDUFS6 | 0.59582071 | 1.38797623 | 0.687823481 | 0.57744018 | 1.276326966 |
| NDUFS7 | 0.936719 | 1.23174356 | 1.156859325 | 1.1474965 | 1.437395257 |
| NDUFS8 | 0.8248013 | 1.61343474 | 1.655260636 | 1.32392551 | 0.811339051 |
| NDUFV1 | 0.90101063 | 1.8367652 | 1.186010645 | 1.01829896 | 2.175548665 |
| NDUFV2 | 0.57280518 | 1.32728892 | 0.514200544 | 1.17274783 | 2.165262026 |
| NDUFV3 | 0.79815237 | 3.16073487 | 0.993135026 | 0.89244126 | 3.002139957 |
| SDHB | 0.74056055 | 1.38756949 | 0.576096987 | 1.32284604 | 2.3663964 |
| SDHA | 0.95527008 | 3.18260473 | 0.974067431 | 1.54564115 | 2.178942128 |
| SDHC | 1.24743537 | 1.67415527 | 1.81376019 | 2.20774211 | 2.453300686 |
| SDHD | 1.35777203 | 1.01082231 | 0.483813291 | 2.66397378 | 2.803481316 |
| CYBRD1 | 3.4475285 | 1.33682967 | 0.449089687 | 0.31560475 | 0.464051525 |
| CYCS | 2.04843906 | 3.46840701 | 2.864976993 | 2.09080249 | 2.061585257 |
| UQCR | 1.06632133 | 2.46148257 | 1.010757933 | 1.0095926 | 2.284024751 |
| UQCRB | 0.97920212 | 1.58707354 | 2.144842536 | 1.29650017 | 1.788641684 |
| UQCRC1 | 0.63221736 | 2.41829039 | 0.741089636 | 0.70499029 | 2.574791777 |
| UQCRC2 | 1.48117053 | 2.93281317 | 1.94455577 | 1.82614893 | 2.18733313 |
| UQCRFS1 | 0.7591443 | 1.25456406 | 0.722770488 | 0.70522641 | 2.49390303 |
| UQCRH | 1.06671785 | 1.52933759 | 0.869346849 | 0.49940891 | 1.410074507 |
| COX11 | 1.37615542 | 1.59273958 | 1.857461721 | 1.38455694 | 1.429776679 |
| COX4I1 | 1.17907595 | 2.43020685 | 1.192561008 | 0.73048782 | 1.526510628 |
| COX5A | 0.65492489 | 2.5426142 | 0.716019764 | 0.65507526 | 2.414946381 |
| COX5B | 0.92034683 | 2.23983577 | 0.939063455 | 0.77266618 | 2.20179893 |
| COX6A1 | 1.08480753 | 0.33021937 | 1.505108724 | 0.94028781 | 0.112193518 |
| COX6C | 1.01312138 | 1.90622886 | 1.192713142 | 0.91609904 | 2.146429546 |
| COX7A2 | 1.21085024 | 1.54542927 | 1.212059634 | 0.97191423 | 0.938767402 |
| COX7A2L | 1.51063958 | 1.29677571 | 1.515576323 | 1.42111895 | 1.069651742 |
| COX7B | 0.80709245 | 2.44819732 | 0.627224241 | 0.90029256 | 2.247435633 |
| COX7C | 1.22442441 | 1.75742143 | 0.943765593 | 0.84119726 | 1.99537939 |
| COX8A | 0.64480809 | 0.84075998 | 0.600739756 | 0.42765476 | 1.354295844 |
| CYC1 | 0.58642357 | 1.58276669 | 0.596872858 | 0.67170809 | 2.101553143 |
| OXA1L | 0.98139418 | 1.5270052 | 0.690078899 | 1.12298604 | 1.795009283 |
| ATP5A1 | 0.6922734 | 1.80965396 | 0.733045865 | 0.66956637 | 1.796025286 |
| ATP5B | 0.86112168 | 2.11616078 | 0.856970746 | 0.7153371 | 2.185495573 |
| ATP5C1 | 0.87771871 | 2.37759253 | 0.819746119 | 1.15922961 | 2.010834006 |
| ATP5E | 1.22667293 | 1.5745573 | 1.028168242 | 0.82200545 | 1.193799474 |
| ATP5F1 | 0.7410323 | 1.27431779 | 0.730361968 | 0.81803854 | 1.528757015 |
| ATP5G1 | 0.49743099 | 2.1482065 | 1.050149603 | 0.7273239 | 1.919227845 |
| ATP5G3 | 0.95004967 | 2.22452222 | 0.671624461 | 0.92263871 | 1.832272947 |
| ATP5I | 0.75997372 | 2.18757288 | 1.042130567 | 0.70248804 | 1.203992878 |
| ATP5J | 1.03406237 | 2.44744384 | 0.892836336 | 1.31537934 | 2.459002892 |
| ATP5J2 | 0.64008387 | 0.9352429 | 0.747932031 | 0.61342487 | 1.158736498 |
| ATP5L | 1.25749417 | 1.45632756 | 1.307160946 | 1.20258224 | 1.942031675 |
| ATP5O | 0.88993577 | 2.36873446 | 0.863307326 | 0.69932866 | 2.116635155 |
| ATPAF1 | 1.12780376 | 2.01910896 | 3.169369474 | 1.4352699 | 2.540009098 |
| ATPAF2 | 1.11767689 | 1.71370366 | 1.379492697 | 1.12861143 | 1.611106382 |
| G6PD | 0.58718029 | 0.29437217 | 0.522477199 | 0.25175222 | 0.320218711 |
| H6PD | 0.95573744 | 1.19876402 | 1.174346418 | 1.10229453 | 0.985284462 |
| PGLS | 0.9280156 | 1.22724887 | 1.156302646 | 1.18282687 | 0.813391507 |
| PGD | 0.18295735 | 0.07175618 | 0.113015143 | 0.14187387 | 0.089502666 |
| RPE | 1.10259057 | 0.91581063 | 1.081995237 | 0.87545397 | 0.707113172 |
| RPIA | 1.38942969 | 1.27865262 | 0.66827056 | 0.68324456 | 1.496483565 |
| TKT | 0.8893507 | 0.11807372 | 0.42682827 | 0.26279039 | 0.078806298 |
| TKTL1 | 0.99739233 | 1.68182996 | 1.334738141 | 1.0941496 | 1.498482784 |
| LOC100133665 | 0.47745907 | 0.1828865 | 0.373246525 | 0.31421218 | 0.205413177 |
| /// TALDO1 | | | | | |
| LHCGR | 2.02926073 | 1.65575807 | 1.253828351 | 1.07305129 | 1.240411578 |
| FSHR | 1.10005715 | 1.64492784 | 1.187899064 | 1.09877941 | 1.552544482 |
| BZRAP1 | 0.9196326 | 1.41312322 | 3.244309716 | 1.23677045 | 1.177161305 |
| STAR | 0.74120792 | 1.02892998 | 1.042357954 | 0.84662239 | 0.877584771 |
| CYP11A1 | 0.89982526 | 0.94772073 | 0.912453274 | 0.96624652 | 0.83281639 |
| CYP17A1 | 0.96852362 | 1.39331657 | 1.60732134 | 1.1572257 | 1.257873613 |
| HSD3B2 | 1.17173503 | 1.85469808 | 1.287354061 | 1.25228846 | 1.595733556 |
| HSD17B12 | 0.95257659 | 1.35540996 | 1.027933688 | 1.04664292 | 1.408097389 |
| HSD17B1 | 0.60879021 | 0.76777294 | 0.713506409 | 0.61934692 | 0.725401358 |
| HSD17B2 | 1.42666289 | 1.32064393 | 1.187273807 | 26.0926082 | 1.524332006 |
| HSD17B3 | 1.2956623 | 1.50710076 | 1.758264556 | 2.09494793 | 1.416412355 |
| CYP19A1 | 1.11888226 | 1.24458304 | 1.244791023 | 1.07220747 | 1.275756662 |
| SRD5A1 | 0.16770921 | 0.14204424 | 0.677535048 | 2.12248215 | 0.146395602 |
| SRD5A2 | 0.92930028 | 1.59208304 | 1.305159619 | 4.22706015 | 1.358424564 |
| AKR1C1 | 1.10286109 | 0.2775561 | 0.230393853 | 2.0481872 | 0.597323943 |
| AKR1C2 | 1.07231278 | 1.33102458 | 0.965164895 | 0.9610461 | 1.377884078 |
| CYP11B1 | 0.96630463 | 1.16259482 | 1.106410286 | 1.09645389 | 1.293022769 |
| CYP11B2 | 0.70113568 | 1.54196599 | 1.254169307 | 1.16037999 | 1.369791781 |
| CYP21A2 | 0.87167615 | 1.16420756 | 1.040427967 | 3.0611919 | 1.354770831 |
| PDHA1 | 1.95912169 | 2.83186742 | 1.614289383 | 1.62474193 | 1.023495744 |
| PDHA2 | 1.04639875 | 1.51647895 | 0.908701209 | 0.90528398 | 1.64477613 |
| PDHB | 0.72775267 | 1.03776236 | 0.710290488 | 0.88221406 | 1.68395311 |
| PDHX | 1.65815216 | 2.57908908 | 1.479442099 | 1.56571387 | 4.097893462 |
| DLAT | 0.94217416 | 1.84878064 | 0.94791439 | 0.93865857 | 3.079397859 |
| DLD | 1.12715602 | 1.67230742 | 1.719040781 | 1.3946467 | 2.848944103 |
| CS | 1.53899198 | 1.85300588 | 0.775072129 | 0.57448553 | 2.002215335 |
| ACO1 | 3.84561297 | 1.72365547 | 0.92094911 | 5.28569085 | 1.042943002 |
| ACO2 | 1.03186876 | 1.45913665 | 1.19202625 | 0.9673123 | 2.051029522 |
| IDH1 | 2.26293696 | 0.46248618 | 0.447779829 | 3.56049599 | 0.418430679 |
| IDH2 | 0.36679763 | 1.75846219 | 0.958735417 | 0.7297543 | 2.200537793 |
| IDH3A | 0.83192885 | 1.40473011 | 1.039762585 | 0.52609699 | 1.858180915 |
| IDH3B | 0.95797604 | 0.86437513 | 1.026214309 | 0.8369894 | 0.741112777 |
| IDH3G | 0.67920363 | 0.88670095 | 1.258572504 | 0.4897573 | 0.984016242 |
| DHTKD1 | 1.20496946 | 1.53908252 | 0.9297508 | 8.34963849 | 1.213815254 |
| DLST /// DLSTP | 0.97946492 | 1.61539963 | 0.720611055 | 1.09367692 | 1.503646136 |
| OGDH | 0.62797085 | 3.07118923 | 0.619381243 | 0.66920642 | 1.79313307 |
| OGDHL | 1.04515404 | 1.38179879 | 4.559457062 | 10.857106 | 1.112002204 |
| SUCLA2 | 1.45539265 | 1.41341424 | 1.167382868 | 0.7279708 | 3.47593651 |
| SUCLG1 | 1.03688638 | 1.82825788 | 0.75126201 | 1.06747391 | 1.199978462 |
| SUCLG2 | 1.88548713 | 1.39582383 | 0.460896647 | 4.88960674 | 2.352579497 |
| NME7 | 0.15399795 | 0.74375325 | 3.42848761 | 0.60467158 | 1.525737871 |
| FH | 0.73089482 | 1.27537089 | 0.666581333 | 1.75745121 | 1.47766346 |
| MDH2 | 0.80296772 | 1.94067112 | 1.562508464 | 1.68347766 | 3.412114437 |
| VLDLR | 1.20221779 | 1.71327278 | 0.668282639 | 0.24764928 | 1.275200477 |
| SEC14L2 | 1.05882012 | 1.54619506 | 1.421561599 | 2.82869578 | 1.410382105 |
| LDLR | 0.65923863 | 0.25880451 | 0.255254809 | 0.57475916 | 0.165442835 |
| NMT1 | 0.88272272 | 0.61405979 | 0.656316222 | 0.88771236 | 0.818459915 |
| NMT2 | 1.91695514 | 1.95774582 | 1.997434113 | 2.91620142 | 1.473815293 |
| SREBF1 | 0.98436429 | 0.99263127 | 0.939067428 | 1.47809469 | 0.876635966 |
| SREBF2 | 0.66402282 | 0.77052082 | 1.352544163 | 0.85061287 | 0.629418727 |
| FABP1 | 1.10437018 | 1.51351603 | 1.137634995 | 5.56194912 | 1.282890795 |
| FABP2 | 0.81935319 | 1.54575288 | 1.250918925 | 1.12809854 | 1.152892957 |
| FABP3 | 0.53533453 | 20.4728512 | 1.768458183 | 0.64100574 | 5.652358794 |
| FABP4 | 18.3986819 | 2.4765471 | 0.089114842 | 0.17863299 | 0.466571727 |
| FABP6 | 1.10978175 | 1.50615511 | 1.221516335 | 1.12611197 | 1.293562719 |
| FABP7 | 1.24126933 | 1.94026348 | 1.40634293 | 1.39426983 | 1.354374038 |
| MUT | 0.91571458 | 0.88785245 | 0.467470765 | 4.02777843 | 0.53840277 |
| GLP1R | 1.15220128 | 1.44435486 | 1.38491324 | 1.2940422 | 1.414027785 |
| GCG | 1.23431531 | 1.5042416 | 1.262265452 | 1.18649262 | 1.364318134 |
| GCGR | 0.92864652 | 0.98117487 | 1.026488719 | 3.01775238 | 1.140274015 |
| GIPR | 0.85535216 | 1.59680894 | 1.153490421 | 1.01577191 | 1.507938294 |
| GIP | 0.97106166 | 1.27291659 | 1.090030739 | 1.16068739 | 1.573569311 |
| CCK | 1.02158357 | 1.34317172 | 9.462714248 | 1.18292642 | 1.587182285 |
| SCT | 0.70548663 | 1.2048569 | 0.926395668 | 0.91748696 | 1.134285608 |
| GHRL | 1.11102724 | 1.55394167 | 1.549433075 | 1.18585084 | 1.36356468 |
| GFPT2 | 4.39189784 | 1.6376273 | 1.341434655 | 0.88261037 | 1.173719567 |
| GFPT1 | 1.8391497 | 0.59444613 | 0.535372699 | 1.15312541 | 0.467370811 |
| ABCD2 | 1.66698723 | 1.50484913 | 1.593266558 | 1.01563599 | 1.320595705 |
| ACAD8 | 1.32049333 | 1.62433764 | 1.267233798 | 2.01361479 | 1.656257291 |
| DECR2 | 1.2246782 | 1.35135479 | 1.177780232 | 3.61831583 | 1.658885484 |
| AMACR | 0.90785182 | 1.06816409 | 1.128016768 | 2.41243477 | 1.022427803 |
| CROT | 0.58745452 | 0.73202007 | 0.64156802 | 1.20554642 | 0.636060366 |
| ACOX1 | 1.01228385 | 1.30836047 | 1.097844037 | 0.99612335 | 1.384977036 |
| ACSL3 | 1.38288679 | 1.67233334 | 2.774485017 | 1.26509018 | 1.873095756 |
| ACSL4 | 3.09518683 | 1.77313099 | 2.282442849 | 0.69249356 | 0.927224413 |
| HSD17B10 | 0.52912983 | 0.49185074 | 0.438211502 | 0.99152643 | 0.42947 |
| ACSL5 | 2.16885274 | 1.52729956 | 1.1785095 | 5.9465184 | 0.924945512 |
| SLC27A2 | 1.87254546 | 0.90388901 | 1.106300772 | 23.8227595 | 0.871511787 |
| ACADSB | 0.89353869 | 0.82629961 | 0.810378327 | 12.9451322 | 1.074528513 |
| ACOX2 | 1.54819097 | 1.78768927 | 0.748182947 | 9.53036763 | 1.443812682 |
| ACOX3 | 0.58750875 | 0.56053181 | 0.503996407 | 0.67852826 | 0.631484881 |
| PHYH | 1.76688094 | 3.84159433 | 0.687705571 | 8.78886115 | 6.858194481 |
| PHYHIP | 1.01392644 | 0.96781783 | 9.651237634 | 0.86484052 | 0.96114712 |
| HACL1 | 0.97634412 | 0.73821443 | 0.752460296 | 1.95036318 | 1.139613123 |

### Human Metabolic Transcriptomic Computational Model

### Validation I:

Inhibition of Cholesterol Synthesis by Mouse Liver after 24 Hrs Food Restriction (Starvation):

Table 18 depicts the liver gene expression as fold change after 24 hours of complete food restriction, qualified as starvation.

TABLE 18

| | | | 24 h |
|---|---|---|---|
| # | enzyme gene | symbol | starved |
| cholesterol metabolism | | | |
| 1 | isopentenyl-diphosphate delta isomerase | Idi1 | −7.92 |
| 2 | farnesyl diphosphate synthetase | Fdps | −2.69 |
| 3 | squalene epoxidase | Sqle | −4.29 |
| 4 | sterol-C5-desaturase, lathosterol oxidase | Sc5d | −3.00 |
| hydroxy-methylglutaryl-CoA synthases | | | |
| 10 | 3-hydroxy-3-methylglutaryl-Coenzyme | Hmgcs1 | −3.56 |
| | A synthase 1 (cytoplasmic) [cholesterol] | | |
| 11 | 3-hydroxy-3-methylglutaryl-Coenzyme | Hmgcs2 | +2.59 |
| | A synthase 2 (mitochondrial) | | |
| | [ketone metabolism] | | |
| up regulated - Fatty acid beta oxidation | | | |
| 9 | enoyl Coenzyme A hydratase 1, peroxisomal | Ech1 | +2.17 |
| 10 | acetyl-Coenzyme A acyltransferase 1, | Acaa1 | +2.53 |
| | peroxisomal 3-ketoacyl-CoA thiolase(Ptl) | | |
| 11 | acetyl-Coenzyme A dehydrogenase, longchain | Acadl | +1.89 |
| down regulated - Fatty acid synthesis | | | |
| 25 | fatty acid synthase | Fasn | −2.07 |

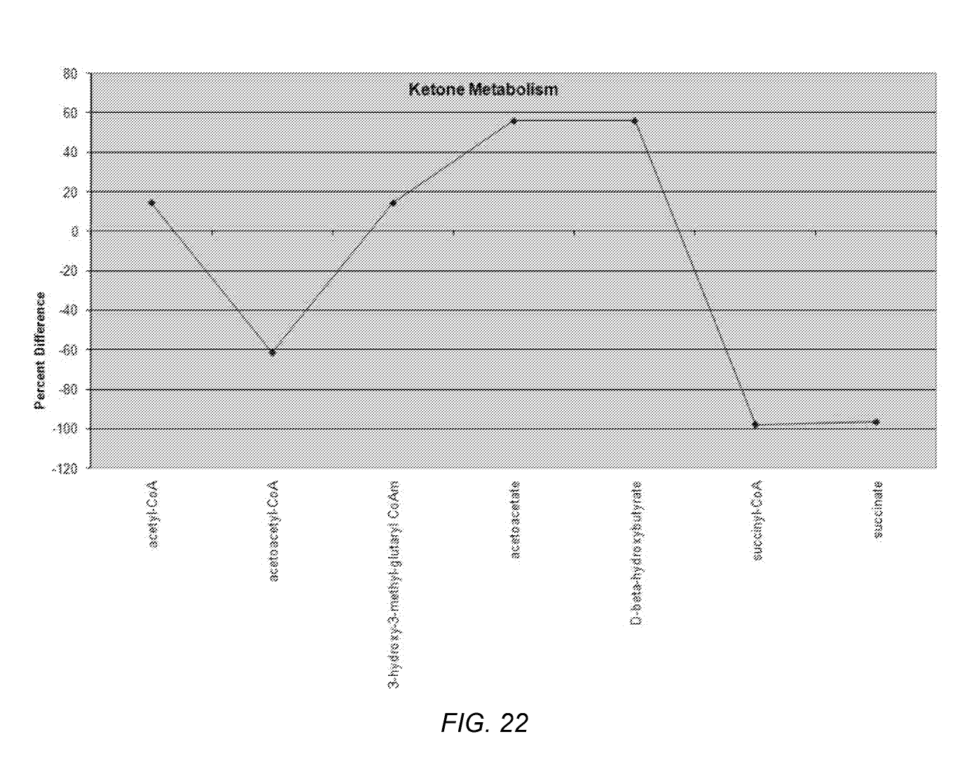

FIG. 22 depicts how the biosimulation model predicts that the levels of ketone bodies increase dramatically with starvation.

### Validation II:

Transcript level as a reliable index of protein level and parallel with enzyme activity: Paradoxical decrease mRNA and protein mass, but increased enzyme activity?

Model Results Test a reduction in KCC for protein prenyltransferase enzyme, RABGGT.

| Enzyme Reaction | Precursor accumulation | Representation |
|---|---|---|
| Flux | [S]* | of product |
| RABGGT | geranyl-geranyl-pyrophosphate | geranyl-geranyl-Rab |
| 72.37 | 29.50 | 1.95 |

a 35% reduction in mRNA leads to nearly two times (172%) the amount of enzyme activity. *Remember the classic formula for enzyme reactions:

[S]+[E]=[SE]=[P]+[E]

also, classic biochemistry is that when you inhibit an enzyme (or decrease concentration) the precursor accumulates.

Why does the model behave more like a ‘living organism’ than the classical ‘biochemical assay methods’?
in vitro the ‘substrate’ concentration is held constant or at saturating levels.
in vivo the substrate precursor concentration increases unless there are alternative pathways for its removal or robust ‘chain reaction’ inhibition of the prior enzyme(s).

### Integrated Organ Systems Metabolomics Transcriptomics Computational Model

The goal is to penetrate the global market for advances in technologies to treat Obesity and Diabetes mellitus, i.e., advance the biomedical knowledge and technology for these human diseases. Current predictions on market penetration are based on technological advances that make the process less cumbersome at competitive prices but the challenges remain to develop the software that integrates glucose levels with insulin secretion. The current algorithms take into account only those two parameters and are not based upon the responses of the tissues affected by insulin insensitivity in Obesity and resistivity in Diabetes mellitus. The Biosimulation Method has this unique capability of simulating the key organ systems for glucose homeostasis, including an “artificial pancreas” with the complete glucose sensing and trigger systems for appropriate insulin secretion rate. Additionally, because the Method uses an individual's gene expression profile to determine the parameters in the Biosimulation Model, the insulin delivery system can be programmed to meet the needs of the individual patient by taking into account how his/her own liver, skeletal muscle, and adipose tissue will respond to the insulin immediately and over time as the glucose homeostasis is normalized and target tissues recover; thereby, reducing risk of insulin overdose as the treatment is efficacious. The Method is revolutionizing the health care system to take Personalized Medicine to the next level of “Individualized Personalized Medicine”. An added market impact for treatment of Obesity and Diabetes mellitus through diet is the provision of Individualized Nutrigenomics. Various meals as part of therapeutic diets can be included and actually simulate the responses of the individual for whom the diet is being designed—the unique technology has such predictive capabilities. Model:

Multi-organ system computational model for insulin control of glucose homeostasis: transcriptome to metabolome in silico testing

Organism=human

Cells=intestinal cells, pancreatic beta cells, liver cells, skeletal muscle cells

Organs=stomach, small intestine, pancreas, liver, skeletal muscle

### Pathways:

Insulin and mTor Signaling Pathways from Reactome® were used for liver and skeletal muscle in a multiorgan system model designed to include organ systems (above). Insulin signaling coupled to insertion of the glucose transport protein-4 into the skeletal muscle membrane and pathways for glucose sensing coupled to insulin synthesis and secretion for the pancreas were developed my manual curation using published descriptions.

This is a multi-organ system kinetic model for which the parameters are determined directly from genome-wide gene expression profiles of species-specific tissues or cells, e.g., liver, skeletal muscle, and pancreatic p-cells. This model includes insulin and mTOR signaling as well as many other pathways for these organs, e.g., insertion of glucose transport protein -4 into the skeletal muscle membrane, and has 34 compartments, 400 species, 180 reactions, and 375 parameters all determined from tissue/cell specific microarray data sets from NCBI GEO GSE3503, and laser-dissected pancreas (GSE20966); 210 genes are represented in this model.

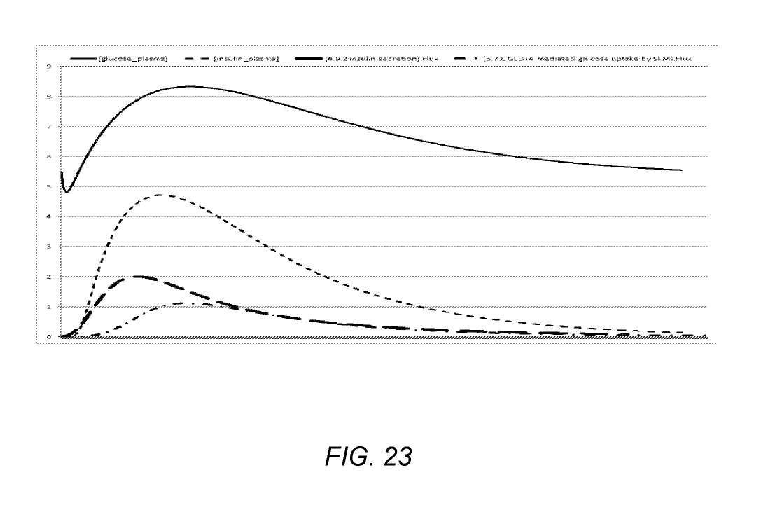

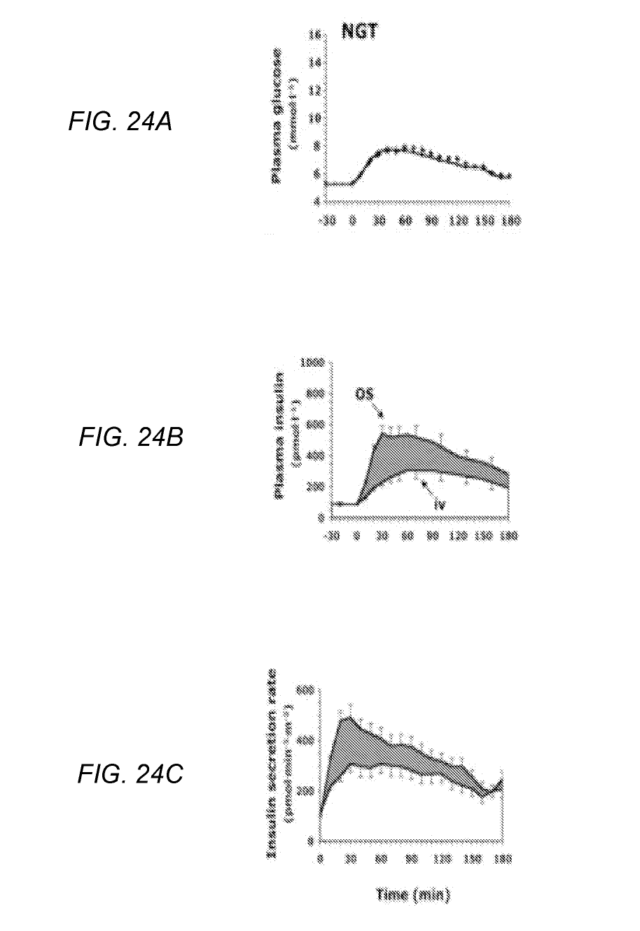

FIG. 23 depicts results of Time Course Biosimulation for Multi-organ System Model, after a challenge with a glucose solution as used in human glucose tolerance tests, using microarray datasets from normal human liver and skeletal muscle from NCBI GEO GSE3503, and laser-dissected pancreatic β-cells (GSE20966). Note validation by published in vivo results from human subjects in (FIG. 24).

FIG. 24A depicts time-course of plasma glucose; FIG. 24B depicts time-course of insulin concentrations; and FIG. 24C depicts time-course of insulin secretion rates, as reconstructed from C-peptide deconvolution, in nondiabetic patients (NGT), following oral glucose (continuous line) and isoglycemic intravenous glucose administration (dashed line). The stippled areas visualize the incretin effect. Data are means±SE. Source: Muscelli E. Diabetes 57:1340-1348, 2008. Note how plasma glucose rises from basal ˜5 mM to ˜8 mM and the model simulation in FIG. 23 matches this ‘exactly’. Also the profiles for plasma insulin and insulin secretion rate (check zero time misalignment with FIG. 24A and FIG. 24B) match the simulation in FIG. 23 where arbitrary units are used and values were multiplied to larger values in order to use y-axis scale of plasma glucose and be seen.

### Example I-5

### Effect of Omega Fatty Acid Supplements on Neotal Baboon Brain: Cholesterol Metabolism

A model of on neotal baboon brain: cholesterol metabolism was created using Kothapalli et al., PLoS One April 2007: Some data from this reference is listed in Table 19

TABLE 19

| Gene Symbol | L | L3 |
|---|---|---|
| ACAD10 | −1.08 | +1.10 |
| DHCR24 | −1.18 | +1.17 |
| FDFT1 | +1.01 | −1.13 |
| FNTB | +1.113 | +1.244 |

[Formula to change k1 value in computational model: k1ᵢₙᵢₜᵢₐₗ×fold change=k1_{diet}(k1 value increased or decreased by the value of the decimal)].
Table 20 shows the results of biosimulation on brain model to test effects of fold changes in select genes. 0.33% DHA diet versus 1% diet:

TABLE 20

| | | Expected | | Concen- |
|---|---|---|---|---|
| Ratios | | Values | Metabolites | tration |
| | 1% DHA Diet | | | |
| squalene/cholesterol | 0.0073224835 | 0.00029 | squalene | 0.1303900000 |
| lanosterol/cholesterol | 0.0004302884 | 0.000098 | lanosterol | 0.0076620600 |
| lathosterol/cholesterol | 0.0001156188 | 0.00037 | lathosterol | 0.0020588000 |
| desmosterol/cholesterol | 0.0000000008 | | desmosterol | 0.0000000136 |
| 7DHC/choelsterol | 0.0126250084 | 0.0027 | 7-dehydro- | 0.2248110000 |
| | | | cholesterol | |
| | | | cholesterol | 17.80 |
| | 0.33% DHA Diet | | | |
| squalene/cholesterol | 0.0073225066 | 0.00029 | squalene | 0.1448260000 |
| lanosterol/cholesterol | 0.0004329600 | 0.000098 | lanosterol | 0.0085631700 |
| lathosterol/cholesterol | 0.0001156187 | 0.00037 | lathosterol | 0.0022867300 |
| desmosterol/cholesterol | 0.0000000074 | | desmosterol | 0.0000001462 |
| 7DHC/choelsterol | 0.0126250114 | 0.0027 | 7-dehydro- | 0.2497000000 |
| | | | cholesterol | |
| | | | cholesterol | 19.77 |

| | | PERCENT CHANGE | |
|---|---|---|---|
| | PERCENT | CONCENTRATIONS | |
| L versus L3 | CHANGE | | Concen- |
| Ratios | RATIOS | Metabolites | tration |
| squalene/cholesterol | 0.0003148189 | squalene | 11.07 |
| lanosterol/cholesterol | 0.6208852890 | lanosterol | 11.76 |
| lathosterol/cholesterol | −0.0000353542 | lathosterol | 11.07 |
| desmosterol/cholesterol | 870.86 | desmosterol | 978.34 |
| 7DHC/choelsterol | 0.0000233854 | 7-dehydro- | 11.07 |
| | | cholesterol | |
| | | cholesterol | 11.07 |

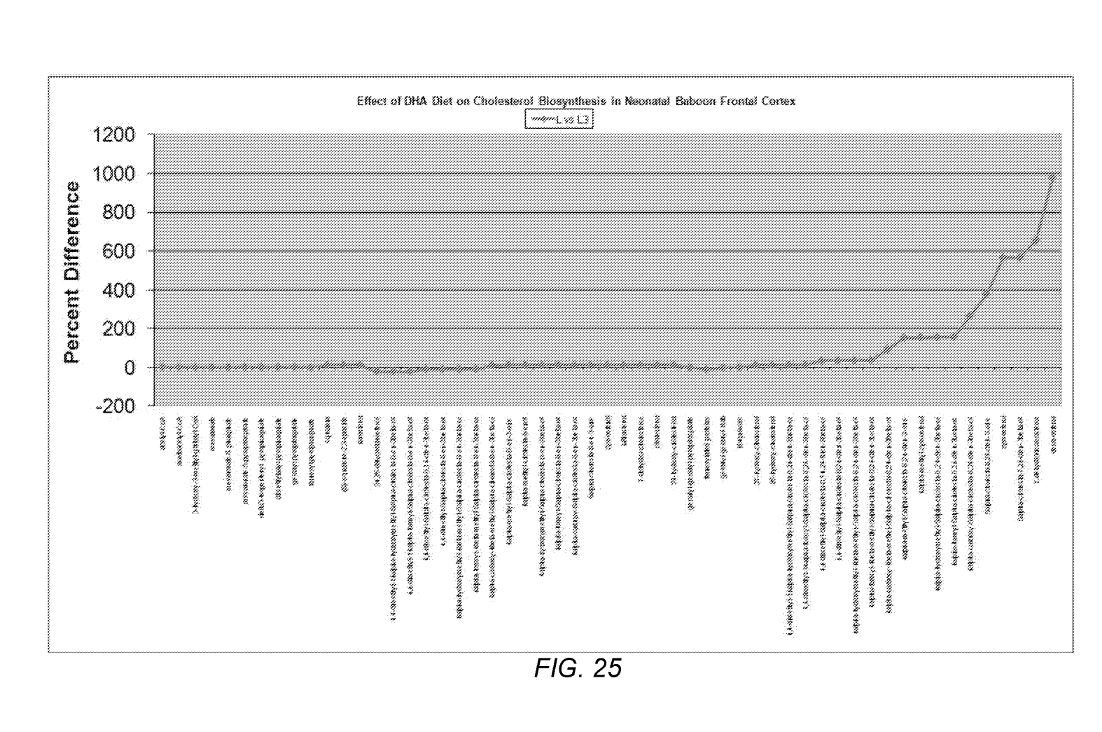

FIG. 25 shows a dramatic increase in metabolites in the later part of the cholesterol pathway. Table 21 shows the effects if a neutral control diet is assumed.

TABLE 21

| | | PERCENT CHANGE | |
|---|---|---|---|
| | PERCENT | CONCENTRATIONS | |
| | CHANGE | | Concen- |
| Ratios | RATIOS | Metabolites | tration |
| L: LCPUFA | | | |
| (0.33% DHA) | | | |
| squalene/cholesterol | 0.0003208401 | squalene | −3.07 |
| lanosterol/cholesterol | 0.3193406749 | lanosterol | −2.76 |
| lathosterol/cholesterol | 0.0000580807 | lathosterol | −3.07 |
| desmosterol/cholesterol | 249.73 | desmosterol | 238.99 |
| 7DHC/choelsterol | −0.0001476499 | 7-dehydro- | −3.07 |
| | | cholesterol | |
| | | cholesterol | −3.07 |
| L3: LCPUFA | | | |
| (1% DHA) | | | |
| squalene/cholesterol | 0.0000060212 | squalene | −12.73 |
| lanosterol/cholesterol | −0.2996839207 | lanosterol | −12.99 |
| lathosterol/cholesterol | 0.0000934349 | lathosterol | −12.73 |
| desmosterol/cholesterol | −63.97 | desmosterol | −68.56 |
| 7DHC/choelsterol | −0.0001710353 | 7-dehydro- | −12.73 |
| | | cholesterol | |
| | | cholesterol | −12.73 |

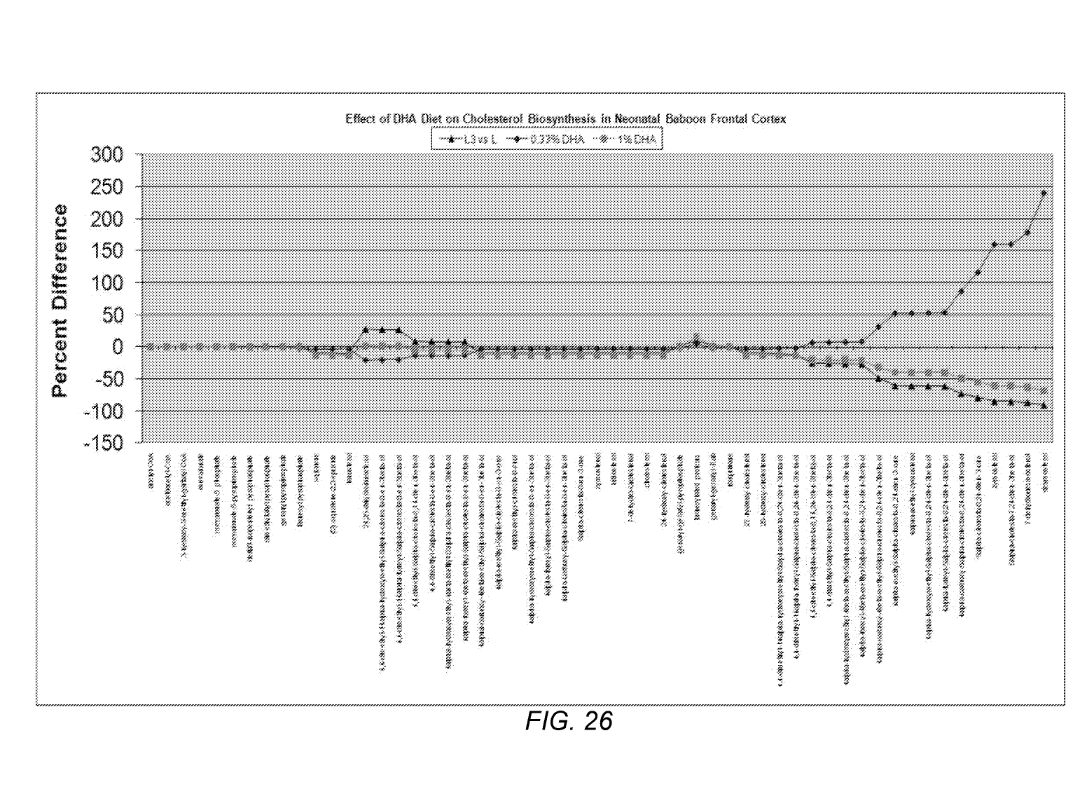

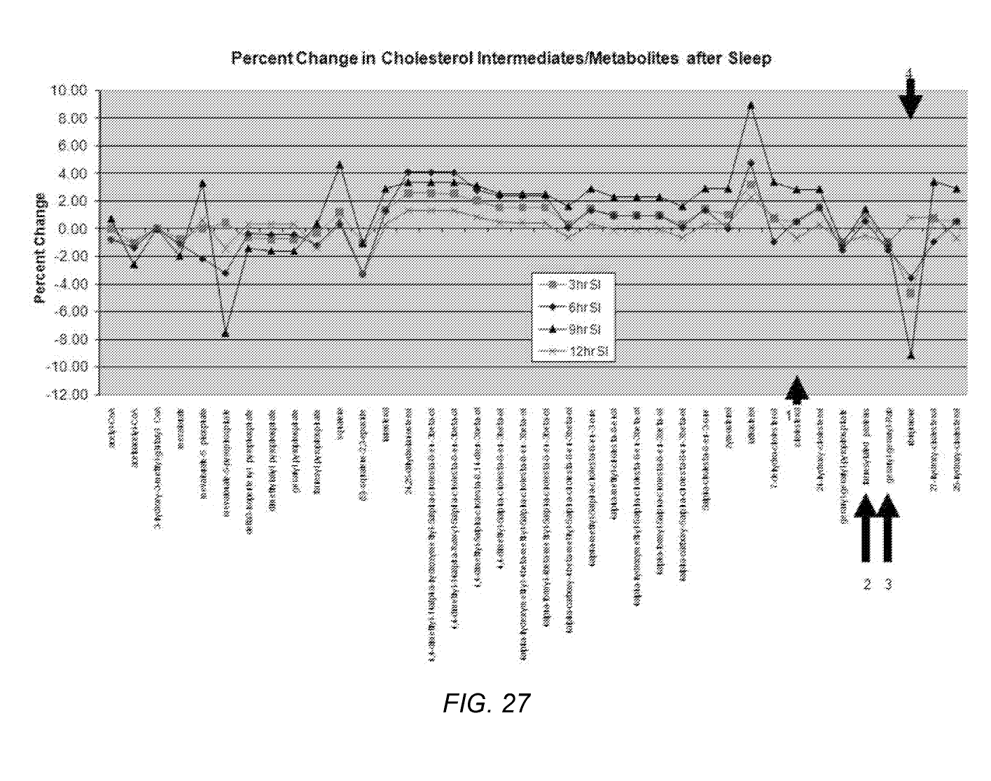

FIG. 26 depicts that lower concentration of DHA increases desmosterol levels, while the higher causes a decrease. Desomoterol is recognized for its role in myelination of the CNS in childhood.

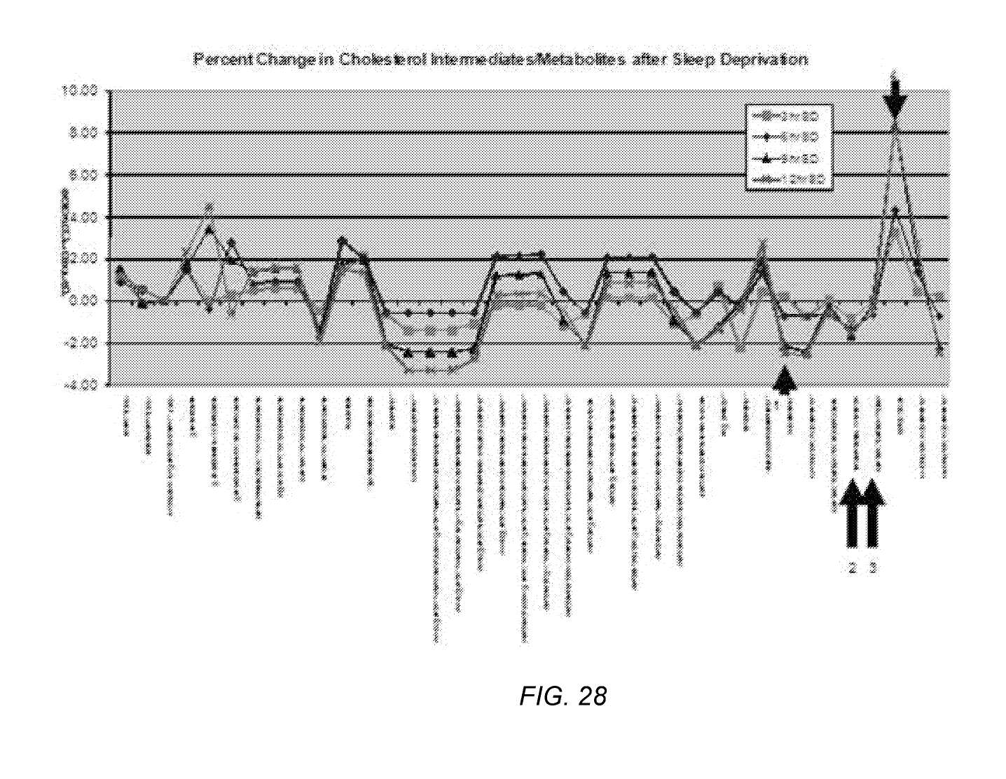

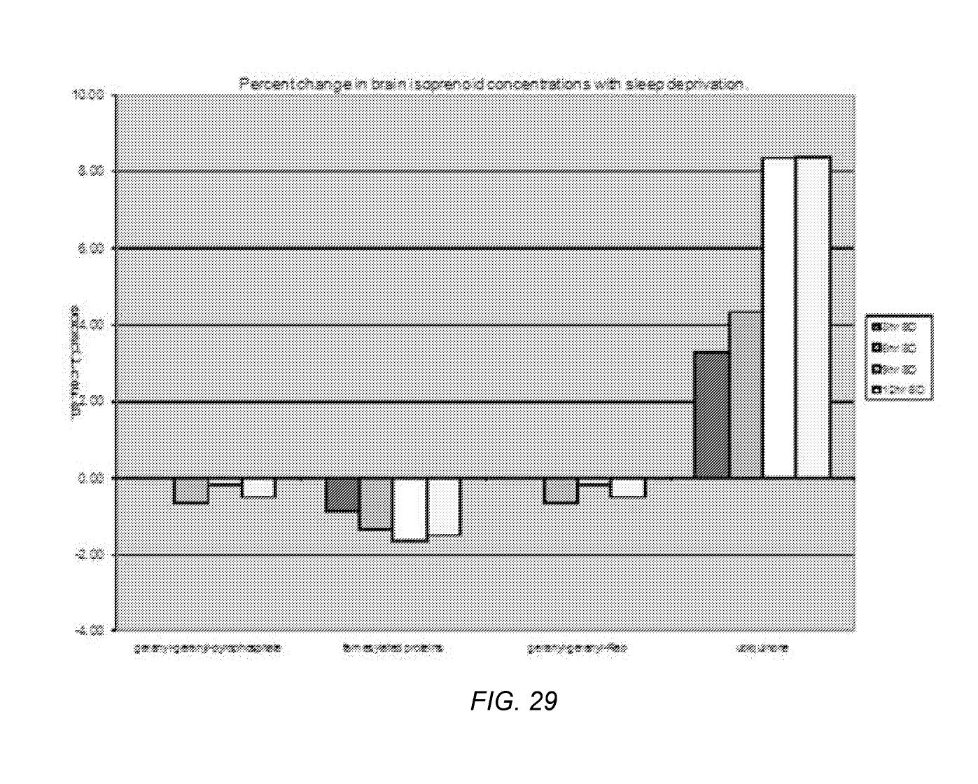

FIGS. 27 and 28 show the effects of sleep and sleep deprivation on brain cholesterol and isoprenoid metabolism as predicted by the biosimulation. FIG. 29 depicts sleep deprivation increases on ubiquinone levels as predicted by the biosimulation.

Use of a weighting factor allows the biosimulation to be modified for other uses. For example, Table 21 depicts the conversion of k-values from adult liver to fetal liver. Using this information, a fetal model can be derived from an adult model.

TABLE 22

| SEQUENCE | PATHWAY | FETAL # | ADULT # | F/A prop | fEXPR (%) | Aexpr (%) | GENE |
|---|---|---|---|---|---|---|---|
| CHOLESTEROL | | | | | | | |
| BIOSYNTHESIS: | | | | | | | |
| 1 | CH1 | 318.5 | 80 | 3.98125 | 0.043794 | 0.011 | ACAT2 |
| 2 | CH1 | 1 | 1 | 1 | 0.008 | 0.008 | ACATE2 |
| 3 | CH2 | 124 | 20 | 6.2 | 0.0682 | 0.011 | HMGCS1 |
| 4 | CH3 | 232.5 | 55.5 | 4.189189 | 0.025135 | 0.006 | HMGCR |
| 5 | CH4 | 864.5 | 1338 | 0.646114 | 0.002584 | 0.004 | MVK |
| 6 | CH5 | 37 | 396.5 | 0.093317 | 0.002008 | 0.0215 | PMVK |
| 7 | CH6 | 22.5 | 20 | 1.125 | 0.003499 | 0.0031 | MVD |
| 8 | CH7 | 1137.5 | 153 | 7.434641 | 0.066912 | 0.009 | IDI1 |
| 9 | CH8 | 1088.5 | 1535 | 0.709121 | 0.095022 | 0.134 | FDPS |
| 10 | CH9 | 490.5 | 178.5 | 2.747899 | 0.046714 | 0.017 | FDFT1 |
| 11 | CH10 | 394.5 | 33.5 | 11.77612 | 0.070657 | 0.006 | SQLE |
| 12 | CH11 | 936 | 656 | 1.426829 | 0.005707 | 0.004 | LSS |
| 13 | CH12 | 2092 | 2490 | 0.840161 | 0.05209 | 0.062 | DHCR24 |
| 14 | CH13 | 369.5 | 111.5 | 3.313901 | 0.036453 | 0.011 | CYP51A1 |
| 15 | CH14 | 647 | 81 | 7.987654 | 0.071889 | 0.009 | LBR |
| 16 | CH15 | 2090 | 2433 | 0.859022 | 0.005154 | 0.006 | TM7SF2 |
| | | | | | | | (DHCR14) |
| 17 | CH16 | 1040 | 79 | 13.16456 | 0.118481 | 0.009 | SC4MOL |
| 18 | CH17 | 447.5 | 309 | 1.44822 | 0.018827 | 0.013 | NSDHL |
| 19 | CH18 | 1 | 1 | 1 | 0.00391 | 0.0039 | HSD17B7 |
| 20 | CH19 | 1930.5 | 3955.5 | 0.488055 | 0.007321 | 0.015 | EBP |
| 21 | CH20 | 381 | 196 | 1.943878 | 0.017495 | 0.009 | SC5DL |
| 22 | CH21 | 2097 | 1060 | 1.978302 | 0.007913 | 0.004 | DHCR7 |
| CHOLESTEROL | | | | | | | |
| CATABOLISM: | | | | | | | |
| 23 | CH22 | 471 | 5599 | 0.084122 | 0.000336 | 0.004 | CYP27A1 |
| 24 | CH23 | 1 | 1 | 1 | 0.009 | 0.009 | CYP39A1 |
| 25 | CH24 | 20 | 20 | 1 | 0.006 | 0.006 | CYP7A1 |
| 26 | CH25 | 20 | 32 | 0.625 | 0.008863 | 0.01418 | CYP7B1 |
| ISOPRENOIDS: | | | | | | | |
| 1 | ISOP1 | 60.5 | 20 | 3.025 | 0.00605 | 0.002 | GGPS1 |
| 2 | ISOP2 | 96 | 350.5 | 0.273894 | 0.000548 | 0.002 | RABGGTA |
| 3 | ISOP3 | 360 | 575 | 0.626087 | 0.005009 | 0.008 | RABGGTB |
| 4 | ISOP4 | 97 | 61 | 1.590164 | 0.00318 | 0.002 | FNTA |
| 5 | ISOP5 | 20 | 46.5 | 0.430108 | 0.00086 | 0.002 | FNTB |
| 6 | ISOP6 | 1 | 1 | 1 | 0.00973 | 0.00973 | TPT (UBIQ) |
| 7 | ISOP7 | 1 | 1 | 1 | 0.002 | 0.002 | DHDDS |
| | | | | | | | (CPT) |
| KETONE | | | | | | | |
| METABOLISM: | | | | | | | |
| 1 | KB1 | 317.5 | 957.5 | 0.331593 | 0.003648 | 0.011 | HMGCL |
| 2 | KB2 | 8115.5 | 15730.5 | 0.515909 | 0.039209 | 0.076 | HMGCS2 |
| 3 | KB3 | 241 | 1085 | 0.22212 | 0.000888 | 0.004 | BDH |
| 4 | KB4 | 146 | 183 | 0.797814 | 0.001596 | 0.002 | OXCT1 |
| GLUCONEOGENESIS: | | | | | | | |
| 1 | GN1 | 1192 | 787 | 1.514612 | 0.070551 | 0.04658 | PC |
| 2 | GN2 | 3350 | 6462 | 0.518415 | 0.008813 | 0.017 | PCK1 |
| 3 | GN2 | 663 | 3681 | 0.180114 | 0.00036 | 0.002 | PCK2 |
| 4 | GN3 | 4175 | 4355 | 0.958668 | 0.344162 | 0.359 | ENO1 |
| 5 | GN3 | 98 | 546 | 0.179487 | 0.001615 | 0.009 | ENO3 |
| 6 | GN4 | 2315 | 2429 | 0.953067 | 0.003812 | 0.004 | PGAM1 |
| 7 | GN4 | 44 | 57 | 0.77193 | 0.003088 | 0.004 | PGAMp |
| 8 | GN5 | 3444 | 2428 | 1.418451 | 0.204257 | 0.144 | PGK1 |
| 9 | GN6 | 867 | 437 | 1.983982 | 0.117055 | 0.059 | GAPD |
| 10 | GN7 | 1436 | 2079 | 0.690717 | 0.032464 | 0.047 | TPI1 |
| 11 | GN8 | 2457 | 1461 | 1.681725 | 0.021862 | 0.013 | ALDOA |
| 12 | GN8 | 9584 | 25793 | 0.371574 | 0.162378 | 0.437 | ALDOB |
| 13 | GN8 | 1000 | 1367 | 0.731529 | 0.013899 | 0.019 | ALDOC |
| 14 | GN9 | 20 | 58 | 0.344828 | 0.013103 | 0.038 | FBP1 |
| 15 | GN10 | 2734 | 3341 | 0.818318 | 0.013911 | 0.017 | GPI |
| 16 | GN11 | 3074 | 3779 | 0.813443 | 0.003254 | 0.004 | G6PC |
| 17 | GN12 | 20 | 20 | 1 | 0.004 | 0.004 | PFKFB1 |
| 18 | GN12 | 303.5 | 373.5 | 0.812584 | 0.006501 | 0.008 | PFKFB2 |
| 19 | GN12 | 140.25 | 129.5 | 1.083012 | 0.002166 | 0.002 | PFKFB3 |
| 20 | GN12 | 20 | 20 | 1 | 0.002 | 0.002 | PFKFB4 |
| GLYCOGENESIS: | | | | | | | |
| 1 | GG1 | 789 | 2251 | 0.350511 | 0.003856 | 0.011 | PGM1 |
| 2 | GG1 | 1 | 1 | 1 | 0.011 | 0.011 | PGM2 |
| 3 | GG1 | 72.6667 | 104 | 0.698718 | 0.001397 | 0.002 | PGM3 |
| 4 | GG1 | 63 | 108 | 0.583333 | 0.001167 | 0.002 | PGM5 |
| 5 | GG2 | 102 | 102 | 1 | 0.061 | 0.061 | UGP2 |
| 6 | GG3 | 162.5 | 259.5 | 0.626204 | 0.01315 | 0.021 | GYS2 |
| 7 | GG3 | 341 | 225 | 1.515556 | 0.019702 | 0.013 | GYS1 |
| 8 | GG3a | 1 | 1 | 1 | 0.009 | 0.009 | GSK3B |
| GLYCOGENOLYSIS: | | | | | | | |
| 9 | GG4 | 395 | 388 | 1.018041 | 0.009162 | 0.009 | PYGL |
| 10 | GG4 | 179 | 327 | 0.547401 | 0.001095 | 0.002 | PYGM |
| GLYCOLYSIS: | | | | | | | |
| 1 | GY1 | 33 | 44 | 0.75 | 0.000488 | 0.00065 | HK1 |
| 2 | GY1 | 33 | 20 | 1.65 | 0.012194 | 0.00739 | HK2 |
| 3 | GY1 | 1 | 1 | 1 | 0.00156 | 0.00156 | HK3 |
| 4 | GY2 | 439 | 647 | 0.678516 | 0.001357 | 0.002 | PFKL |
| 5 | GY2 | 28 | 20 | 1.4 | 0.0112 | 0.008 | PFKP |
| 6 | GY3 | 143 | 49 | 2.918367 | 0.026265 | 0.009 | PDHA1 |
| 7 | GY3 | 292 | 77 | 3.792208 | 0.022753 | 0.006 | PDHX |
| 8 | GY3 | 656 | 432 | 1.518519 | 0.003037 | 0.002 | PDHB |
| 9 | GY4 | 596.5 | 233 | 2.560086 | 0.156165 | 0.061 | PKM2 |
| 10 | GY4 | 1 | 1 | 1 | 0.008 | 0.008 | PKLR |
| CITRIC ACID CYCLE: | | | | | | | |
| 1 | TCA1 | 726 | 419 | 1.732697 | 0.013862 | 0.008 | CS |
| 2 | TCA2 | 994 | 788 | 1.261421 | 0.010091 | 0.008 | ACO1 |
| 3 | TCA2 | 1 | 1 | 1 | 0.002 | 0.002 | ACO2 |
| 4 | TCA3 | 662 | 709 | 0.933709 | 0.039216 | 0.042 | IDH1 |
| 5 | TCA3 | 1509 | 2105 | 0.716865 | 0.001434 | 0.002 | IDH2 |
| 6 | TCA3 | 1 | 1 | 1 | 0.002 | 0.002 | IDH3A |
| 7 | TCA3 | 512 | 185 | 2.767568 | 0.116238 | 0.042 | IDH3B |
| 8 | TCA4 | 310 | 208 | 1.490385 | 0.013413 | 0.009 | OGDH |
| 9 | TCA5 | 1 | 1 | 1 | 0.011 | 0.011 | SUCLG1 |
| 10 | TCA5 | 31 | 20 | 1.55 | 0.02325 | 0.015 | SUCLG2 |
| 11 | TCA5 | 31 | 20 | 1.55 | 0.0124 | 0.008 | SUCLG2 |
| 12 | TCA6 | 808 | 543 | 1.488029 | 0.145827 | 0.098 | SDHD |
| 13 | TCA6 | 1 | 1 | 1 | 0.008 | 0.008 | SDHDP7 |
| 14 | TCA6 | 1 | 1 | 1 | 0.008 | 0.008 | SDHA |
| 15 | TCA6 | 1 | 1 | 1 | 0.006 | 0.006 | SDHC |
| 16 | TCA7 | 577 | 591 | 0.976311 | 0.00781 | 0.008 | FH |
| 17 | TCA8 | 1536 | 429 | 3.58042 | 0.046545 | 0.013 | MDH1 |
| 18 | TCA8 | 105 | 120 | 0.875 | 0.02625 | 0.03 | MDH2 |
| FATTY ACID | | | | | | | |
| SYNTHESIS: | | | | | | | |
| 1 | FAS1 | 1 | 1 | 1 | 0.004 | 0.004 | CLYBL |
| 2 | FAS1 | 698 | 167 | 4.179641 | 0.008359 | 0.002 | ACLY |
| 3 | FAS2 | 145.5 | 289 | 0.50346 | 0.002014 | 0.004 | ME1 |
| 4 | FAS2 | 26 | 20 | 1.3 | 0.0052 | 0.004 | ME2 |
| 5 | FAS2 | 20 | 20 | 1 | 0.004 | 0.004 | ME3 |
| 6 | FAS3 | 112.5 | 91.5 | 1.229508 | 0.034426 | 0.028 | TIMM17A |
| 7 | FAS4 | 104 | 90 | 1.155556 | 0.032182 | 0.02785 | ACACA |
| 8 | FAS4 | 231 | 491 | 0.470468 | 0.002573 | 0.00547 | ACACB |
| 9 | FAS5 | 842 | 3045.5 | 0.276473 | 0.014653 | 0.053 | ACAA1 |
| 10 | FAS5 | 1 | 1 | 1 | 0.015 | 0.015 | ACAA2 |
| 11 | FAS6 | 125 | 314 | 0.398089 | 0.002389 | 0.006 | MT |
| 12 | FAS7 | 1167 | 5963 | 0.195707 | 0.001761 | 0.009 | FASN |
| BETA OXIDATION | | | | | | | |
| OF FATTY ACIDS: | | | | | | | |
| 1 | FAO1 | 1 | 1 | 1 | 0.072 | 0.072 | ACSL1 |
| 2 | FAO2 | 1 | 1 | 1 | 0.023 | 0.023 | ACADVL |
| 3 | FAO3 | 21 | 20 | 1.05 | 0.02205 | 0.021 | EHHADH |
| 4 | FAO4 | 372.5 | 735.5 | 0.506458 | 0.005571 | 0.011 | HADHSC |
| 5 | FAO5 | 1733 | 992 | 1.746976 | 0.066385 | 0.038 | HADHB |
| 6 | FAO6 | 23.5 | 22 | 1.068182 | 0.004273 | 0.004 | ACADL |
| 7 | FAO7 | 287.5 | 50.5 | 5.693069 | 0.062624 | 0.011 | ACADM |
| MYRISTOYLATION | | | | | | | |
| OF PROTEINS: | | | | | | | |
| 1 | MYR1 | 116 | 75.5 | 1.536424 | 0.006146 | 0.004 | NMT1 |
| 2 | MYR2 | 116 | 59.5 | 1.94958 | 0.011697 | 0.006 | NMT2 |
| BIOSYNTHESIS OF | | | | | | | |
| COENZYME A: | | | | | | | |
| 1 | CoASH1 | 1 | 1 | 1 | 0.002 | 0.002 | PANK1 |
| 2 | CoASH1 | 1 | 1 | 1 | 0.004 | 0.004 | PANK3 |
| 3 | CoASH2 | 1 | 1 | 1 | 0.008 | 0.008 | COASY |
| 4 | CoASH3 | 112.5 | 20 | 5.625 | 0.045 | 0.008 | AASDHPPT |
| GLUCOSE | | | | | | | |
| TRANSPORT: | | | | | | | |
| 1 | GLUT2 | 42 | 50 | 0.84 | 0.02856 | 0.034 | SLC2A2 |
| 2 | GLU3 | 461 | 21 | 21.95238 | 0.043905 | 0.002 | SLC2A3 |
| 3 | GLUT4 | 1 | 1 | 1 | 0.009 | 0.009 | SLC2A4RG |
| 4 | GLUT4 | 1 | 1 | 1 | 0.02466 | 0.02466 | SLC2A4 |
| 5 | GLUT5 | 20 | 20 | 1 | 0.00591 | 0.00591 | SLC2A5 |
| 6 | GLUT9 | 1 | 1 | 1 | 0.01739 | 0.01739 | SLC2A9 |
| 7 | GLUT10 | 1 | 1 | 1 | 0.002 | 0.002 | SLC2A10 |
| 8 | GLUT11 | 1 | 1 | 1 | 0.00509 | 0.00509 | SLC2A11 |
| PENTOSE | | | | | | | |
| PHOSPHATE SHUNT: | | | | | | | |
| 1 | PPP1 | 79 | 62 | 1.274194 | 0.002548 | 0.002 | G6PD |
| 2 | PPP1 | 1373 | 918 | 1.495643 | 0.002991 | 0.002 | H6PD |
| 3 | PPP2 | 1507 | 1213 | 1.242374 | 0.032302 | 0.026 | PGD |
| 4 | PPP3 | 199 | 314 | 0.633758 | 0.001268 | 0.002 | RPE |
| 5 | PPP4 | 176 | 78 | 2.25641 | 0.004603 | 0.00204 | RPI |
| 6 | PPP5 | 1195 | 84 | 14.22619 | 0.355655 | 0.025 | TKT |
| 7 | PPP5 | 20 | 150 | 0.133333 | 0.000267 | 0.002 | TKTL1 |
| 8 | PPP6 | 1535 | 883 | 1.738392 | 0.18427 | 0.106 | TALDO1 |

### Example I-6

### Oxidative Pathways to Apoptotic Cell Death Computational Model for Atherosclerosis

### Statement of Problem:

This project was set for the design, development, validation, and testing of the transcriptome to reactome biosimulation of oxidative pathways to apoptotic cell death computational systems biology model. Both the apoptosis and oxidative pathway models are more comprehensive than the origin sources, due to the availability of resources recently provided by public sites or publications. Importantly the oxidative pathway network now includes the lipid peroxidation pathways and the “one-carbon” pathway for metabolizing folic acid (vitamin B9) and requiring cobalamin (vitamin B12). This set of integrated vitamin pathways is linked directly to epigenetic mechanisms (DNA methylation) and anti-oxidative systems (glutathione), including vitamins C and E. Importantly this model includes epigenomics pathways, including DNA methylation. The biosimulations of the macrophage from humans with atherosclerosis was completed and data are consistent with published evidence on key metabolites and processes.

### Model:

### Transcriptome to Reactome Biosimulation of Oxidative Pathways to Apoptotic Cell Death

Organism=human
Cells=macrophage derived from blood monocytes

### Pathways:

Apoptosis from Reactome®, and One Carbon Glutathione Pathways were used for developing a complex network system model designed to assess oxidative stress and cell death. Additional pathways for anti-oxidative vitamins and lipid hydroperoxidation were developed my manual curation using published descriptions. This model has 13 compartments, 442 species, 260 reactions, and 326 parameters derived from 380 genes.
RESULTS: Comparison of macrophage from human subjects with versus without atherosclerosis (NCBI GEO GSE9874):

The transcriptome to reactome biosimulator for oxidative pathways to apoptotic cell death model was used to compare macrophage derived from blood monocytes for two sets of human subjects: with and without atherosclerosis. Because the gene expression profiles used to determine parameters for the model were generated from macrophage in an unchallenged state, the results of the biosimulation have no counterpart in the literature (Seimon and Tabas 2009 Mechanisms and consequences of macrophage apoptosis in atherosclerosis. JLR 50:S382-S387) and further work is required to test the gene expression profiles of these subsets of macrophage after an oxidative challenge, such as with oxidized LDLs in the GSE9874. Those results could be compared with findings that describe how lower apoptosis in early lesions enhances plaque formation.

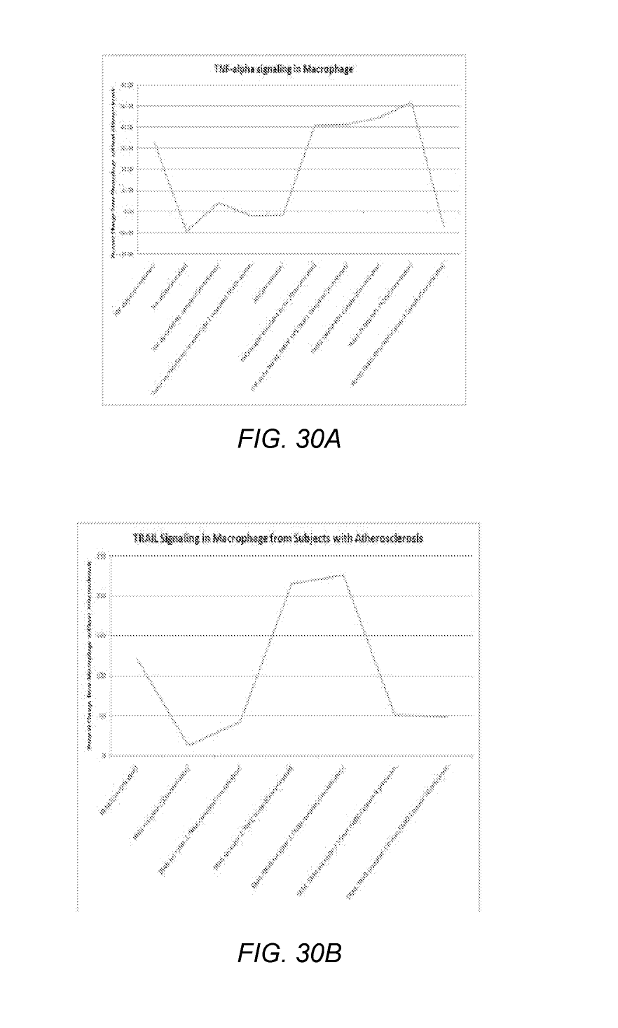

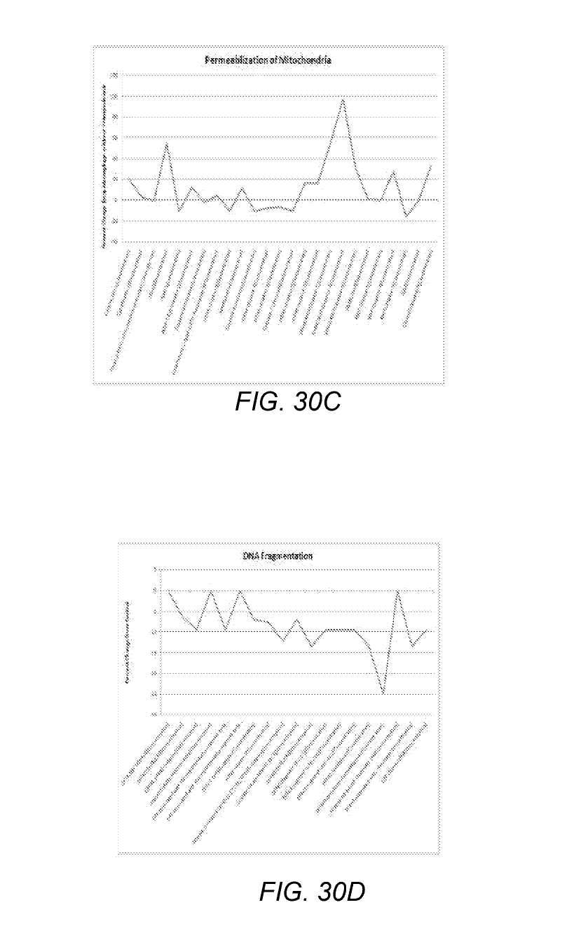

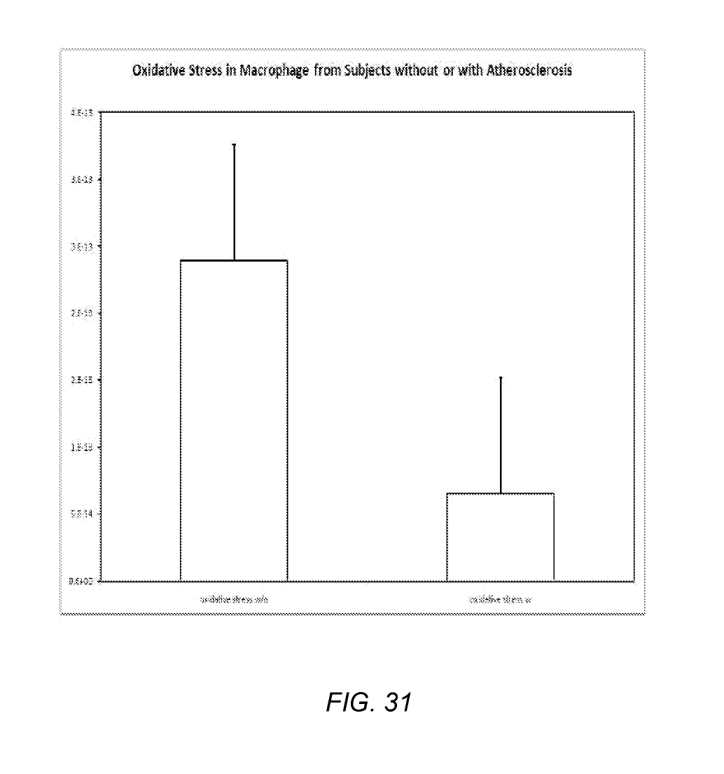

FIGS. 30A, 30B, 30C, 30D. Apoptosis: TNF and TRAIL signaling were enhanced in the macrophage from subjects with atherosclerosis (FIG. 30A and FIG. 30B) but the indicators of apoptosis were at lower levels (FIG. 30C and FIG. 30D). Oxidative Stress Oxidative stress in the model, shown in FIG. 31, was determined from cytosolic concentrations of iO₂+HO*+O²⁻*. The HO* was generated primarily from hydrogen peroxide that had been generated by SOD-1 in the cytosol from O²⁻*. The O²⁻* was generated by NADPH Oxidases. Macrophage from human subjects with atherosclerosis are intrinsically set to handle lower levels of oxidative stress.

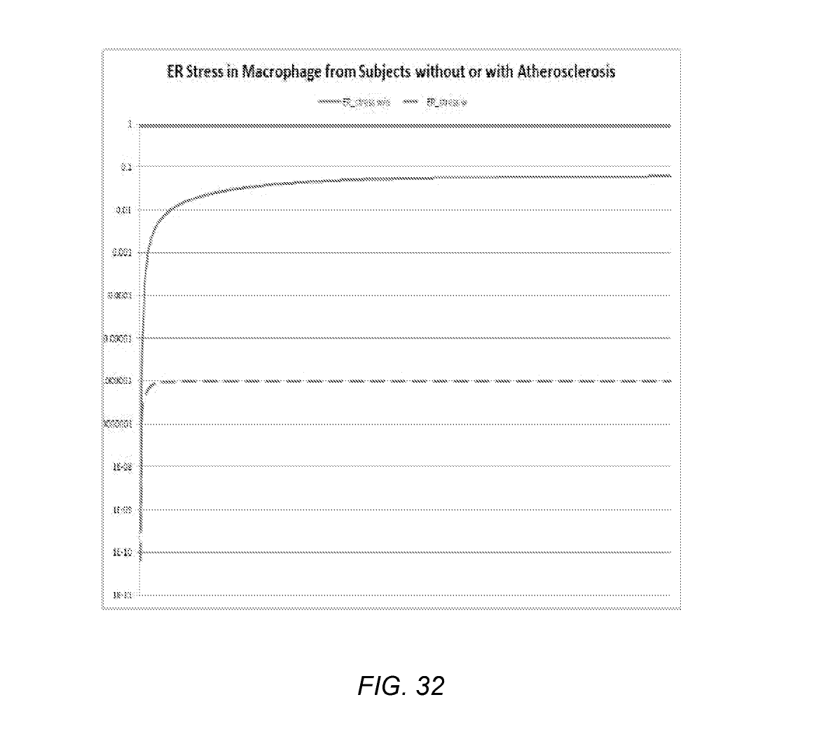

ER Stress (ER=endoplasmic reticulum) is recognized as a key factor associated with apoptosis in macrophage that play a role in progression of atherosclerotic plaque. Macrophage from human subjects with atherosclerosis are intrinsically set at lower levels of ER stress and less likely to undergo apoptosis. This state of macrophage at entry into a developing plaque could aggravate the atherosclerotic lesion, as shown in FIG. 32.

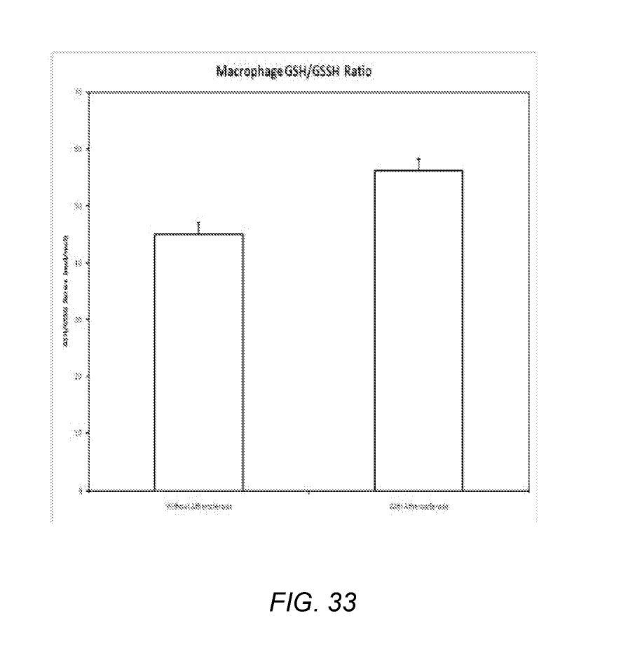

Glutathione-Redox Balance: The ratio of reduced glutathione (GSH) to oxidized glutathione (GSSH) is critical for macrophage to sustain an oxidative challenge. The ratio of GSH to GSSH in the macrophage for normal human subjects in a study was slightly above 40; the ratio from the simulated macrophage of human subjects without atherosclerosis was comparable at 45. The simulation showed that in the unchallenged state the ratio was 56 in macrophage from human subjects with atherosclerosis (shown in FIG. 33).

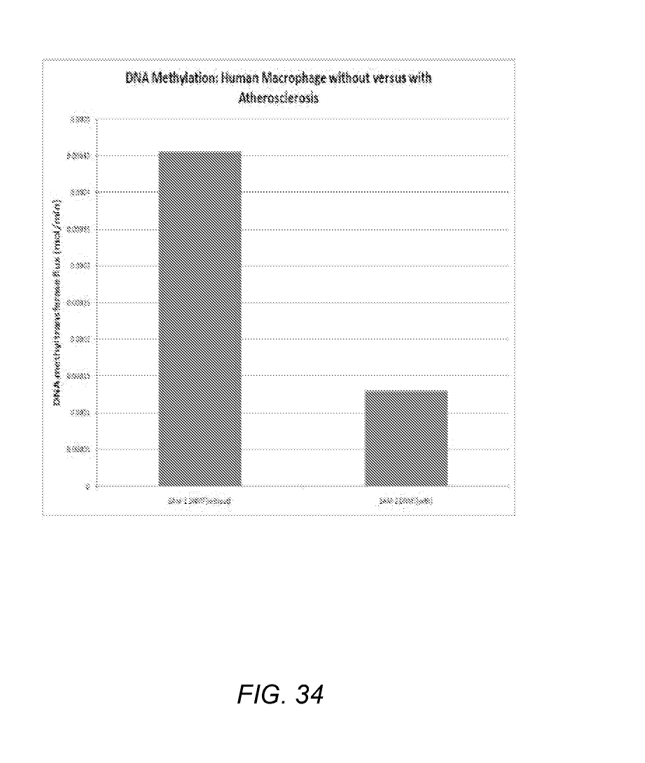

Epigenetics: DNA Methylation—Studies have demonstrated that there is a global DNA hypomethylation in macrophage of humans with atherosclerosis. The biosimulation showed this difference as the rate of methylation of DNA by the enzyme DNA methyltransferase being lower by more than 70% (depicted in FIG. 34).

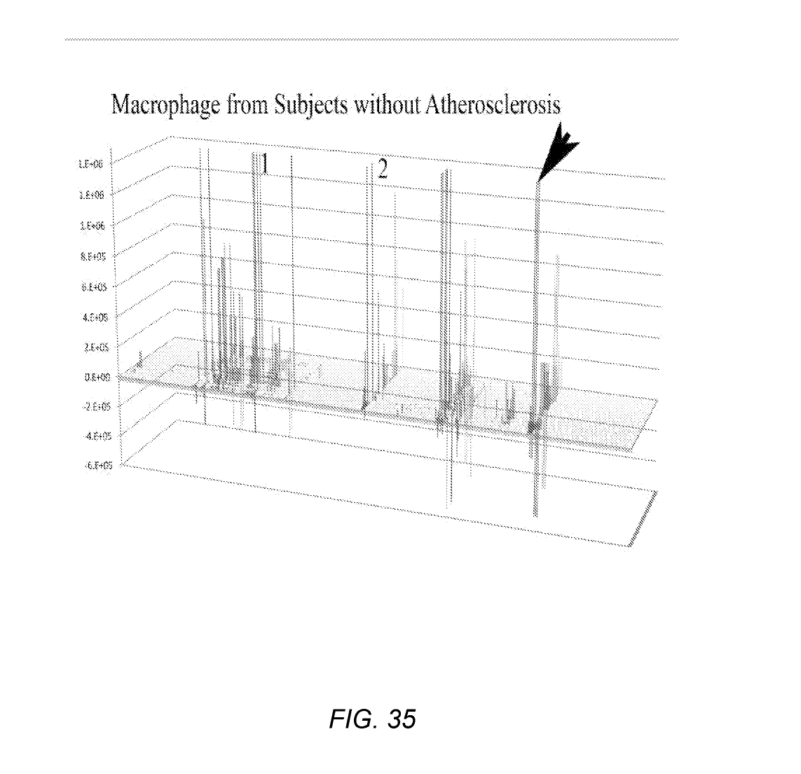

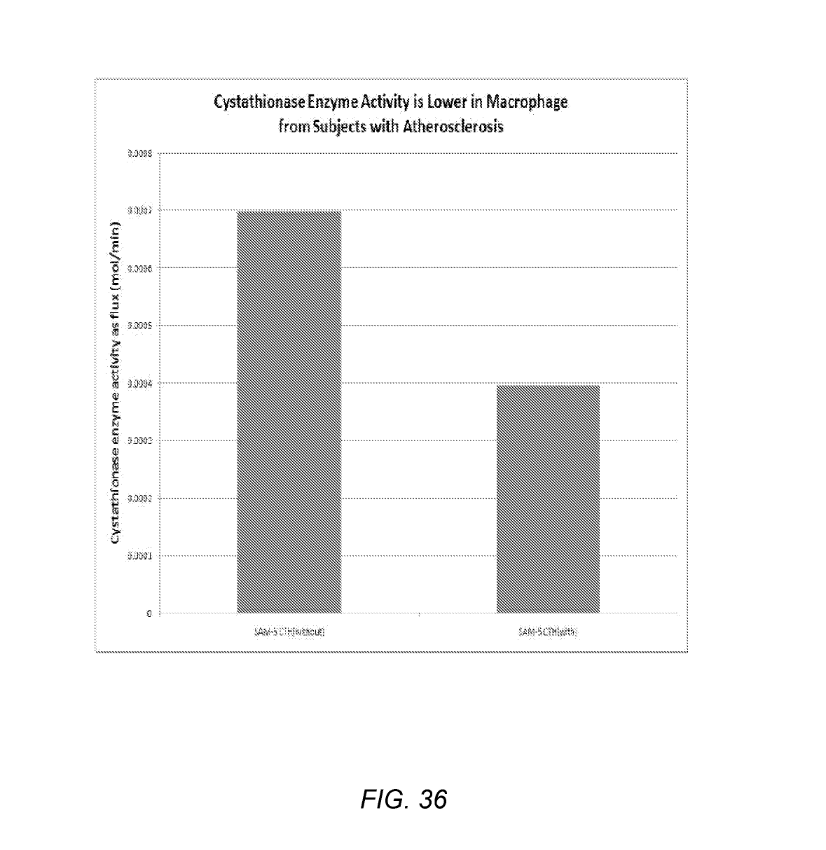

Biomarker and Target Identification by Sensitivities Analysis: FIG. 35 depicts sensitivities analyses performed on the oxidative pathways to apoptotic cell death models for macrophage from subjects without (A) and subjects with (B) atherosclerosis. The reactants are on the x-axis and the reactions are on the z-axis. Note that the macrophage from subjects with atherosclerosis have reactions that are generally less sensitive to reactants. Reactants at location 1 are related to apoptosis signaling, at 2 is the g-coupled proteins involved in signaling for folate receptors and at the arrow are the 3 folate receptors with g-proteins with GDP bound. Note at location 1, the upward directed columns are for a lipid oxidation reaction that is very sensitive to reactants in macrophage from subjects without and very insensitive (downward directed) in macrophage from subjects with atherosclerosis. Additionally, the reaction at the arrow is different between groups, i.e., glutathione reductase for the without and cystathionase for the with atherosclerosis groups. It has been shown that atherosclerosis is exacerbated if the cystathionase enzyme does not function at full capacity in mice. Since it is not a candidate for drug development for inhibition, because that would worsen atherosclerosis, it is a candidate biomarker in peripheral blood cells. From the biosimulations, the level of activity (flux) for cystathionase was 43% lower in macrophage from subjects with atherosclerosis (See FIG. 36).

### Example II-1

### Hydrogen Production and Metal Mining Computational Model for Archaea

Statement of Problem: The goal is to penetrate the global market for advances in technologies to generate alternative fuels and exploitation of extremely thermoacidophilic Archeon for mining precious metals.

### Model:

Archaea metabolic system computational model for hydrogen production and mining.

### Organism=Archaea

### Cells=Archaea

### Pathways:

Central Carbohydrate Metabolism Pathways of Thermoproteus tenax, Pyrococcus furious, and Metallosphaera sedula were accessed from KEGG®. Additional reactions of pathways for hydrogen production and metal mining were developed my manual curation using published descriptions.

This is a multi-pathway system kinetic model for which the parameters are determined directly from genome-wide gene expression profiles of species-specific cells. This model includes core metabolic pathways for carbohydrate metabolism unique to these organisms, and has 2 compartments, 75 species, 74 reactions, and 99 parameters all determined from cell specific microarray data sets from NCBI GEO GSE11296 for Metallosphaera sedula, and from MEXP-1376 from ArrayExpress; 121 genes are represented in this model. Because the gene annotations are incomplete for both these species, some parameter estimation was required. After establishing this model as a baseline autotrophic simulation, kinetic values were changed on those reactions for which the enzymes had fold changes due to heterotrophic growth in glucose rather than CO₂.

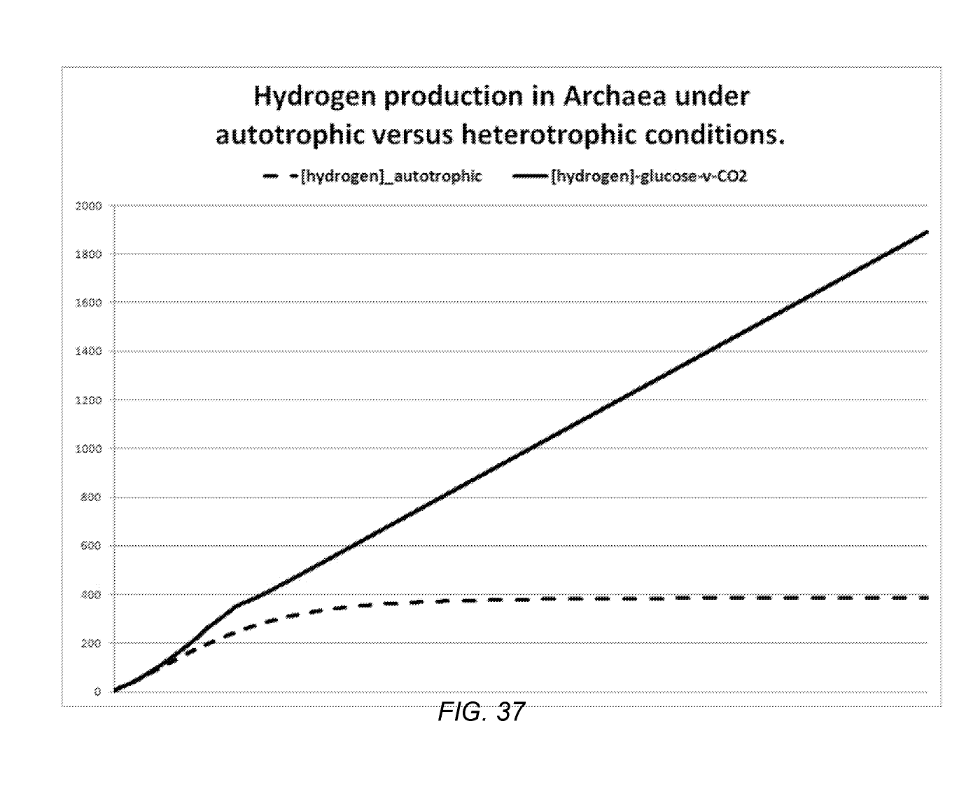

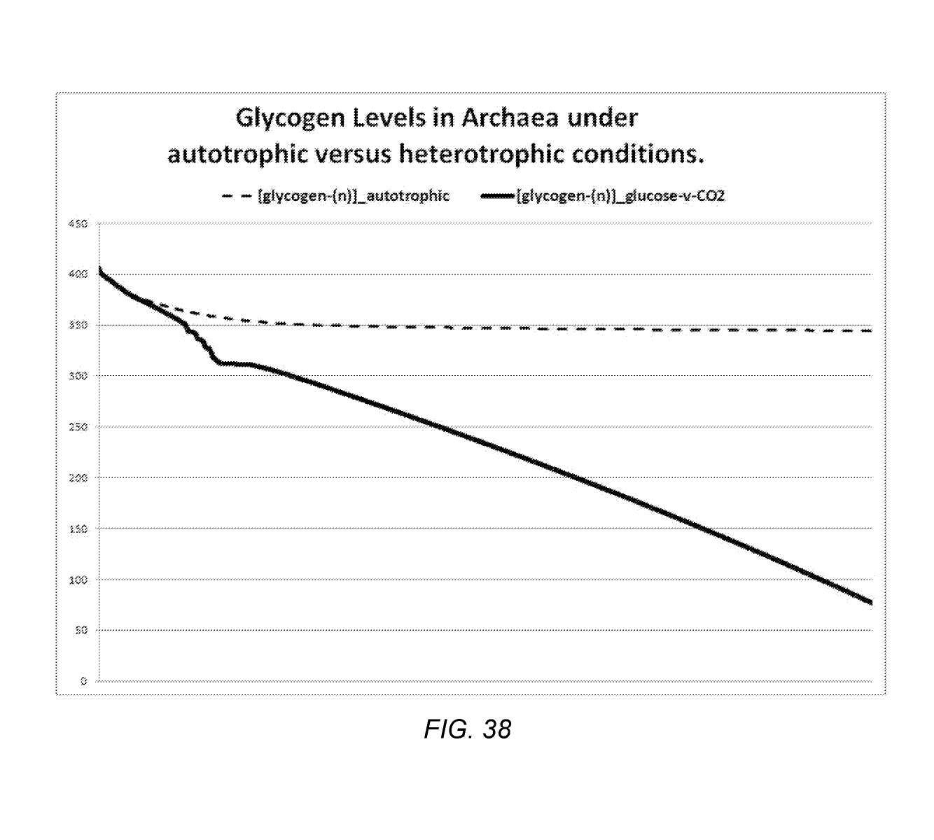

FIG. 37 depicts the results of time course biosimulation for central carbohydrate metabolism and hydrogen production in Archaea under two different growth conditions, autotrophic and heterotrophic of glucose versus CO₂. FIG. 38 depicts results of time course biosimulation for central carbohydrate metabolism and glycogen levels over the simulation time, in Archaea under two different growth conditions, autotrophic and heterotrophic of glucose versus CO₂.

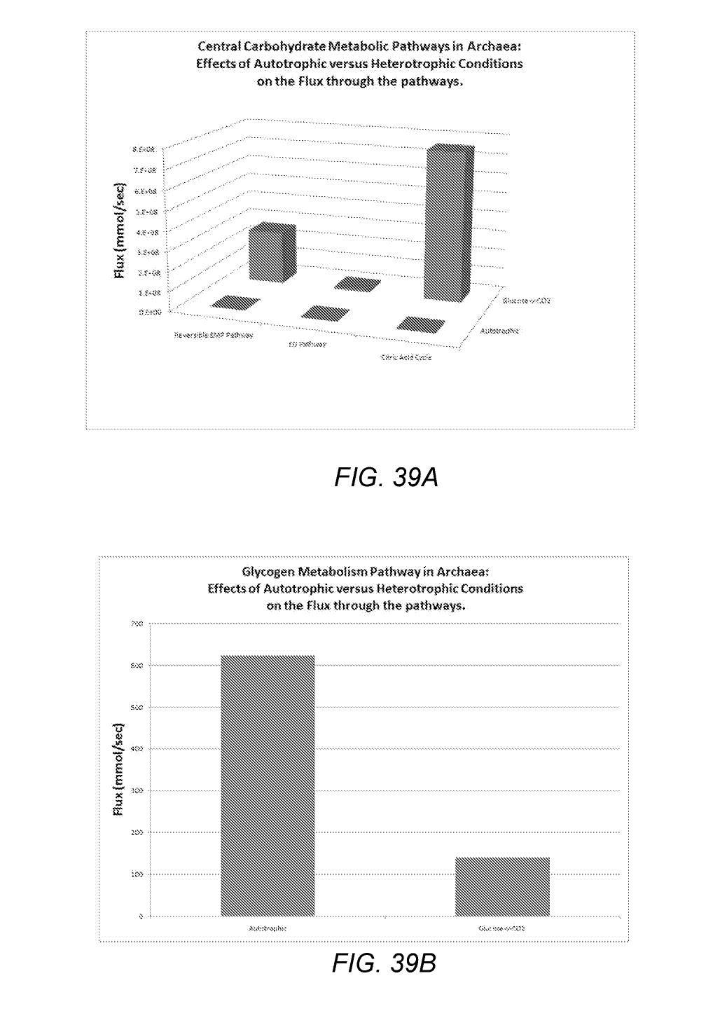

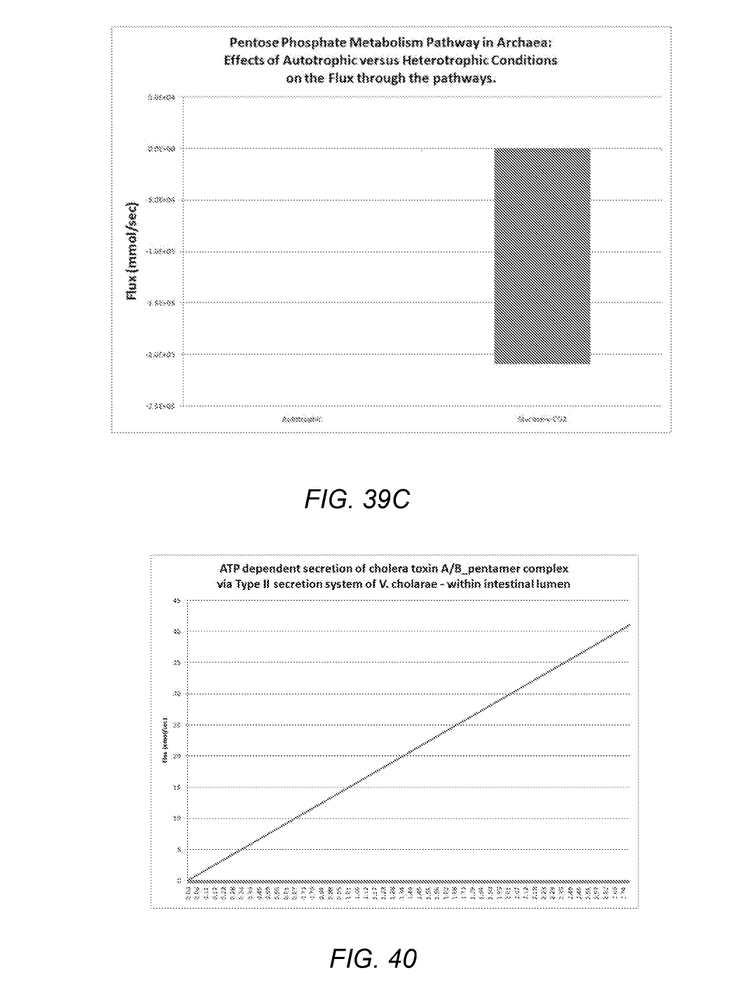

FIGS. 39A-39C: The average flux through metabolic pathways change dramatically due to heterotrohic growth conditions. Of the central carbohydrate pathways the citric acid cycle was increased most (FIG. 39A), with the reversible EMP pathway increased more moderately. The ED pathway was affected the least. Flux through the glycogen metabolism pathway (FIG. 39B) decrease dramatically; but the pentose phosphate pathway (FIG. 39C) showed a reversal of flux.

### Example II-2

### Bacterial Infection of Intestine—a Multicellular Two Organism Model

Statement of Problem: Simulations of intestinal and immune cell responses to infection by Vibrio cholerae.

Host pathogen interactions are complex and involve many different cell types. Cholera is caused by a bacterial infection in humans and the mouse model of intestinal infection with Vibrio cholera is commonly used. Such a model is created for in silico study of the potential for improved treatment of cholera and for vaccination development strategies. Because any infectious agent or parasite and any host cell can be modeled with the methods described herein, this model is an example of how host parasite interaction and pathogen resistance to treatment can be modeled.

For effective prevention of cholera, the shifting of immune responses to the IgA antibody production is important. This model includes only a naïve B-lymphocyte from the lamina propria, but numerous other cell types and destinations for distributions can be easily included. The cell specific microarray gene expression profiles are readily available for such applications to multi-cellular models—including multiple organisms.

### Model:

Multiple Cell System and Organism Model: transcriptome reactome in silico testing—an ex vivo simulation model for studying immune responses to bacterial infections.
Organisms=mouse and Vibrio cholerae
Cells=Intestinal epithelial cells, M-cells of intestine lining, dendritic cell of lamina propria, B lymphocytes of lamina propria, and Vibrio cholerae.

### Pathways:

Wnt Signaling, Cell Junction Organization for Adherens Junctions Interactions, and TGFβ Signaling Pathways from Reactome®, and the Vibrio cholera Infection and Bacterial Secretion System from KEGG were used for the mouse intestinal and bacterial cells, respectively. Extensive additional manual curation was required by use of the literature, for M-cell transcytosis of V. cholera and Wnt secretion into the lamina propria, O-catenin signaling pathway for dendritic cells and TGFβ Signaling for the B lymphocyte switching to IgA synthesis. This Model has 5 cell types represented with 31 compartments total, 229 reactants, 114 reaction, and 120 parameters; 191 genes were used to generate parameters in this model. Gene expression profiles were accessed from two different sources: 1) ArrayExpress record E-SMDB-1384 for transcription profiling of Vibrio cholera isolated from human cholera feces; 2) NCBI GEO GSE22127 for lamina propria dendritic cells, GSE7838 for both M-cells and intestinal epithelial cells, and GSE18746 for naïve B lymphocytes, all three of which were from mouse samples.

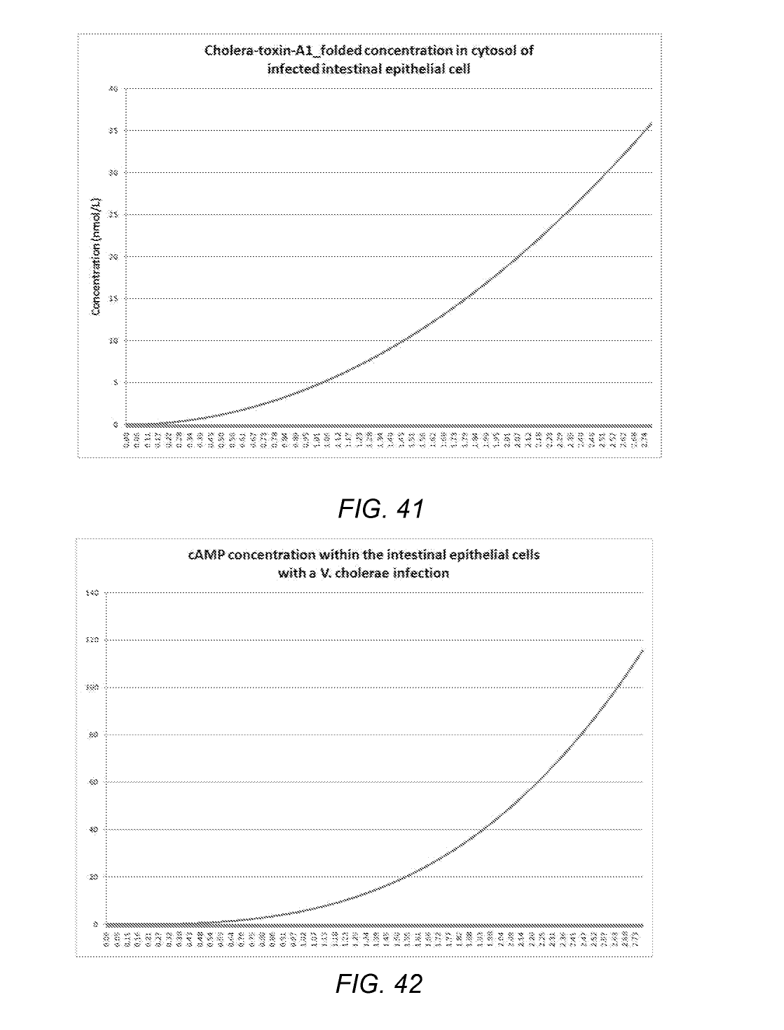

FIG. 40 depicts the graphical data for the temporal increase in cholera toxin secretion (flux) by the bacteria within the intestinal lumen. FIG. 41 depicts a graph of concentration change over time for accumulation of the cholera toxin A1 subunit in the cytosol of intestinal epithelial cells, after having been endocytosed, passed to the endoplasmic reticulum, retrograde, from the Golgi apparatus, and subsequently escaping the ER to the cytoplasmic compartment. This is the toxin that activates the adenylate cyclase causing the voluminous diarrhea. Due to constitutively active adenylate cyclase by the cholera toxin 1A (see FIG. 41) cAMP accumulates continuously within the cytosol of intestinal epithelial cells (FIG. 42).

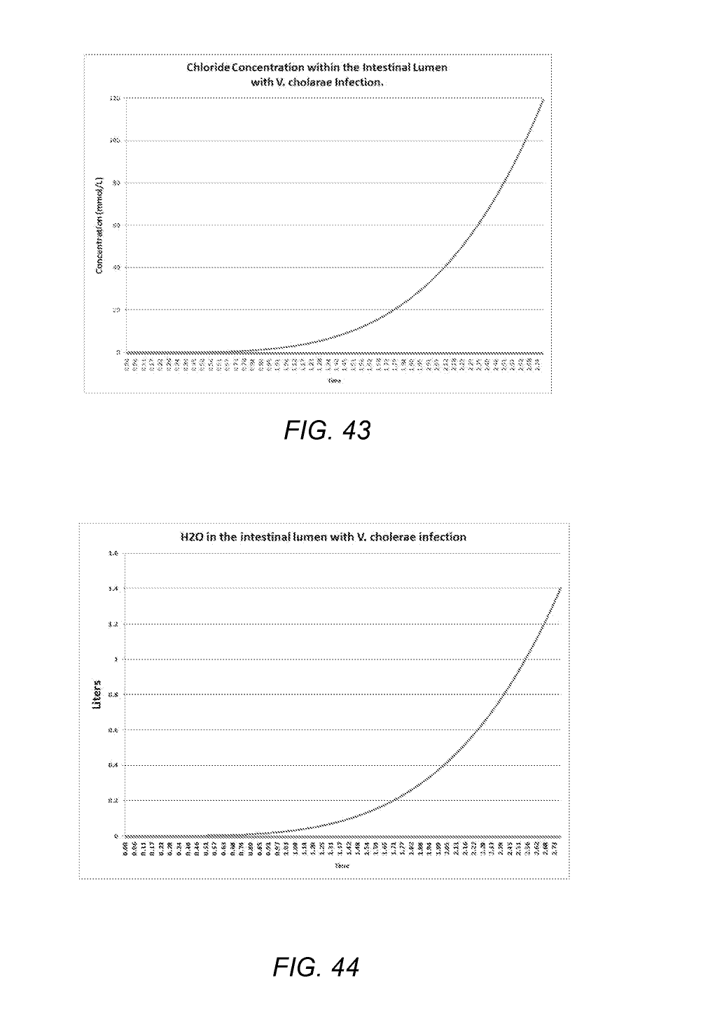

FIG. 43 is a temporal profile of the chloride concentration increase within the intestinal lumen, due to the Vibrio cholera infection in the simulation. FIG. 44 depicts the collection of water within the intestinal lumen on a temporal basis high correlated with the chloride efflux shown in FIG. 44.

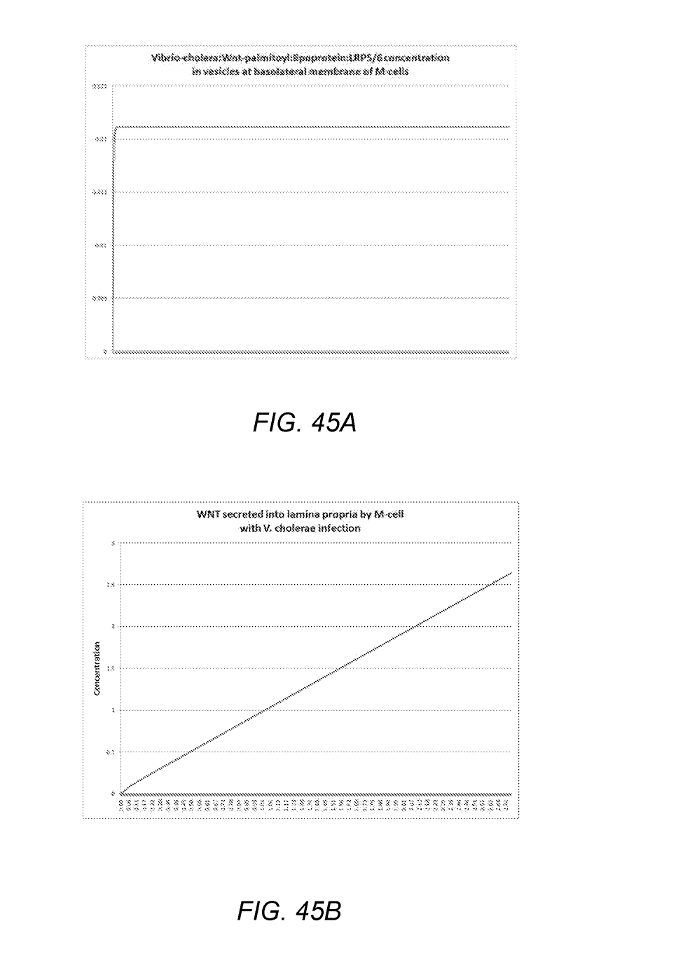

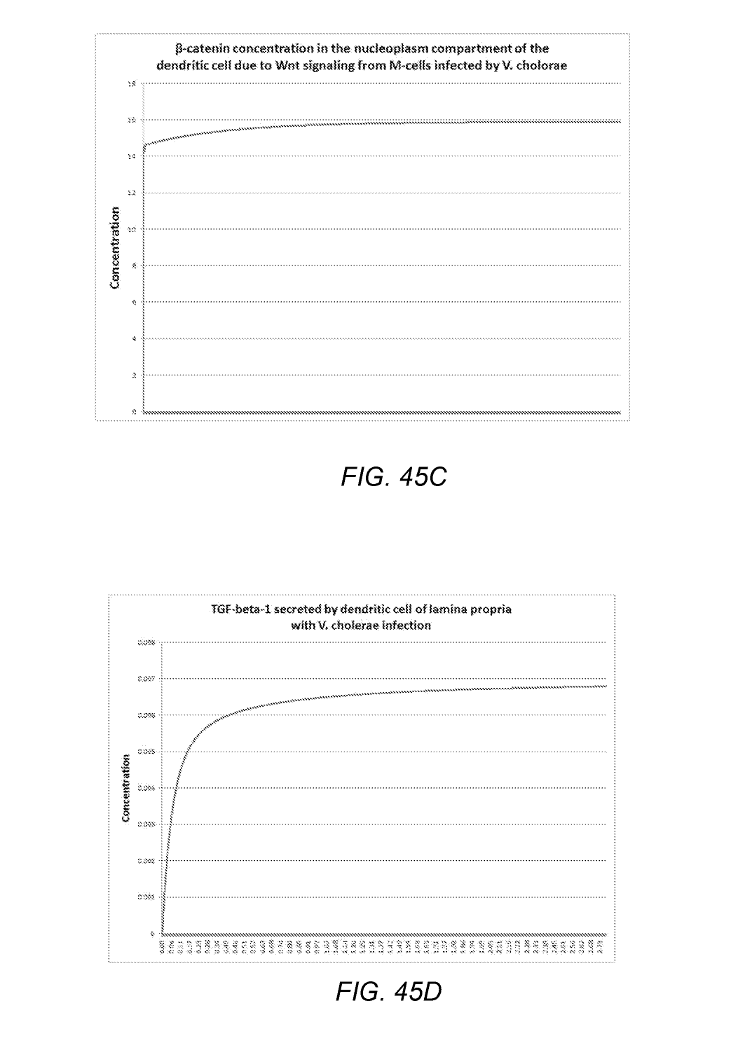

FIG. 45A depicts that whole Vibrio cholera bacteria accompany palmitoylated-Wnt through the endosomal system of M-cells, from the apical membrane to the basolateral membrane for release into the lamina proporia. FIG. 45B shows that this Wnt diffuses long distances and targets LPR5/6 and frizzled receptor proteins in the plasma membrane of dendritic cells. FIG. 45C shows that, due to the presence of Wnt, β-catenin accumulates in the nucleus acting as a transcription factor. FIG. 45D shows that the Wnt signaling within the dendritic cells causes the β-catenin destruction complex to dissociate and the nuclear translocation of β-catenin targets expression of transforming growth factor β-1 that is synthesized and secreted into the lamina propria interstitial fluid also.

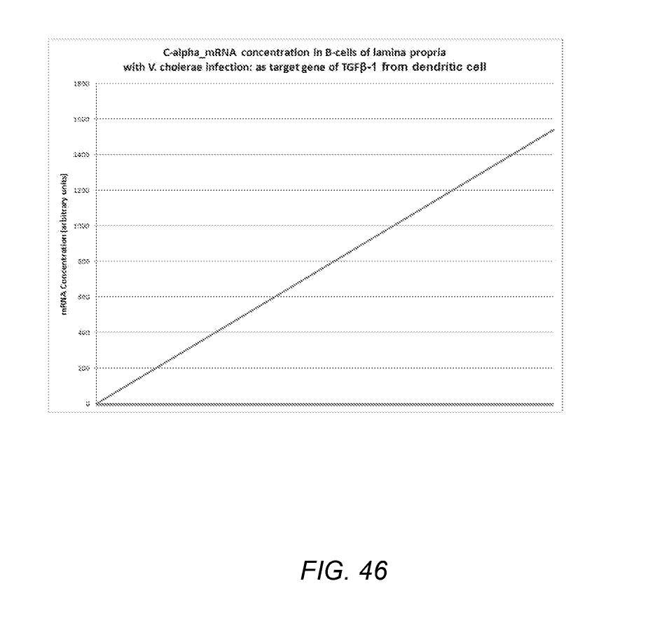

FIG. 46 shows that an end point of the cellular communications in response to the bacterial infection is the switching of immunoglobulin production to IgA by populations of B-lymphocytes in the lamina propria. The Smad complex activated and translocated to the nucleus within the B-lymphocytes by the TGFβ-1 from the dendritic cells turns on the gene for the C-alpha protein of the IgA antibodies that get secreted into the intestinal lumen to protect against the bacterial infection.

### Multicellular organisms

### Example III

### Example III-1

### Soy Bean Seed Oil Production During Development

Table 23: List of genes from soybean that are known to be involved in the fatty acid synthesis (FAS) pathway based upon the Affymetrix gene chip for soy bean microarray analyses.

TABLE 23

| Rxn | Path- | Seq | GENE | | SYSTEM |
|---|---|---|---|---|---|
| Code | way | # | SYMBOL | DESCRIPTION | PATHWAY |
| 15.1.1 | FAS | 1 | ACC1 | Acetyl_CoA_carboxylase_[Camellia_sinensis_(Tea)] | Fatty Acid |
| | | | | | Biosynthesis |
| 15.1A.1 | FAS | 1A | ACC1 | Acetyl_CoA_carboxylase_[Camellia_sinensis_(Tea)] | Fatty Acid |
| | | | | | Biosynthesis |
| 15.2.1 | FAS | 2 | CAC3 | Carboxyl_transferase_alpha_subunit_[Glycine_max_( | Fatty Acid |
| | | | | Soybean)] | Biosynthesis |
| 15.3.1 | FAS | 3 | CAC2 | Biotin_carboxylase_precursor_[Glycine_max_(Soybe | Fatty Acid |
| | | | | an)] | Biosynthesis |
| 15.4.1 | FAS | 4 | CAC1A | Biotin_carboxyl_carrier_protein_of_acetyl- | Fatty Acid |
| | | | | CoA_carboxylase,_chloroplast_precursor_[Glycine_{—} | Biosynthesis |
| | | | | max_(Soybean)] | |
| 15.5.1 | FAS | 5 | ACP1 | Acyl_carrier_protein_1,_chloroplast_precursor_{—} | Fatty Acid |
| | | | | [Casuarina_glauca_(Swamp_oak)] | Biosynthesis |
| 15.6.0 | FAS | 6 | AACS | Hypothetical_protein_[Medicago_truncatula_(Barrel_{—} | NA |
| | | | | medic)] | |
| 15.7.1 | FAS | 7 | ACPMT | Malonyltransferase_[Glycine_max_(Soybean)] | Fatty Acid |
| | | | | | Biosynthesis |
| 15.8.1 | FAS | 8 | KAS1 | 3-oxoacyl-[acyl-carrier- | Fatty Acid |
| | | | | protein]_synthase_[Capsicum_chinense_{—} | Biosynthesis |
| | | | | (Scotch_bonnet)_(Bonnet_pepper)] | |
| 15.9.1 | FAS | 9 | 3OXR | 3-oxoacyl-[acyl-carrier- | Enterochelin |
| | | | | protein]_reductase,_chloroplast_precursor_{—} | Biosynthesis |
| | | | | [Cuphea_lanceolata] | |
| 15.10.0 | FAS | 10 | BHAD | Beta-hydroxyacyl- | Fatty Acid |
| | | | | ACP_dehydratase_[Picea_mariana_(Black_spruce)] | Biosynthesis |
| 15.11.1 | FAS | 11 | MOD1 | Enoyl- | NA |
| | | | | ACP_reductase_precursor_[Nicotiana_tabacum_{—} | |
| | | | | (Common_tobacco)] | |
| 15.12.1 | FAS | 12 | KAS1 | 3-oxoacyl-[acyl-carrier- | Fatty Acid |
| | | | | protein]_synthase_[Capsicum_chinense_{—} | Biosynthesis |
| | | | | (Scotch_bonnet)_(Bonnet_pepper)] | |
| 15.13.1 | FAS | 13 | 3OXR | 3-oxoacyl-[acyl-carrier- | Enterochelin |
| | | | | protein]_reductase,_chloroplast_precursor_{—} | Biosynthesis |
| | | | | _[Cuphea_lanceolata] | |
| 15.14.0 | FAS | 14 | BHAD | Beta-hydroxyacyl- | Fatty Acid |
| | | | | ACP_dehydratase_[Picea_mariana_(Black_spruce)] | Biosynthesis |
| 15.15.1 | FAS | 15 | MOD1 | Enoyl-ACP_reductase_precursor_{—} | NA |
| | | | | [Nicotiana_tabacum_(Common_tobacco)] | |
| 15.16.1 | FAS | 16 | KAS1 | 3-oxoacyl-[acyl-carrier-protein]_synthase_{—} | Fatty Acid |
| | | | | [Capsicum_chinense_(Scotch_bonnet) | Biosynthesis |
| | | | | _(Bonnet_pepper)] | |
| 15.17.1 | FAS | 17 | 3OXR | 3-oxoacyl-[acyl-carrier- | Enterochelin |
| | | | | protein]_reductase,_chloroplast_precursor_{—} | Biosynthesis |
| | | | | _[Cuphea_lanceolata] | |
| 15.18.0 | FAS | 18 | BHAD | Beta-hydroxyacyl- | Fatty Acid |
| | | | | ACP_dehydratase_[Picea_mariana_(Black_spruce)] | Biosynthesis |
| 15.19.1 | FAS | 19 | MOD1 | Enoyl-ACP_reductase_precursor | NA |
| | | | | _[Nicotiana_tabacum_(Common_tobacco)] | |
| 15.20.1 | FAS | 20 | KAS1 | 3-oxoacyl-[acyl-carrier- | Fatty Acid |
| | | | | protein]_synthase_[Capsicum_chinense_{—} | Biosynthesis |
| | | | | (Scotch_bonnet)_(Bonnet_pepper)] | |
| 15.21.1 | FAS | 21 | 3OXR | 3-oxoacyl-[acyl-carrier- | Enterochelin |
| | | | | protein]_reductase,_chloroplast_precursor_{—} | Biosynthesis |
| | | | | [Cuphea_lanceolata] | |
| 15.22.0 | FAS | 22 | BHAD | Beta-hydroxyacyl- | Fatty Acid |
| | | | | ACP_dehydratase_[Picea_mariana_(Black_spruce)] | Biosynthesis |
| 15.23.1 | FAS | 23 | MOD1 | Enoyl-ACP_reductase_precursor_{—} | NA |
| | | | | [Nicotiana_tabacum_(Common_tobacco)] | |
| 15.24.1 | FAS | 24 | FATB | Acyl-ACP_thioesterase_[Garcinia_mangostana] | Fatty Acid |
| | | | | | Biosynthesis |
| 15.25.1 | FAS | 25 | KAS1 | 3-oxoacyl-[acyl-carrier-protein]_synthase_{—} | Fatty Acid |
| | | | | [Capsicum_chinense_(Scotch_bonnet)_(Bonnet_pepp | Biosynthesis |
| | | | | er)] | |
| 15.26.1 | FAS | 26 | 3OXR | 3-oxoacyl-[acyl-carrier- | Enterochelin_{—} |
| | | | | protein]_reductase,_chloroplast_precursor_{—} | Biosynthesis |
| | | | | [Cuphea_lanceolata] | |
| 15.27.0 | FAS | 27 | BHAD | Beta-hydroxyacyl- | Fatty Acid |
| | | | | ACP_dehydratase_[Picea_mariana_(Black_spruce)] | Biosynthesis |
| 15.28.1 | FAS | 28 | MOD1 | Enoyl-ACP_reductase_precursor_{—} | NA |
| | | | | [Nicotiana_tabacum_(Common_tobacco)] | |
| 15.29.1 | FAS | 29 | KAS1 | 3-oxoacyl-[acyl-carrier-protein]_synthase_[ | Fatty Acid |
| | | | | Capsicum_chinense_(Scotch_bonnet)_(Bonnet_peppe | Biosynthesis |
| | | | | r)] | |
| 15.30.1 | FAS | 30 | 3OXR | 3-oxoacyl-[acyl-carrier- | Enterochelin |
| | | | | protein]_reductase,_chloroplast_precursor_{—} | Biosynthesis |
| | | | | [Cuphea_lanceolata] | |
| 15.31.0 | FAS | 31 | BHAD | Beta-hydroxyacyl-ACP_dehydratase_{—} | Fatty Acid |
| | | | | [Picea_mariana_(Black_spruce)] | Biosynthesis |
| 15.32.1 | FAS | 32 | MOD1 | Enoyl-ACP_reductase_precursor_{—} | NA |
| | | | | [Nicotiana_tabacum_(Common_tobacco)] | |
| 15.33.1 | FAS | 33 | FATB | Acyl-ACP_thioesterase_[Garcinia_mangostana] | Fatty Acid |
| | | | | | Biosynthesis |
| 15.34.1 | FAS | 34 | KAS1 | 3-oxoacyl-[acyl-carrier-protein]_synthase_{—} | Fatty Acid |
| | | | | [Capsicum_chinense_(Scotch_bonnet)_(Bonnet_pepp | Biosynthesis |
| | | | | er)] | |
| 15.35.1 | FAS | 35 | 3OXR | 3-oxoacyl-[acyl-carrier-protein]_reductase,_{—} | Enterochelin |
| | | | | chloroplast_precursor_[Cuphea_lanceolata] | Biosynthesis |
| 15.36.0 | FAS | 36 | BHAD | Beta-hydroxyacyl- | Fatty Acid |
| | | | | ACP_dehydratase_[Picea_mariana_(Black_spruce)] | Biosynthesis |
| 15.37.1 | FAS | 37 | MOD1 | Enoyl-ACP_reductase_precursor_{—} | NA |
| | | | | [Nicotiana_tabacum_(Common_tobacco)] | |
| 15.38.1 | FAS | 38 | FATB | Acyl-ACP_thioesterase_[Garcinia_mangostana] | Fatty Acid |
| | | | | | Biosynthesis |
| 15.39.1 | FAS | 39 | SACPD | NA | Fatty Acid |
| | | | | | Biosynthesis |
| 15.40.1 | FAS | 40 | FATA | Acyl-ACP_thioesterase_[Garcinia_mangostana] | Fatty Acid |
| | | | | | Biosynthesis |
| 15.41.0 | FAS | 41 | MACPT | Myristoyl- | NA |
| | | | | acyl_carrier_protein_thioesterase,_chloroplast_precur | |
| | | | | sor_[Gossypium_hirsutum_(Upland_cotton)] | |

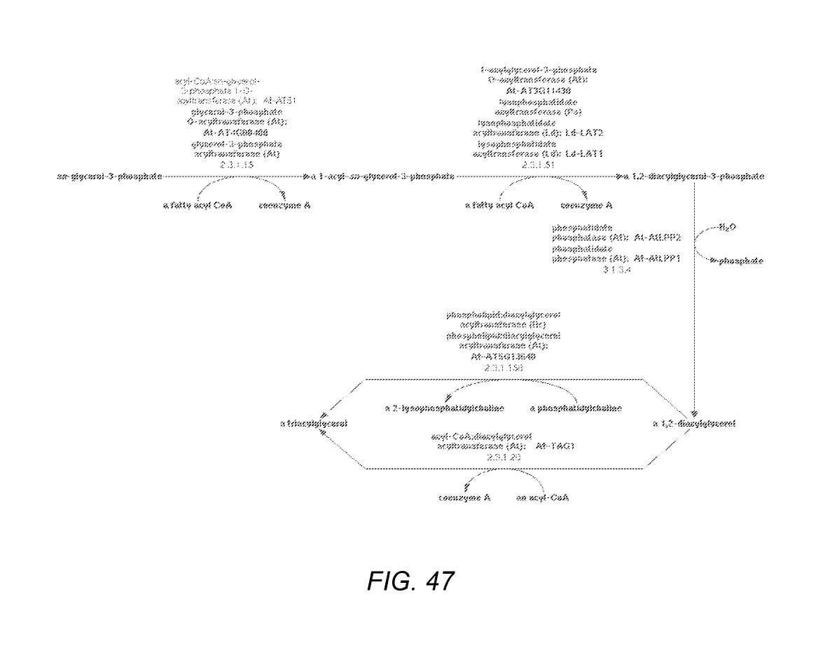

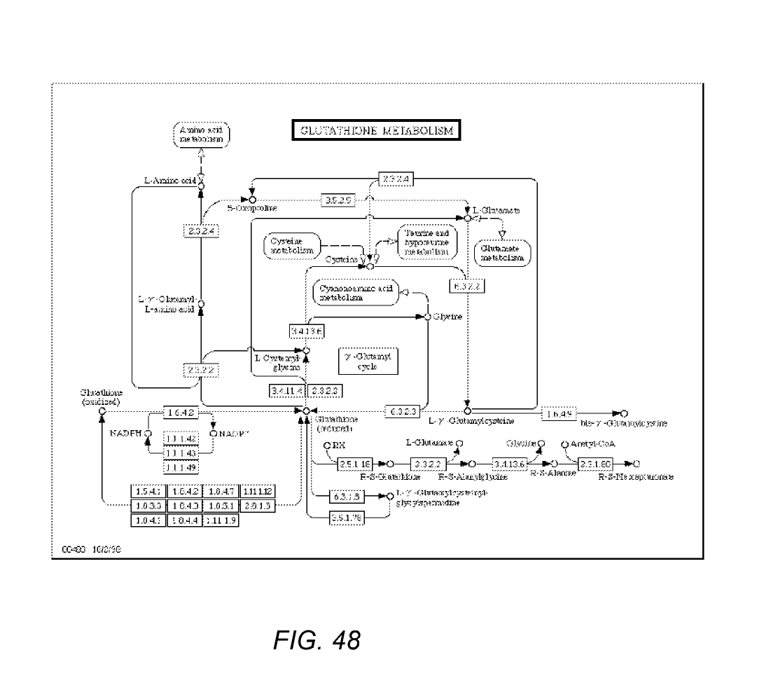

FIG. 47 depicts the triacylglycerol biosynthesis pathway. FIG. 48 shows enzymes only for those organisms listed above. If an enzyme name is shown in bold, there is experimental evidence for this enzymatic activity.

The fatty acid synthesis model developed includes 108 reactions, 12 cellular compartments, and 550 metabolites. FIG. 48 depicts an example of a biochemical pathway map from KEGG.

### Sensitivity Analyses:

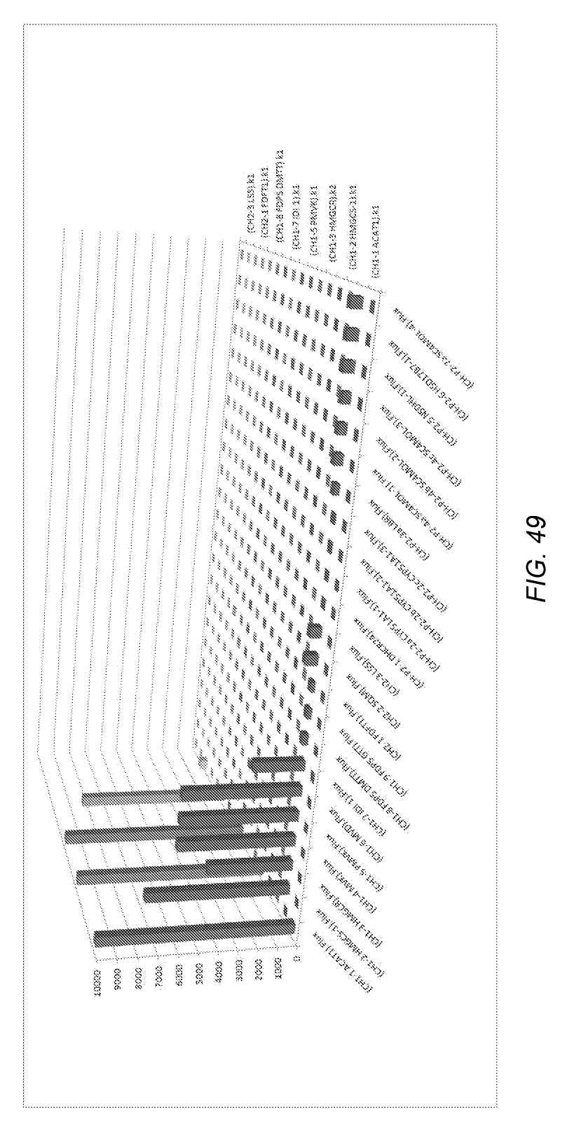

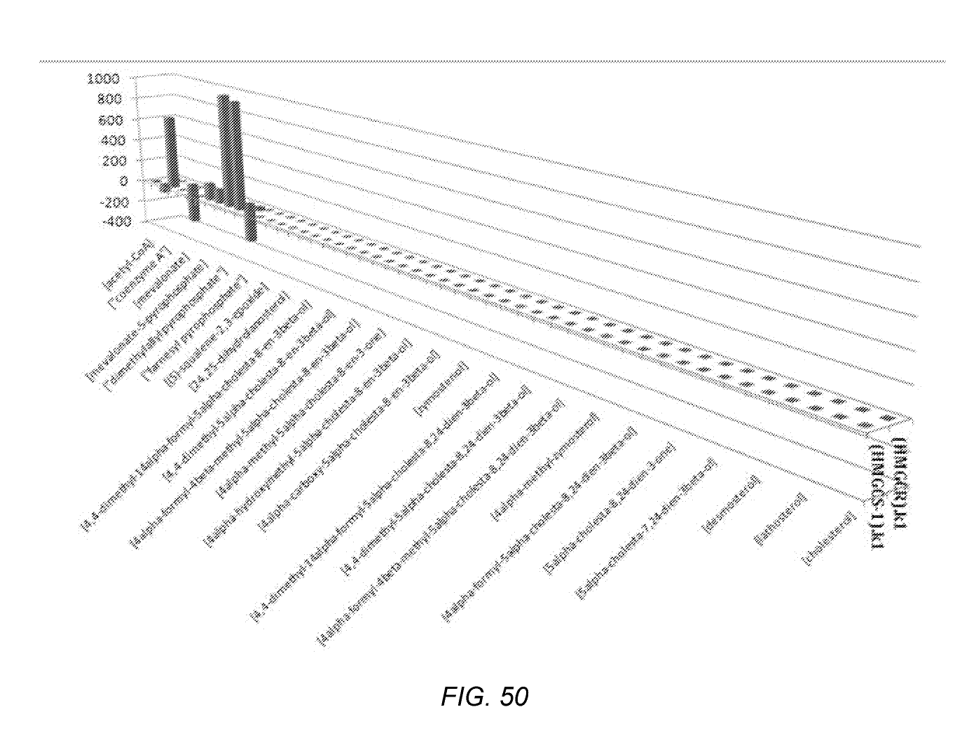

Biosimulation models were used to study the effects of various factors on biochemical pathways. FIG. 49 depicts human liver biosimulation: flux of enzymes in early sterol biosynthesis pathway are most affect by changes early metabolite changes in kinetic values for reactions. FIG. 50 depicts that for human airway epithelial cells kinetic values at HMGCS and HMGCR steps in sterol synthesis have most profound effects on early intermediate metabolites the sterol pathway.

The effects of diet on biosynthetic process may be studied using biosimulation. For example, Table 24 shows liver biosimulation results for several metabolic pathways using gene expression profiles from a study of subjects after 8 weeks on the American Heart Association diet with concomitant weight loss and gene changes in liver samples.

TABLE 24

| | Percent Change AHAD v CD |
|---|---|
| METABOLIC PATHWAY | AVG FLUX % DIFFERENCE |
| Acetyl-CoA Biosynthesis | 539.00 |
| Cholesterol Biosynthesis | 229.36 |
| Isoprenoid Branch and Products | 301.05 |
| Ketone Metabolism | −99.71 |
| Gluconeogenesis | 6.25 |
| Glycogenesis | 2.23 |
| Glycogenolysis | 14.85 |
| Glycolysis | 13.92 |
| TCA Cycle | 191.98 |
| Fatty Acid Synthesis | 203.97 |
| Fatty Acid Beta Oxidation | 91.95 |
| Pentose Phosphate Shunt | 21.00 |
| Glucose Transport (GLUT) | 16.50 |
| Steroid Synthesis | 425.25 |
| Coenzyme A synthesis from | −12.14 |
| pantothenic acid | |
| Cholesterol Transport | 215.73 |
| Cholesterol catabolism (bile acid) | 229.15 |

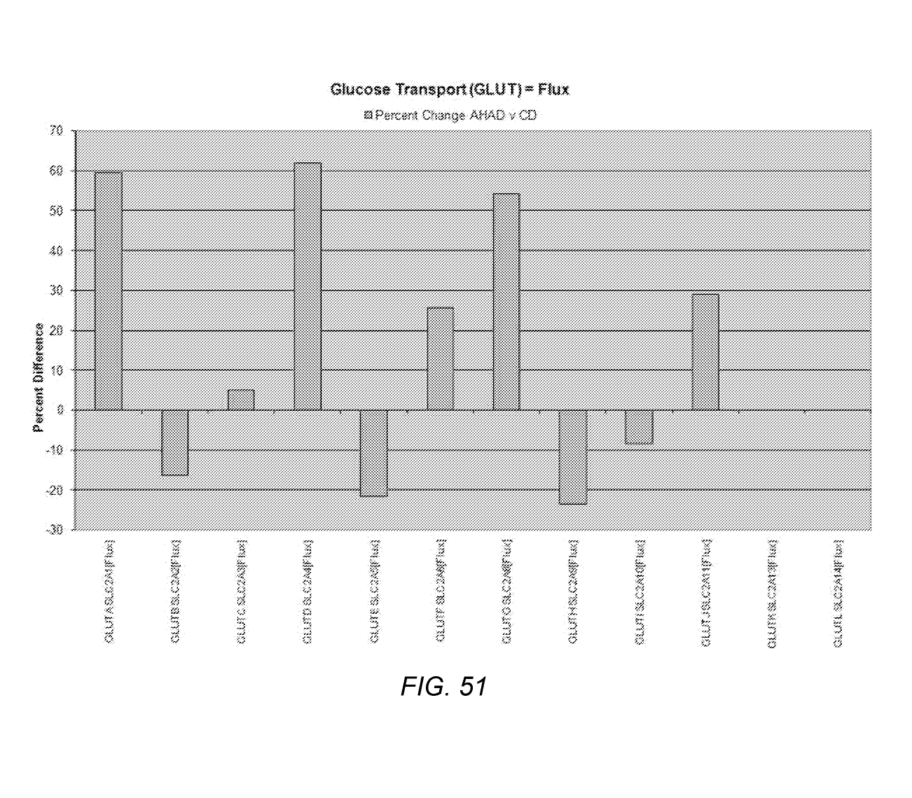

FIG. 51 depicts a graph of hepatic glucose transport flux based on this biosimulation model.

### Example IV

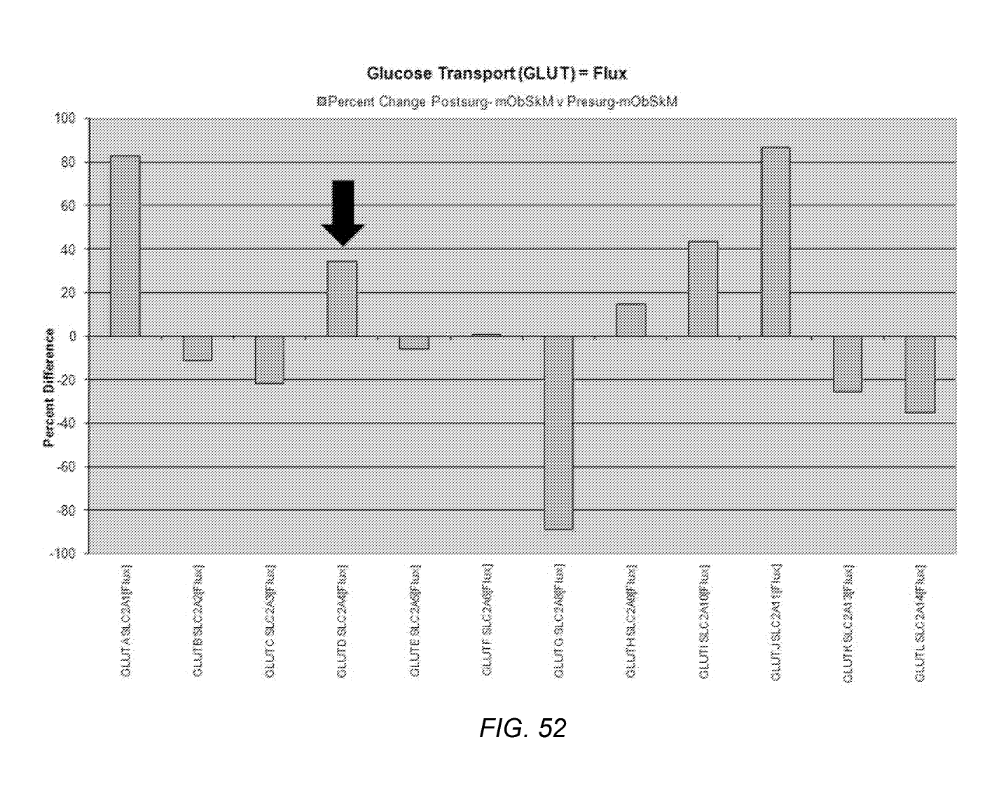

One year after gastric bypass surgery in morbidly obese humans, the skeletal muscle metabolic flux is dramatically suppressed in most metabolic pathways. See biosimulation results depicted in FIG. 52 and Table 25. Note how glucose transport is dramatically improved, in particular for the GLUT 4 uptake into skeletal muscle (see arrow in FIG. 52).

TABLE 25

| glycemia set at 5 mmol/L | Percent Change Postsurg- mObSkM v |
|---|---|
| for each case | Presurg-mObSkM |
| METABOLIC PATHWAY | AVG FLUX % DIFFERENCE |
| Acetyl-CoA Biosynthesis | 4.19 |
| Cholesterol Biosynthesis | 15.08 |
| Isoprenoid Branch and Products | 29.18 |
| Ketone Metabolism | −15.69 |
| Gluconeogenesis | −46.42 |
| Glycogenesis | −83.83 |
| Glycogenolysis | −83.90 |
| Glycolysis | −52.46 |
| TCA Cycle | −5.84 |
| Fatty Acid Synthesis | −15.66 |
| Fatty Acid Beta Oxidation | −17.36 |
| Pentose Phosphate Shunt | −58.92 |
| Glucose Transport (GLUT) | 21.73 |
| Steroid Synthesis | −24.04 |
| Coenzyme A synthesis from | 7.71 |
| pantothenic acid | |
| Cholesterol Transport | 6.37 |
| Cholesterol catabolism (bile acid) | −18.95 |

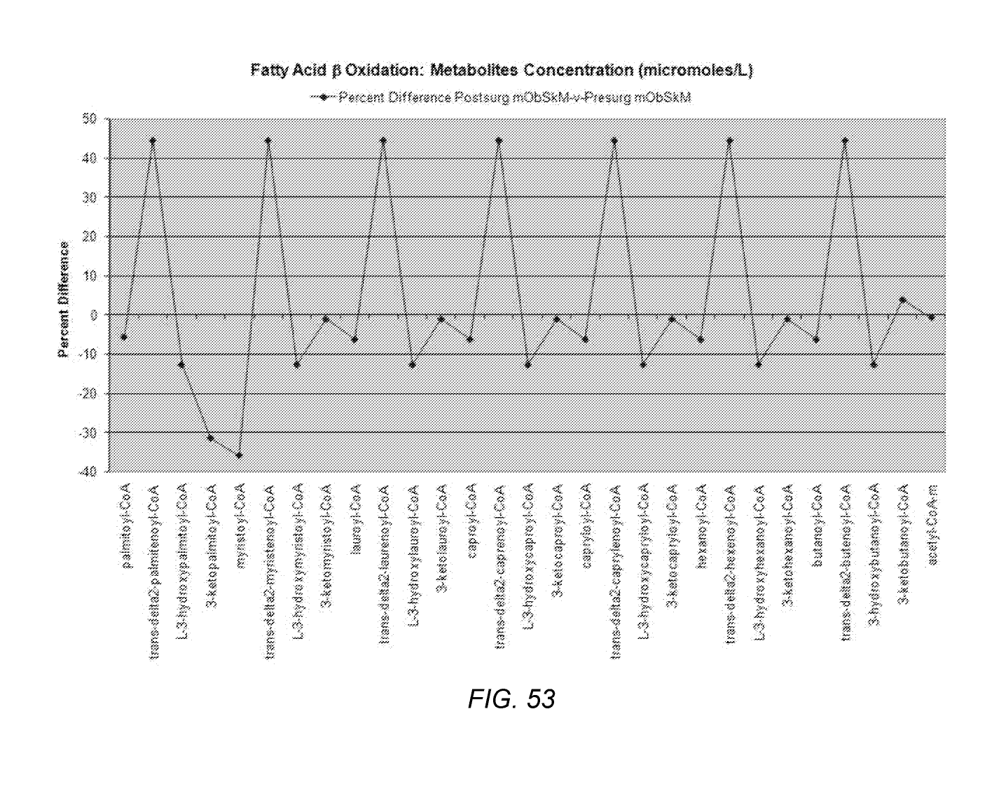

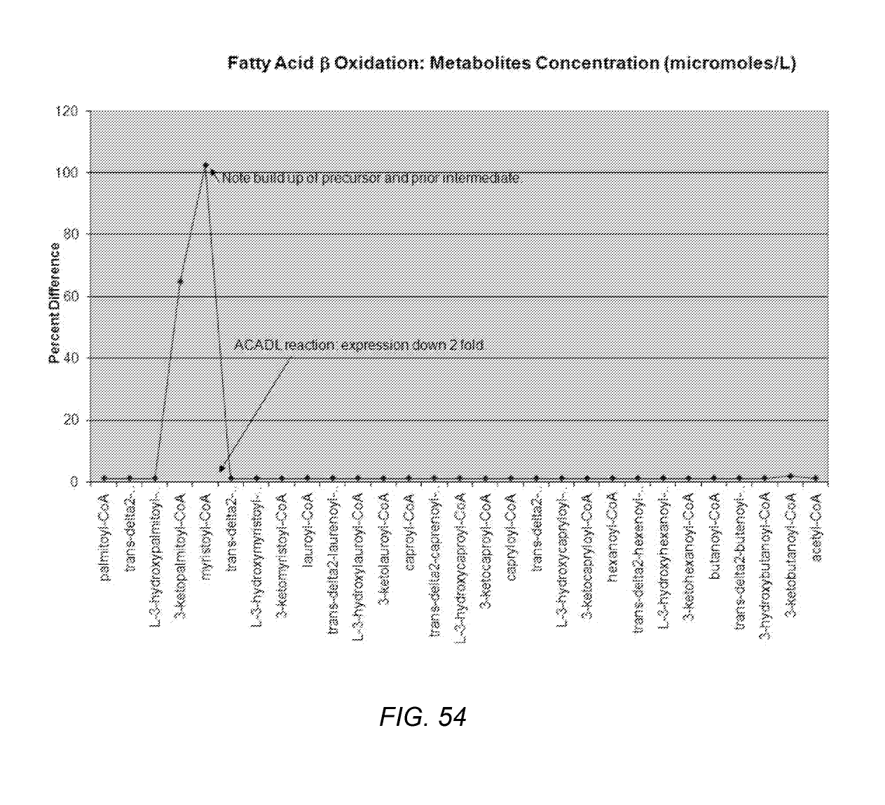

FIG. 53 shows that myristoyl-CoA is selectively reduced by nearly 40% one year after gastric bypass surgery in humans. This particular fatty acid is known to have negative effects on glucose transport and insulin sensitivity in obesity and Diabetes mellitus. FIG. 54 shows that fetal liver under conditions of restricted calories shows myristoyl-CoA as an interesting biomarker also.

### Example V

### Algae Modeling: Using Chlamydomonas reinhardtii as a Surrogate of Botryococcus braunii to Study Biofuels Production and Release

The goal is to penetrate the global market for advances in technologies to generate alternative fuels and exploitation of algae for production of alternative biofuels. The model organism, Chlamydomonas reinhardtii was used to design and develop a deterministic kinetic computational model of starch degradation to glucose with ultimate generation of acetyl-CoA as a precursor to fatty acid biosynthesis. This type of modeling requires knowledge of the parameters for kinetic values of reactions and they were generated from the method herein. This approach is in direct contrast with stoichiometric models that cannot reflect individual cell samples. This deterministic modeling can also be distinguished from mathematical modeling where the data from observed biological systems are used to train the model to fit the organism; whereas these results show that the transcriptome to metabolome approach generates kinetic models that behave like the living organism from which the microarray gene expression profile was generated. These fatty acids were then metabolized to generate triacylglycerides, or tri-fatty acids (TFAs). The Chlamycyc web site was particularly useful for identifying annotated genes to associate with the gene expression profiles from a genome wide microarray study. The model also mimicked transgenic expression of one gene for Botryococcus braunii, i.e., botryococcene synthase, the enzyme for the initial step in synthesizing botryococcene hydrocarbons.

Model: Algae metabolic system computational model for hydrocarbon production.

### Organism=Eukarya: Algae

Cells=Chlamydomonas reinhardtii and Botryococcus brauni

### Pathways:

Central Carbohydrate and Lipid Metabolism Pathways of Chlamydomonas reinhardtii and botryococcene biosynthesis of Botryococcus brauni were accessed from KEGG®, Chlamycyc and MetaCyc. Additional reactions of pathways for hydrocarbon production were developed my manual curation using published descriptions.

The main biochemical reactions for the synthesis of fatty acids are shown in Table 26.

TABLE 26
Fatty Acid Synthesis and Metabolism Reactions for Algae
Biofuel Simulation Model (Source: KEGG Pathways)

Malonyl-CoA + [acyl-carrier protein] = CoA + malonyl-[acyl-carrier protein].
Acyl-[acyl-carrier protein] + malonyl-[acyl-carrier protein] = 3-oxoacyl-[acyl-carrier protein] + CO(2) + [acyl-
carrier protein].
ATP + biotin-carboxyl-carrier protein + CO(2) = ADP + phosphate + carboxybiotin-carboxyl-carrier protein.
(3R)-3-hydroxyacyl-[acyl-carrier protein] + NADP(+) = 3-oxoacyl- [acyl-carrier protein] + NADPH.
(3R)-3-hydroxyacyl-[acyl-carrier protein] + NADP(+) = 3-oxoacyl- [acyl-carrier protein] + NADPH.
Acyl-[acyl-carrier protein] + malonyl-[acyl-carrier protein] = 3-oxoacyl-[acyl-carrier protein] + CO(2) + [acyl-
carrier protein].
Malonyl-CoA + [acyl-carrier protein] = CoA + malonyl-[acyl-carrier protein].
Acyl-[acyl-carrier protein] + malonyl-[acyl-carrier protein] = 3-oxoacyl-[acyl-carrier protein] + CO(2) + [acyl-
carrier protein].
(3R)-3-hydroxyacyl-[acyl-carrier protein] + NADP(+) = 3-oxoacyl- [acyl-carrier protein] + NADPH.
(3R)-3-hydroxyacyl-[acyl-carrier protein] + NADP(+) = 3-oxoacyl- [acyl-carrier protein] + NADPH.
Acyl-[acyl-carrier protein] + NAD(+) = trans-2,3-dehydroacyl-[acyl- carrier protein] + NADH.
(3R)-3-hydroxyacyl-[acyl-carrier protein] + NADP(+) = 3-oxoacyl- [acyl-carrier protein] + NADPH.
Acyl-CoA + acetyl-CoA = CoA + 3-oxoacyl-CoA.
(3S)-3-hydroxyacyl-CoA = trans-2(or 3)-enoyl-CoA + H(2)O.
(3S)-3-hydroxyacyl-CoA = trans-2(or 3)-enoyl-CoA + H(2)O.
An alcohol + NAD(+) = an aldehyde or ketone + NADH.
Acyl-CoA + ETF = 2,3-dehydroacyl-CoA + reduced ETF.
An alcohol + NAD(+) = an aldehyde or ketone + NADH.
An aldehyde + NAD(+) + H(2)O = an acid + NADH.
Acyl-CoA + acetyl-CoA = CoA + 3-oxoacyl-CoA.
An alcohol + NAD(+) = an aldehyde or ketone + NADH.
(3S)-3-hydroxyacyl-CoA = trans-2(or 3)-enoyl-CoA + H(2)O.
3-cis-dodecenoyl-CoA = 2-trans-dodecenoyl-CoA.
ATP + a long-chain carboxylic acid + CoA = AMP + diphosphate + an acyl-CoA.
RH + reduced flavoprotein + O(2) = ROH + oxidized flavoprotein + H(2)O.
RH + reduced flavoprotein + O(2) = ROH + oxidized flavoprotein + H(2)O.
RH + reduced flavoprotein + O(2) = ROH + oxidized flavoprotein + H(2)O.
RH + reduced flavoprotein + O(2) = ROH + oxidized flavoprotein + H(2)O.
Octane + reduced rubredoxin + O(2) = 1-octanol + oxidized rubredoxin + H(2)O.
RH + reduced flavoprotein + O(2) = ROH + oxidized flavoprotein + H(2)O.
An aldehyde + NAD(+) + H(2)O = an acid + NADH.
Glutaryl-CoA + acceptor = crotonoyl-CoA + CO(2) + reduced acceptor.
An alcohol + NAD(+) = an aldehyde or ketone + NADH.
Acyl-CoA + O(2) = trans-2,3-dehydroacyl-CoA + H(2)O(2).
Acyl-CoA + O(2) = trans-2,3-dehydroacyl-CoA + H(2)O(2).
(3S)-3-hydroxyacyl-CoA = trans-2(or 3)-enoyl-CoA + H(2)O.
ATP + a long-chain carboxylic acid + CoA = AMP + diphosphate + an acyl-CoA.

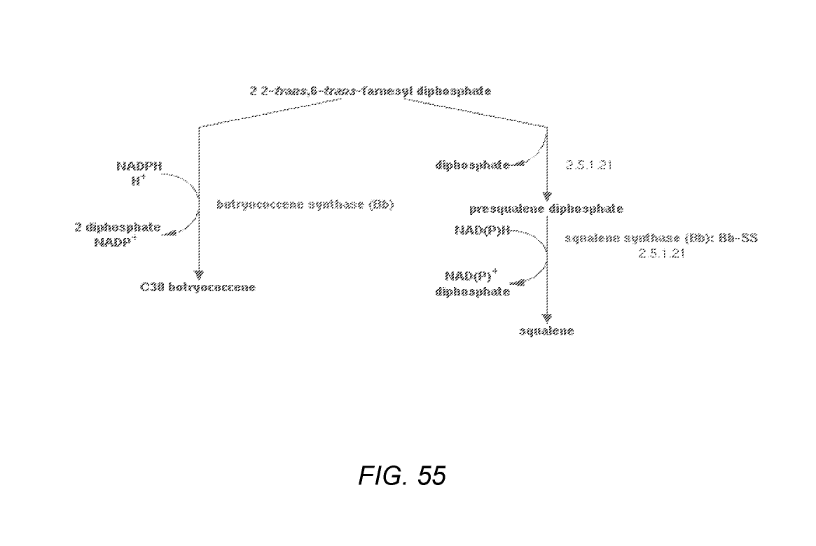

C30 botryococcene biosynthesis is depicted in FIG. 55. FIG. 55 shows enzymes only for those organisms listed. If an enzyme name is shown in bold, there is experimental evidence for this enzymatic activity.

The extracellular matrix of the alga Botryococcus braunii, consists mainly of botryococcenes, which have potential as a hydrocarbon fuel. C30 botryococcene are structurally similar to squalene raising the possibility of a common enzyme for the biosynthesis of both. The alga are classified into 3 different races (A, B and L) based on the kind of hydrocarbons they produce. The B race produces the C30 botryococcene triterpenoid hydrocarbons, the A race produces nonterpenoid alkaldienes and alkaltrienes derived from fatty acid. The L race produces tetraterpene hydrocarbons called lycopadiene. Of these C30 botryococcene are very promising as renewable source of energy. They accumulate very rapidly in the algae and have high octane rating as a fuel source for their highly branched structures. C30 botryococcene is the precursor of all other botryococcenes by methylation S-adenosylmethionine

This is a multi-pathway system kinetic model for which the parameters are determined directly from genome-wide gene expression profiles of species-specific cells. This model includes core metabolic pathways for carbohydrate and lipid metabolism unique to these organisms, and has 8 compartments, 193 species, 154 reactions, and 186 parameters all determined from cell specific microarray data sets from E-GEOD-2153 from ArrayExpress; 119 genes are represented in this model. Because the gene annotations are incomplete for both these species, some parameter estimation was required.

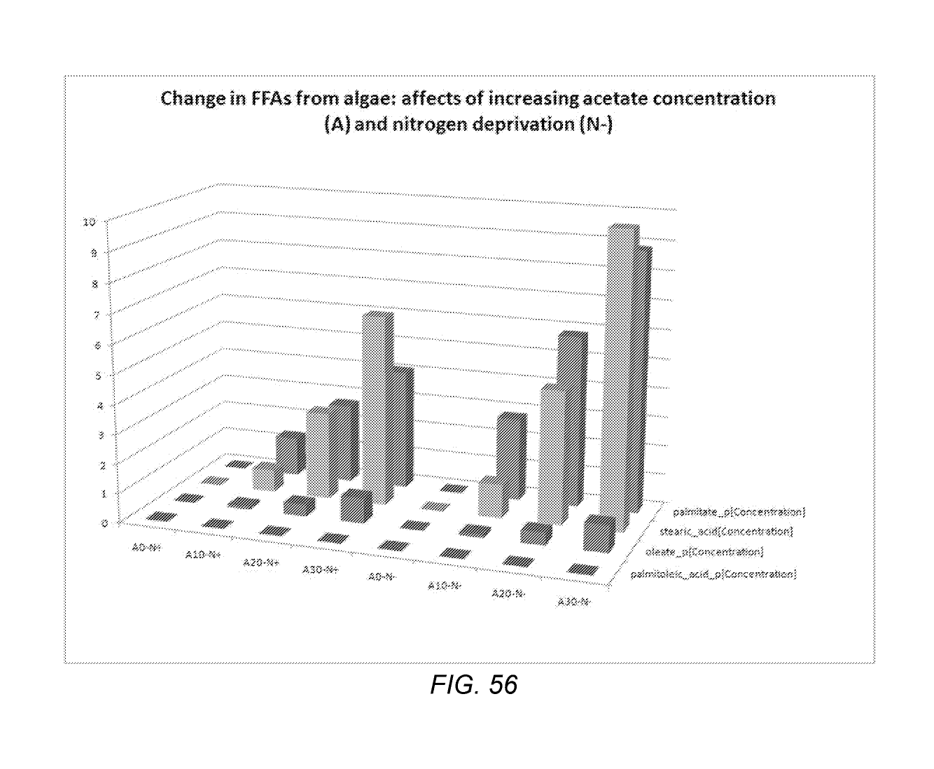

Results on initial runs showed low levels of free fatty acids and TFAs. Subsequent checking of the literature showed that an alternate carbon source is required, other than the starch from photosynthesis, for the generation of TFAs. The model was then run under 3 different levels of acetate (10, 20, and 30 mM: see FIG. 56), after having added a plastidial reaction for conversion of acetate to acetyl-CoA. This model was considered as a baseline model for which kinetic values of a subset of reactions were changed based upon fold changes in gene expression levels after nitrogen deprivation with the results validating observed changes in TFA levels in accordance with published results on actual biological samples.

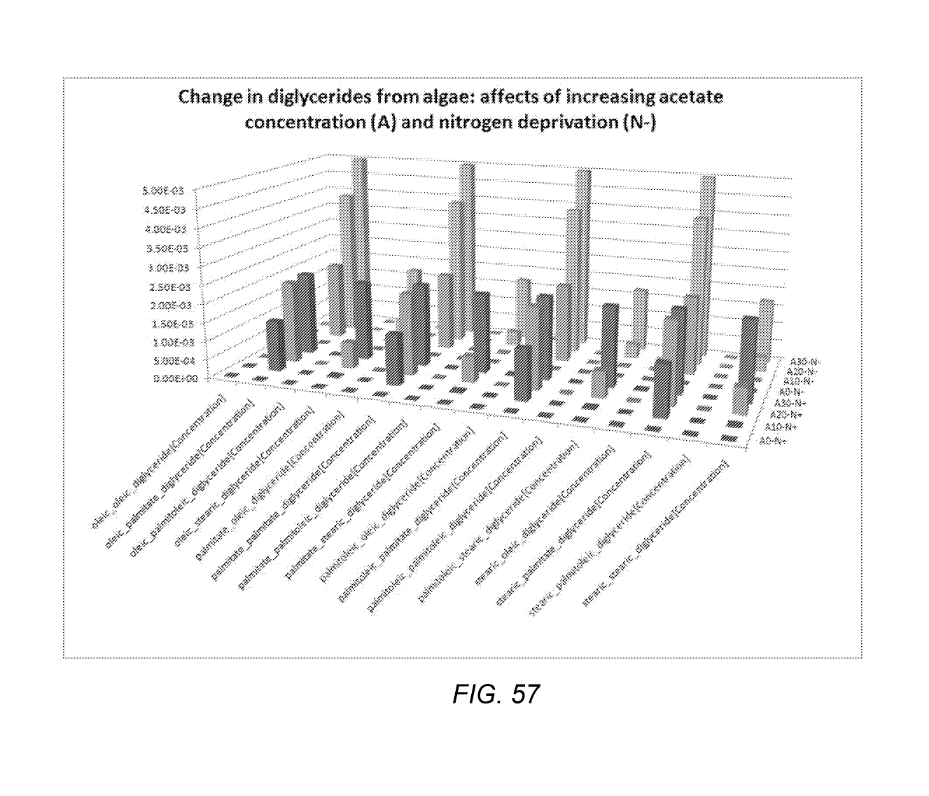

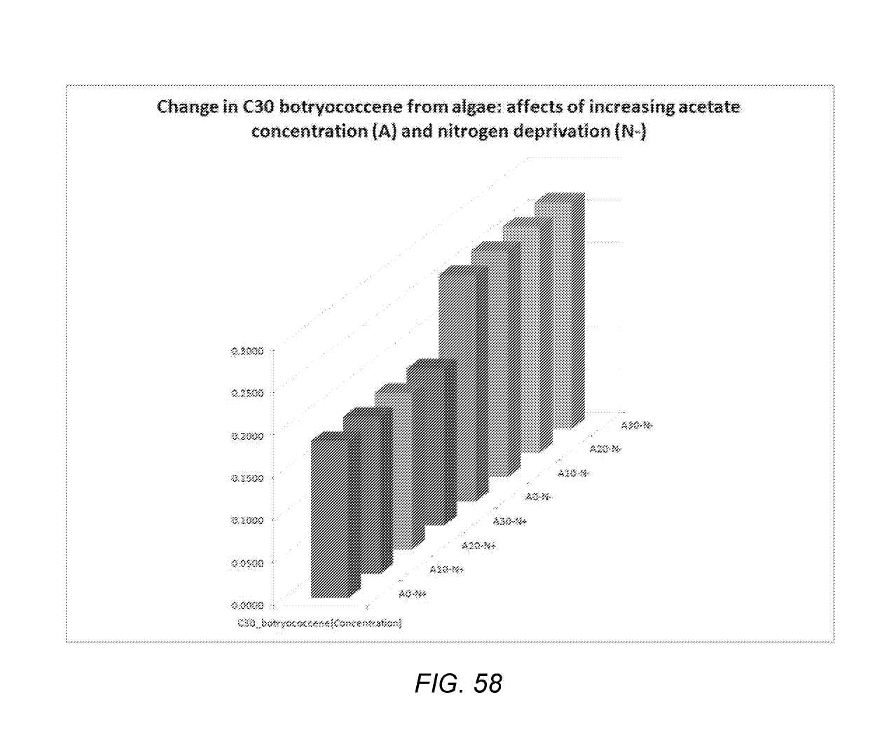

FIG. 56 depicts the results of time course biosimulation for fatty acid biosynthesis under conditions of increased acetate and deprivation of nitrogen. Palmitate and stearate were more selectively increased. FIG. 57 depicts results of simulation on diglycerides that are used by the cell for production of membrane phospholipids. Note the differential effects of acetate concentration and nitrogen deprivation on the levels of distinct subsets of diglycerides. FIG. 58 depicts results of simulation on the C30 botryococcene molecule after transgenic addition of the botryococcene synthase reaction in the model. Note that only the nitrogen deprivation had an effect (˜45% increase) that was uniform across all concentrations of acetate.

### Example VI

### In Silico Simulations of TGFbeta-1 Signaling and Apoptosis in Osteosarcoma, MG63 Cells, and Patient Samples—a Dynamic Model

Composite Biomarkers for Prognoses in Bone Cancer—using immortalized bone cancer cells as the in vitro Biological Systems Analysis. This study had as a primary design component the utilization of immortalized bone cancer cells as the ‘wet lab’, in vitro, biological system for the in silico model validation and then to use the validated model to study patient simulations based upon their response as good or poor to chemotherapy and whether metastasis had occurred. Sensitivities analyses were performed to identify candidate biomarkers that could be used along with other diagnostic tests and then to guide therapeutic and prognostic decision making clinically.

This is a dynamic model because the growth factor (transforming growth factor-β1; TGFβ-1) signaling pathway targets gene expression changes that lead to a new phenotype of the cells, e.g., epithelial to mesenchymal transition important for metastasis, or can contribute to the cells shifting into a cell death status, i.e., apoptosis. The TGF-β1 signaling pathway has several potential targets for cancer therapy.

Integrated Systems Biology (ISB) was used to study bone cancer. The in silico study was a computer simulation model of the Transforming Growth Factor-Beta (TGF-β) signaling pathway. The in vitro study was on osteosarcoma (MG-63) cells. The in vivo part was represented by gene expression profiles of patients' cancer cells, from a public database. A set of parameters from four categories of human bone cancer patient groups (based on response to chemotherapy and metastasis) was input into the computer model, obtained from Reactome®, simulating the TGF-β signaling and apoptosis pathway. The results from the computer simulation were compared to the results from the in vitro research. MG-63 cells were grown in culture and exposed to TGF-β1 to identify differences in a target-gene, transforming growth factor, beta-induced, 68 kDa protein (TGFBI), expression at various time intervals. Real-time PCR was used to measure TGFBI mRNA levels and the profile was identical temporally to that predicted by the in silico model. Because of this match, the model is validated. A sensitivities test was performed through the in silico model and the two categories with metastasis despite their response to chemotherapy showed to be more insensitive to molecules in the TGF-β signaling pathway. These sensitivities differences can possibly be used to explain the various patient responses to cancer therapy. The results will to understand why some cancer therapies fail and why some are more successful. The overall goal is to develop successful cancer therapies for the individual patient through individualized personalized medicine. No other type of computational model for TGF signaling has this capability.

Model: TGFβ-1 Signaling and Apoptosis Cancer Cell System Model: transcriptome to metabolome and reactome in silico testing—a dynamic model. Organism=human. Cells=MG63 osteosarcoma cell line and human osteosarcoma tumors. Pathways: TGFβ Signaling and Apoptosis Pathways from Reactome®, were used for the osteosarcoma cells. Manual curation was required to set the reactions and to add reactions for simulating signal-dependent regulation of gene expression over time. MG63 osteosarcoma cell microarray data sets were used from GSE11414 and Human patients' osteosarcoma tumors from GSE14827 were the source for gene expression profiles in this study.

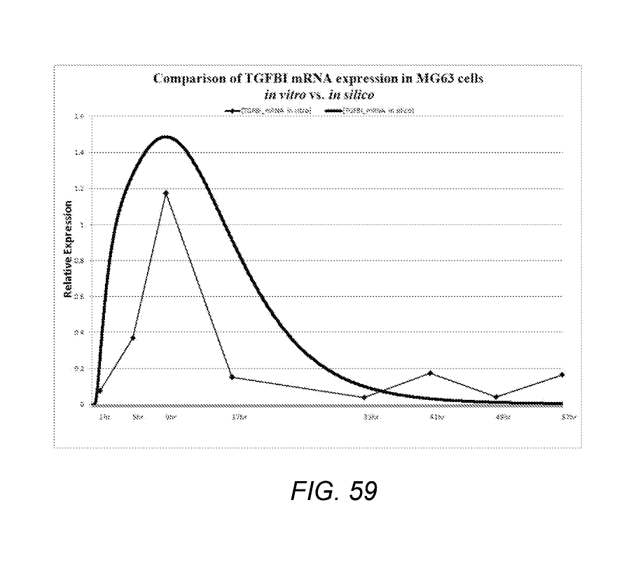

FIG. 59 depicts the temporal profile of TGFBI gene expression as mRNA levels for the in vitro (straight line curve) and in silico (smooth curve) results. This result is validation of the model. The values for relative expression on the y-axis were adjusted such that the values for both the simulation and quantitative RT-PCR can be seen.

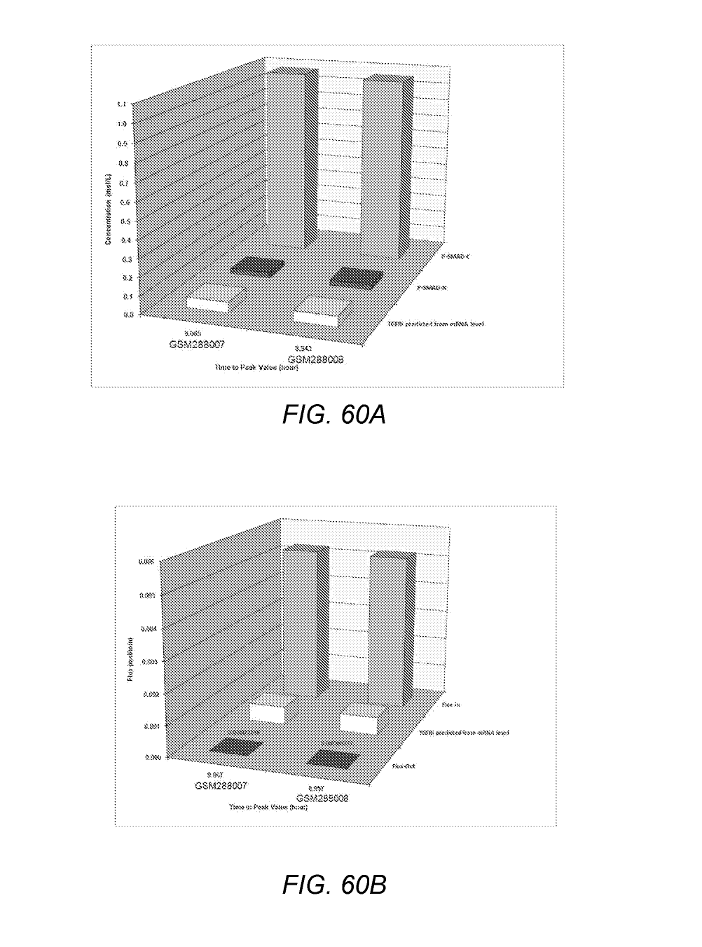

FIGS. 60A and 60B: MG63 Osteosarcoma cells, 3-D graphs showing concentration or flux on the y-axis, time to peak value and sample identifier on the x-axis and dependent variables measured on the z-axis. Results of phospho-Smad in the cytoplasm (P-SMAD-C) and in the nucleus (P-SMAD-N) are shown in FIG. 60A. The P-SMAD-N acts as a transcription factor to change gene expression; TGFBI is one of those target genes. Note uniformity of simulation results from two independent replicate microarray data sets. In FIG. 60B the flux of P-SMAD-C into the nucleus and of P-SMAD-N out of the nucleus are shown. These results show a consistent effect on the TGFBI levels as predicted from the mRNA level within each microarray data set. This TGFBI level is not the result of the simulation, but is a result from the original experiment on the MG63 cells for which the microarray test was run.

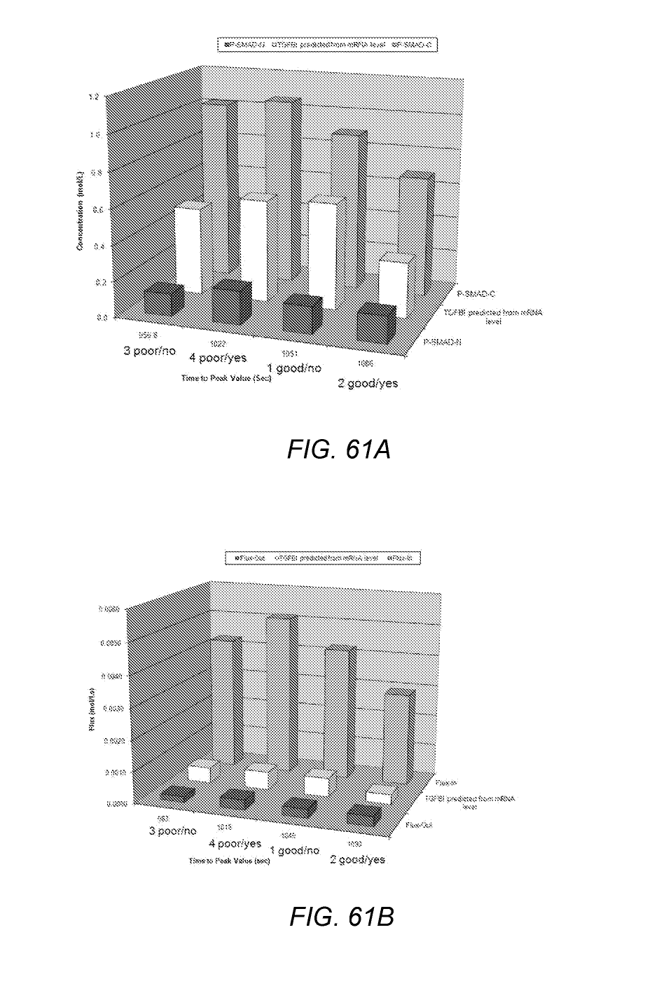

FIGS. 61A and 61B: 3-D graphs showing concentration or flux on the y-axis, time to peak value and patient category identifier on the x-axis and dependent variables measured on the y-axis. Good or poor is the response to chemotherapy and yes or no is the occurrence of pulmonary metastasis. Results of phospho-Smad in the cytoplasm (P-SMAD-C) and in the nucleus (P-SMAD-N) for the 4 categories of patients are shown in (a). The P-SMAD-N acts as a transcription factor to change gene expression; TGFBI is one of those target genes. Note how the time to peak value sorts the patient categories the same for concentration as for flux in (b). In (b) the flux of P-SMAD-C into the nucleus and of P-SMAD-N out of the nucleus are shown. These results show a consistent effect on the TGFBI levels as predicted from the mRNA level within each microarray data set. This TGFBI level is not the result of the simulation, but is a result from the original experiment on the patients' tumor cells for which the microarray test was run.

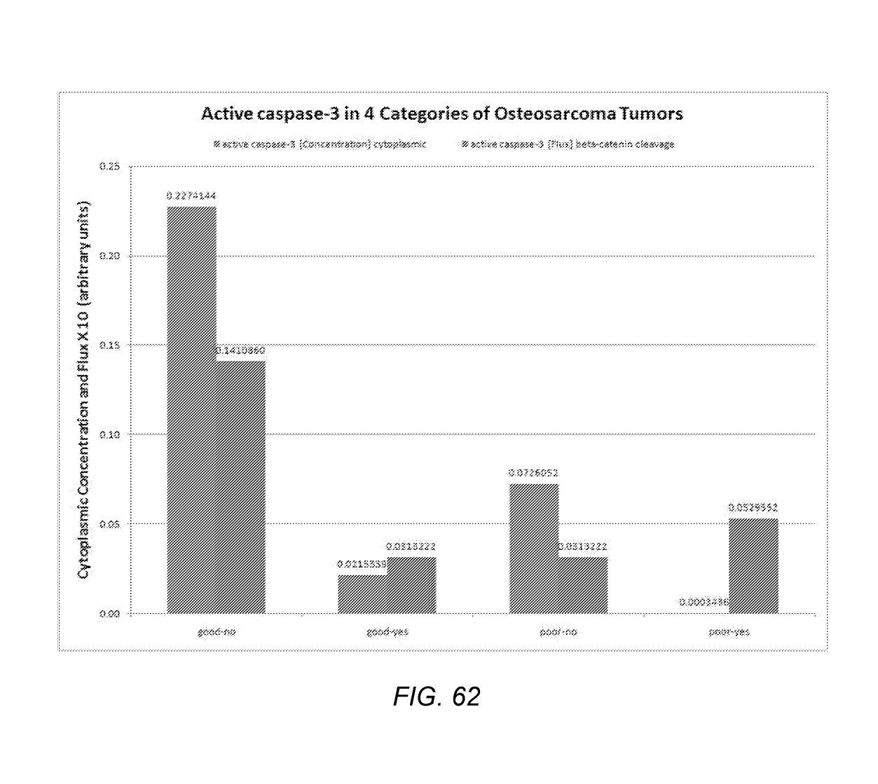

FIG. 62: Active caspase-3 is a standard biomarker for a high level of apoptosis and beta-catenin is a target of this cleavage enzyme—the flux of this cleavage reaction is shown by the right column. Note that both the concentration and activity of the active-caspase-3 are highest in the patient category with the most desired outcome from chemotherapy.

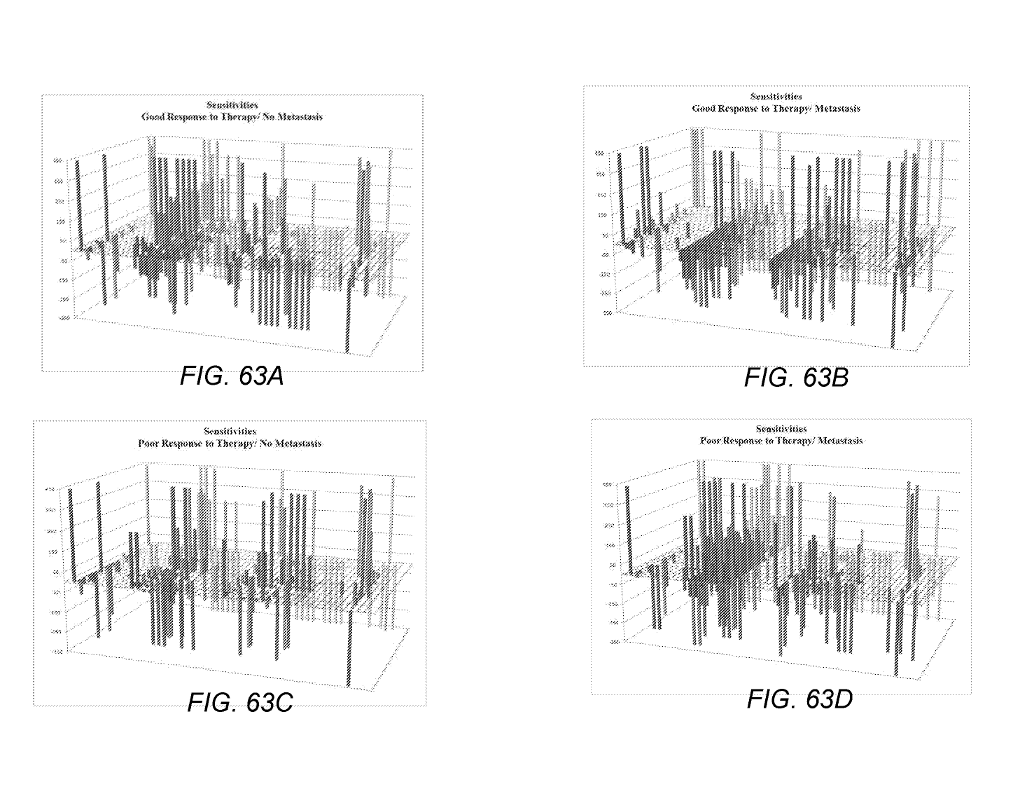

FIGS. 63A-63D: Shown are the sensitivities tests for each of the four different cancer patient groups. Despite the response to chemotherapy, the two groups with secondary tumor progression (FIG. 63B & FIG. 63D) showed more negative values, which correlate to the TGF-β1 signaling being insensitive to the molecules in those specific reactions. This set of insensitive reactions could be responsible for the epithelial to mesenchymal transition required for metastasis.

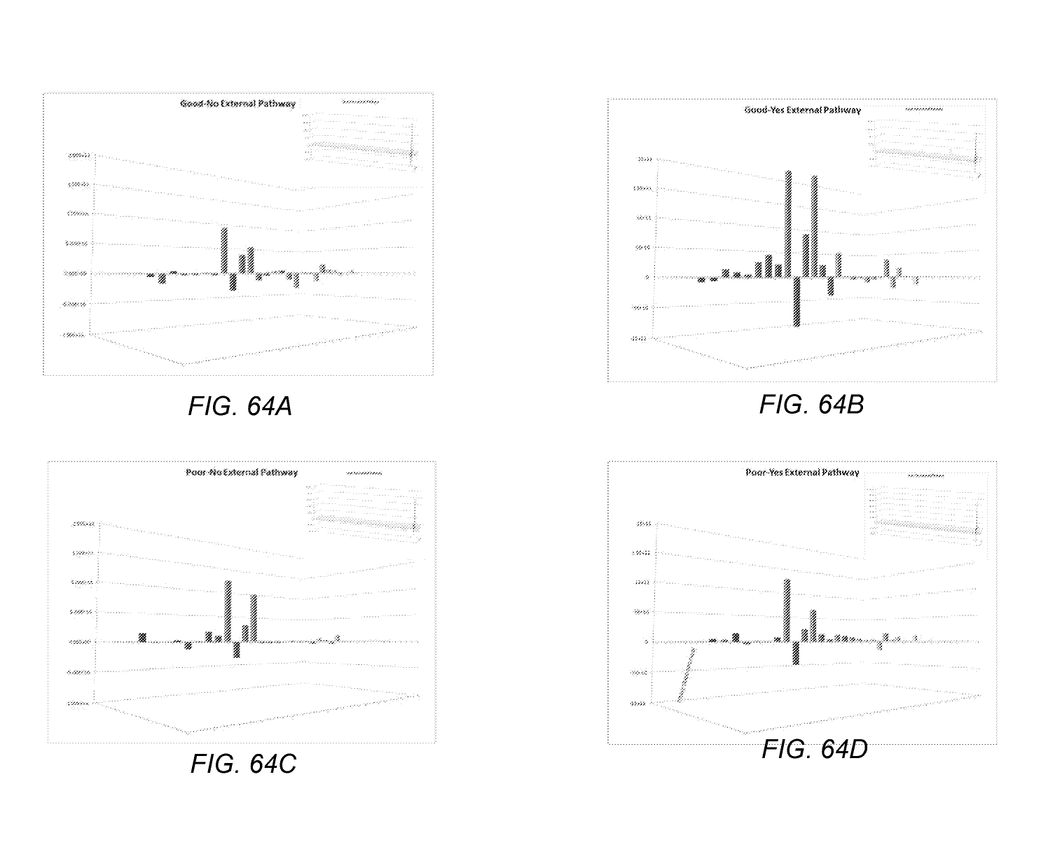

FIG. 64A-D: TGFβ1 signaling and external apoptosis (TNFα, TRAIL, FasL) pathways sensitivities analyses. Insets: When values of the Y-axis in apoptosis model (inset) were set to automatic, only one obvious set of sensitivities peaks were observed in all 4 categories of patients. When only this reactant (TRAF2:TRADD:RIP1:FADD) is graphed on the x-axis (rotated to left) and the maximum y-axis value is set at 2×10¹¹ in each category, the good/yes category is revealed to have the greatest sensitivity to this reactant, a heterotetrameric protein complex that is part of the death signal in apoptosis. This is a candidate target as a composite biomarker across all reactions or possibly as a novel target for therapeutic intervention to improve responses that prevent metastasis. X-axis=reactants; y-axis=sensitivities values; z-axis=reactions.

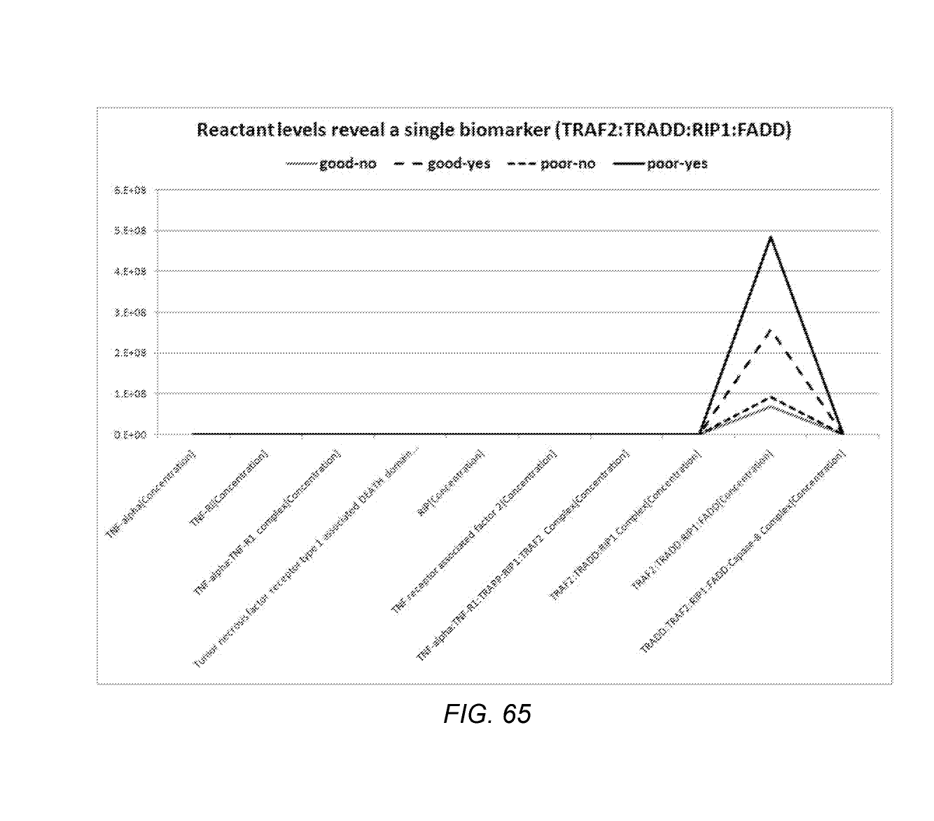

FIG. 65: Simulation results for one of the external apoptotic pathways (TNFα). Note the pronounced peak of the single biomarker (TRAF2:TRADD:RIP1:FADD), exactly the same as was revealed by the sensitivities analyses in FIGS. 64A-64D. It is the exact marker identified in the sensitivities analyses. The levels are highest in the two categories of patients that had pulmonary metastasis. These results will lead to an experimental design that will validate the findings from the simulation results.

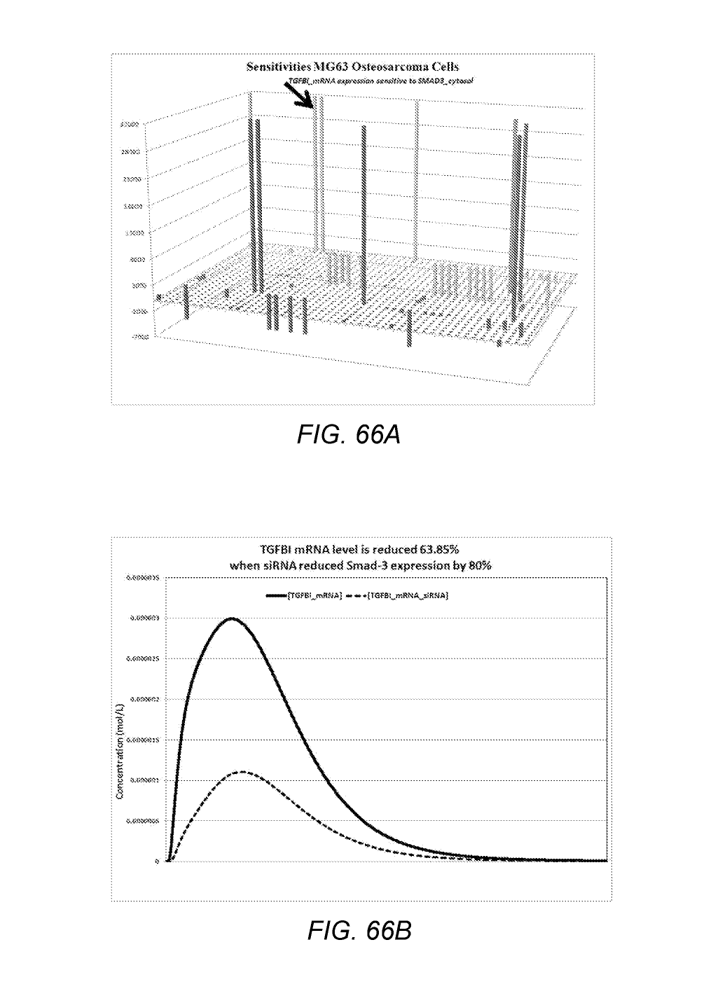

FIGS. 66A and 66B: Sensitivities analysis (FIG. 66A) of the TGFβ signaling for the MG63 cells shows only two major reactions (z-axis) with sensitivity values in the range of 3300 (y-axis). These reactions (TGFBI mRNA expression in background-arrow, and TGFβ-1 dimer binding to the TGFβ receptor-1 in foreground) are sensitive (positive value) and insensitive (negative values) to subsets of reactants (x-axis). At the arrow, the reactant is Smad-3. This was used as a biomarker for testing by simulating the use of siRNA to attenuate the expression of the candidate target, Smad-3 mRNA in the model, down to 80% below control. Note in FIG. 66B that the target gene expression (TGBI_mRNA) is suppressed down to approximately 64% of control.

### Example VII

### Surrogate Cells & Integrated Organ Systems Models of Transcriptome to Metabolome and Reactome Computational Biosimulations

Statement of Problem: Composite Biomarkers for Resistance Reversal in Childhood Acute Myeloid Leukemia—using buccal cells as surrogate for liver metabolism of cytarabine. This study had as a primary design component the utilization of oral buccal epithelial cells as surrogates for modeling the liver metabolism of a chemotherapeutic agent, cytarabine, in leukemic patients. The model includes two organ systems, hepatic and leukemic cells of the immune system.

The scientific community, biotechnology, pharmaceutical, and medical industries, have well defined gaps in their needs for Bioinformatics and Biomarkers, especially interfacing with computational, network models for simulation of biological systems and predicting prognoses. Integrative biology studies help understand how the mRNA, metabolites, and protein measurements over time after exposure to local signals, e.g., TGFβ-1, will be ‘reflected’ back onto computational network models, as part of the iterative process of tool development in Personalized Medicine. The specific intent of the project is to design, develop, validate, and test a Biosimulations “Tool” for FIPCOs (fully integrated pharmaceutical companies) to license for commercialization along with specified genomic, transcriptomic, proteomic, and metabolomic biomarkers as companion tests and individualized personalized medicine marketing strategy. Once established, these composite biomarkers and tests would be used at all stages of the disease process, i.e., diagnosis to cure. The long term goals for enhanced treatment options and successful cures, i.e., resistance reversal, are guided by a recent paradigm shift in drug development with a biomarker-driven approach to early clinical trials in oncology. Within this paradigm, the resultant rationalized-individualized-therapeutic-strategies can lead to novel molecularly targeted agents that are more effective and less toxic.

Two examples of prior art for transcriptomic-metabolomic in silico mapping for cancer cells set the stage for the studies (Ippolito et al., PNAS, 2006, vol. 103(33), 12505-12510) and Arakaki et al., Molecular Cancer, 2008, 7:57; both of which are incorporated herein by reference). The iterative process of mutual reflection of in silico onto in vitro and/or in vivo, and vice versa, is ever present in such biomarker studies. In each case, “The intracellular level of a given metabolite is predicted to be decreased or increased in cancer cells based upon an analysis of the relative expression levels of the human genes encoding for all identified enzymes that employ the metabolite as substrate or product.”, either manually (Ipolito et al 2006) or by an algorithm (Arakaki et al., 2008). These predictions are followed up by measurements of the identified metabolites from the particular cancer cells, either from cell cultures or clinical samples directly. Two key, methodological, advances are contributed by the embodiments described herein of modeling a biological system: enzymatic reactions and biological processes, e.g., drug metabolism and DNA replication, are combined into network kinetic models that actually simulate the functioning system revealing emergent properties of the reactome, fluxome, metabolome, physiome and phenome; the reactions and processes from gene expression to gene-product degradation are represented (life cycle of a protein) and thus, the proteome becomes available for biomarker analyses in silico. The transcriptome is used to determine the parameters in the deterministic model, thus generating level values for metabolites and flux through singular steps or collective pathways (FIG. 61A-B). The ultimate distinction is that a single transcription profile from an individual specimen/sample is used to ‘drive’ the simulation; not the relative gene expression levels compared with control or other reference material (Ippolito et al., 2006; Arakaki et al., 2008).

The method is an in silico version of the xenograft modeling in conjunction with the in vitro component of the NCI Pediatric Preclinical Testing Program (PPTP) with extension to clinical testing and utility. The present approach uses a proprietary method for utilizing genome-wide gene expression levels to determine the parameters in a kinetic model of comprehensive biological network systems for both static and dynamic modeling. The companion “-omics” parallel progression of the cancer and therapy, along with this biosimulation as a confirmative clinical set of composite biomarkers. By using an individual tumor transcriptomic profile to drive the kinetics of biosimulation, personalized medicine becomes individualized. If your cancer cells are used to ‘drive’ the kinetics and dynamics of this network systems model, then “it is your cancer”; a tool to characterize your cancer along with traditional differential diagnostics, to assign candidate therapies, and to test the efficacy and safety of those chemotherapies before taking those medicines yourself—to demonstrate the simulated prognosis with potential modifications throughout the therapeutic regimen and, in particular to reveal unique, possibly novel, targets for reversing resistance to chemotherapy; strategies urgently needed for clinical trail “go-no go” decisions.

A decade ago, individualized chemotherapy likely meant adjusting the dosage for each person. Even today there are concerns that ‘individualized’ is still ‘categorized’, when used in the context of personalized medicine. The types of integrated-systems-biology, “-omic”, experiments proposed have only been accomplished at the level of bacteria, with the next closest method in humans lacking the value of emergent properties recognized for simulations of biological reactions and processes. The system and method for generating a biosimulation that represents ‘your’ cancer cells extend into the next era. This is a utility not possible with mathematical modeling of cancers.

Model: Multi-organ system computational model for Surrogate Cancer Cell System Model: transcriptome to metabolome and reactome in silico testing. Organism=human. Cells=oral mucosal cells as surrogate for hepatic cells, blood lymphocytic-leukemic (cancer) cells. Organs=liver. Pathways: DNA Replication Pathway from Reactome®, was used for the leukemic cells and the metabolic pathway for transport and biochemical alteration of cytarabine were used for liver and leukemic cells in a multiorgan system model. Manual curation was required for the latter.

Human patients with acute myeloid leukemia (AML) were the source for gene expression profiles in this study. Oral epithelial buccal cell microarray data sets were used from GSE10746 for one patient with gene indicators for being a high metabolizer of cytarabine and a second patient as a low metabolizer. The Kineticome Coefficient was calculated for each gene in the transcriptomic profile and then the conversion factor was used to convert that value to one representing the human liver. These converted values were used as parameters in the model for the liver reactions. The buccal cells served as surrogate cells for modeling the liver metabolism of the chemotherapeutic agent, cytarabine. The transcriptomic profile of AML cells were used from GSE12417. The low metabolizer, surrogate, liver parameters were matched with the long survival patient's AML cell parameters. The high metabolizer, surrogate, liver parameters were matched with the short survival patient's AML cell parameters. For actual clinical use, both cell samples would come from the same individual patient. The levels of inhibited DNA polymerase and Okasaki fragments were consistent with a poor response to a standard dose of cytarabine in the high metabolizer short survival model. The sensitivities analyses showed that the model for the good response to the cytarabine was more robust.

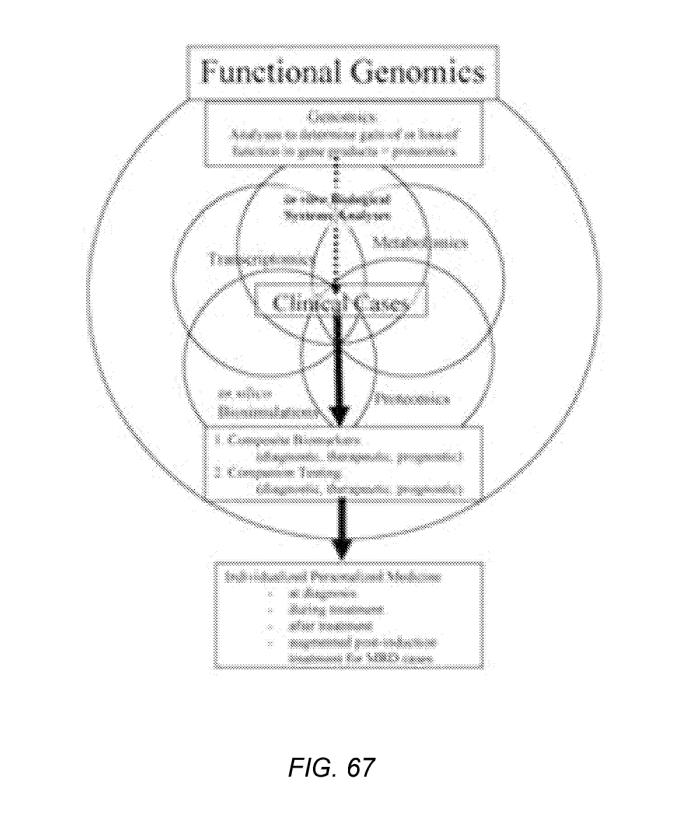

FIG. 67 is a schematic diagram, that illustrates the integrated functional genomics approach for using transcriptome to reactome and transcriptome to metabolome technology for testing clinical cases of cancers for determining biomarkers and companion testing for efficacy.

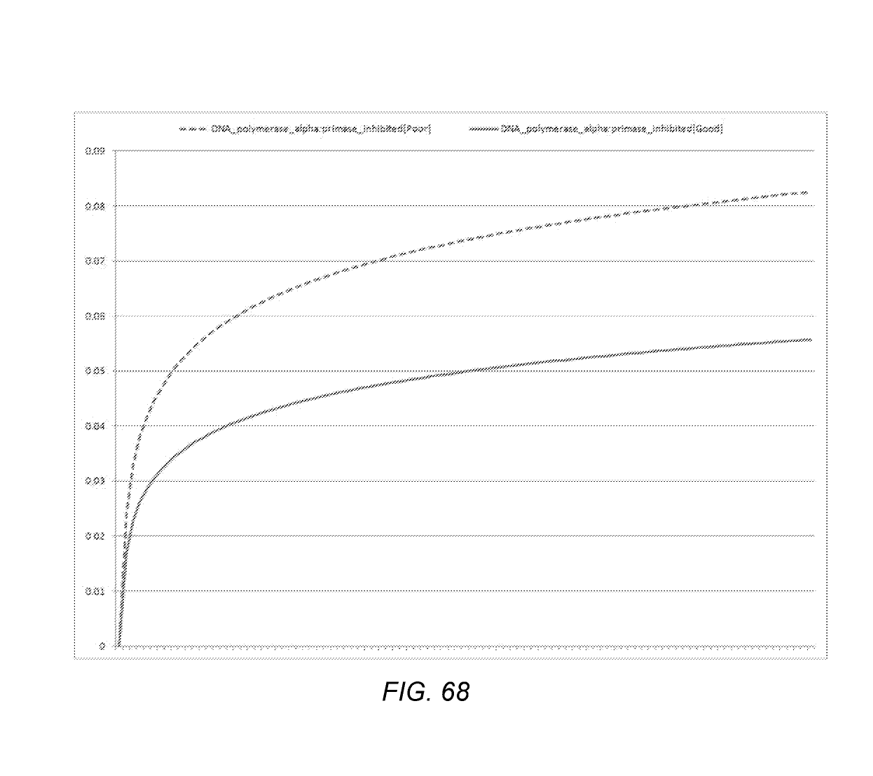

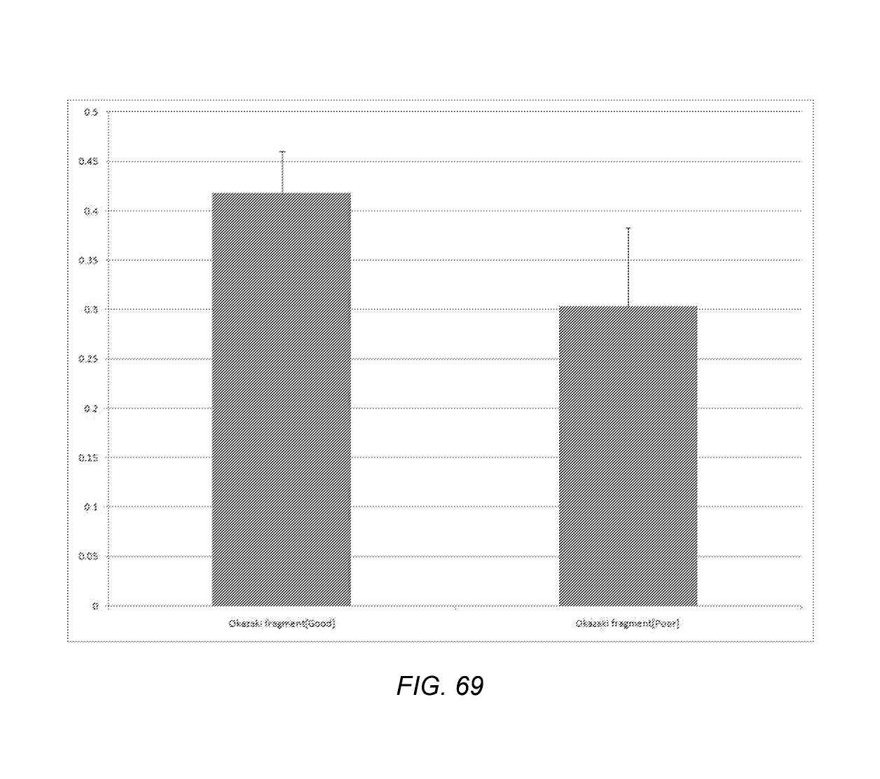

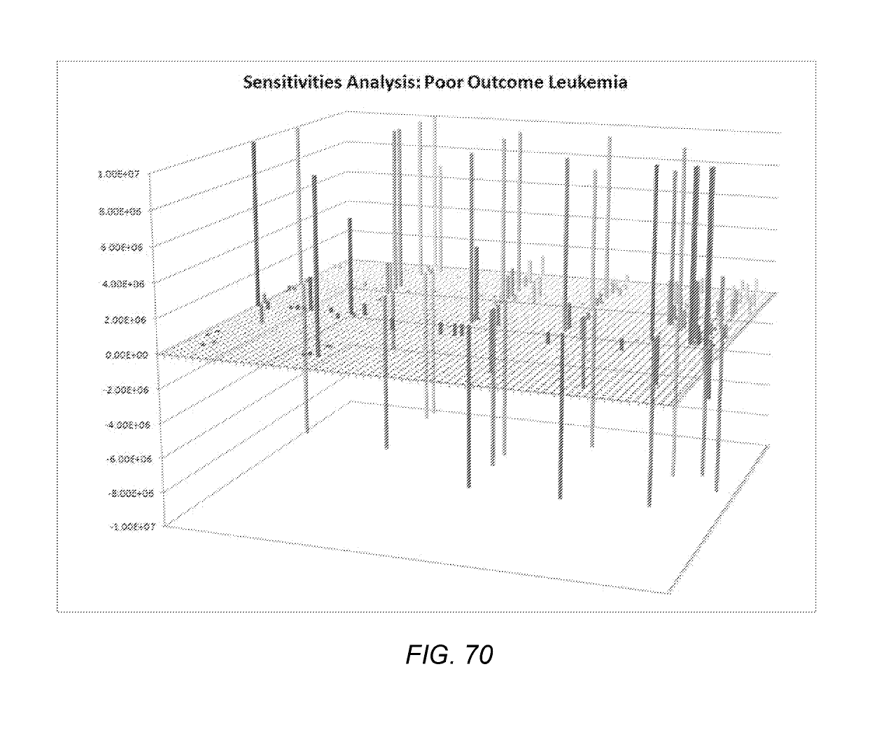

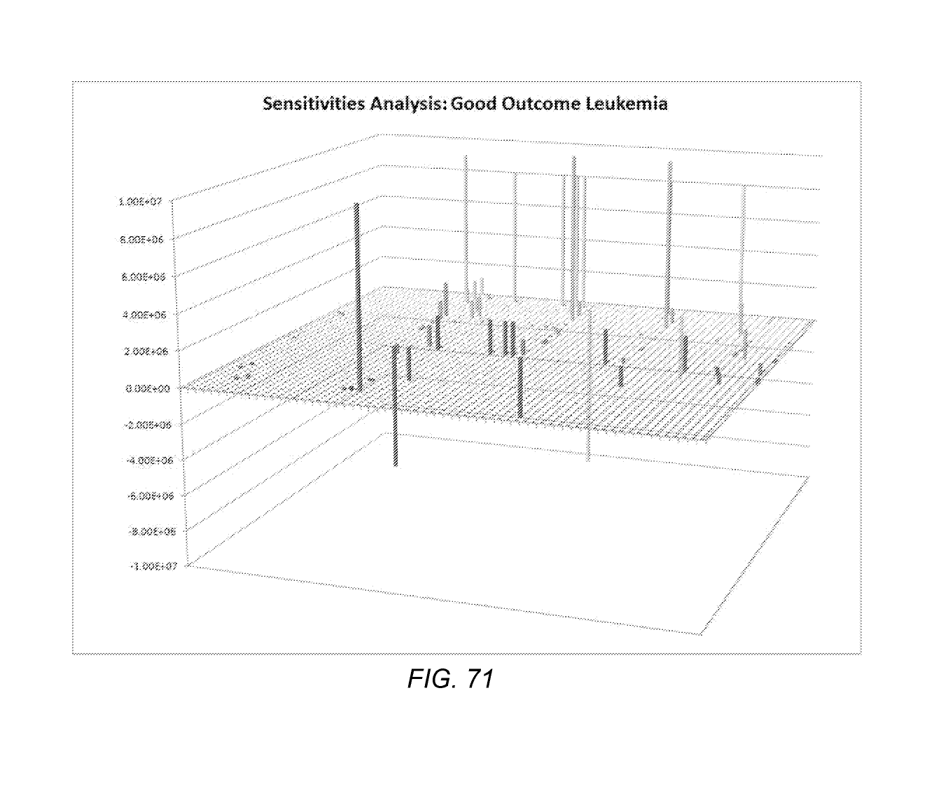

FIG. 68 depicts the results of time course biosimulation for surrogate cancer cell system model, after a challenge with a standard dose of cytarabine. This graph shows that the cytarabine generates a higher inhibition of DNA Polymerase in the poor responder; thus, less of the cytarabine is added to the replicating DNA and Okasaki fragments. FIG. 69 depicts Okasaki fragments accumulate in the good responder indicating a more successful effect of the chemotherapeutic drug. FIG. 70 depicts a sensitivities analysis of surrogated liver cells and leukemia cells in patient model for poor outcome to chemotherapeutic treatment. FIG. 71 depicts sensitivities analysis of surrogated liver cells and leukemia cells in patient model for good outcome to chemotherapeutic treatment.

### Example VIII

### Modeling Telomere Regulation Processes for Cellular Replicative Senescence And Stable Versus Unstable Growth Arrest

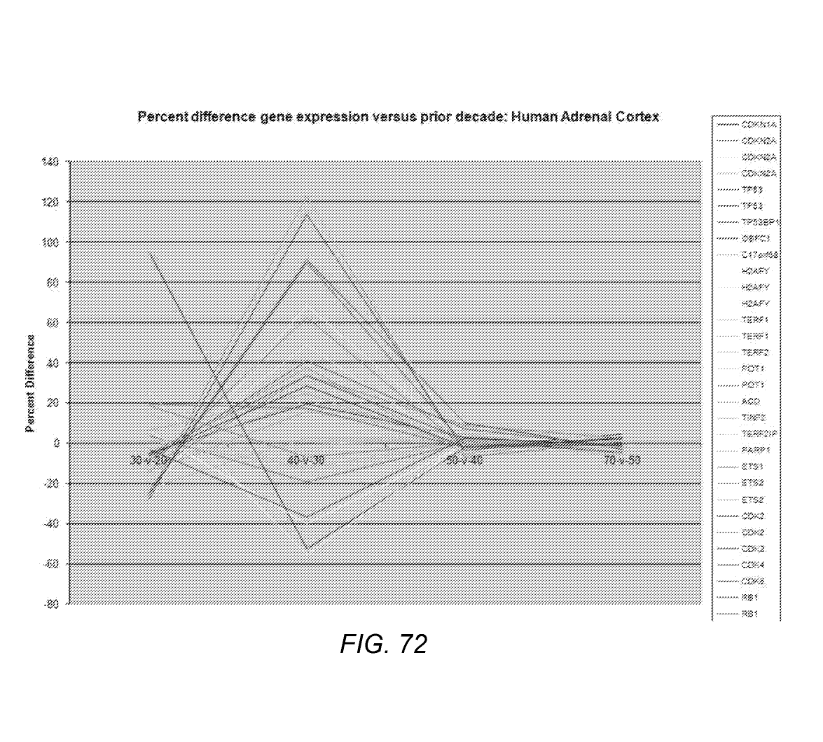

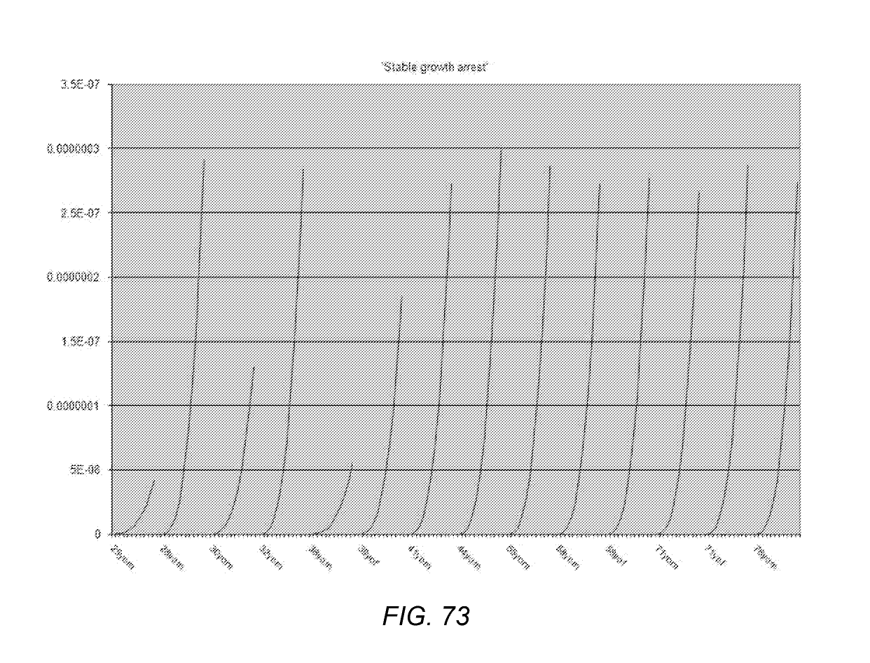

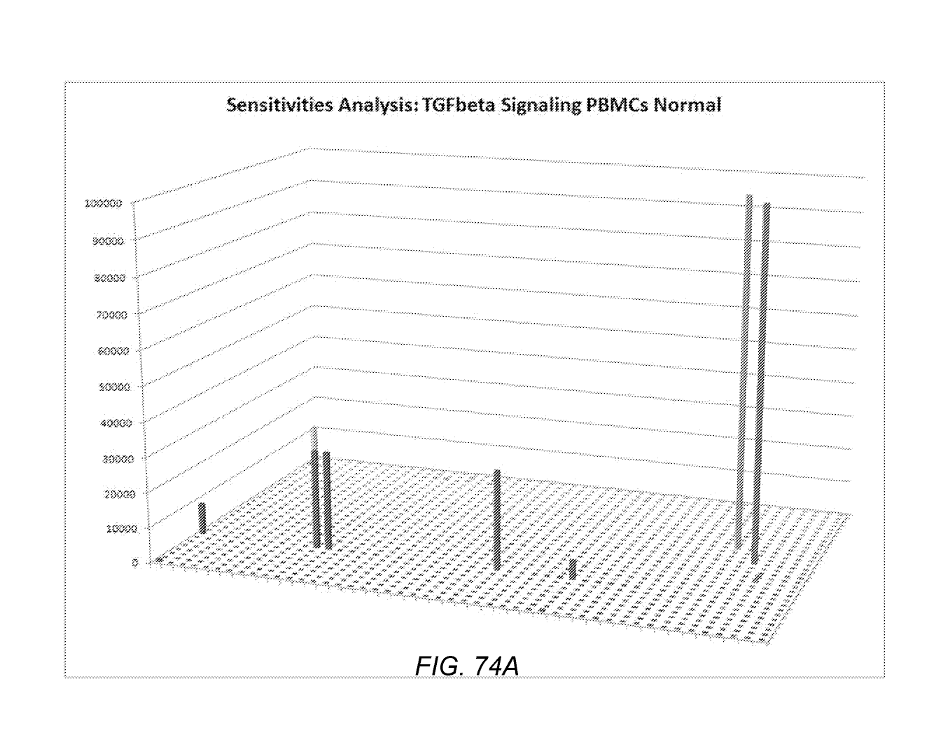

FIG. 72 depicts the percent differences in gene expression over the prior decade for the human adrenal cortex. Comparing data from tissues collected at different times can be used to show changes in gene expression over time. FIG. 73is a graph of stable growth arrest for each individual human subject in the original study.

### Example IX

### Biomarkers Phase III Development and Validation

Statement of Problem: Ex vivo simulations of TGFbeta-1 signaling in peripheral blood mononuclear cells (PBMCs) from patient samples for biomarker discovery and evaluation. This study was designed to follow the Phases of Discovery and Evaluation of Cancer Biomarkers, wherein the validated simulation model from Example IX-1 was considered to have accomplished Phase I (pre-clinical exploratory studies) and Phase II (clinical assay/technique validation studies) and the gene expression profiles from PBMCs from human females in categories of normal, benign, and malignant breast cancer in the model were tested from an existing data archive, as accomplishing Phase III (retrospective validation studies for disease detection to evaluate sensitivity & specificity of disease detection). Using the peripheral blood mononuclear cells (PBMCs) from human cancer patients demonstrated the usefulness of an ex vivo stimulation assay for assessing potential biomarkers of the TGFβ3 signaling pathway. Human patients' PBMCs from GSE27562 were the source for gene expression profiles in this study; and the TGFβ Signaling Model from Example IX-1 was used again in this study to simulate an exposure to a bolus of TGFβ-1. Thus the Method is used as an ‘ex vivo simulation assay’. The sensitivity, specificity, and predictive values of the mammography test are known, and for the GSE27562 study, Peripheral blood mononuclear cell (PBMC) samples were collected from women with a suspect initial mammogram prior to undergoing a diagnostic biopsy procedure to determine whether the detected abnormality was benign or malignant. In total, blood from 57 women with a diagnosis of breast cancer and 37 with a benign diagnosis was collected. Also collected were blood samples from 31 women with normal initial mammograms as negative controls. A total of 10 samples in each category were used for microarray gene expression profiles as training data sets; and more than twenty were available for the validation data sets. Five of each group, i.e., normal, benign, and malignant, were use in this biomarker study. The PBMCs are also an interesting cell type because they are a potential source of bone marrow mesenchymal stem cells that can infiltrate tumors and promote breast cancer metastasis making the search for potential drug interventions of value.

Sensitivities analyses were used to identify biomarkers and candidate targets for novel drug development. Also, because optimum biomarkers may also be a derivative property of the system, the slopes of temporal profiles for the reaction fluxes were assessed; also many of the limitations were overcome by the Method for large-scale cell parameter determinations for both normal and disease states in the present invention. The generic 2×2 table and formula were used for calculating sensitivity, specificity, positive predictive value, negative predictive value, and prevalence. One biomarker identified by sensitivities analysis was considered within on the groupings where the mammogram result was suspect, i.e., benign and malignant, as is often effective. The second biomarker was evaluated by including all three categories altogether.

Model: TGFβ-1 Signaling Surrogate Cell System Model: transcriptome reactome in silico testing—an ex vivo s(t)imulation model. Organism=human. Cells=peripheral blood mononuclear cells (PBMCs) from human females. Pathways: TGFβ Signaling Pathway Reactome®, was used for the PBMCs. This is the same model used in Example IX-1 for osteosarcoma cells and had been validated by that study.

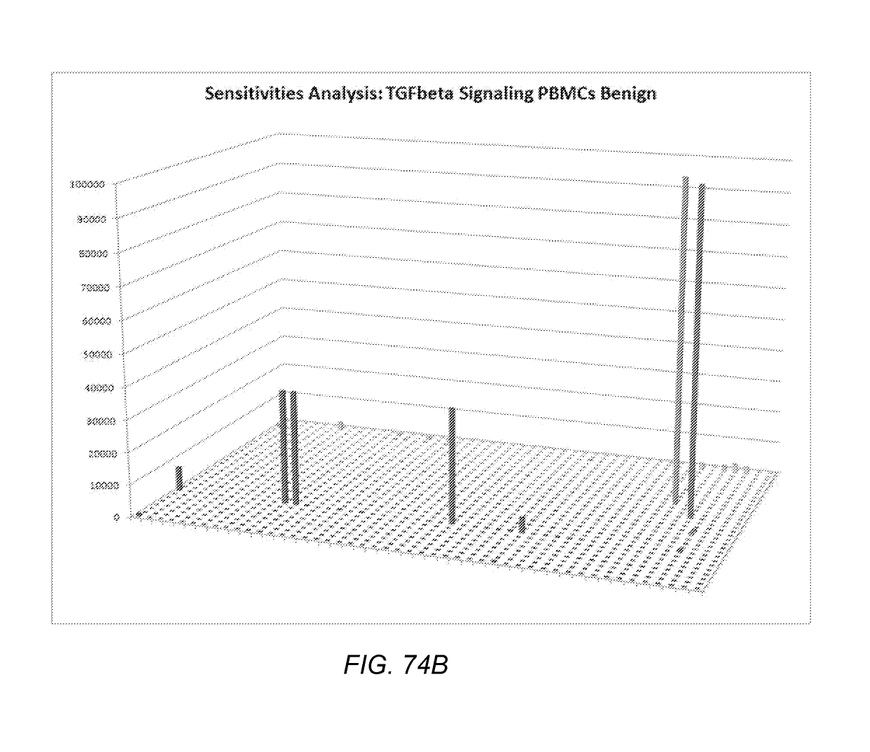

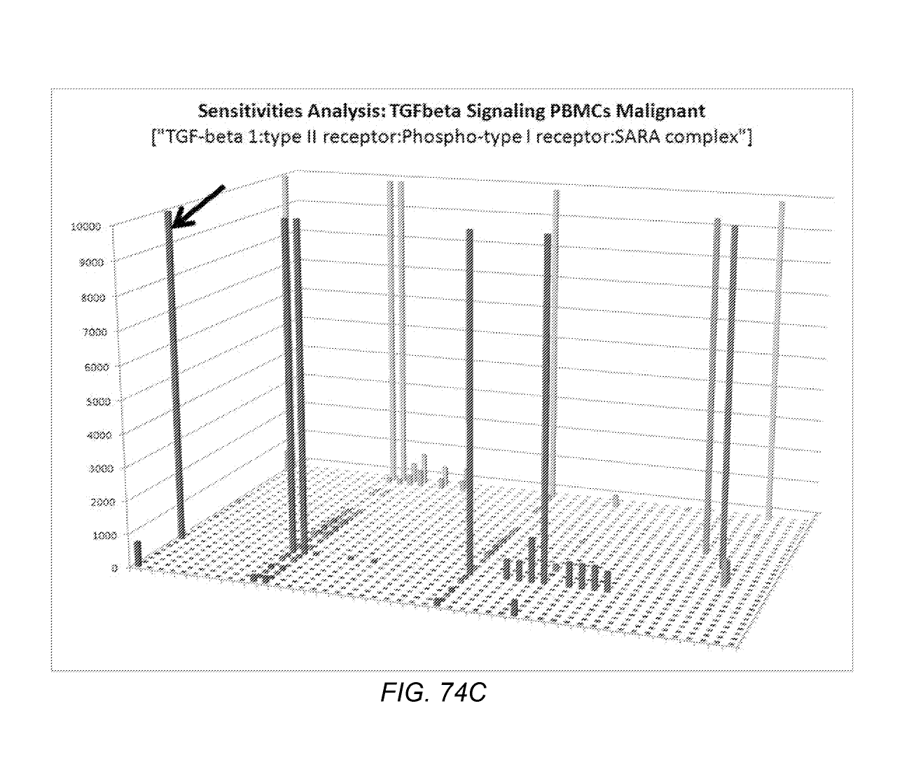

FIGS. 74A-C depict the 3D graphical display of the sensitivities analyses results on the PBMCs from the normal (FIG. 74A), benign (FIG. 74B), and malignant (FIG. 74C) groups of patient subjects. These analyses represent the average for these groups from the training data set. Note the distinct appearance of the sensitive reactions (z-axis) to reactants (x-axis) in the malignant group. The arrow identifies a unique biomarker (TGF-beta-1-Type II receptor:Phospho-type I receptor:SARA complex). The reaction is the dissociation of extracellular dimeric TGF-β1 with the Type II TGF-β Receptor. Because the biomarker is a complex of bound proteins with SARA being recruited to the activated receptors—and subsequently recruiting Smad-2 and Smad-3 to the receptor complex for phosphorylation—this biomarker is also a candidate target for novel drug development to affect this step in the signaling process. In this sense, this target in this cell population would be important to modify this cell population that insinuates itself into developing tumors, in particular malignant tumors. and contributes to the local milieu for promoting metastasis.

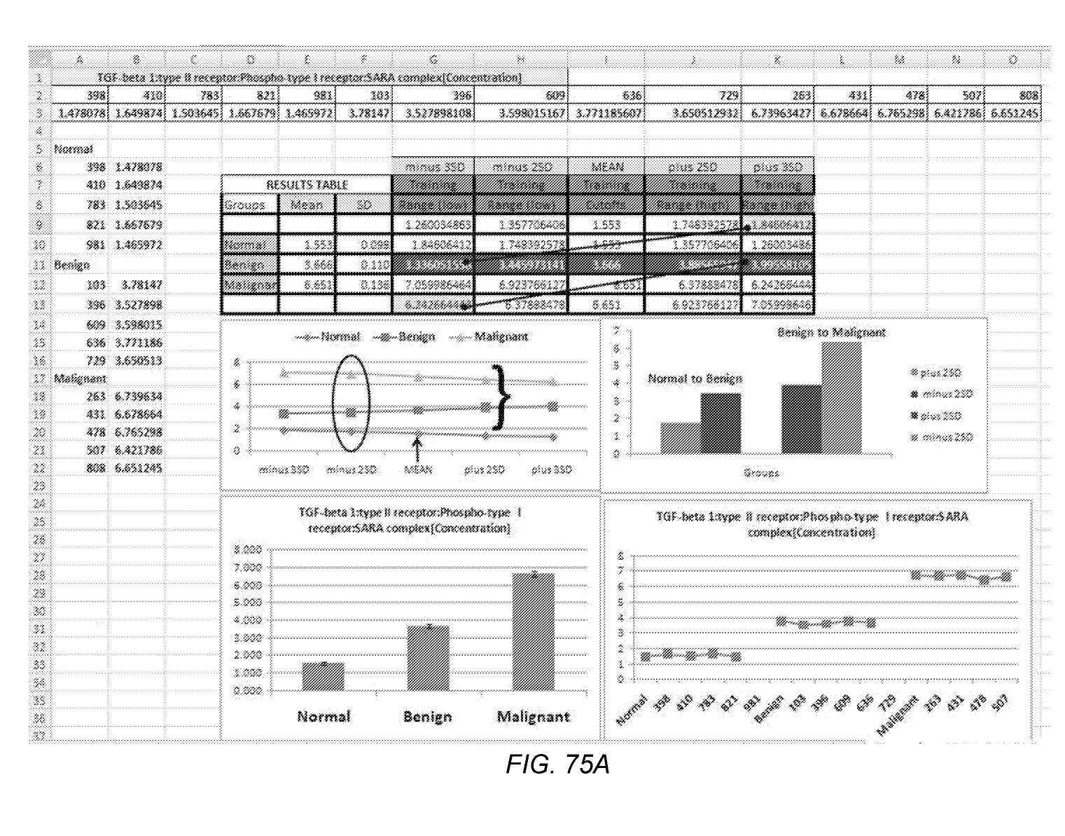

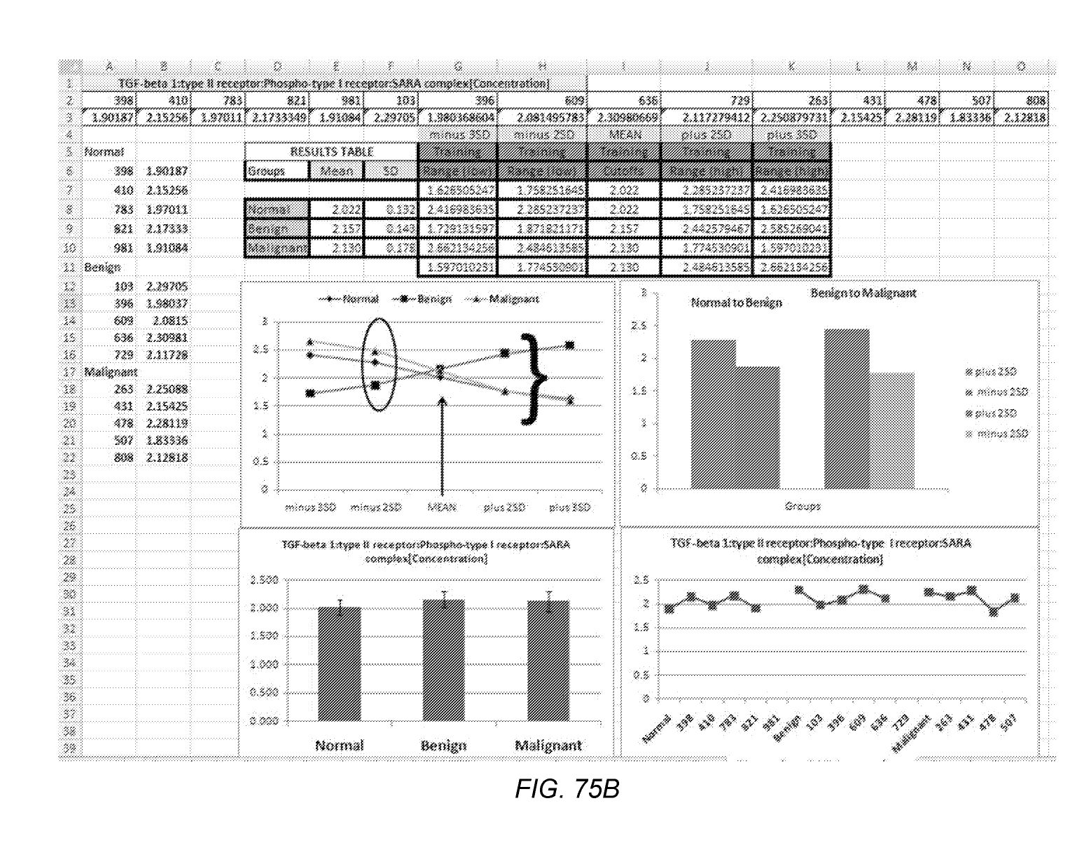

FIG. 75A-B depict the results of the training set of PBMCs for assessing the “SARA” biomarker identified by the sensitivities analyses in FIG. 74. An idealized result is shown in FIG. 75A where 2 was added to the test results for benign and 5 was added to the test results for malignant. This demonstrates how the Results Table and graphical displays allow rapid visual screening of the mean values and ranges (plus and minus 2 and 3 standard deviation) of the expected test results for the three patient groups. The actual results for this biomarker are shown in FIG. 75B and are more typical of realistic results, especially when using surrogate cells that have not been affected by and are not (representing) the tumor cells themselves (see Example VIII).

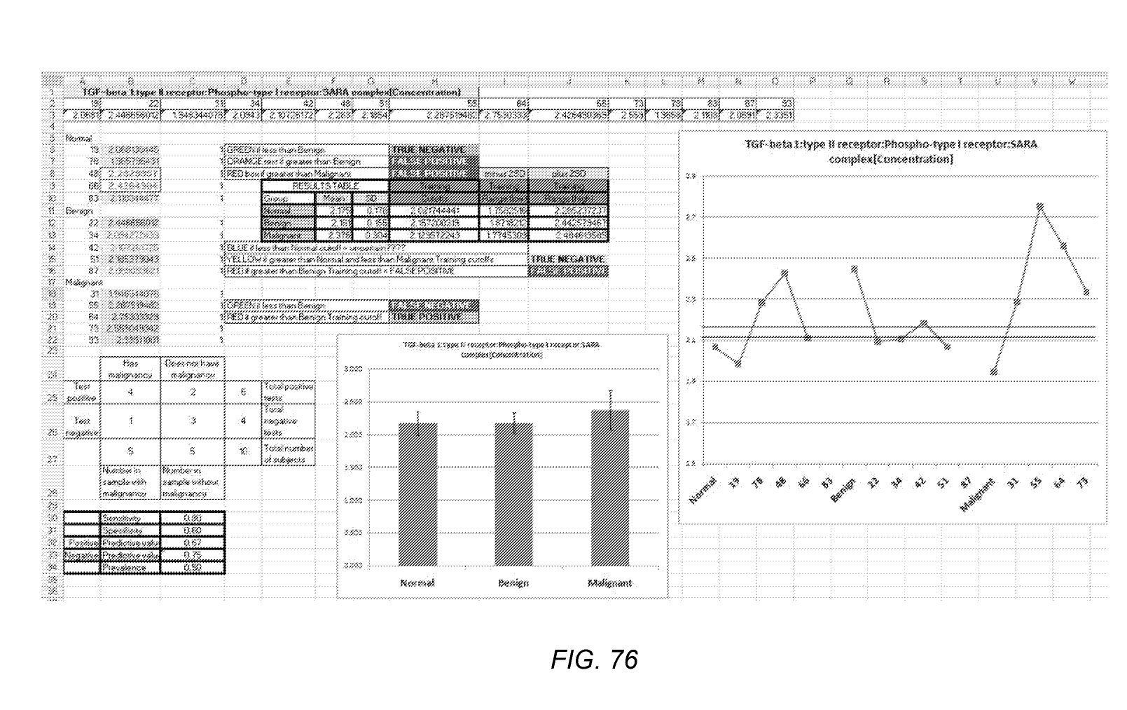

FIG. 76 depicts results of the validation data sets using the training data set results as cut off values for the “SARA” biomarker test results to assign patients to the diagnostic categories of normal, benign, and malignant. The True Positives, True Negatives, False Positives, and False Negatives are revealed in the patient test values at the far left. The 2×2 table is shown on the bottom left with the calculations of sensitivity, specificity, positive predictive value, negative predictive value, and prevalence in the far bottom left.

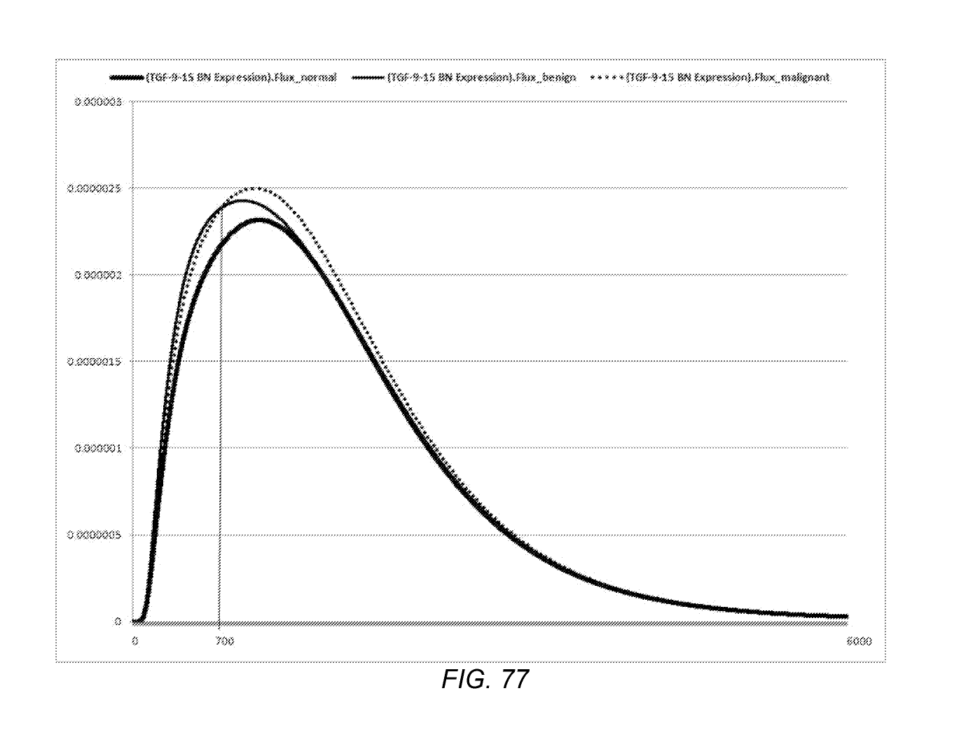

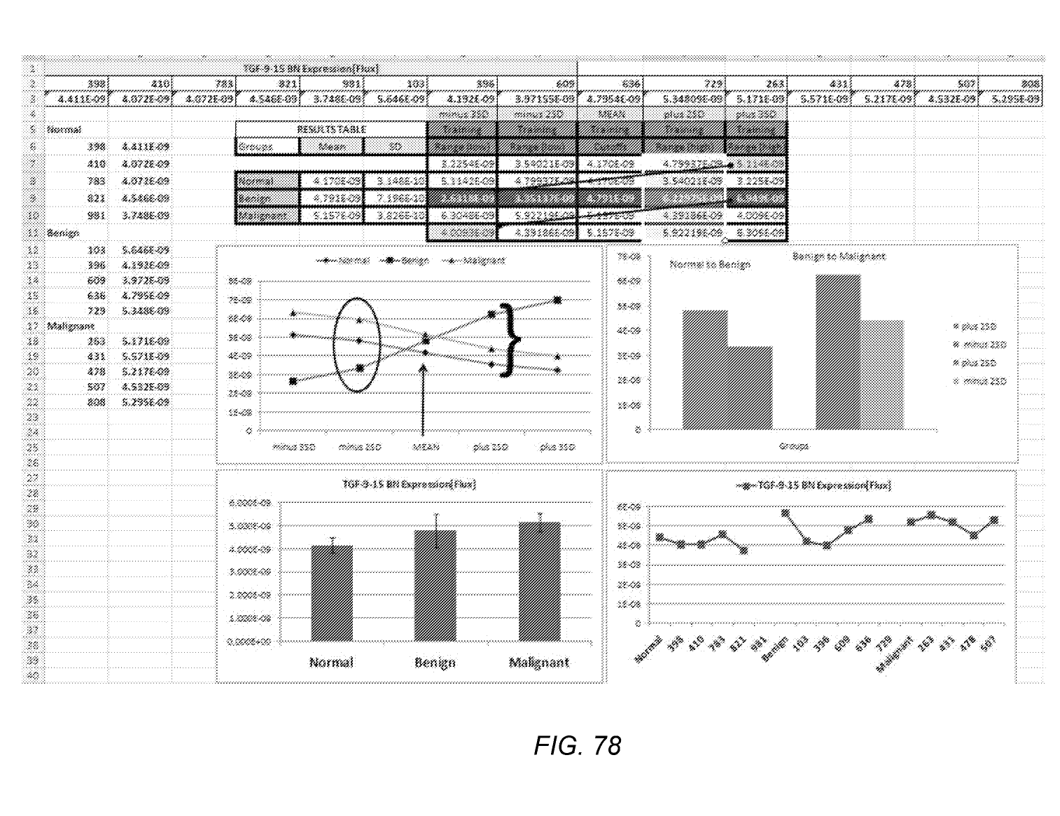

FIG. 77 depicts a temporal profile of the flux through the model simulation of the TGFBI (also called betanectin or BN) mRNA expression—the target gene of TGFβ1 signaling validated in Example VIII. These curves represent the averages of the training data sets for normal, benign, and malignant groups. Visual inspection indicated the slope of the rising phase might be a useful optimum biomarker derivative property of the system. The simulation time of 700 is shown with the vertical line that intersects with the first point of convergence of the benign (thin solid line) and malignant (dotted line) results. The slopes of these lines from time zero to 700 were used for biomarker analysis on the training data set and then validation data set.

FIG. 78 depicts the results of the training set of PBMCs for assessing the biomarker identified by the temporal analyses in FIG. 77. The slope of the first 700 events was calculated for each individual subject in the normal, benign, and malignant training data set. The Results Table shows the derivation of the cut off values and ranges used for the validation study. The graphical displays assist with visual assessment of the potential efficacy of the data, e.g., for mean (arrow), plus two standard deviations (bracket), and minus two standard deviations (elliptic outline).

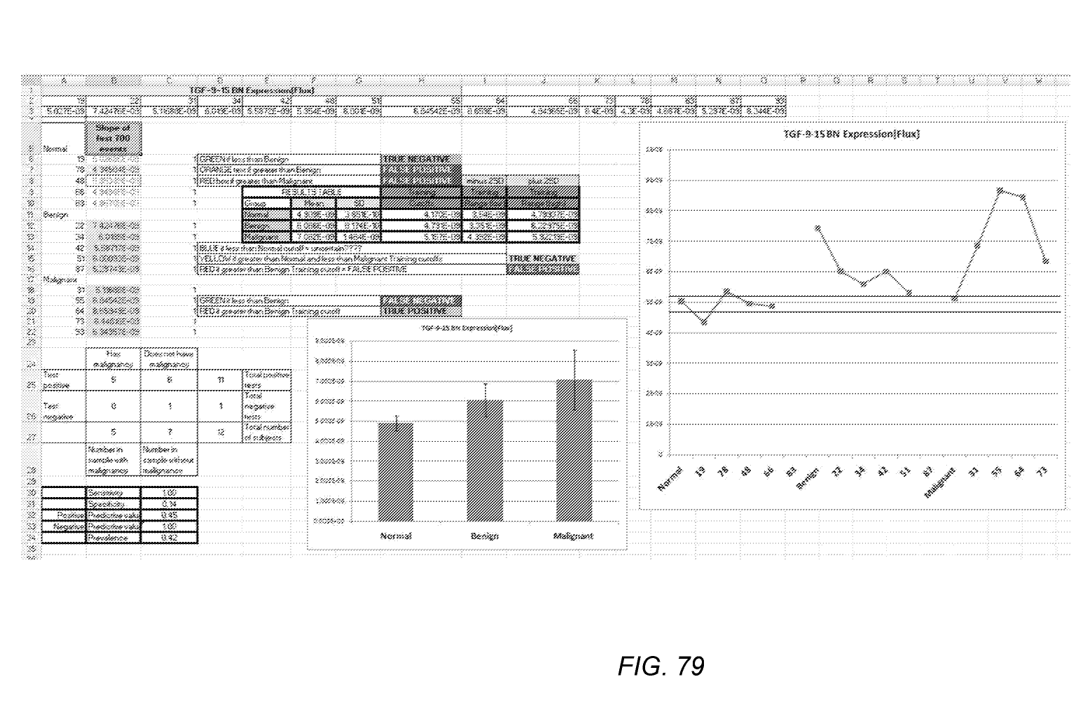

FIG. 79 depicts the results of the validation data sets using the training data set results as cut off values for the “slope of BN mRNA expression flux” biomarker test results to assign patients to the diagnostic categories of normal, benign, and malignant. The True Positives, True Negatives, False Positives, and False Negatives are revealed in the patient test values at the far left. The 2×2 table is shown on the bottom left with the calculations of sensitivity, specificity, positive predictive value, negative predictive value, and prevalence in the far bottom left. In this case, the calculation included normal, benign, and malignant patient cases, altogether.

The above represent specific examples of biosimulation models. Using the techniques specified herein it should be understood that the biosimulation models may be generated for the following:

Prokarvotes:
Bacteria (e.g., models to determine effects of agents in treatment of bedsores, infectious disease, etc.)
Archaea (e.g. generating hydrogen),

Eukaryotes:
Algae (e.g., biofuels—modeling of manipulation of algae cells to enhance lipid production and harvest)

Animal:
Mouse, buffalo, bovine, rhesus (e.g., modeling estrogen/progesterone profiles)
Domesticated pets like dogs and cats (e.g., individualized diet determination)

Human:
Cancer treatment/therapy (e.g., modeling of tumor cell response to therapeutic agents)
Brain/Alzheimer's studies (e.g., modeling neurological cell response to therapeutic agents)
Atherosclerosis (e.g., modeling effects of nutrition, therapeutic agents, lifestyle changes on cholesterol metabolism, etc.)
Individualized medicine (e.g., work from patient's cells/transcriptome to determine individual response to agents, e.g. insulin, cholesterol etc.; diagnosis/prognosis based on individual metabolic profiles)
Surrogate cells (e.g., modeling use of cheek cells, etc. as surrogates for brain, liver metabolism studies)

Misc:
Agricultural/livestock industry (e.g., modeling livestock meat/fat production, crop growth enhancement)
Insects and plants for pesticide/herbicide resistance.
Drug discovery and evaluation (e.g., modeling of tumor growth or metabolic response to therapeutic agents; reduce need for in vivo studies)
Research Use (e.g., study of biochemical pathways, metabolic indicators, biomarkers)

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method for simulating the reactions (reactome) of known biological pathways using a computer-implemented computational modeling system containing biological, natural, and synthetic chemicals, compounds, and molecules of the biological pathway, the method comprising:
obtaining a data set representing the gene expression values levels (transcriptome) for a biological specimen;
inputting the gene expression values into the modeling system;
wherein the modeling system applies the gene expression values to derive the kinetic reaction rate value (kineticome) for protein and reactant interactions of the biological pathway.

2. The method of claim 1, wherein the biological specimen is derived from a single individual, and wherein the modeling system is customized for the individual.

3. The method of claim 1, wherein the biological specimen is derived from one or more individuals having a specified disease state or condition, and wherein the modeling system is customized for individuals having the specified disease state or condition.

4. The method of claim 1, wherein deriving the kinetic reaction rate value comprises:
the modeling system assigning a Kineticome Control Coefficient, computationally derived from the value of gene expression level value;
the modeling system assigning a weighting factor that is combined with the Coefficient to derive a gene expression index value; and
the modeling system applying the derived gene expression index as the kinetic reaction rate value (kineticome) for each protein and reactant interaction of the biological pathway.

5. The method of claim 1, further comprising wherein the modeling system generates an output data set representing the simulated reactions (reactome) and metabolites (metabolome) of the biological pathway in the biological specimen; and wherein the modeling system generates an output of biological processes representing functional properties of living systems.

6. The method of claim 1 wherein the biological specimen is a treated biological specimen, such treatment comprising:
exposure to a nutritive or other energy source, physical activity, therapeutic agent, gene, protein, enzyme or other substrate;
wherein the gene expression level values represent the effect of the treatment on the biological specimen;
wherein the output data set represents the simulated reactions (reactome) and metabolites (metabolome) of the biological pathway in the treated biological specimen;
wherein the modeling system generates an output of biological processes representing functional properties of living systems.

7. The method of claim 1, wherein the data set representing the gene expression level values (transcriptome) for the biological specimen are obtained through microarray analysis.

8. The method of claim 1, wherein the gene expression index for each gene is computationally derived as a combination of proportion of the total of gene expression level values within the gene expression values data set, called the Kineticome Control Coefficient, and a weighting factor accounting for other determinants of kinetics collectively.

9. The method of claim 1, wherein the kinetic reaction rate value (kineticome) applied by the model for each protein and reactant interaction of the biological pathway is adjusted by a mathematical modification of either the Coefficient or weighting factor, such mathematical factoring comprised of one or more of the following:
a user-defined input variable; or
an input variable derived by the modeling system through analysis of the output deviation from a desired target output data set.

10. The method of claim 1, wherein the biological pathway is one or more metabolic pathways.

11. The method of claim 1, wherein the modeling system is a model of at least the major biological pathways for an entire organism.

12-17. (canceled)

18. The method of claim 1, wherein the modeling system is a model of human or other animal species.

19. The method of claim 1, wherein the modeling system is a model of a known biological pathway.

20. The method of claim 1, further comprising studying the effects of genetic manipulation using the modeling system.

21. The method of claim 1, wherein the modeling system is a model of various pathways in cells, tissues, organs and whole organisms.

22-24. (canceled)

25. The method of claim 1, wherein the biological specimen obtained from an individual is derived from a surrogate cell or tissue source and the modeling system is utilized to predict simulation outcomes for other cells, tissues, organs or organ systems within the individual.

26. The method of claim 1, further comprising studying the effects of disease status or disease progression using the modeling system.

27. The method of claim 1, further comprising studying the effects of diet, exercise or lifestyle behavior using the modeling system.

28. A method for identifying a therapeutic agent for a disease state or condition in an individual that is the source of a biological specimen or sample, based on use of a computer-implemented computational modeling system, the method comprising:
obtaining a data set representing the gene expression values levels (transcriptome) for the individual biological specimen;
inputting the gene expression values into the modeling system;
wherein the modeling system applies the gene expression values to derive the kinetic reaction rate value (kineticome) for protein and reactant interactions of the biological pathway;
determining the effect of a therapeutic agent on one or more protein and reactant interactions of the biological pathway; and
adjusting the modeling system to take into account the effect of the therapeutic agent;
assessing if the therapeutic agent has a therapeutic effect with respect to the disease state or condition based on the behavior of the adjusted modeling system.

29-30. (canceled)

31. A method for determining a response to a therapeutic agent for a disease state or condition in an individual that is the source of a biological specimen or sample, based on use of a computer-implemented computational modeling system, the method comprising:
obtaining a data set representing the gene expression values levels (transcriptome) for the individual biological specimen;
inputting the gene expression values into the modeling system;
wherein the modeling system applies the gene expression values to derive the kinetic reaction rate value (kineticome) for protein and reactant interactions of the biological pathway;
determining the effect of a therapeutic agent on one or more protein and reactant interactions of the biological pathway; and
adjusting the modeling system to take into account the effect of the therapeutic agent;
assessing the therapeutic efficacy of the agent with respect to the individual based on the behavior of the adjusted modeling system.

32-33. (canceled)
